(19) United States
(12) Patent Application Publication
(10) Pub. No.: US 2002/0132214 A1
(43) Pub. Date: Sep. 19, 2002

(54) Medical patient training systems and methods

(75) Inventors: Linda A. Mattson, Nashville, TN (US); Gayle W. Hall, Orange Park, FL (US)

Correspondence Address: GAMBRO, INC, PATENT DEPARTMENT, 10810 W COLLINS AVE, LAKEWOOD, CO, 80215, US

(73) Assignee: Gambro, Inc.

(21) Appl. No.: 10/042,050

(22) Filed: Jan. 7, 2002

Related U.S. Application Data
(60) Provisional application No. 60/260,160, filed on Jan. 5, 2001.

(51) Int. Cl. G09B 7/00

(52) U.S. Cl. 434/323; 434/365

(57) ABSTRACT

A system and/or a method for training a patient/learner, the system or method including one or more training modules, each training module involving a concept or operation to be learned, at least one such training module containing an illustration of at least a part of the concept or operation and including the presentation to the patient/learner of the illustration of a training module, and the presentation to the patient/learner of the concept or the operation; and the demonstration by the patient/learner of the concept or the operation. A system or method of this invention may particularly involve dialysis or peritoneal dialysis patients.

### INTRODUCTION

This invention is related generally to educational and/or training means and/or methods for medical patients, and more particularly is concerned with new patient educational/training systems and methods directed to achieving desirable patient outcomes. The currently described systems and methods involve the tasks needed and the different types of education required for a patient to learn to perform certain medical operations for themselves; taking as particular examples, dialysis and/or peritoneal dialysis. The systems may include methods and lesson plans and/or media which provide stimulation for various types of learning/training situations.

### BACKGROUND

Training medical patients self-care concepts and procedures are difficult issues for care-givers. Such patients usually have exceedingly varied educational backgrounds, and they typically experience learning in variety of distinct ways. Also, care-givers need educational/training systems that they can deliver themselves, thus not requiring external trainers to come in and give training, and that they can use on-site either in a clinic or at the patient's home as opposed generally to in a classroom. The training systems of this invention are thus designed to effectively convey information using one or more means of communication (e.g., auditory, visual, and/or kinesthetic), and may be both delivered by care-givers and used on-site. Thus, as will be described further below, when a care-giver needs to train a new patient on how to perform certain self-care operations, the care-giver can simply open a system or set of training materials, e.g., a binder or binders with lesson plans and illustrations, and perform the training. An illustration vehicle is preferably used in the present training systems as will be described in more detail below and allows the care-giver to use them in a wide variety of patient care settings.

Various theories have been posited for developing means and methods for teaching patients skills for caring for themselves and even for teaching them how to perform certain medical procedures on or for themselves. Dr. Terry TenBrink, Ph.D., proposed various learning concepts for arthritis patients to care for themselves; see the article entitled “Patient and Family Education,” published by Postgraduate Advances in ARTHRITIS for Health Professionals, Forum Medicum, Inc., 1989. The use of auditory, visual and motor skill development techniques are described therein, particularly for developing arthritis patients' abilities to manage pain. Also, distinctive training theories relative to memory, concept formation, problem solving and physical ability development are also described, along with some thoughts on attitude and/or behavior modification.

Medical patients who are expected to perform medical procedures for themselves present a significant further obstacle such that it is important that the patients learn safe procedures to avoid infections (of various types) and/or otherwise causing harm to themselves. In peritoneal dialysis, for example, peritonitis and exit site infections are common problems which appear to often be caused by inappropriate patient self-care techniques, and are thus avoidable problems.

In summary, medical patients often must learn numerous concepts and abilities to achieve effective self-care skills, and since patients learn in many different ways, many presentation issues abound. It is therefore desirable to provide education/training tools that provide for effectively conveying the desired information, and in so doing, do not depend upon a single teaching concept alone to communicate the message. The systems of the present invention thereby rely upon various presentation conduits, including auditory and visual illustrations as well as hands on/kinesthetic training concepts to communicate key learning points, as well as being relatively compactly contained and easy-to-use.

### BRIEF SUMMARY OF THE INVENTION

This invention relates to educational/training systems for use by a trainer as well as methods of teaching the performance of certain tasks associated with medical self-care. The training systems here comprise training procedures which may be used with associated documentation and/or illustrations of specific self-care operations as well as indications of appropriate (and at times, inappropriate) situations, behaviors, techniques, steps or results relative to such an operation. The operations and/or behaviors, techniques, steps and/or results may preferably be identified in or on illustrations by numbers or letters or both to help identify the operations and/or situations relative to the training procedures. One or more of the systems may use auditory, pictorial, documentary, model or other illustrative or media forms depicting inappropriate operations, situations, behaviors, techniques or results, either alone or for comparison with appropriate depictions. Note, the terms illustration or media are herein intended to include verbal/auditory, documentary, graphic, pictorial, symbolic, video and/or physical (two or three dimensional) model elements which are used for visual and/or verbal and/or kinesthetic presentation to a patient/learner. Also, the term training is intended here to include therewithin the potentially otherwise distinguishable elements of learning and/or education, or the like.

The training systems of the present invention include at least one and preferably a plurality of sections or modules, each module related to a discrete group of tasks associated with respective types of medical self-performance operations/functions e.g., device handling, asepsis, fluid balance, and the like. The terms chapter or unit may also be used in reference to the sections or modules, particularly when/if the system is packaged in a binder or book-like form (with chapters). Each section or module may also contain one or more sub-sections.

More particularly, he training systems here also preferably employ, at least in certain sections or modules, the trainer telling the trainee patient about a concept or process step in that module substantially simultaneously with the use of an illustration (auditory, pictorial, video, model or the like) from the training material which illustrates the concept or process step; then the trainer may demonstrate the concept or performance of the physical step while the patient watches; then the patient may be asked to repeat the concept or perform the same physical step demonstrated by the trainer. Preferably, the trainer may coach may provide feedback during and concerning the quality of the patient's activity, and then the patient may be asked to review each concept or step with the trainer, perhaps while using the illustrations from the training materials until satisfactory learning is accomplished.

In this way, there can easily be provided to a patient not only the information but also the training and education necessary to guide the patient as to what to do and what not to do when performing the task throughout the process, no matter what part of the process is being performed. Similarly, the patient will be able to memorize and/or learn concepts and/or problem-solving techniques which can be applied to situations or scenarios not previously encountered by the patient.

As introduced, the training systems herein are preferably of a modular design. Each system may thus be divided (by chapter tabs, for example, in a binder containing system materials) into separate modules or sections. As one particular example, a section for “Fluid Balance” in a peritoneal dialysis training system may include all of the aspects for performing typical self-care operation such as balancing or maintaining a proper balance of fluids in the patient body. There are several advantages to the modular design of the present training systems. Most of the modules preferably allow the trainee to focus on mastering one skill at a time. Also, it has been found that many patients may learn certain skills more readily by hands-on experience. The training system modules also herein provide for the trainee to repeat a concept or perform a task repetitively until they are ready to move on to the next skill. Another benefit of the present invention is that re-training of existing patients may be much easier. For example, if a patient develops a particular bad habit or other performance deficiency (which may be tracked by development of an infection due to an inappropriate self-care action), the patient can use the particular raining tool or tools to re-train only in the key area or areas where the patient's skills have been lacking.

Moreover, each area of a medical self-care operation may have one or several key items that if not correctly performed may result in patient problems. For example, in maintaining asepsis, certain particular failures in patient performance may lead to infection. As a result, though each of the self-care operation modules may have numerous (e.g., fifteen to twenty, or more or less) individual concepts or steps involved overall, at times only a few (e.g., three to five steps, or more or less) of these concepts or steps may be more critical and thus the educational presentation may emphasize these more critical steps accordingly. In the present systems, these more critical concepts and/or steps may be communicated to patients and their importance emphasized by using auditory descriptions, as well as illustrations depicting appropriate and/or inappropriate actions or results relative to these issues. These auditory descriptions and associated illustrations are intended to focus the patient on the items that are most important to their self-care operations.

This disclosure also describes the impact of such new patient training systems and methods on selected patient outcomes. Exemplar systems were particularly devoted to peritoneal dialysis and were developed by breaking down the tasks needed to perform a peritoneal dialysis process into the different types of learning required. Based on the understanding that each type of learning is learned differently, it was determined to teach certain tasks separately. Lesson plans and media were developed to provide stimulation for all types of learners; for example, those who are adapted to learn primarily auditorily, visually, and/or kinesthetically. A study was then designed for new peritoneal dialysis patients. Eighteen peritoneal dialysis clinics/units served as pilot facilities with fourteen others serving as controls. Data collected for all patients included patient outcomes, including peritonitis and exit site infections. In the pilot training program, using a system according to the present invention, it was found that peritonitis and exit site infection rates were half in the pilot-trained group of patients (using systems of the present invention) versus the control group of patients. More particularly, one in about fifty patients in the pilot group developed peritonitis relative to about one in about twenty-six patients in the control group; and about one in about twenty-five patients in the pilot-trained group developed exit site infections compared to about one in about thirteen such infections in the control group. Thus, a learning theory-based curriculum for peritoneal dialysis training has been demonstrated to promote better patient outcomes.

### BRIEF DESCRIPTION OF THE DRAWINGS

FIGS. 1A-1H are illustrations for conveying information to the patient according to one embodiment of this invention;

FIGS. 2A-2F are illustrations for conveying information to the patient according another embodiment of this invention;

FIGS. 3A-3B are illustrations for conveying information to the patient according to yet another embodiment of this invention;

FIG. 4A is an illustration for conveying information to the patient according to still another embodiment of this invention;

FIGS. 5A-5F are illustrations for conveying information to the patient according to a further embodiment of this invention;

FIGS. 6A-6O are illustrations for conveying information to the patient according to yet one further embodiment of this invention;

FIGS. 7A-7E are illustrations for conveying information to the patient according to still one further embodiment of this invention;

FIGS. 8A-8L are illustrations for conveying information to a patient according to the present invention.

FIGS. 9A-9I are illustrations for conveying information to the patient according to a further embodiment of this invention; and,

FIGS. 10A-10D are illustrations for conveying information to the patient according to a still further embodiment of this invention.

### DETAILED DESCRIPTION OF THE PREFERRED EMBODIMENTS

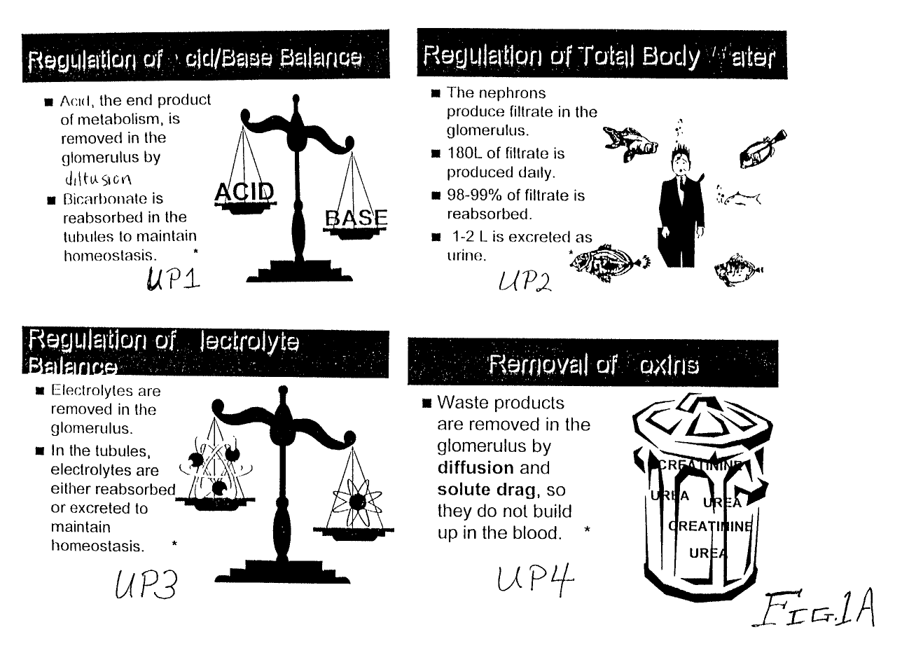

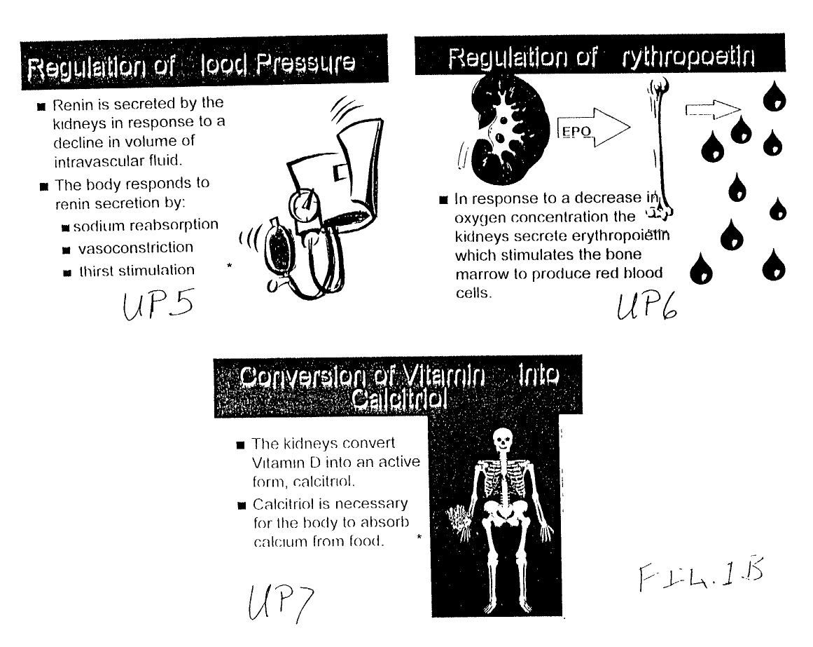

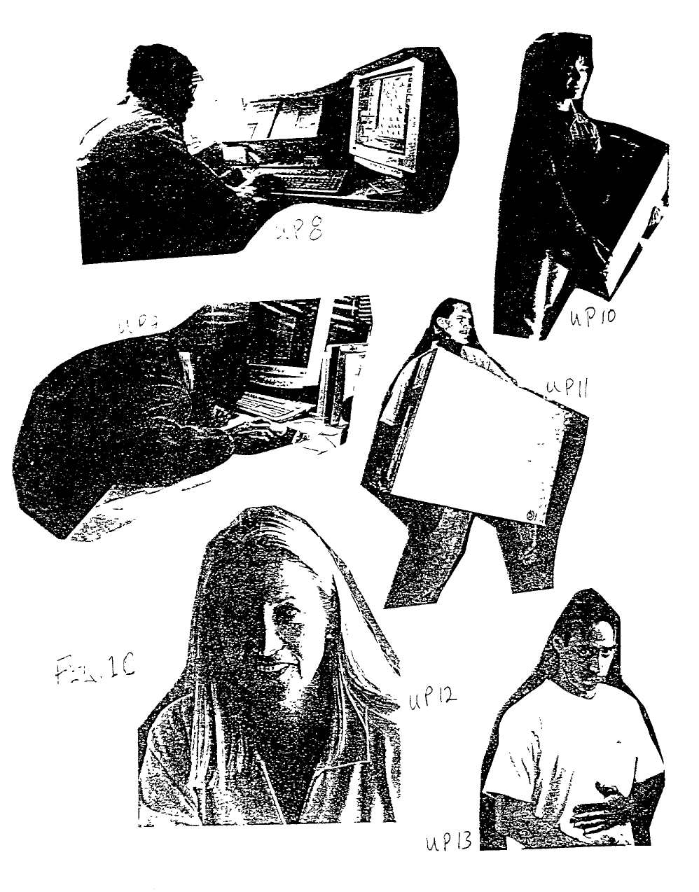

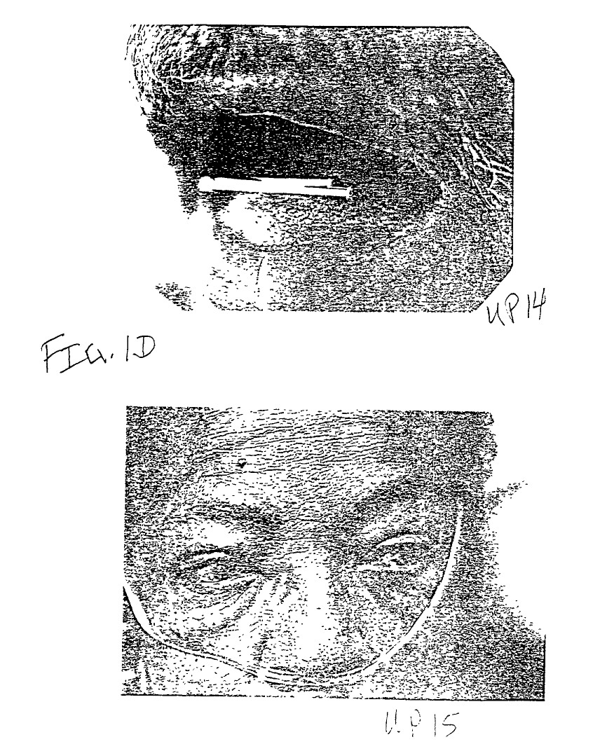

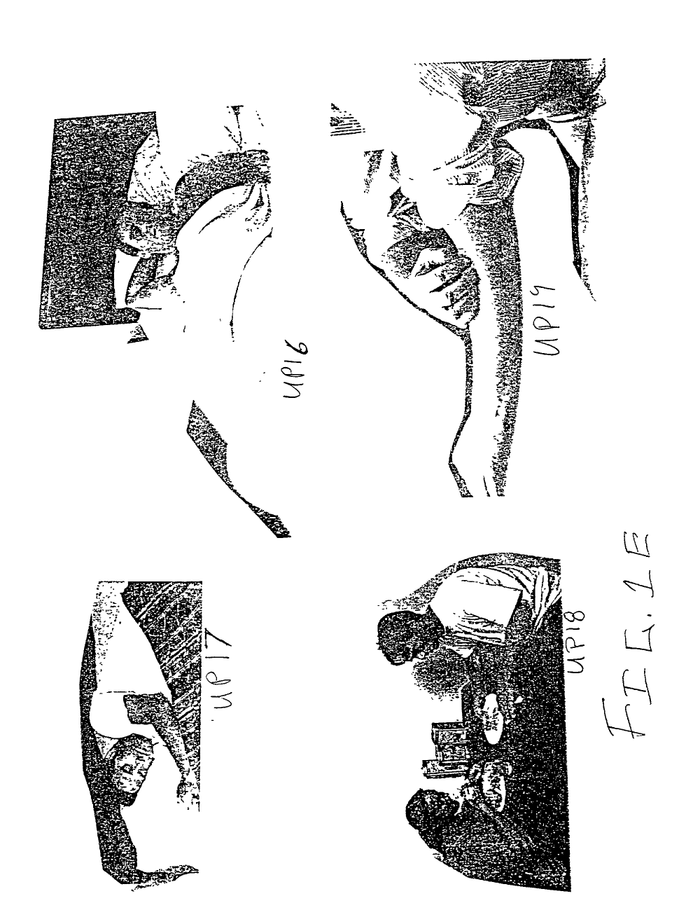

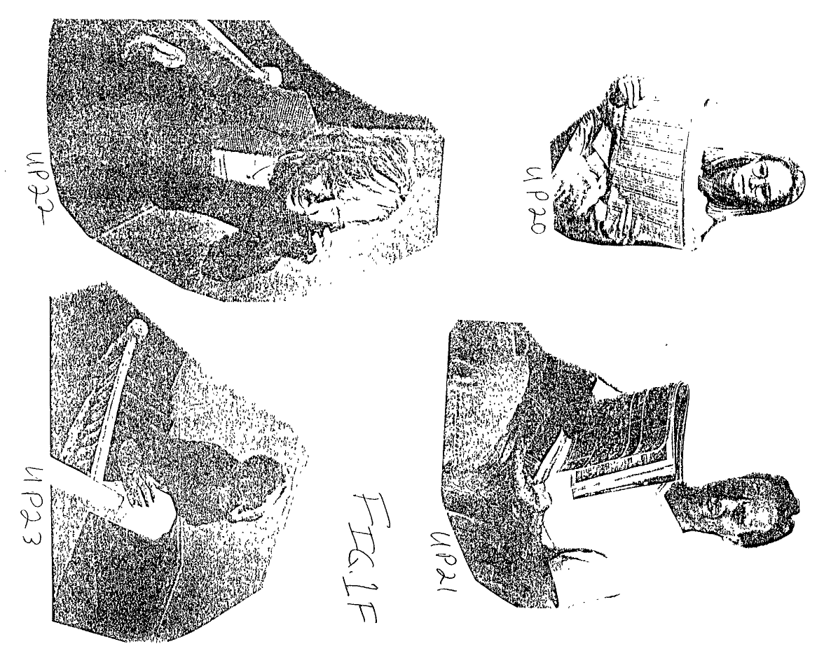

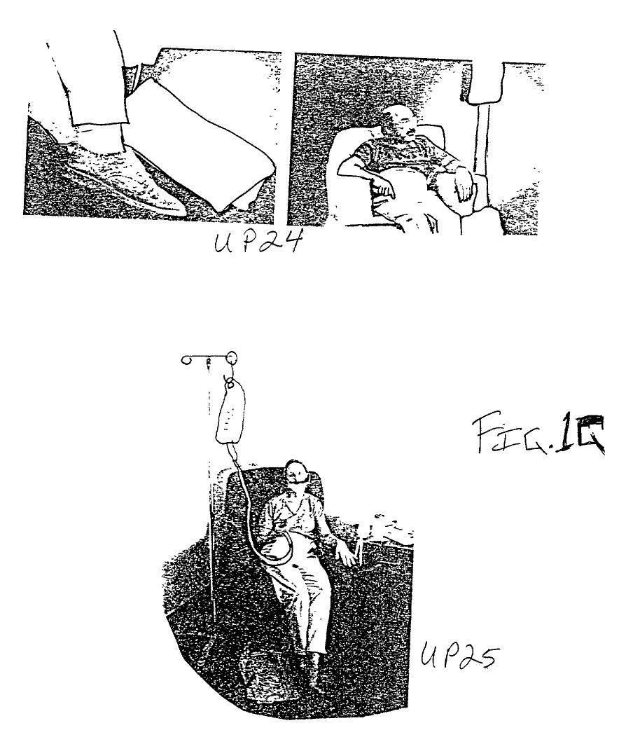

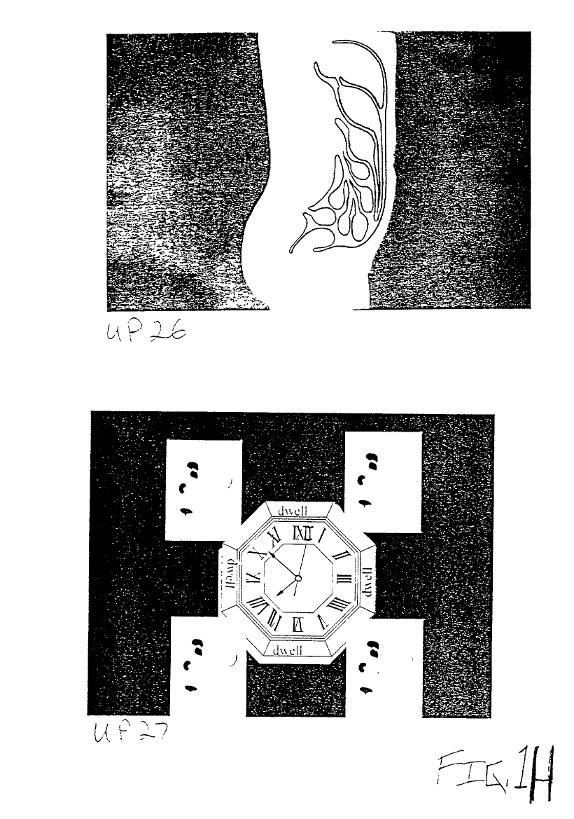

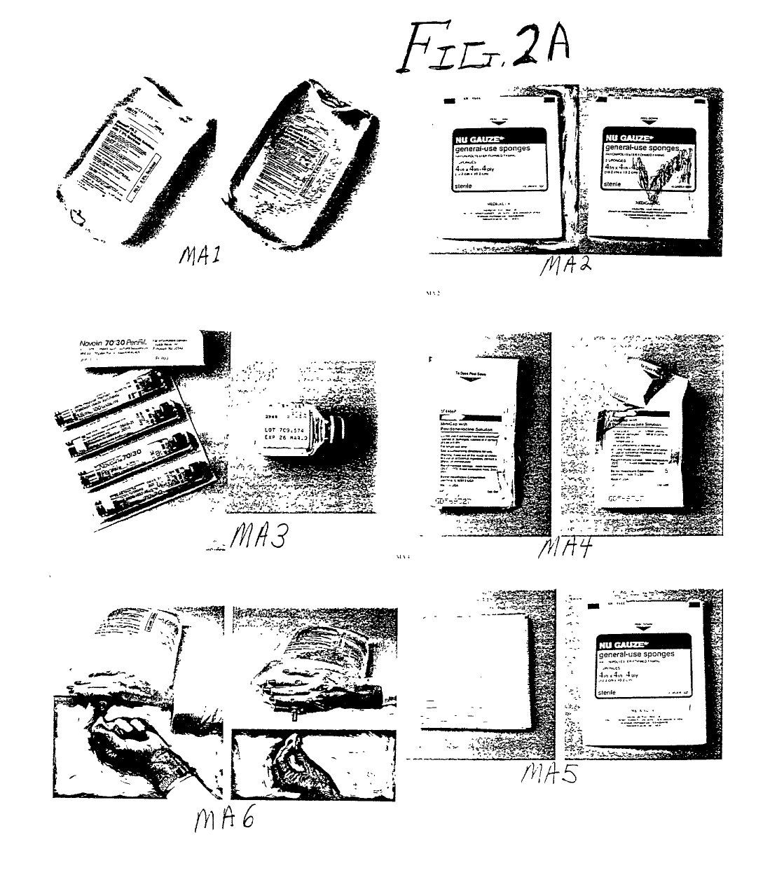

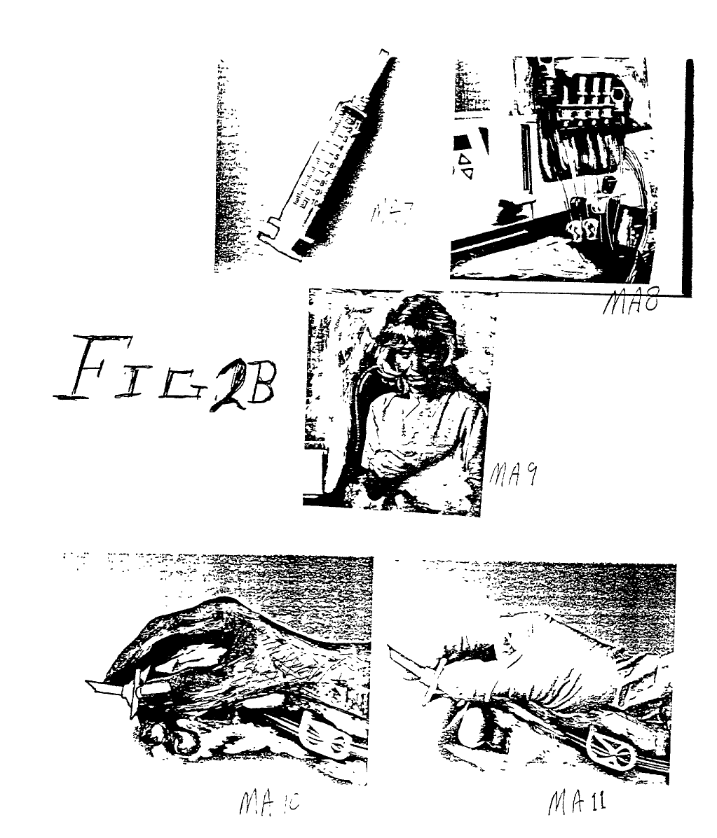

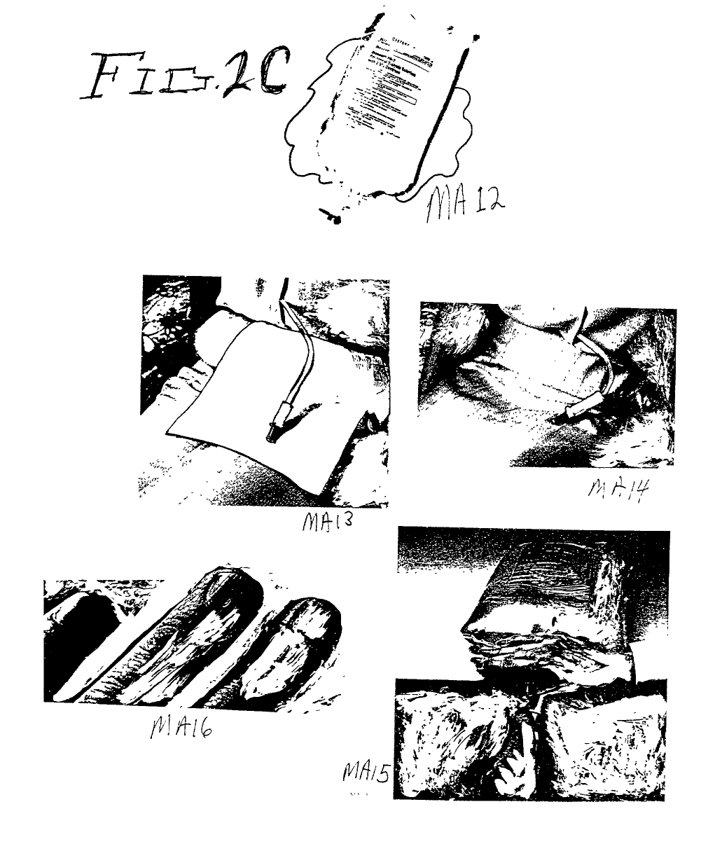

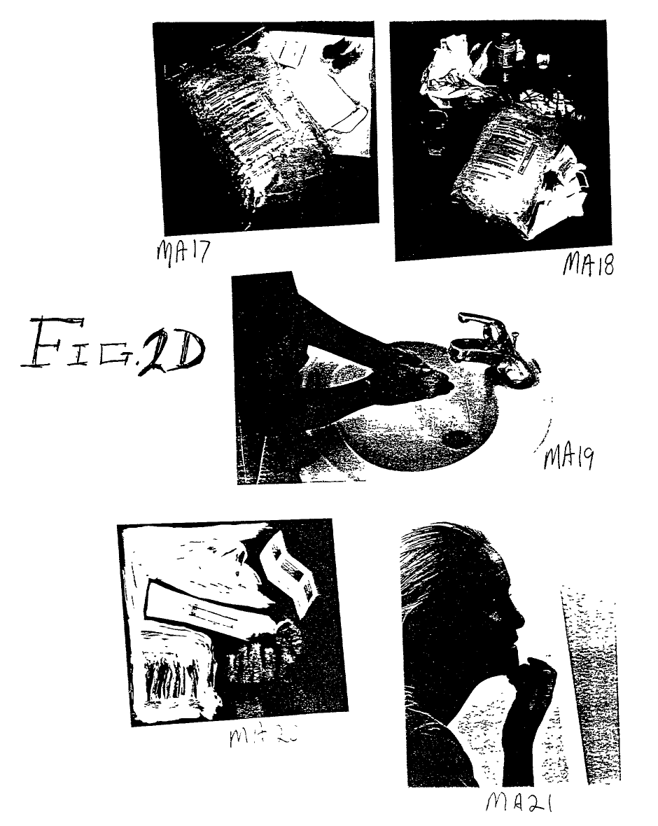

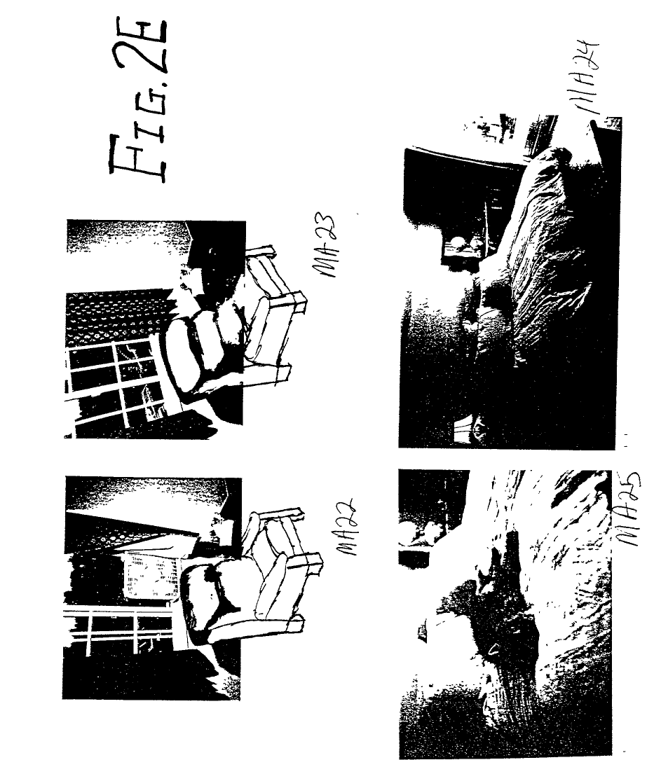

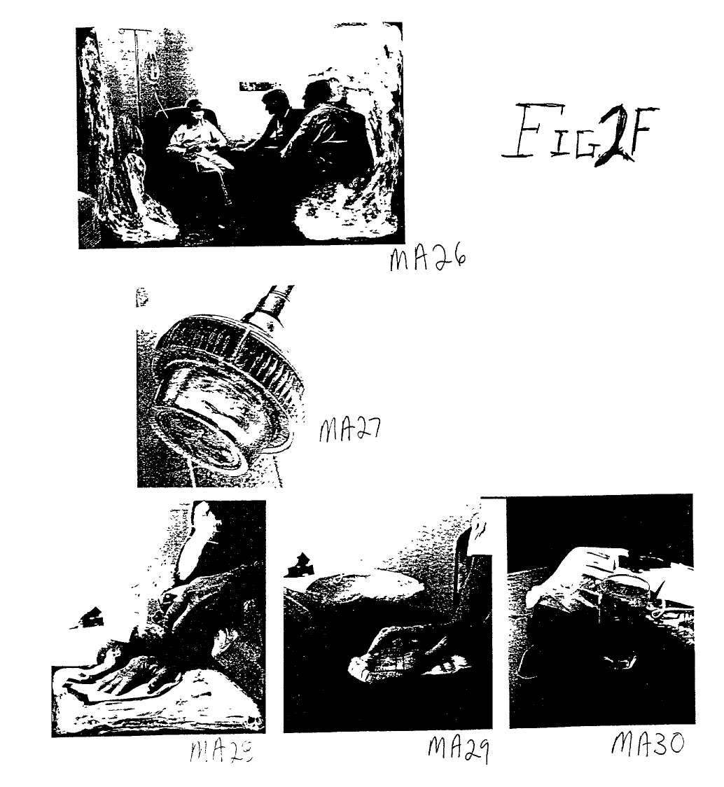

Referring now to FIGS. 1 to 10 (the term “FIG. 1” is intended to encompass FIGS. 1A-1H and so on as well for FIGS. 2-10 and like FIGS. also encompassing their respective suffixed sub-Figures), a preferred embodiment of a training system of this invention is shown in illustrations, although the systems may further include written and/or oral training plans which may be presented each with one or more visual training presentations, e.g., illustrations (See FIGS. 1-10), for teaching patients concepts and/or how to perform certain overall functions. For example, a concept to be taught may include educating a patient in understanding their medical situation (FIG. 1) and both concepts and steps to perform may be included in training to maintain aseptic conditions (FIG. 2). Note, the plans themselves may be written or recorded (or otherwise preserved for future use) and may be kept in a binder or other package or device (none shown) for storage or transport. The visual illustrations may take various forms as well, including pictures, posters, charts diagrams, written phrases and/or physical models or specimens. Any or all of the two (and sometimes three) dimensional varieties of visual illustrations or media may also be pre-packaged in a binder or other package or device for storage and/or transport. The three dimensional models may require separate packaging, and/or may be obtained from other sources (such as common household or medical clinic stores) and/or may be uniquely acquired by each patient/learner for his/her particular condition.

FIG. 1 preferably includes numerous illustrations for presentation to a patient for him or her to understand his/her particular condition. In many medical patient training situations, the first subject to be taught would likely concern the particular patient's particular situation. Thus, in a peritoneal dialysis situation according to a preferred embodiment of the present invention, the initially here presented example, “Understanding Peritoneal Dialysis,” as shown in FIG. 1, would be the first module or section (at times also referred to as a chapter) taught to the new peritoneal dialysis (PD) patient/learner. This exemplar module preferably uses concept development and memory lesson plan formats to explain the need for PD, how dialysis occurs, and how fluid exchanges are to be completed in the home environment.

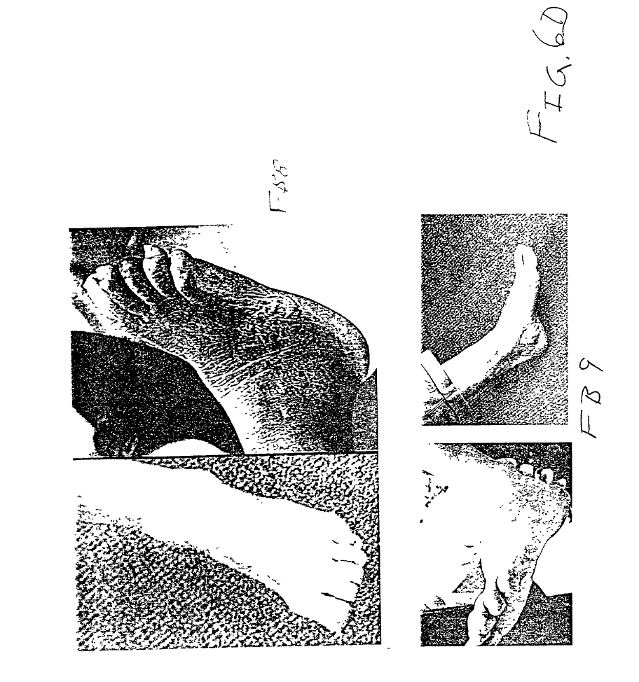

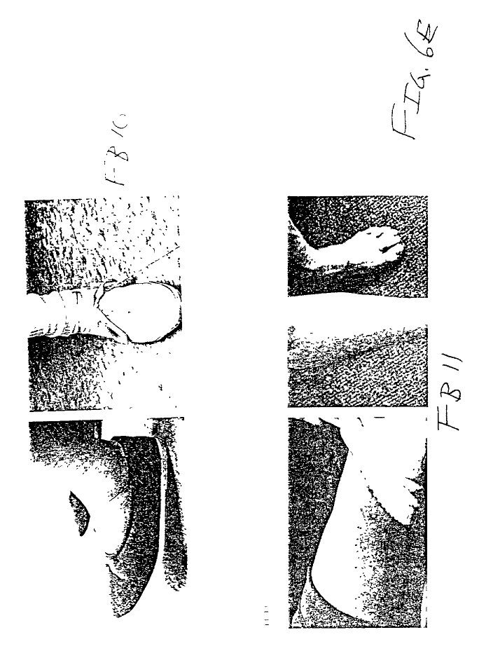

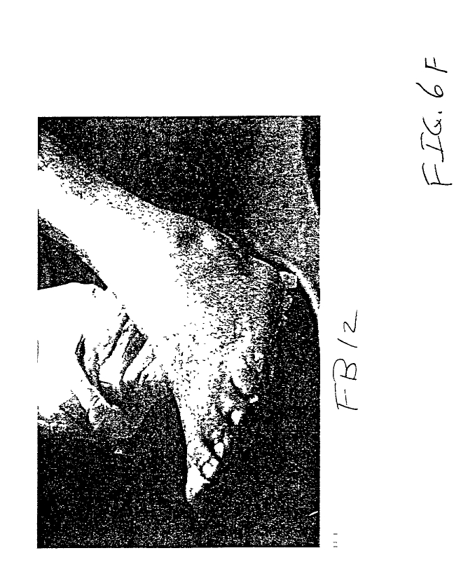

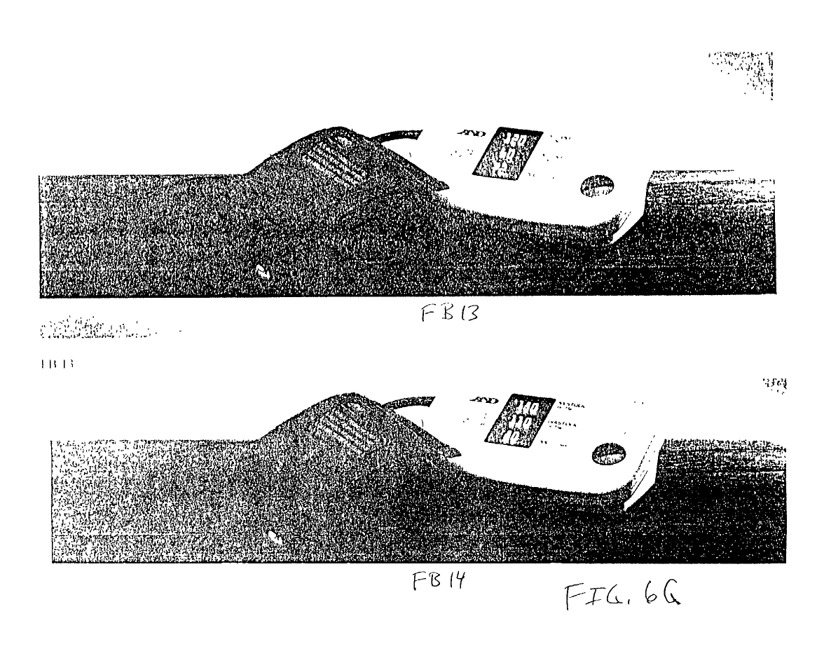

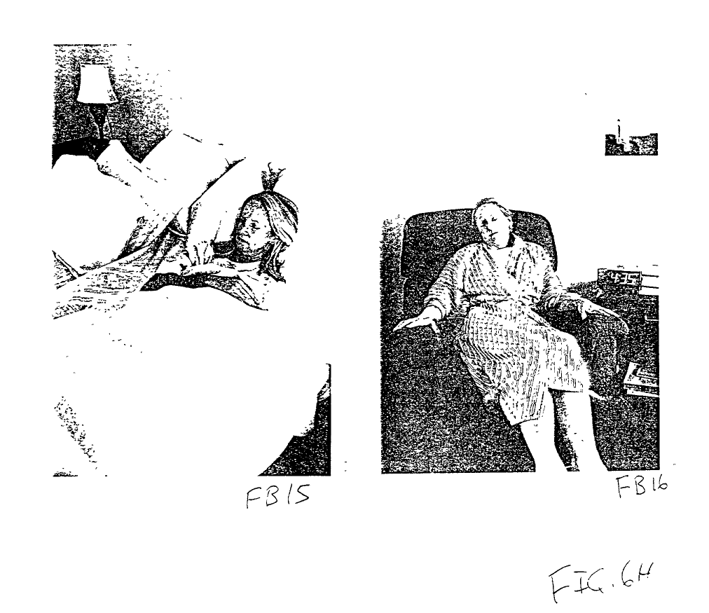

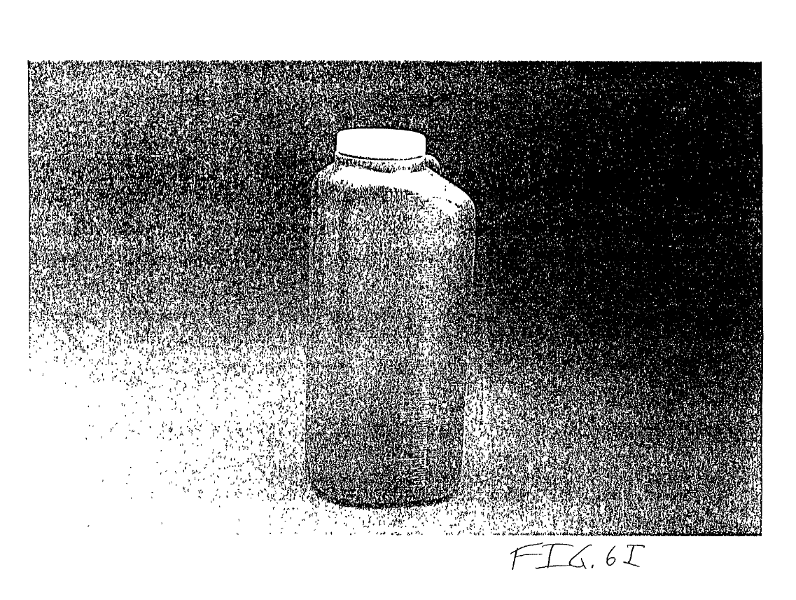

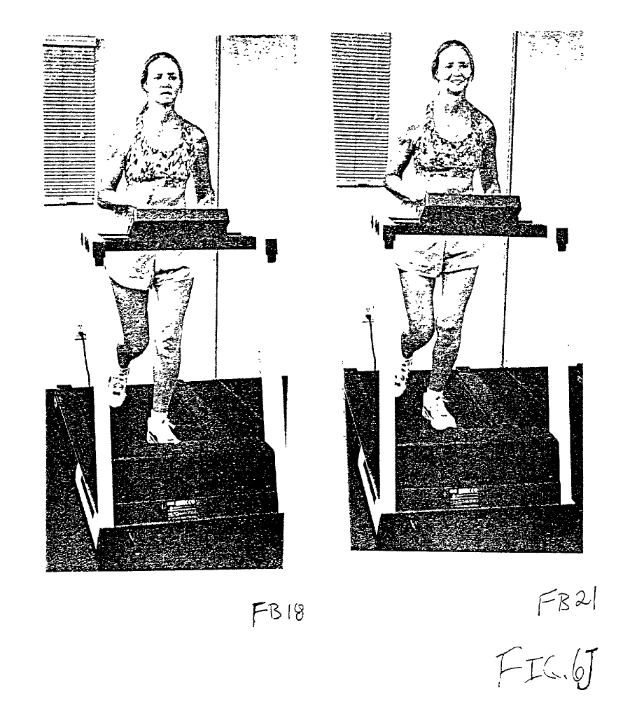

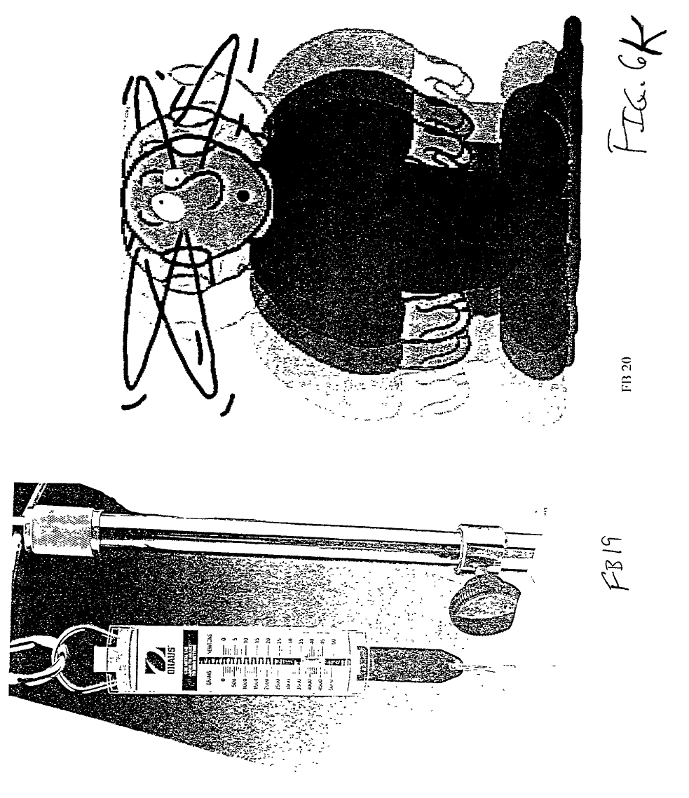

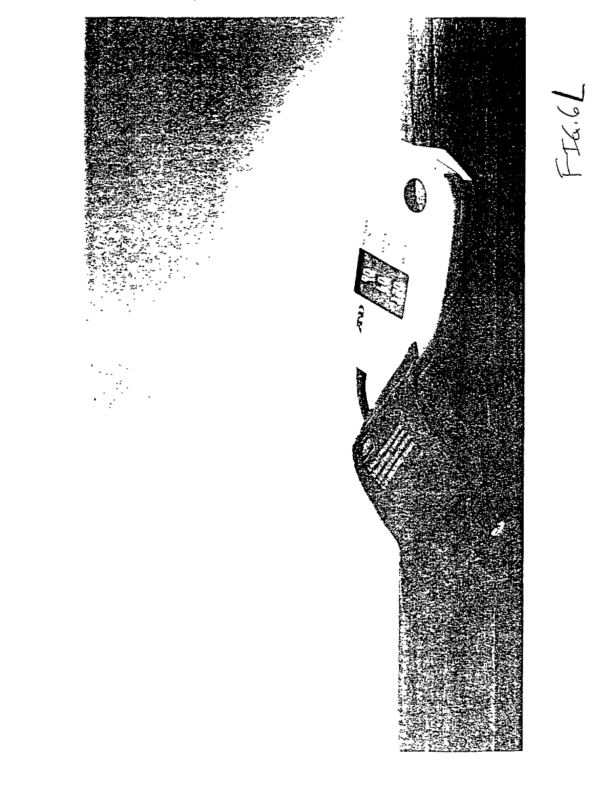

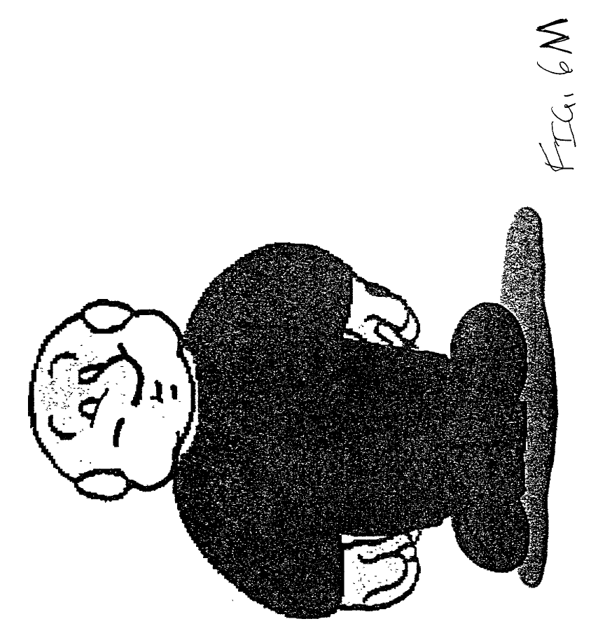

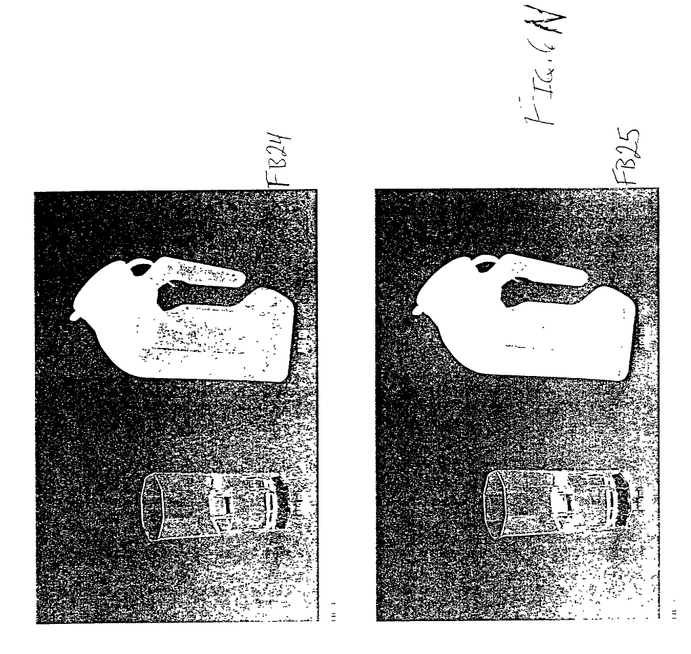

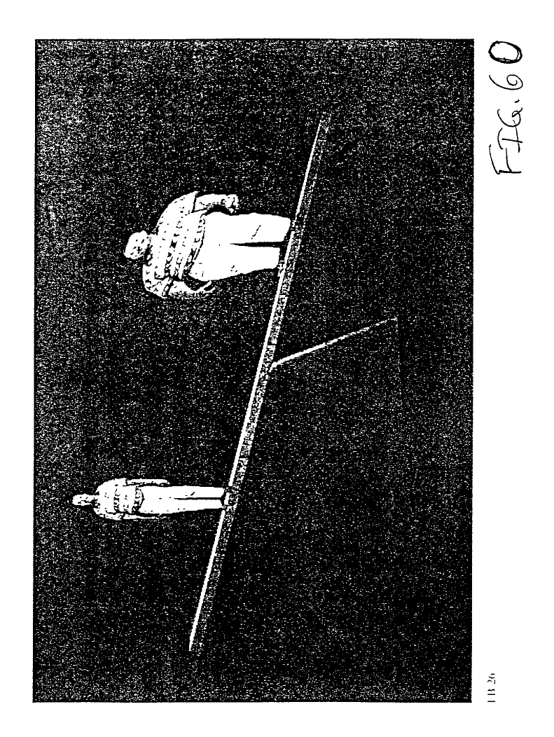

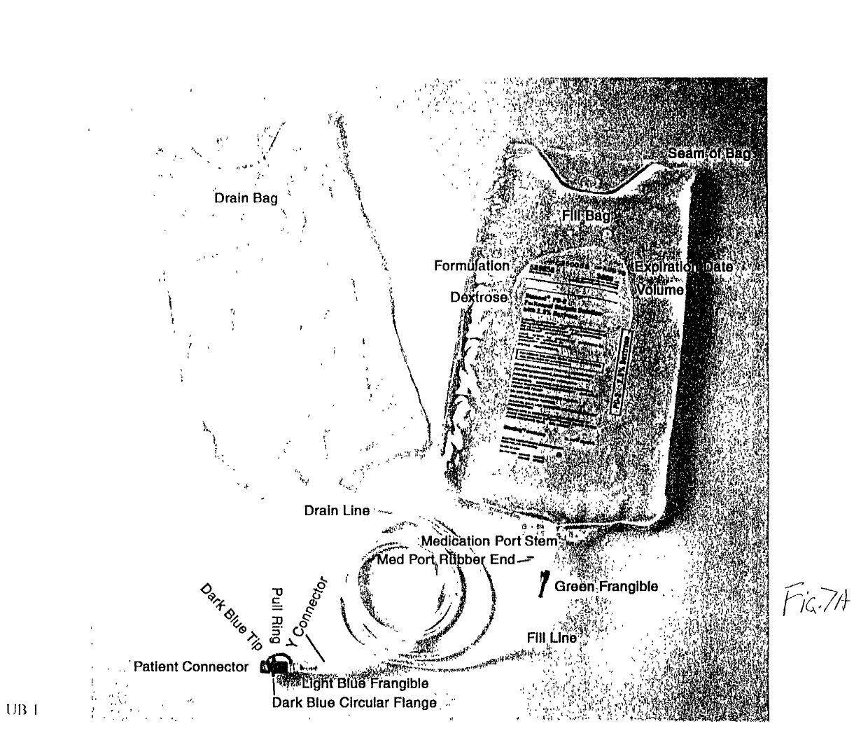

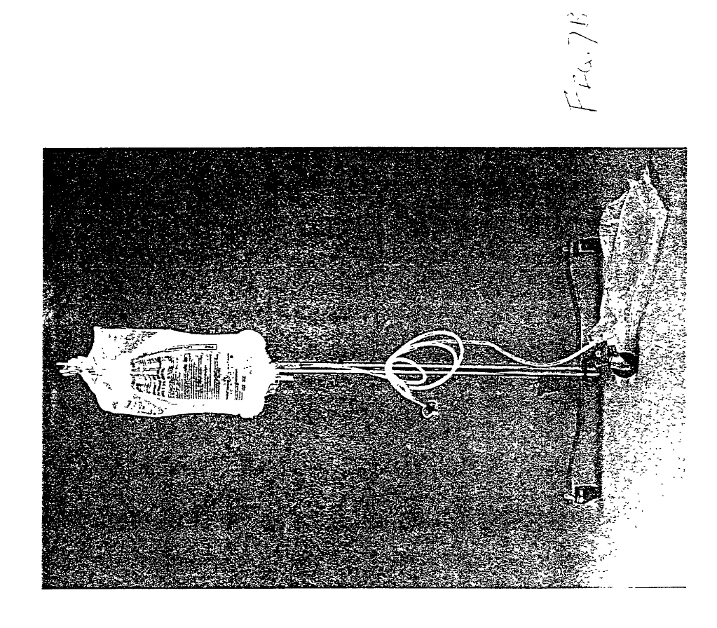

Illustration media in this FIG. 1 module may include pictures or posters that may be presented to the patient during the teaching of the material. The lesson plans involving how dialysis occurs may and preferably do also use tangible objects for demonstrations. These lessons may also then be reviewed during the teaching of a fluid balance section (see FIG. 6 module below).

The following is one proposed module or chapter outline of sub-sections based on several preferred “Understanding Peritoneal Dialysis” subjects, processes and/or requisite knowledge concepts (note, various of the following sub-sections can be introduced at different times and in various orders, although some may have pre-requisite knowledge requirements one from one or more of the other sub-sections):

Normal Kidney Function (memory)

Kidney Failure (memory)

Uremia (concept formation)

Peritoneum (memory)

Semi-permeable Membrane (concept formation)

Osmosis (concept formation)

Solute (concept formation)

Diffusion (concept formation)

Components of the PD Exchange (memory)

Dwell Time (concept formation)

PD at Home (memory)

Adequacy (memory and principles, judgement/decision, problem solving)

Anemia (concept formation, principles, judgement/decision, problem solving).

Note, the “Uremia” portion of this section may provide a way to complete an initial patient assessment through a review of symptoms and systems. Further, the parenthetical information after each heading is intended to designate the type of learning/training associated with the information thereof. Thus, “memory” is associated with those types of information which the patient/learner is intended to memorize, and “concept formation” is associated with a desired broader cognitive ability to distinguish and/or associate elements related to a particular subject, even if the patient learner has not been exposed to such an element previously. The “principles/judgement/decision/problem-solving” category is broader still requiring further cognitive ability. Such sub-sections incorporate those characteristics to be instilled in a patient/learner such that the patient/learner will not only be able to distinguish or associate elements, but also be able to solve problems or apply principles or make decisions or judgements concerning the subject matter of such a sub-section. Note also that the phrases “patient”, “patient/learner” and the like are intended to refer to the person being taught, primarily in the present invention, a patient who will be expected to perform certain self-care procedures for him or herself, however, it is also expected that non-patients may also, at times, undergo the learning processes or use the systems of the present invention, whether to learn to assist actual patients or otherwise, and thus these non-patients may also be considered within the definition of learners, trainees, students or like terms according to this invention.

In this case, where the general information sought to be conveyed is an overview of peritoneal dialysis, the initial concept of normal kidney function as demonstrated by the first sub-section, “Normal Kidney Function” (above), may include media illustrations relative to fluid regulation (including acid-base balance (UP1), water regulation (UP2), electrolyte balance (UP3), toxin removal (UP4) (see FIG. 1A), and pressure and chemical regulation (blood pressure (UP5), EPO production (UP6) and vitamin D conversion (UP7)(see FIG. 1B)). The “Kidney Failure” sub-section may also make use of these graphics/illustrations. Also included in the FIG. 1 graphics are various physical representations/illustrations of the general well-being of a patient (UP8-UP23) (FIGS. 1C-1F), which may be used in the teaching of the “Uremia” sub-section, interalia. Ultimately, also shown is the general procedure for peritoneal dialysis (including a draining procedure (UP24, FIG. 1G), and filling procedure (UP25, FIG. 1G), and filled peritoneum illustration (UP26, FIG. 1H) and a dwell-time graphic (UP27, FIG. 1H)). Note, the parenthetical combinations of letters and numerals disposed in the above and all subsequent disclosure materials represent a preferred identification scheme for respective illustrations relative to this text. In particular, the initial one, two or three alphabetic letters represent a particular module with which the illustration may primarily be associated. Here, the letters “UP” are representative of the “Understanding Peritoneal Dialysis” module. The numerals are serial signifiers of each discrete illustration preferably representing the order in which the illustration may preferably be used. Illustrations may be used out of order and/or may be used in other modules, and are thus not restricted in use merely due to their respective alpha or numerical identifications.

In this initial sub-section, “Normal Kidney Function”, the training system intends to provide for teaching the patient/learner the normal functions of the kidney. Posters or flip-charts (see FIGS. 1A and 1B, details not listed here) may also be used whereby the educator may tell the patient/learner about the normal functions while showing the graphics (see UP1-UP7 of FIGS. 1A and 1B). The patient/learner may then be asked to memorize these functions. Respective presentations, or verbal repetitions and/or mnemonics may be used to assist in memorization, as may practice and/or testing of the patient/learner.

The “Kidney Failure” sub-section (the second such sub-section in the “Understanding Peritoneal Dialysis” module, see list above) may be taught in a similar fashion with a preferred goal of memorization of the most common causes of kidney failure. Graphics or flip-charts (not shown) like (or not like) those used above (in the first sub-section) may be used, or as one possible alternative, a dry erase board with markers may be used for visual presentation during an oral exposition. Then, the patient/learner may be asked to memorize the objects of this sub-section, again with potential assistance (“repeat after me” or self-study, e.g.) and/or practice and/or testing. Note, though not shown, the most common causes of kidney failure are diabetes, hypertension, polycystic kidney disease, congenital abnormalities, glomerulonephritis, and systemic lupus, among other causes. The patient/learner may also advantageously be asked to learn/memorize the cause of his/her particular kidney failure.

The “Uremia” sub-section may be taught in yet still similar fashion, using visually perceived illustrations together with an auditory presentation; however, memorization along with concept formation will both be desirable outcomes. Thus, the learner may be presented with illustrations (see, e.g., UP8-UP13 of FIG. 1C as well as UP14-UP23 of FIGS. 1D-1F) along with an oral/auditory presentation about uremia (uremic syndrome due to loss of kidney function). By definition, using critical characteristics, the symptoms of uremia may include any or all of feeling tired, weak, nauseated, having a metallic taste in the mouth, being restless, or having edema, itching, anorexia, shortness of breath, decreased concentration, and/or sexual dysfunction. For example, certain example/non-example pairs of illustrations may be presented to demonstrate various symptoms of uremia. Some suggested example/non-example pairs for demonstrating these symptoms are shown in FIGS. 1C-1F and these may preferably be presented with verbal descriptions, pictures/video-clips, scenarios or the like and may include the following:

Picture with a person working/scene with person sleeping at the desk (UP 8, 9; FIG. 1C);

Person carrying a large box/person carrying a very small box (UP 10, 11; FIG. 1C);

Picture of two people, one smiling, the other with a green face holding their stomach (UP 12, 13; FIG. 1C);

Person with tongue sticking out with nails on it (UP 14; FIG. 1D);

Pictures of edema from edema lesson plan (UP 15; FB 7-18; (FIG. 1D and FIGS. 6C-6F);

Person in bed with neat bed clothes/person in bed with bed clothes askew (UP 16, 17; FIG. 1E);

Picture of two people at a table eating, one with a large plate of food, the other pushing the full plate of food away (UP 18; FIG. 1E);

Person shown scratching their lower arm (UP 19; FIG. 1E); and

Person climbing stairs with ease/person climbing the stairs bent over, holding hand rail, red-faced, puff of breath coming out of mouth (UP 22, 23; FIG. 1F).

Verbal descriptions of symptoms as presented by the patient (not shown); may also be included in lesson plan. In this latest example, the teacher may ask the patient/learner about particular symptoms the patient/learner has experienced (the teacher should keep in mind all body systems, so they can determine whether such symptoms are relative to kidney function or otherwise—patient assessments may be further developed in this way if the care-giver is the teacher).

The next several sub-sections of this first module will be treated in similar fashions hereon as they follow similar processes as introduced above (e.g., particularly for memory and concept formation learning modes). For example, in the “Peritoneum” sub-section, the learner will preferably be taught the ability to list the characteristics of the peritoneum. A picture or poster illustration (see, e.g. UP26 (FIG. 1H, described further below)) or other media device (not shown) may be used for visual presentation to highlight parts or characteristics of the peritoneum). Information to be presented about the peritoneum may include its location along lines of the abdominal wall from the diaphragm to the pelvis; how it encloses the liver, stomach, spleen, gall bladder, large and small intestines and in females the ovaries and fallopian tubes; that its size is approximately the same as the skin surface—one to two meters square; it has a blood supply; is a semi-permeable membrane; its normal volume is 100 ml, and normally contains some fluid, but can expand to hold a large amount of fluid. The patient/learner then memorizes this material, as before.

The “Semi-permeable Membrane” sub-section may logically be related to the “Peritoneum” sub-section and thus easily precede or follow it. This sub-section will preferably involve concept formation as opposed to mere memorization. Thus, a concept preferably to be formed by the patient/learner is the ability to distinguish permeability from non-permeability. Media models (not shown) may be used such as permeable (screening, cheese cloth, an air filter) and non-permeable (aluminum foil, waxed paper, or plastic wrap). A definition is preferably given (“permeable materials allow dissolved solids and water to pass through them”) and the media model examples (and non-examples) may be presented for the patient/learner to attempt concept formation. Guessing by the patient/learner is allowable. Feedback about guess accuracy is preferred. Pairing permeable examples with non-permeable examples may help the patient/learner identify the relevant characteristics. As learning increases, the examples (and/or non-examples) may be made more difficult so that finer discriminations may be made. Then, a discussion of body parts which are permeable (blood vessels, intestinal wall; cell walls, peritoneum) can be presented. Semi-permeability may also be discussed as opposed to complete permeability (as in air).

An “Osmosis” sub-section may then be taught. A presentation including an everyday life example, may be made to the patient/learner; for example, with a fruit or vegetable (strawberries, cucumbers, raisins or other dried fruits) and sugar or salt and/or warm water. Strawberries or cucumbers may be sliced and placed in a container and then a large amount of sugar or salt, respectively, may be poured thereon to move fluid out of the fruit or vegetable. Similarly, dried fruit may be placed in warm water, whereby water will move into the fruit. Then, a definition of what occurred may be made (by the teacher with or without assistance from the patient/learner). A sample definition by critical characteristics may include fluid movement across a semi-permeable membrane; fluid moves from an area where there is low solute concentration to an area with high solute concentration; the goal of osmosis being having to have the same concentration of solute on both sides of the semi-permeable membrane. Concept formation by the patient/learner for extension of comprehension beyond these examples would then be the goal of this sub-section.

A “Solute” sub-section may similarly be taught with physical model media (e.g., cups of water, sand, small stones, marbles, pepper, salt, sugar, creamer, powdered hot chocolate mix, rice, bouillon, or the like). A definition of a solute may be given (preferably initially here, but could be after the presentation, or otherwise, as shown and described throughout this specification), then an oral presentation with visual illustrations in the form of mixing various materials in water (e.g., sand or stones versus salt; marbles versus sugar; pepper versus creamer; rice versus hot chocolate mix or bouillon). The concept of a solute being something which dissolves in a fluid will then be taught with comprehension.

A “Diffusion” sub-section, also preferably involving concept formation, may then be taught. Media for presentation may include cups of water, tea bags and a bottle of food coloring. A definition may be given (again, either initially or post-presentation; though, if after the presentation, the learner should use their own words to define the term). As a presentation, the teacher may place a tea bag in a cup of water and add food coloring to show the movement of the solute (not the tea leaves) throughout the solution. Concept formation can be demonstrated by the learner giving other examples of diffusion (e.g., odors or smoke diffusing throughout an air-filled area, coffee through a coffee filter).

A “Components of a PD Exchange” sub-section may then be taught. A poster or other visual representation or illustration of a peritoneum (preferably anatomically correct) (see, e.g., UP26 of FIG. 1H), may be presented so that the patient will come to learn (preferably through memorization) the component procedural portions of a peritoneal dialysis fluid exchange operation. More particularly, as shown in FIG. 1G, UP24 represents a drain operation (fluid draining out of peritoneum to a bag disposed below the patient's peritoneal cavity) and UP25 represents a fill procedure (where fluid is drained from a hanging bag down into the patient's peritoneum). A dwell component may best be shown or described simply as fluid remaining in the peritoneum for a particular period of time.

A separate “Dwell Time” sub-section may follow. This sub-section may also make use of the illustrations from FIGS. 1G and 1H (and/or the like) and further may include clock models. A definition of “dwell time” will preferably be given early in the presentation (as the period of time the dialysate is in contact with the peritoneum (e.g., between 4-6 hours from CAPD or at least 1.5 hours for CCPD) (as determined by cycles) with longer times at night and even spacings during the day). Example/non-example pairs may also be presented with verbal descriptions, pictures, video-clips, and/or scenarios. Some suggested examples may be:

24 Hour clock (or two 12 hour clocks) with four evenly spaced exchanges/clock with four exchanges within four hours (nurse demonstration);

24 Hour clock (or two 12 hour clocks with five evenly spaced exchanges/clock with five exchanges within twelve hours;

24 Hour clock (or two 12 hour clocks) with four evenly spaced exchanges/clock with two of the four in the middle of the night (nurse demonstration);

Picture of a person filling during an UltraBag exchange (UP25; FIG. 1F);

Picture of a person draining during an UltraBag exchange (UP 24; FIG. 1F);

Picture of a peritoneum filled with dialysate (UP 26; FIG. 1G); and

Picture of evenly spaced exchanges illustrating dwell time between (UP 27; FIG. 1G).

A memory lesson for “PD at Home” may then be taught. The goal is to have the learner describe a typical day of peritoneal dialysis at home. Flip-chart illustrations using pictorials as described above, or the like, may be used as media for presentation with a verbal description. A flow sheet depicting 48 hours may also be used for the trainer and/or learner to mark the events of a typical day or two at home. A depiction of a 24 hour clock (not shown) or one or two 12 hour clocks (UP 27, FIG. 1H). may also be used. The teacher will then help the learner identify when four evenly spaced exchange processes can be scheduled during a 24 hour day. Particular attention must be paid to the dwell times such that these are similar in length. Changes in the patient/learning routines may be necessary in order to accommodate four even dwell times. A flow sheet (sometimes referred to as a “CAPD/CCPD flow sheet”) may also be introduced to the patient so that the patient can mark thereon their exchange schedule for two days of home peritoneal dialysis. Memorization of these points (number of exchanges, equal spacing of dwell times, documentation of exchanges, and routine modification necessities) is a goal, here.

The sub-section on “Adequacy” will preferably next be taught. The learner will be able to describe characteristics related to adequacy of dialysis. Media may include illustrations which may present visual phrases such as “To Dialyze Well is to Feel Better,” inter alia. As a first portion of an adequacy teaching plan, a learner may be expected to learn via memorization, e.g., the characteristics of adequate dialysis. Preferable information to be memorized may include 1) Adequate dialysis is the opposite of uremia; 2) the dialysis prescription (the fill volume, the number of exchanges and the dextrose concentration) is designed to give the patient adequate dialysis, 3) Adequacy is the measurement of toxins in the peritoneal fluid and urine; 4) tested periodically; 5) Results of testing may indicate the need for more dialysis; and 6) Kt/V and Creatinine clearance are two ways we measure adequacy of dialysis (the learner should learn his/her particular desired Kt/V and Creatinine Clearance for his/her modality). As with previous memory exercises, presentation of the definition (above), followed by repetition of the information particularly by the learner, and practice and potential testing will lead to learning.

The “Adequacy” lesson plan may also include a principle learning portion which may be directed toward teaching the patient/learner the ability to identify the relationships between adequate dialysis and uremia. Though having memorization as a part of this learning sub-section, other higher cognitive abilities are also preferably used as well. First, the relationship definitions are given to the patient/learner (e.g., if the patient is getting enough dialysis then the patient will avoid uremia and if the patient is not getting enough dialysis then the patient may develop signs and symptoms of uremia) for memorization which may require some of the memorization skills as above (repetition, etc.). Then, the educator may give the patient/learner verbal scenarios that are examples and non-examples of the principles and ask the learner to guess and give feedback. Then, the learner should restate the principles in their own words. Some exemplar scenarios may be as follows: 1) the prescription is for four exchanges, and the patient does the exchanges as prescribed and feels great; 2) the prescription is for four exchanges and the patient states that it takes too much time and energy to do more than three; 3) the prescription is for 2.5 Liters, but the patient doesn't let the whole bag run in because it hurts with all of that fluid in their belly; 4) the patient wants to look thin and attractive so drains the fluid before going out for the evening; 5) the patient goes to church all day on Sunday and do not have time to do peritoneal dialysis; 6) the nurse asks the patient to bring in their adequacy collection but the patient doesn't want to because the patient is afraid they will ask to do more exchanges; 7) the patient's urine output is way down, almost nothing at all, and the patient starts to feel tired and nauseated, 8) the patient feels so full when he/she puts the full amount of dialysate that he/she can't eat, so the patient reduces the fill volume so he/she can eat; 9) the nurse tells the patient that his/her Kt/V should be 2.0, but the patient's report card states it is a 1.8. Then, when the patient is able to determine whether a scenario (such as those above, or the like) illustrates one or another of the previously set forth principles/relationships, then it will be evident that the patient has mastered this lesson plan.

The “Adequacy” lesson plan may further include a judgment/decision learning portion which may be directed toward teaching the patient/learner the ability to recognize symptoms of uremia, situations that may contribute to inadequate dialysis and take the correct action. Though memorization may also be a part of this learning sub-section, other cognitive abilities are also preferably used as well. First, the relationship definitions are given to the patient/learner (e.g., the same as set forth in the adequacy principle lesson above), then, the teacher will present the scenarios (also as set forth in the principle section above), then the teacher and the patient/student should go over action steps to be taken (i.e., judgments and/or decisions to make). For example, in the first scenario above (the prescription is for four exchanges, and the patient does the exchanges as prescribed and feels great), an appropriate decision/action is to have the patient feel good about the situation and continue doing the exchanges as prescribed; for the second scenario (the prescription is for four exchanges and the patient states that it takes too much time and energy to do more than three) the patient should learn to instead do the exchanges as prescribed and perhaps talk to their nurse, doctor or other care-giver; for the third scenario (the prescription is for 2.5 Liters, but the patient doesn't let the whole bag run in because it hurts with all of that fluid in their belly) the action response should be to do the dialysis as prescribed and talk to the care-giver. The fourth and fifth scenarios (the patient wants to look thin and attractive so drains the fluid before going out for the evening, and the patient goes to church all day on Sunday and do not have time to do peritoneal dialysis) should generate similar action responses. The sixth (the nurse asks the patient to bring in their adequacy collection but the patient doesn't want to because the patient is afraid they will ask to do more exchanges) should generate a response that reflects compliance with bringing in the adequacy studies as requested, and the seventh (the patient's urine output is way down, almost nothing at all, and the patient starts to feel tired and nauseated) should generate an action response to report the urine output and symptom changes to the care-giver. The eighth scenario (the patient feels so full when he/she puts the full amount of dialysate that he/she can't eat, so the patient reduces the fill volume so he/she can eat) should generate a response to talk to the care-giver and perhaps try eating during a drain process, and the ninth scenario (the nurse tells the patient that his/her Kt/V should be 2.0, but the patient's report card states it is a 1.8) should generate a continue as before, but also talk to the care-giver in order to attempt to determine a means for improvement. These and other scenarios should be continued and/or repeated until the patient/learner has satisfactorily learned the proper decision-making process. Problem-solving scenarios may also be implemented in a similar fashion with the goal of having the patient/learner develop the ability to recognize and identify the problem as well as develop a satisfactory solution.

In an “Anemia” concept formation lesson plan of the “Understanding PD” unit, the objective is to have the learner be able to define anemia and state the effects of anemia on the body. Preferred media illustrations may include examples and non-examples such as those shown by UP 8, 9, 12, 13, 17, 20, 21, 22, 23; FB 13, 21, and 22 (FIGS. 1C-1E and 6D, 6E and 6F). Evaluation of whether learning has occurred may be defined by when the patient/learner can define anemia and state effects of anemia on the body. The trainer may begin the presentation by getting the learner ready: “Now it is time to learn what anemia is. I will give you a definition of anemia and show you examples that illustrate the effects of anemia. You (the learner) will pay close attention to the definition and when shown examples (given verbal descriptions) of anemia, will guess if they are illustrations of the effect of anemia or not. Don't worry if you make mistakes, that is how you learn. When you are guessing correctly, we will know that you understand anemia.”

Activities of the trainer and learner will now be described. The trainer gives a definition of the concept (although the trainer may delay giving a definition of the concept to the end of the lesson). The learner will pay attention to the definition. Then, the trainer will present examples and non-examples of items to illustrate concept. Give learner feedback about accuracy of guesses. The presentation will usually start with example/non-example pairs, then as learner is guessing correctly, present single examples and non-examples. Final examples and non-examples presented should be very close so learner must make fine discriminations. The learner should then guess if it is an example or non-example, and the learner continues guessing as examples and non-examples are presented. The trainer preferably continues to present examples and non-examples until learner is guessing correctly all of the time, and then have the learner formulate a definition of the concept. If the definition has been presented at start of lesson, the trainer has the learner use his/her own words to formulate a definition. Critical characteristics of the definition of anemia may include: a low red blood cell count (Hgb<11) poor quality of red blood cells. Signs and Symptoms may include pallor; lowered body temperature; fatigue; altered mental status; tachycardia; lowered blood pressure; and shortness of breath with exertion.

Suggested Example/Non-Example Pairs (presented by verbal descriptions, suggested pictures/video-clips, and/or written or verbal scenarios) may include:

Picture of person with rosy cheeks/picture of person with very pale cheeks. (UP 12 and 13; FIG. 1C);

Picture of person climbing the stairs with ease/picture of person having difficulty climbing stairs (red-faced, struggling to catch breath). (UP 22 and 23; FIG. 1D);.

Picture of person sitting at desk working/picture of person sitting at desk sleeping. (UP 8 and 9; FIG. 1C);

Flow sheets with temperature, pulse and blood pressure within normal ranges/flow sheets with temperature and blood pressure below normal ranges and pulse higher than normal range. (Teacher to mock up flow sheets to illustrate concepts) (FB 13 and 22 (FIGS. 6D and 6E) are another example of BP and pulse in normal range and BP low with tachycardia.);

Picture of person reading the paper/picture of person reading the paper with a question mark over their head, not understanding what they are reading. (UP 20 and 21; FIG. 1D);

Picture of person exercising/picture of person sleeping. (FB 21 and UP 17; FIGS. 6D and 1D); and

Nutritional report cards (not shown) with mocked up Hgb values to illustrate anemia and Hgb that exceeds minimum may also be used.

A principle learning lesson plan for the Anemia sub-section will give the learner the ability to identify the relationships between anemia, erythropoietin and iron. Preferred illustrations may include a card with the relationships (principles) listed or verbal scenarios the same as or similar to those listed below:

Criteria to evaluate whether learning has occurred will be determined as of when the learner will state the following principles:

If erythropoietin levels decrease, then the bone marrow is not stimulated to produce enough red blood cells.

If there is inadequate iron stored in your body, then the red cells that are formed will not have enough hemoglobin in them.

If there are not enough red blood cells or the red blood cells do not have enough hemoglobin, then you will have signs and symptoms of anemia.

The learner may be prepared using introductory words such as “at the end of this lesson you will be able to state the relationships between iron, erythropoietin, and anemia. I will tell you what the relationships are. You (the learner) will listen carefully to what I (the trainer) say and repeat the information until you think you know the relationships. When you think you know the relationships, I will give you verbal scenarios that may or may not illustrate the relationships. When you can tell me whether or not the scenarios illustrate the principles (relationships) we will know you have learned it.”

Activities of the trainer and learner may include the trainer reviewing concepts and stating principles such as “patients need erythropoietin to stimulate bone marrow to produce red blood cells; and patients need enough iron stored in the body to make red blood cells with enough hemoglobin to carry oxygen to body cells, tissues, and organs; and if erythropoietin levels decrease, then the bone marrow is not stimulated to produce enough red blood cells; and if there is inadequate iron stored in your body, then the red cells that are formed will not have enough hemoglobin in them; and if there are not enough red blood cells or the red blood cells do not have enough hemoglobin, then you will have signs and symptoms of anemia.

The trainer may also give the learner a card (not shown) with the relationships printed on it; and may have to repeat relationships to learner several times (the teacher may enlarge the principles from the analysis to show to the learner); give the learner verbal scenarios that are examples and non-examples of the principles; ask the learner to guess and give feedback; and restate the principles linking the concepts and have learner restate the principles in his/her own words. The learner should listen and repeat relationships, and listen to the scenarios and guess if they illustrate the principles; and finally formulate a definition of the principles involved.

A sample list of concepts linked to form principles is as follows:

You need erythropoietin to stimulate bone marrow to produce red blood cells.

You need enough iron stored in your body to make red blood cells with enough hemoglobin to carry oxygen to body cells, tissues, and organs.

If erythropoietin levels decrease, then the bone marrow is not stimulated to produce enough red blood cells.

If there is inadequate iron stored in your body, then the red cells that are formed will not have enough hemoglobin in them.

If there are not enough red blood cells or the red blood cells do not have enough hemoglobin, then you will have signs and symptoms of anemia.

Suggested scenarios which may also be given to the learner may include verbal scenarios such as:

Description of person making this statement as they take the prescribed medications: “I get so constipated from this iron pill that I am not going to take it anymore.”

Description of person making this statement: “Iron upsets my stomach if I take it alone, so I take it with food and my phosphate binder.”

Description of person stating: “I get stuck often enough when I give my insulin. I just don't want any more sticks so I am not giving my EPO this week.”

Description of person stating: “I am feeling good and full of energy so I don't think I need to give myself that shot this week.”

Description of person stating: “I haven't been able to take my iron, but I have told my nurse and they are going to give me IV iron.”

Description of person stating: “I am so tired and weak that I can't get to the clinic for my EPO shot, so I'm going to stay here and take a nap.”

Description of person stating: “I don't like taking my iron so I',I'double my EPO shots instead.”

Description of person stating: “I threw up several times this week and there was blood in each one, but I don't think it's a big deal so I haven't told the nurse.”

Description of person stating: “I have been working hard to take my iron and EPO as prescribed. It has taken several weeks but I feel better.”

Or other scenarios for discussion may involve the patient's iron supplement raising your iron stores to normal levels and/or the patient forgetting to take EPO with him/her on a month's vacation.

A judgement/decision learning lesson plan for the “Anemia” sub-section of the “Understanding PD” unit may have the objective of providing the learner with the ability to recognize symptoms of anemia, conditions that may contribute to anemia and to state actions to take. Illustrative media may include scenarios as described below. Evaluation of the learning process may be determined as when the learner identifies symptoms of anemia, and when given problem situations identifies conditions that contribute to anemia and appropriate actions to take.

The learner may be prepared to learn using phrases like: “Now that you understand signs of anemia and how iron and EPO relate to anemia it is time to learn actions to take when you encounter situations that may contribute to anemia. I (the trainer) will present situations to you and suggest some actions to take if this happens to you. You (the patient/learner) just pay attention and try to memorize the correct actions. We will know that you have learned what to do when you can repeat to me what actions you should take for each situation.”

The patient/learner's activities include paying attention and recalling the concepts while the trainer reviews associated concepts; states the principles; and presents what the learner should be looking for and possible action steps that should be taken. (Note, the purpose of this lesson is to get the learner to memorize where/when judgements should be made and the correct actions that should be taken.) The learner should then repeat the judgement and decision while the trainer provides feedback. This process should continue until the learner has memorized the principles.

A suggested list of principles used to help the learner make judgement decisions may include:

The patient needs erythropoietin to stimulate bone marrow to produce red blood cells.

The patient needs enough iron stored in his/her body to make red blood cells with enough hemoglobin to carry oxygen to body cells, tissues, and organs.

If the patient's erythropoietin levels decrease, then the bone marrow is not stimulated to produce enough red blood cells.

If there is inadequate iron stored in the patient's body, then the red cells that are formed will not have enough hemoglobin in them.

If the patient does not have enough red blood cells or the red blood cells do not have enough hemoglobin, then the patient will have signs and symptoms of anemia.

Following are suggested scenarios concerning what the learner should be looking for in making judgements and what possible choice(s) are and/or action steps should be taken in making decisions (some judgements will have several consequent action steps).

1. The patient says “I get so constipated from this iron pill that I am not going to take it anymore.”; to which the patient should decide to tell the nurse; take stool softeners if prescribed; increase activity level; and consult dietician for diet changes to increase fiber intake.

2. “Iron upsets my stomach if I take it alone, so I take it with food and my phosphate binder.” to which the patient should learn to respond not to take iron with binders; and to call the nurse or dietitian.

3. I get stuck often enough when I give my insulin. I just don't want any more sticks so I am not giving my EPO this week,” with an appropriate response being to talk to the nurse.

4. “I am feeling good and full of energy so I don't think I need to give myself that shot this week,” to which a good decision is to continue EPO as prescribed.

5. “I haven't been able to take my iron, but I have told my nurse and they are going to give me IV iron.” With response to pat yourself on the back; and make sure you go to the clinic for the IV iron.

6. “I am so tired and weak that I can't get to the clinic for my EPO shot, so I'm going to stay here and take a nap.” The proper response being to contact nurse for assistance.

7. “I don't like taking my iron so I'll double my EPO shots instead.” The patient should learn to contact nurse or dietitian for assistance with iron; and take EPO as prescribed.

8. “I have been working hard to take my iron and EPO as prescribed. It has taken several weeks but I feel better.” The patient should respond by patting him/herself on the back and continuing to take iron and EPO as prescribed.

9. The patient recognizes that his/her iron supplement raises his/her iron stores to normal levels, and should respond by continuing to take iron as prescribed.

10. The patient forgets take his/her EPO with his/her on a month's vacation. The response should be to contact the nurse at the patient's home or back-up clinic.

A problem solving lesson plan for the Anemia sub-section will preferably provide for the learner to be able to identify situations that may contribute to anemia and take the correct actions. The trainer will review associated concepts, re-state the principles, and present scenario(s) and ask the learner to identify and solve the problem. After each scenario, the teacher asks the learner to state the possible problem and describe the appropriate actions to take. Note, the teacher may need to prompt learner to solve the problem, e.g., “What is happening here?”; “What do you know about that?”; and “What do you think you should do?” If the learner is having difficulty identifying the problem then go back and review associated concepts. Problem solutions should also include unit/clinic specific standing orders. The trainer should continue presenting scenarios until learner is developing correct solutions and taking correct actions. A list of principles used to solve the problem may include:

Patient needs erythropoietin to stimulate bone marrow to produce red blood cells;

Patient needs enough iron stored in your body to make red blood cells with enough hemoglobin to carry oxygen to body cells, tissues, and organs;

If erythropoietin levels decrease, then the bone marrow is not stimulated to produce enough red blood cells;

If there is inadequate iron stored in your body, then the red cells that are formed will not have enough hemoglobin in them; and

If there are not enough red blood cells or the red blood cells do not have enough hemoglobin, then you will have signs and symptoms of anemia.

Suggested Problem Scenarios and associated problem solutions may include:

1. “Going to the clinic just for a shot seems like a lot of trouble.”; Solution—Continue to go to the clinic for the shot. Talk to the nurse about alternatives to administer the EPO.

2. “Iron upsets my stomach.”; Solution—Contact the nurse or dietitian.

3. “Iron makes me constipated.”; Solution—Take iron and stool softener as prescribed. Contact the nurse.

4. “I don't like taking shots.”; Solution—Continue EPO as prescribed, and talk to the nurse.

5. “My friend says if you eat a lot of liver it will build your blood.”; Solution—Continue EPO and iron as prescribed, and consult dietitian for dietary changes.

6. “After I got on the plane I realized I forgot to bring my EPO with me for the week I am away from home.”; Solution—Contact home or back-up facility for guidance.

7. “It's hard for me to remember to take all of my pills, so I have started taking them all at the same time.”; Solution—Take medications as prescribed, and consult nurse for suggestions.

8. “I've been taking iron and EPO as prescribed. I have begun to ride my bike again and feel good.”; Solution—Continue to take medications as prescribed. Pat yourself on the back.

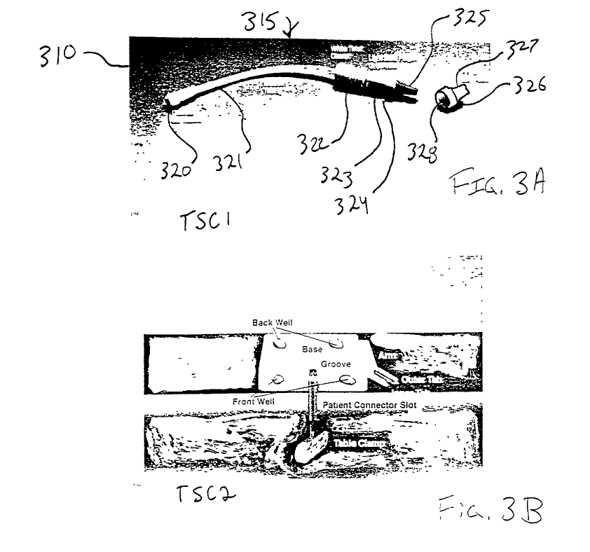

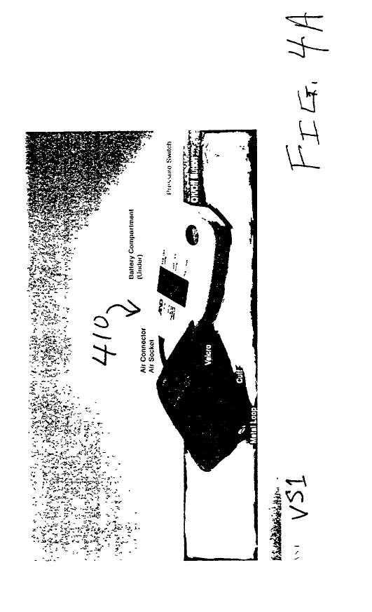

The illustrations of FIG. 2 (here again, as above, the term “FIG. 2” is intended to encompass all of the sub-figures, i.e., FIGS. 2A-2F, just as will the remaining FIGS. 3-10 and like Figs. also represent and encompass their respective suffixed sub-Figures) show several of the steps to be used in maintaining asepsis as well as proper and improper techniques and/or behaviors to be used in each operation, the safety sterility and cleaning methods and equipment to be used by the patient and the do's and dont's associated with each step as well as those teachings which will not be acceptable. In particular, this will be one of the first units or modules taught leading to either teaching of the UltraBag™ Exchange or Home Choice™ Cycler. This unit preferably involves memory/habit, concept formation, and motor skill learning.

The preferred media pictures may also be disposed in a media book. Pictures as well as tangible objects may be made available before starting these lesson plans. If a learner is taught outside a clinic, access to a work surface will be necessary, as well as a sink with water and soap; more specifically the preferred materials are liquid antibacterial soap, paper towels, bleach, measuring instruments. A suggested outline based on requisite knowledge to be imparted by this module follows:

Sterile/Unsterile (concept formation)

Clean/Dirty (concept formation)

Cleaning the Work Surface (memory/habit)

Masking/Washing Hands (motor skill)

Opening a Sterile Package (motor skill)

In the “Sterile/Unsterile” sub-section the objective is to recognize sterile/unsterile conditions when the learner sees them. Also, it is preferable to use media, such as pictures of examples and non-examples, see illustrations (MA 1-15 of FIGS. 2A-2C). Also, in order to evaluate whether learning has occurred, the trainer, who may be a nurse, will preferably give a description of an item or a situation and the learner will then have been taught the ability to the determine whether it is sterile or unsterile. A trainer may present initial auditory information about what may be learned, such as:

“At the end of this lesson you will be able to tell whether something is sterile or not sterile. Then I'll show you pictures representing sterile and unsterile conditions, then ask you to guess, and I will tell you if you are right or wrong and why. It's okay if you make mistakes because that is how you learn. We will keep doing this until you are getting them all correct, and then we'll know you have learned it.”

Several different interactions between the learner (student) and teacher may be important to such a learning activity. In teaching the concept of “sterile/unsterile” the progression might proceed as follows.

First it is important for the learner to pay attention as the teacher gives a definition of sterile/unsterile (see definitions below; alternatively, the teacher may delay giving an actual definition of sterile/unsterile until the end of the lesson). Secondly, the teacher may give examples and non-examples of items to illustrate sterile/unsterile conditions. The student guesses if it is an example or non-example, and the teacher tells the student if he/she is accurate or not. (It is usual to start with example/non-example pairs, then as the learner is guessing correctly, present single examples and non-examples. Final examples and non-examples should be very close so learner must make fine discriminations.) Third, the teacher continues to present examples and non-examples as the learner continues guessing until the learner guesses correctly all of the time. Finally, the teacher has the learner formulate a definition of sterile/unsterile, helping the student find a definition meaningful to him/herself. (If a definition was presented at the beginning of the lesson, the student should make a definition using his/her own words.) It may be necessary that certain minimal elements for each module be learned. For the definition of sterile/non-sterile the critical characteristics are 1) free of disease-causing germs; 2) label indicating that the item has been sterilized; 3) packaging of the item is intact, not soiled, nor wet; 4) once opened, the item has not been in contact with any object that is not sterile; 5) once opened the item has not be exposed to the air or room environment for more than several minutes; 6) any expiration date has not been exceeded.

Following are several suggested example/non-example pairs the trainer might present to the learner about sterile/unsterile conditions. They cover a range of modes including verbal descriptions, suggested pictures/video-clips and scenarios:

Bag of clear PD solution/bag of PD fluid with discoloration (MA1, FIG. 2A);

Package of drain sponges that is intact with no evidence of wetness or stains/package of drain sponges with a stain on the package (MA2, FIG. 2A);

Medication vial which has not reached the sterile expiration date/Medication vial which is past its sterile expiration date (MA3, FIG. 2A);

Minicap with package intact/torn minicap package (MA4, FIG. 2A);

Package of 4×4 with “sterile” on the package label/4×4 not in any type of package (MA5, FIG. 2A);

Scenario with patient removing rubber protective cap from bag of PD fluid; port extends over surface that bag is on/same scenario, but port touches surface of table after protective cap is removed (MA6, FIG. 2A);

Syringe on table out of the outer wrapper (MA7; FIG. 2B);

Picture of Home Choice with organizer on the door and cap off one spike (MA8, FIG. 2B);

Picture of person, not wearing a mask, holding uncovered spike (MA9, FIG. 2B);

Bare finger touching a spike (MA10, FIG. 2B);

Gloved hand touching a spike (MA11, FIG. 2B);

Bag of dialysate solution with a puddle of liquid under and next to it (MA12, FIG. 2C);

Patient with transfer set with minicap off; end of transfer set touches patient's clothing (MA14, FIG. 2C);

Patient with transfer set with minicap off; end of transfer set touches pad in patient's lap (MA13, FIG. 2C); and

Scenario of patient spiking a bag of PD solution with thumb touching spike. (MA15, FIG. 2C).

Other sub-sections in “Maintaining Asepsis” may also be taught in a similar fashion as well (as set forth above, “Clean/Dirty;” “Cleaning the Work,” “Surface; Masking/Washing Hands;” “Opening a Sterile Package,” or the like). See the following.

The “Clean/Dirty” lesson plan teaches the patient/learner to define and recognize clean and dirty situations. To begin with the trainer provides a definition of “clean” and “dirty” (or may wait until examples have been presented to help the learner formulate definitions). The trainer provides several example/non-example pairs; then single examples, having the patient identify each as “clean” or “dirty”. As the patient becomes more accurate the more difficult examples are presented making identification harder. Suggested pairs and examples may include:

Picture of obvious dirt on hands (MA 16; FIG. 2C);

Picture of dialysis supplies on clean surface/picture dialysis supplies on filthy surface (MA 17/18; FIG. 2D);

Picture of washing hands, then opening sterile supplies (MA 19/20; FIG. 2D)/Picture washing hands then scratching chin, then opening sterile supplies (MA 19/21/20; FIG. 2D);

Picture of room with open window, fan blowing, and drapes billowing in towards room/picture of room with window closed (MA 22/23; FIG. 2E)

Picture of room with cat sleeping on the bed/Picture of same room without the cat (MA 24/25; FIG. 2E)

Picture of person in room doing exchange with other people who are not masked (MA 26; FIG. 2F);

Picture of dirty shower head (MA 27; FIG. 2F);

Picture cleaning table with paper towel and disinfectant solution (MA 28; FIG. 2F);

Picture washing the work surface with a kitchen dish rag (MA 29; FIG. 2F);

Dry work surface/work surface with puddle of liquid (MA 17/30; FIGS. 2D and 2F);

Verbal scenario of person placing dialysis supplies on unwashed table/scenario of person placing dialysis supplies on clean work surface;

Verbal scenario with patient drying self after shower, then using same towel to dry exit site;

PD catheter care in the shower with bar of soap that is well-used with hair on it (not shown).

The trainer reviews examples/non-examples with the patient/learner and helps the patient formulate a definition of “clean/dirty.” Critical characteristics in the definition include being relatively free of disease-causing germs; area has been cleaned; there is no evidence it has contaminated (made dirty); and the item was produced in a clean environment.

The next sub-module of “Maintaining Asepsis” to be learned is “Cleaning the Work Surface.” Materials needed for this lesson are bleach, teaspoon, measuring cup, mixing bowl, paper towels and a surface to work on. The trainer explains that every time a clean work surface is needed it has to be cleaned and demonstrates the technique. First the trainer demonstrates how to mix a cleaning solution of one part bleach to fifty parts water using 1 teaspoon of bleach to one measuring cup of water. Optional containers to use for mixing are presented and/or discussed. Next the trainer demonstrates cleaning the area using spiraling strokes from the center of the area to the edge, and then drying the area with a clean paper towel following the same pattern. Next the patient/learner follows the same steps of mixing the cleaning solution, cleaning and drying the area. Finally the trainer discusses the procedure with the patient and answers any questions, making sure the patient understands and can perform the task.

A further sub-module in “Maintaining Asepsis” to follow “Clean/Dirty” is “Masking/Washing Hands”. Materials needed for this lesson include a sink, paper towels, antibacterial soap in a pump dispenser; mask, waste receptacle. The trainer goes through each step in the procedure, first demonstrating the procedure, a second time discussing what he/she is doing and pointing out key points to remember, and a third time using a shortened description (see detailed steps below). Then the patient masks and washes hands, repeating the procedure until he/she is able to perform it properly several times in a row. During the practice period the trainer encourages the patient and helps correct mistakes. The steps and their order to follow to properly mask and wash hands are:

Put loops of mask behind the ears; pull mask down so top covers the nose and bottom covers the chin. Identify metal strip if present.

Fold down top edge if necessary for optimal vision and comfort.

Wet hands. Hands stay clear of sink edges.

Remove watch and excess jewelry before washing hands.

Pump two pumps of antibacterial soap into palm of right hand.

Begin handwashing—turn faucet on, adjust water temperature to warm.

Rub palms of hands together ten times.

Have patient count to ten as they perform each activity.

Place palm of right hand over back of left hand and rub ten times.

Repeat with palm of left hand over back of right hand.

Use right thumbnail to clean under nails and around cuticles of left hand.

Use left thumbnail to clean under nails and around cuticles of right hand.

Interlace fingers and rub together ten times.

Grab the left thumb with right hand and rub in a circular motion ten times.

Repeat with right thumb and left hand.

Circle left wrist with right thumb and fingers and rub in a circular motion ten times.

Repeat with the right wrist.

Rub palms together ten times.

Place palm of right hand over back of left hand and rub together ten times

Place palm of left hand over back of right hand and rub together ten times

Point fingertips toward ceiling, wrists down, and move hands into faucet stream.

Allow soap to completely rinse from hands keeping fingertips highest at all times.

Grasp paper towel with right hand and pull off the roll.

Pat hands dry, beginning at fingertips and ending at the wrists.

Use paper towel to turn off the faucet.

Discard paper towel in waste receptacle.

Keep hands forward and in view. Keeps hands uncontaminated.

“Opening a Sterile Package” continues the “Maintaining Asepsis” unit. After the patient learner has mastered the “Sterile/Unsterile,” “Clean/Dirty,” “Masking/Washing Hands,” and “Cleaning the Work Surface” sub-modules, the teacher demonstrates how to open a sterile packing using the same process of repeat demonstration and analysis and then having the patient/learner repeat the procedure until he/she has mastered it. Several varieties of sterile packages, such as sterile gauze packages, Minicaps, and syringes should be available to use in the lesson. When ready, the trainer proceeds with the lesson including the following sequential steps:

Clean work surface

Gather supplies appropriate to this procedure.

Mask and wash hands

Pick up the sterile package. Find the top of the package where there are flaps that can be peeled apart

Hold the flaps between the thumbs and sides of the forefingers

Gently pull in opposite directions to separate the flaps about ¼ inch.

Put the package on the work surface with the writing side up.

Hold the lower flap down on the work surface with the tips of the fingers of the left hand.

Holding the upper flap between the right fingers and thumb, continue pulling the upper flap until the package is open all the way.

With particular reference now to FIG. 3 (including FIGS. 3A and 3B), a training system for particular product use may be illustrated by a sequence of steps as follows: 1) gathering and/or identifying the equipment; 2) operation of the equipment; 3) cleaning and/or maintenance of the equipment; 4) proper storage of the equipment; all further described below.

As maybe seen in FIG. 3A (TSC 1), the equipment is illustrated in box 310 which pictorially shows the equipment to be gathered e.g., transfer set with clamp, silastic tubing, and minicap, etc., used for connecting a patient catheter peritoneal dialysis fluid set. Identifying numbers or words or both are shown depicting a transfer set 315 including, e.g., a catheter connector 320, tubing 321, clamp 322, grip area 323 with notches 324, tip 325 and minicap 326 with grip area 327 and inserted betadine sponge 328.

Thereafter, illustrations may be (but are not here) provided showing how one might learn to identify the transfer set 315 and its parts 320-328, as well as how one might be expected to use the transfer set 315, and/or how to open and close the clamp 322, how to connect and disconnect the catheter connector 320 and/or the minicap 326. Indeed, an unlabeled set may be used for both identification and use demonstration and/or practice. As an additional step in training patients to use the transfer set, pictorial illustrations (not shown here) may be provided to demonstrate those steps or missed steps which the patient has to pay particular attention to performing during use/operation of the equipment (in this case, the transfer set) operation for successful self-care.

Further, the transfer set module provides the trainer with the opportunity to step-by-step show the person being trained what is needed to perform other aspects of the task such as how to efficiently clean, maintain and store the transfer set, how to maintain sterility thereof (particularly emphasizing the sterilizing of the tip and the inside of the minicap) as well as the safe way of doing each of these steps (particularly with a fully assembled transfer set) and what to avoid in doing these functions, thereby maintaining asepsis and sterility.

By this presentation, training those having language or other educational difficulties can be done in an efficient and effective way. As an additional aid for the patient after training has taken place, training materials and media (illustrations, verbal and/or hardware) may be provided to the patient and pictorials and hardware as have the information which has already been shown and demonstrated by the trainer.

Note, as above, it is preferred that the trainer should also perform as many of the steps illustrated in FIG. 3 as possible, rather than only describing the applications to the patient being educated.

Referring now to FIG. 3B (TSC 2), shown is an assistance type of equipment arrangement which may be used with the transfer set shown in FIG. 3A. Such a device is sometimes sold under the name EZ-Aide™ assist device. Training in the identification of the parts of such an assist device may proceed as suggested for the transfer set above (e.g., presentation by a trainer of a labeled illustration or physical model, followed with patient trainee learning of the associated parts, then education on use may be performed, first with securing the assist device to a work surface such as a table. Options may also be taught such as in using suction cups (top and/or side) to assist the table clamp in holding the assist device to the work surface. After demonstration and practice with securing the assist device to a work surface; then the trainer can educate the patient in use of the assist device with the transfer set. Pictorials and or hardware models (not separately shown) may be used in introducing these methods of use. Then, preference is for a hands-on physical demonstration by the trainer of use (with assistance of the assist device in holding the transfer set for opening and/or closing by patient), followed by patient learner hands-on repetition of demonstrated use with multiple performance until the skill is developed to an automated stage.

In a similar fashion, FIG. 4A (VS1) shows an illustration of a device for use in a Vital Signs module, in particular here a blood pressure device 410 which may be digital (as shown) or otherwise (as known, but not shown). This module preferably provides for teaching the learner the mechanics of measuring vital signs, including troubleshooting vital sign problems. Memory and motor skill education make up most of the module with some problem solving and judgement/decision concepts.

Media for this module may include photos in a Media Book and actual models/supplies—e.g., a blood pressure machine, a digital thermometer, a scale, CAPD/CCPD flowsheets, and pen.

The following is a proposed chapter/module outline based on subject and requisite knowledge:

Components of Digital Blood Pressure Monitor(memory skills)

Measuring and Recording Blood Pressure and Pulse using a Digital Monitor (motor skills)

Measuring and Recording Blood Pressure/Pulse (principle/judgement/decision/problem solving)

Measuring and Recording Manual Pulse (motor skill)

Components of a Digital Thermometer (memory)

Measuring Temperature with a Digital Thermometer (memory/habit)

Weight measurement (memory/habit)

Teaching the use of these devices and concepts may proceed in known fashions with the preferable addition of enhanced interaction with the patient/learner having the patient/learner demonstrate proficiency in order to ensure learning. For further examples, scenarios may be presented to the patient/learner concerning proper (or improper) operation or problem situations with trainer feedback and/or testing.

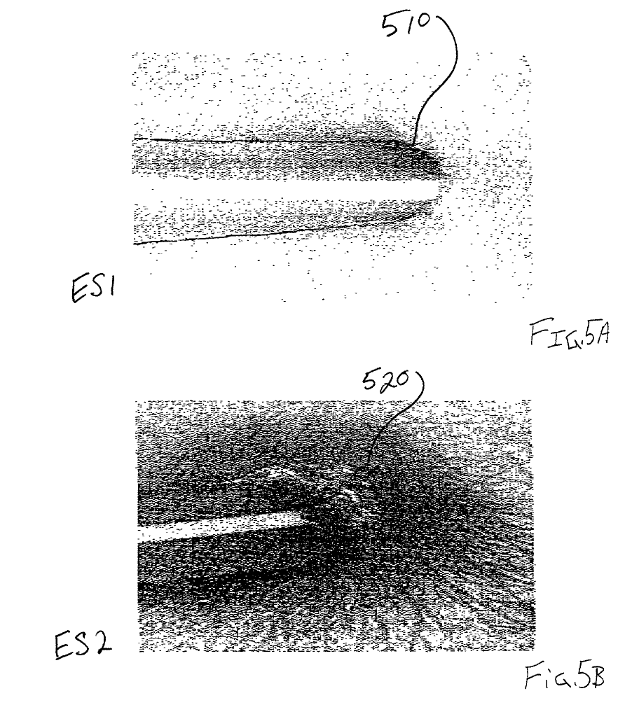

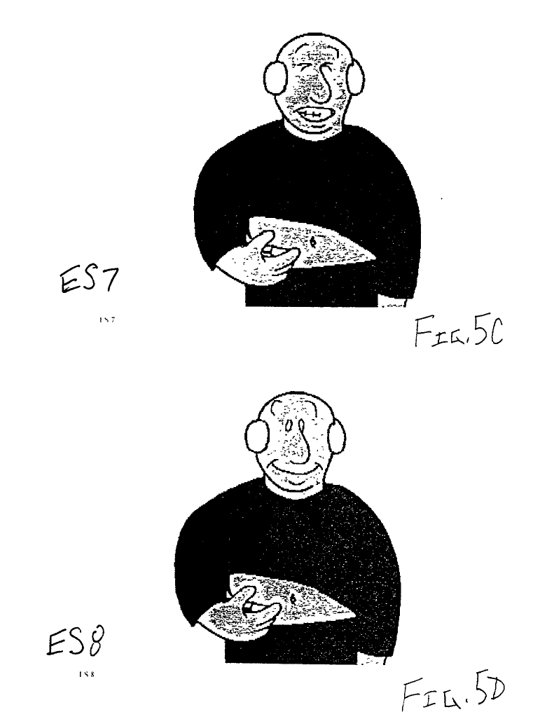

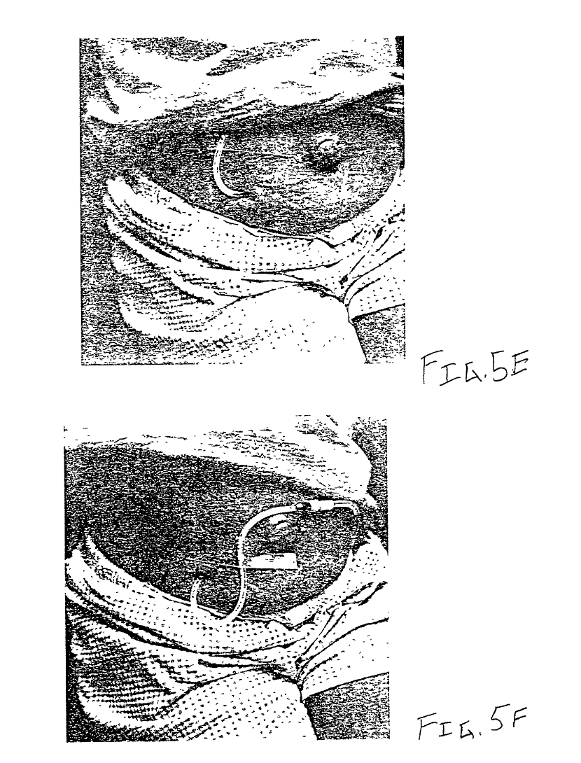

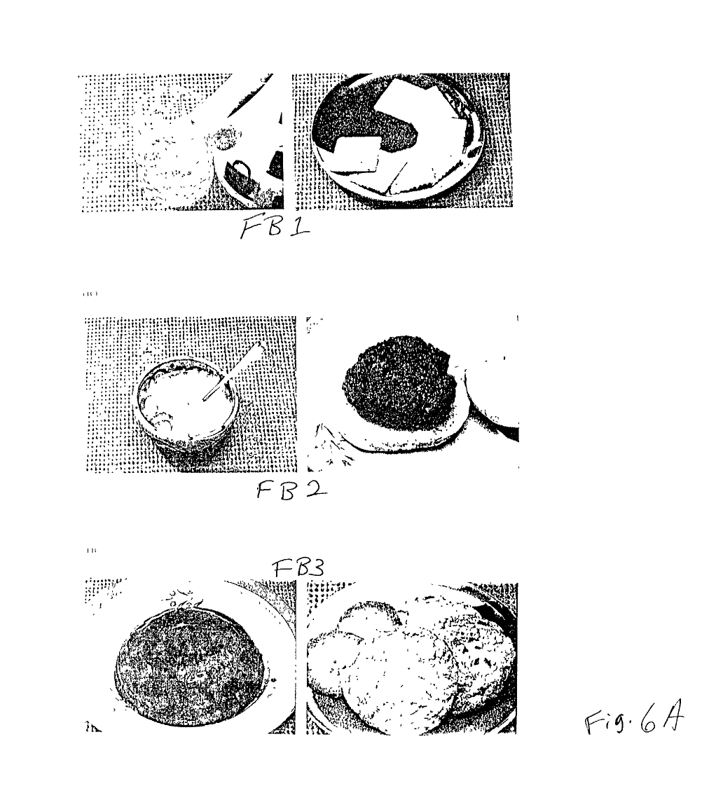

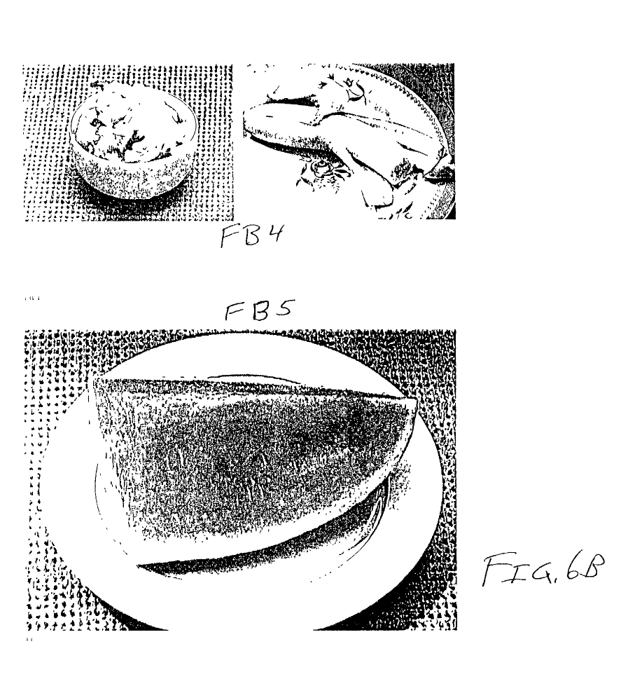

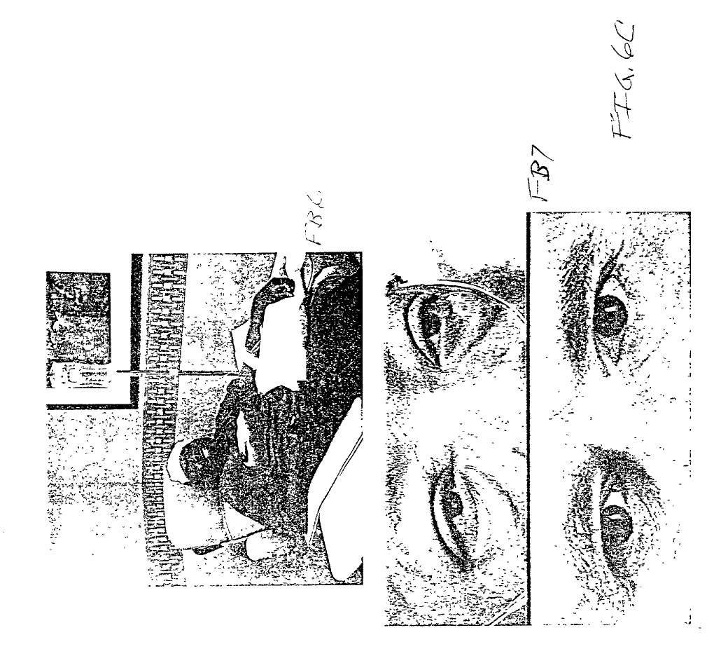

A further module/chapter is demonstrated here with reference to FIGS. 5A-5F, here referred to as “Exit Site Care.” This module will teach the learner how to care for an exit site. The learning concepts here include motor skills for the actual exit site care, some memory habit lessons, and judgements/decisions to determine catheter and exit site condition. As with many of the modules present here, the learner should first be familiar with the “Maintaining Aesepsis” module and the “Transfer Set/Clamps” module (both modules described above). For Media there are many items preferred including a “Peritoneal Catheter Exit Site Classification Guide”, a“Catheter Exit Site Wall Chart”, and a transfer set practice apron. Other items that may be used: hand wipes, cleaning solution, possibly a mirror on a stand, and a spray bottle. A camera (perhaps of the instant-developing type) may be used to photograph the patient's exit site.

Following is a suggested module outline based on requisite knowledge:

Exit Site Characteristics (concept formation)

Exit Site Inspection (principles, judgement/decision, problem solving)

Gathering Supplies for Aseptic Exit Site Care (memory)

Exit Site Care in the Shower (motor skill)

Exit Site Safety (memory)

Note, numerous pictorial illustrations may be used (only examples shown here) to depict acceptable versus unacceptable exit site characteristics for the purpose of demonstrating to the patient-learner the desired goals for exit site characteristics. For example, FIG. 5A (ES1) shows a “perfect” exit site, generally designated 51 versus an equivocal or perhaps infected exit site, designated 520 in FIG. 5B (ES2).

The module “Care of Exit Site” may be divided into several teaching sub-units, e.g., Exit Site Characteristics; Exit Site Inspection; Gathering Supplies for Aseptic Exit Site Care; Exit Site Care—Aseptic; Gathering Supplies for Exit Site Care in the Shower; Exit Site Care in the Shower; and Exit Site Safety. These include various learning modes, from memory and concept formation to motor skill development and principle, judgement/decision making and problem-solving. Before the patient learns the care of the exit site, the “Maintaining Asepsis” and Transfer Set/Clamps” units should be completed.

The trainer begins the module of “Care of Exit Site” by demonstrating and explaining acceptable versus unacceptable “Exit Site Characteristics,” first explaining the characteristics, then presenting examples of acceptable and unacceptable sites, following with having the patient/learner correctly identify both acceptable and unacceptable site examples, and finally working with the patient in concept formation to formulate acceptable definitions of acceptable and unacceptable exit site characteristics.

Critical characteristics of acceptable site characteristics may include a catheter aligned and anchored properly; a catheter free of redness; catheter free of swelling; catheter free of drainage; catheter cuff is not visible; catheter free of proud flesh; catheter free of scabs; catheter site and tunnel area free of tenderness. Some illustrative pictorials which can be used to show acceptable and unacceptable sites are:

Picture of perfect exit/picture of equivocal exit showing redness (light skin).(ES 1 and ES2; FIGS. 5A and 5B);

Picture of perfect exit/picture of infected exit showing drainage (dark skin)(not shown);

Picture of perfect exit./picture of exit with scab (not shown);

Picture of good exit/picture of exit with proud flesh (not shown);

Picture good exit with small crust/picture of infected exit with scab (not shown);

Picture of equivocal exit with redness and slight crust/picture of infected exit with swelling and shiny appearance (not shown);

Cartoon of palpating exit site and grimacing/palpating exit site and smiling (ES 7-8; FIGS. 5C and 5D);

Picture of catheter aligned and taped properly/picture of catheter pulled tight and out of alignment (ES 9-10; FIGS. 5E and 5F);

These materials may be laminated flip cards with exit-site pictures with the learner guessing if the site is pictured ok or not. An instant-style picture may be taken of the patient's exit for reference and have the patient/learner examine the patient's exit site and compare it to the chart. The trainer should also show a picture of a catheter cuff if available.

When the patient can correctly identify acceptable and unacceptable exit sites, the teacher may next present the module “Exit Site Inspection” using pictures of exit sites and verbal scenarios as teaching aides. The patient must learn how to evaluate unacceptable exit sites, identifying possible problems and causes. As in many other lessons described here, the trainer presents the principles involved, then gives examples, then works with the patient until the patient can correctly identify the following principles from illustrative examples and/or scenarios:

If the exit site is red, tender, swollen, or has drainage, an infection could be present.

If the cuff is showing, infection could be present.

If proud flesh is visible, infection could be present.

If crust is present, infection could be present.

If scab is present, infection could be present.

If an exit site infection is untreated, it could become a tunnel infection.

If a tunnel infection is present, it could lead to peritonitis.

If an exit site/tunnel infection leads to peritonitis, the catheter could need to be removed.

When the above principles are learned the trainer teaches symptoms to look for and possible action steps to take for different conditions:

Redness—inspect for tenderness, swelling, and drainage, call clinic;

Tenderness—inspect for redness, swelling, drainage, call clinic;

Swelling—inspect for redness, tenderness, drainage, and call clinic;

Drainage—note color, consistency, odor, amount, visible on exit site or only on dressing; draining freely or only with pressure, inspect for redness, tenderness, swelling, and call clinic;

Cuff visible—inspect for redness, tenderness, swelling, drainage, and call clinic;

Proud flesh—inspect for redness, tenderness, swelling, drainage, all clinic;

Crust—inspect for redness, tenderness, swelling, drainage, if present, call clinic; if not present, attempt to remove with gentle cleaning; and

Scab—inspect for redness, tenderness, swelling, drainage; if present, call clinic, if not present, allow to heal.

Some scenarios used to convey these concepts are:

Exit site is red and tender(ES 2, FIG. 5B);

Catheter cuff is visible(Verbal or show catheter with cuff);

Proud flesh is present(not shown);

Crust is present(not shown);

Scab is present (not shown);

Untreated exit site infection (Verbal);

Tunnel infection (Verbal); and

Peritonitis after tunnel infection (Verbal).

The patient is then taught which certain exit site situations require special intervention and the appropriate steps to take. As before the teacher presents the problem, describes possible interventions using visual and auditory examples, and ensures the patient/learner has correctly learned the material by having the patient identify the problem and give the possible action steps to use. These situations and appropriate actions may include:

Exit site is red, swollen, tender, or drainage is present—inspect exit for other signs and symptoms; notify nurse, go to clinic ASAP;

Cuff is visible at skin surface—inspect exit for other signs and symptoms of Infection; notify nurse, go to clinic ASAP;

Crust noted on exit site—inspect exit for other signs and symptoms of infection; if present, notify nurse, go to clinic ASAP; if absent, attempt gentle removal with soap and water;

Scab noted at exit site—inspect exit for other signs and symptoms; if present, notify nurse, go to clinic ASAP; if absent, leave intact, allow to heal;

Tunnel is tender when palpated—inspect for drainage; notify nurse, go to clinic ASAP; and

Exit site infection present, cloudy fluid noted—notify nurse, go to clinic ASAP.

When the patient/learner has learned exit site characteristics, including unacceptable situations and action steps to take regarding them, he/she is then presented with learning how to clean the exit site.

The first step in exit site care is “Gathering Supplies for Aseptic Exit Site Care”. The patient is introduced to the necessary supplies, hand wipe, solution (Shurclens, saline, liquid antibacterial soap), mask, sterile 4×4's, lap pad and tape. The trainer presents a card with a mnemonic (Wipe (hand wipe), Solution Four×fours, Mask Two×two (split or plain), Pad, Tape—Why Solve Four Minus Two Plus Two) or may ask the patient to form his/her own association to remember the list of supplies. Pictures or groups of supplies are presented and the patient is asked to identify if all the necessary supplies are present and if not, which are missing. When the patient can correctly do this, it is deemed that he/she has mastered the lesson.

The second step in exit site care is “Exit Site Care—Aseptic” during which the teacher instructs the patient/learner in how to properly care for the exit site. In addition to the supplies gathered in the previous lesson the site should have a work surface, transfer set practice apron turned inside out, large shirt for tucking, supplies for exit site care; possibly mirror on stand. The trainer first demonstrates proper cleansing technique, repeats the procedure describing and analyzing the steps, and then again repeats the steps with a brief description. The patient is then asked to first describe and then perform the requisite steps until he/she can successfully clean the site using the steps in the proper order. The preferable steps used are:

1. Clean surface (previously learned motor skill);

2. Wash hands (brief);

3. Gather supplies (adapt to dressing used by patient);

4. Inspect supplies (previously learned J/D);

5. Mask and wash hands (3 minutes) (previously learned motor skill);

6. Pick up the 4×4 package;

Find the top of package where there are flaps that can be pulled apart.

Hold the flaps between the thumb and sides of your forefingers

Gently pull in opposite directions to separate the flaps about ¼ inch

Put the package on the work surface with the writing side up.

Hold the lower flaps down on the work surface with the tips of your fingers.

Continue pulling the upper flap with your right hand until the package is open all the way

Repeat with remaining 4×4, 2×2 and IV sponges positioning each package in a straight line across the table top

7. Tear several pieces of tape large enough to cover dressing

Place edge of tape on edge of table (tape may be silk or paper).

8. Pour Shurclens, saline, or antibacterial liquid soap on one 4×4 (if antibacterial liquid soap is used, will need to wet several four by fours with water).

9. Secure clothing away from exit site to remain in place throughout dressing change procedure.

10. Place edge of lap pad in waistband. Remove transfer set from clothing. Sit down

11. Remove old dressing by grasping edge of tape and peeling back gently to completely remove. Remove IV sponges from around catheter by gently pulling slit and place old dressings in lap pad

12. Inspect exit site and catheter (previously learned J/D).

13. Clean hands with wipe

14. Starting with fold of 4×4, use left thumb and forefinger to pick up four corners of 4×4 and place each in turn between right thumb and forefinger

15. Place saturated center of 4×4 at exit site.

16. Hold catheter in left hand between thumb and forefinger, and move away from body. Move catheter during procedure to facilitate circumswabbing of exit.

17. Beginning at exit site with moderate pressure on the saturated are of 4×4, move around in a circular motion one time until an area approximately 2 inches in diameter has been cleaned. Drop 4×4 in lap pad

This may be difficult for patients whose exit site is still freshly post-op

Trainer may wish to only demonstrate end perform for patient until toward the end of training when their exit is less tender

18. Repeat with bottom 4×4; if antibacterial soap is used, continue circumswab motion with 4×4s until soap is rinsed completely off.

Dry with dry 4×4 if desired.

19. Apply dressing: with right hand, pick up comer of one 2×2 IV sponge at slit side.

Place corner of slit at exit site, with slit pointing down. Release catheter.

Pick up corner of second 2×2 IV sponge and place slit around catheter, with slit pointing to the left of the patient. Pick up plain 2×2 and with folded corner, place over split 2×2 to cover them completely

Hold in place gently with index and middle finger of left hand

Ensure no tension exerted on exit.

20. With right hand pick up tape and place horizontally over dressing

Tape should be centered over 2×2 and overlap onto skin approximately one inch on each side. Continue until dressing is secure.

Window pane or cover with tape.

21. Place strip of tape loosely over catheter at point of exit from dressing.

Pinch underneath to form tunnel for catheter. Inmmobilizes catheter.

Catheter should be snug but not tense at exit.

22. Immobilize transfer set per patients preference.

23. Discard used supplies in waste receptacle.

A brief description of the logically grouped steps is given as a mnemonic aid:

1. Wash hands, gather supplies.(Gather supplies.)

2. Open supplies, tear tape, pour solution, prepare self. (Prepare supplies and self.)

3. Remove dressing., inspect site. (Inspect.)

4. Clean in circular motion. Rinse and dry if necessary. (Clean, rinse, dry.)

5. Apply dressing, tape securely, apply immobilizer or tape and secure. (Dress, immobilize.)

The final step in the “Exit Site Module” is teaching the patient/learner how to care for the exit site in the shower. As in the previous unit, the first step taught is gathering the needed supplies using examples (either illustrative or actual), special washcloths, liquid antibacterial soap, drying using special washcloths and dressings. As in the previous “Gathering Supplies” unit, teaching continues until the patient/learner is able to correctly identify the whole group of necessary supplies and identify missing ones from a displayed group.

The trainer then proceeds to demonstrating the steps and then having the patient practice the steps involved until he/she has mastered them. For the practice session the following items may be used: practice apron with dressing applied worn backwards, liquid antibacterial pump soap, 2 special washcloths, 1 plain washcloth, spray bottle for rinsing, garbage bag, bath towel. First the patient is taught to gather the items necessary. Then the trainer demonstrates the steps for shower cleansing of an exit site (using a practice apron). The steps covered are:

1. Wash hands(brief) (previously learned motor skill).

2. Gather supplies. (previously learned memory lesson).

3. Remove old dressing by grasping edge of tape and peeling back gently to completely remove.

Remove IV sponges from around catheter by gently pulling slit.

Free remainder of dressing and pull carefully away from exit site. Discard. (adapt the removal of dressing to that used by the patient)

4. Inspect exit site and catheter. (previously learned judgment/decision).

5. Shower as usual.

6. Grasp clean special washcloth (may use soapy fingers).

7. Place quarter size puddle of solution at center of washcloth, gauze or on fingers (antibacterial pump soap should be used).

8. Place solutioned area at exit site.

9. Using moderate pressure on washcloth, clean in circle from exit site outward, forming a spiral approximately 6″ in radius.

Use thumb and forefinger of opposite hand to hold catheter out of the way.

10. Rinse.

11. After shower is complete: dry body first, then using clean unused special washcloth, pat exit site dry in spiral pattern from exit site out, (make sure exit is completely dry. May use blow dryer set on low).

The lesson is then reviewed and a brief description of the steps is given:

1. Wash hands, gather supplies. 1. Prepare.

2. Remove old dressing. Inspect Site. 2. Inspect.

3. Shower. Clean exit Site. Rinse. 3. Shower.

4. Dry with special washcloth, hairdryer. 4. Dry.

A memory and/or habit learning plan may then be taught for Exit Site Safety, a potential last sub-section of the Exit Site Care unit. Here, the objective will be to have the learner be able to name the critical aspects of safe exit site care. Presentation and repetition with the learner as above described should be done here as well. A List of information to preferably be memorized with a Mnemonic(s) or other helpful memory aids or memorization strategies are following:

1. Exit site care and catheter inspection are done daily to prevent infection and sustain catheter life. A Card with critical aspects of safety listed on it may be used.

2. Catheters are secured to prevent any twisting, tugging or pulling at the exit site.

3. Maintain good personal hygiene.

4. Swimming in well maintained chlorinated pools and clean ocean water is acceptable. Exit site care is done immediately after swimming.

5. Swimming in rivers, lakes, public pools, whirlpools and hot tubs is prohibited.

6. Conditions that are detrimental to the exit site include: alcohol, powders, oil based ointments, irritation or excoriation from tape, twisting or pulling on the catheter, perspiration, scratching, pressure from tight clothing, pressure from seat belts, sleeping on the abdomen.

7. Only substances approved by the Clinic may be used for catheter and/or exit site care.

8. Cleansing agents should remain in their original container. Reusable soap dispensers are avoided.

A next-taught module may be the “Fluid Balance” module (note, many of the modules here may be taught in many different orders, not restricted to the order set forth here). The Fluid Balance module will teach the learner about components of fluid balance. The ultimate goal is a human body that maintains a target weight, and the ability of the learner to choose solutions (both fluid and problem solutions) appropriate for their fluid balance state. The learning involved is primarily concept formation, and there are plenty of visual pictures, inter alia, for presenting example scenarios. In addition, a fluid balance video and/or video script may preferably be included.

Prior to this module, the learner should have mastered skills from the “Vital Signs Unit”. Many of the concepts in fluid balance incorporate body weight, blood pressure and pulse so it is important that the learner understands these first. The “Hyperosmolarity” sub-section (see below) requires knowledge of the “Sugar” and “Sodium ” sub-sections from the “Managing Diet Unit”; thus, the trainer and/or patient/learner may wish to come back to this after the “Managing Diet” module has been completed. The media that each clinic/trainer should gather prior to teaching these lesson plans include some non-clinic items; water balloons, silly putty, containers to measure fluid in different amounts (1 cup to 1 gallon). The “Choosing Dialysate” lesson plan also refers to a Personal Fluid Balance Chart, contact your health care product representative for a copy. After, or instead of, viewing a fluid balance video (if chosen), the trainer may also be inspired to have objects shown in the video included in the media such as; cucumbers, strawberries, buttons, food cards, and/or empty food boxes for display. There are several PAUSE sections in the video when the teacher and learner can simulate the experiments.

There is a lesson plan that corresponds with the Fluid Balance video (or video script, see below). This should be reviewed along with the video (or script) prior to teaching the first learner. The video is interactive and the teacher should watch the video with the learner. As mentioned above, there are several PAUSE sections for the teacher and learner to interact, whether for evaluating learning or trying experiments. After viewing the video once with the learner, the trainer may want to re-run it without the pause sections so the patient/learner can view it in its entirety.

Following is an outline of the “Fluid Balance” module based on requisite knowledge (this is presented in a slightly different order in the Video—see the Video Lesson Plan); the learning modality required follows each topic covered:

Body Weight Components (memory)

Body Weight Changes (concept formation)

Fluid Intake (concept formation)

Systolic and Diastolic Blood Pressure (concept formation)

Edema (concept formation)

Fluid Overload (concept formation)

Fluid Output (concept formation)

Dextrose Concentration (memory)

Ultrafiltration (concept formation)

Dehydration (concept formation)

Target Weight (concept formation)

Hyperosmolarity (principle)

Choosing Dialysate (principle, judgement/decision, problem solving)

The “Body Weight Components” sub-section of the “Fluid Balance” module will present the objective for the learner to be able to correctly identify the components of body weight. A Laminated card or like visual aid (not shown) may be used for an illustration. The teacher will then present the body weight components (fluid, muscle, bone, organs, fat) and then preferably have the learner repeat the information several times. The teacher may ask the learner questions to help the learner form his/her own association. A mnemonic may be presented, e.g., Fluid Muscles Bone Organs Fat—“Fluid Makes Bodies Overweight Faster.” The teacher may then question and provide feedback until the learner has it memorized.

The “Body Weight Changes” lesson plan of this “Fluid Balance” module has the objective that the learner will be able to identify the difference between body weight changing slowly and fluid weight changing rapidly. Media which may be used can include a weight scale, solid food objects (crackers, cereal), fluid containers with water (½ L, 1 L, 1 Gallon). The teacher may then prepare the learner and explain that body weight is different from fluid weight and that body weight changes slowly over time compared to fluid weight which can change rapidly. Fluid increases body weight rapidly. Solid body mass changes weight slowly over time. Weigh yourself or a suitable victim on a standing scale. Note the weight. Using solid food examples, hold items one by one while on scale (note, May choose to use nonperishable food items like crackers, cereal, Twinkies). Then remove solid food items (may remove individually noting respective changes or cumulatively). Standing on scale add (1) sleeve of crackers and note weight change. Standing on scale add (1) carton crackers and note weight change. Standing on scale add (1) box of cereal and note weight change. Standing on scale add Twinkies and note weight change. Remove solid food objects (if not done individually) and note weight change. Standing on scale add (1) can soup and note weight change. Standing on scale add (1) ½ L water bottle and note weight change. Standing on scale add (1) 2 L soda bottle and note weight change. Standing on scale add (1) Gallon water bottle and note weight change. Remove liquid objects (if not done individually) and note weight change. Note to teacher: May also have learner stand on scale with empty gallon container. Gradually add fluid to container to represent fluid intake throughout the day. Repeat same activity using fluid examples (Can of soup, ½ L water, 1 L water, 2 L soda, gallon of fluid). The trainer will help the learner formulate definition of concept with asking learner to verbalize the difference between solid weight and fluid weight changes.

The “Fluid Intake” sub-section of the “Fluid Balance” module will preferably provide the learner with the ability to be able to identify sources of fluid intake. Preferred media may include pictures of examples and non-examples (FB1-FB6) (FIG. 6A-6C). The teacher may prepare the learner using phraseology such as the following:

“At the end of this lesson you will be able to identify sources of fluid intake. I will tell what fluid intake is and give you the critical features of fluid intake. Pay close attention to what I am saying. When I am finished, I will give you some examples and I want you to guess if they represent fluid intake or not. Don't worry if you make a mistake, I will help you as you go along. We will know you have learned this when you can correctly identify fluid intake without any help from me.”

The trainer may give a definition of fluid intake (characteristics such as drinking, eating, and/or intravenous infusions (IV's).), or delay giving definition of fluid intake to end of lesson. The trainer may then present examples and non-examples of items to illustrate concepts and give the patient/learner feedback about accuracy of his/her guesses. The trainer should start with example/non-example pairs, then as learner is guessing correctly, present single examples and non-examples. Final examples and non-examples should be very close so learner must make fine discriminations. Suggested examples and non-examples may include:

Picture of a glass of water/cracker (FB 1; FIG. 6A).

Picture of soup/hamburger(FB 2, FIG. 6A).

Picture of jello/cookies (FB 3; FIG. 6A).

Picture of ice cream/banana (FB 4; FIG. 6B).

Picture of watermelon (FB 5; FIG. 6B).

Picture of a patient getting IV fluids (FB 6; FIG. 6C).

The trainer should then have the learner formulate a definition of the concept to ensure learning.

The Systolic and Diastolic Blood Pressure sub-section of the Fluid Balance module has the objective of having the learner learn to be able to define the critical characteristics of systolic and diastolic blood pressure readings. A proposed media illustration may include a balloon half-filled with water.

The trainer should then define systolic and diastolic using the critical characteristics: systolic blood pressure is when the most pressure is exerted on your blood vessels; diastolic blood pressure is when the heart is at rest, and diastolic blood pressure is the minimum amount of pressure placed on your blood vessels. The trainer may present examples and non-examples of items to illustrate the concept and then ask the learner to feel the half-filled water balloon when it is squeezed and at rest, asking the learner to touch the balloon and guess whether it represents the systolic or diastolic reading (squeezed systolic; rest diastolic). The trainer gives the learner feedback about the accuracy of guesses; and finally has the learner formulate definition of the concept.

The Edema sub-section of the Fluid Balance module will give the learner the ability to identify edema and demonstrate the grades of edema using silly putty. Preferred media may include photos of examples and non-examples (FB 7-12; FIGS. 6C-6F), and/or three dimensional models of or actual clay or silly putty. These may be used with verbal scenarios as described below. Preferably, the learner will be able to identify edema and demonstrate the grades of edema using silly putty. The educator may start by giving the definition of edema (fluid accumulation under the skin resulting in swelling; an impression left after applying pressure on the skin over a bone; an impression which may remain for a period of time after pressure has been applied; skin which may be tight and shiny). As usual, the definition of edema may be delayed to the end of lesson. In any case, the educator will preferably also present examples and non-examples of edema (puffy eyes versus normal eyes (FB 7; FIG. 6C); indentations on foot and normal sized feet (FB 8-9; FIG. 6D); tight shoes with indentations on feet and normal feet with shoes laced tightly (FB 10; FIG. 6E); impressions of socks on swollen ankles and normal sized ankles (FB 11; FIG. 6E); indentations on shins/Normal shins (FB 11; FIG. 6E); a 4+ edema on ankle (FB 12; (FIG. 6F). The educator may then give a verbal description of swollen hands with tight rings, and then demonstrate grades of peripheral edema with clay or silly putty. The educator will show various grades of edema using silly putty, noting that grading of edema may be very subjective. Each clinic should establish parameters and the terminology used, i.e., trace, moderate, severe; or trace, 1+, 2+, etc. The educator may also show photos of edema and ask learner to guess grade of edema. Ask learner to demonstrate various grades of edema until they consistently demonstrate the correct grade. The learner should guess the grades of edema and the teacher will give feedback about accuracy of guesses. Showing pictures or silly putty should continue until the learner is guessing consistently correctly. Ultimately, the learner will formulate a definition of edema. If the definition has been presented at start of lesson, the learner should use his or her own words to formulate a definition.

The Fluid Overload sub-section of the Fluid Balance module should give the learner the ability to recognize fluid overload. Preferred media for assisting in the demonstration may include pictures of examples and non-examples (FB7-FB16; FIGS. 6C-6H), and UP15, UP17, and UP23; FIGS. 1D, 1E and 1F). The educator will preferably give the learner the characteristics of fluid overload (Edema; Increased blood pressure; Increased weight; and Shortness of breath), and then present examples and non-examples of items to illustrate fluid overload. These may include photos of edema on patients, such as depictions of peripheral, periorbital (FB 7-11; FIGS. 6C-6E); blood pressure (BP) display with normal and display with elevated BP (FB13-14; FIG. 6G); a photo of a patient with oxygen (UP 15; FIG. 1D); a photo of person sleeping elevated with 3-4 pillows and a photo of person sleeping flat (FB 15/UP 17; FIGS. 6H and 1E); a photo of a person sleeping erect in chair (FB 17; FIGS. 6H); a picture of a character who is short of breath (UP 23; FIG. IF). Verbal scenarios may also be presented. In addition, the educator should provide discussion with the patient/learner of higher than normal weight which might mean fluid overload. The educator may further examine the patient's CAPD/CCPD flow sheets with weights and blood pressures that may indicate fluid overload. The learner should be given feedback about accuracy of their guesses during the presentation process (if the learner doesn't identify the area of the flow sheet, you may have to indicate where to look for the information (BP and weight)); Ultimately, the learner will be able to formulate the definition of fluid overload.

The Fluid Output sub-section of the Fluid Balance module will provide the learner with ability to be able to identify fluid output. Preferred media may include pictures of examples and non-examples (FB 17-19; FIGS. 61-6K). The teacher will give a definition of output including critical features of fluid output (e.g., Urine output; Stool; Diarrhea; Vomiting; Sweating; and Ultrafiltration), and then present the above verbal examples and photographic examples of fluid output. The verbal cues to learner may include: “Having diarrhea or having a normal bowel movement”; “Vomiting or nausea”; “Perspiration or cool dry skin”; “Vomiting and diarrhea”; “Removing extra fluid with an exchange or retaining fluid.” Preferred photos to give the learner assistance may include: a 24-hour urine jug (FB 17; FIG. 61); a person doing a lot of exercise and perspiring (FB 18; FIG. 6J); and ultrafiltration (represented by FB 19 (FIG. 6K). The educator should give the learner feedback about accuracy of guesses. Success will be achieved when the teacher will have the learner formulate definition of fluid output.

The Dextrose Concentration sub-section of the Fluid Balance module will preferably leave the learner with the ability to be able to correctly identify the different dextrose concentrations and their relative strength. Picture illustrations of and/or models or actual solution bags with different dextrose concentrations may also be used. The educator will preferably present pictures of solution bags and point out different strengths and emphasize the color schemes of pull rings as a helpful memory aid or memorization strategy; i.e., 1.5% dialysate−weakest solution=Yellow pull ring; 2.5% dialysate−middle strength solution=Green pull ring; and 4.25% dialysate−strongest solution=Red pull ring. Then, the educator will preferably show the three solution bags writing side up and increasing in concentration, and then ask the learner to guess the dextrose concentration of each. The educator will then flip the solution bags over so the writing is against the table, and then again, ask the learner to guess the dextrose concentration. The learner will examine the examples of solution bags with different concentrations of dextrose and guess the strengths of solution according to dextrose percentage and pull ring color coordination. Then, the educator will rearrange the solution bags with writing side down and ask learner to guess the dextrose concentration Ask learner to choose different concentrations of solution bags from supply closet. Ask learner to identify by strength. i.e. weakest. Practice/Test by choosing solution bags from supply closet. Ultimately, the learner will be able to identify the weakest and strongest solutions.

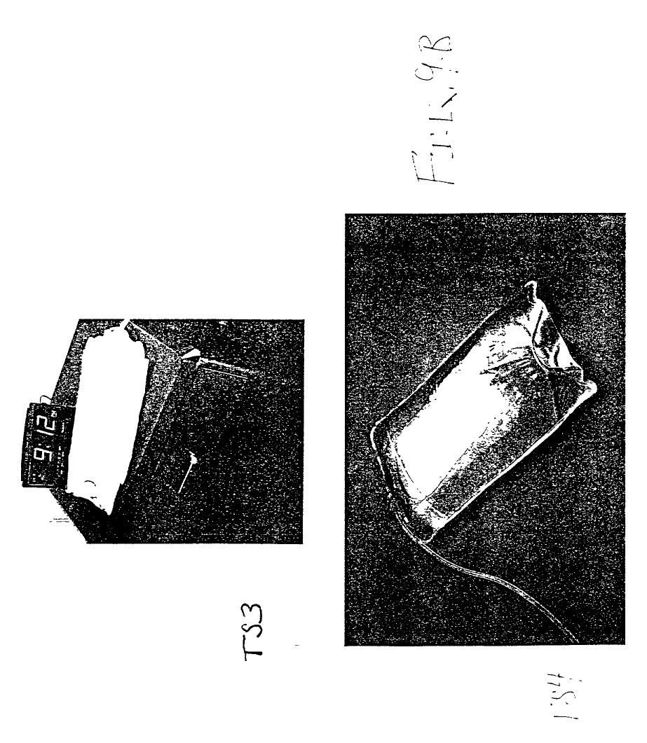

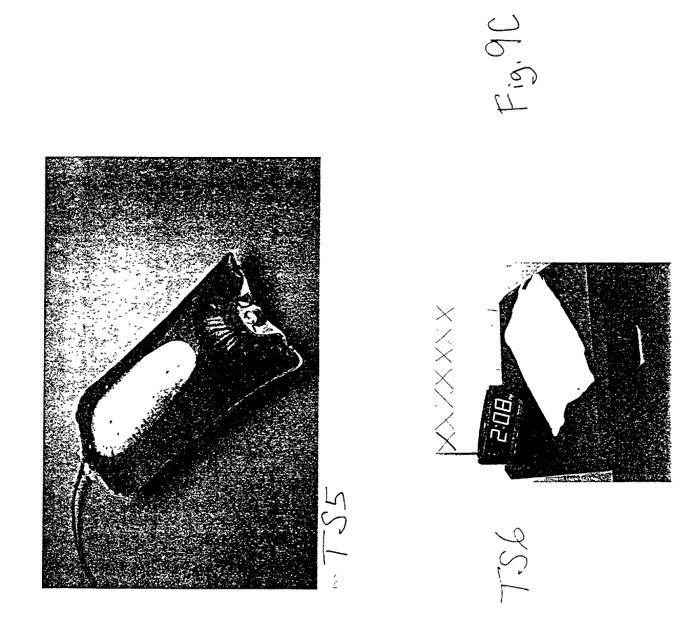

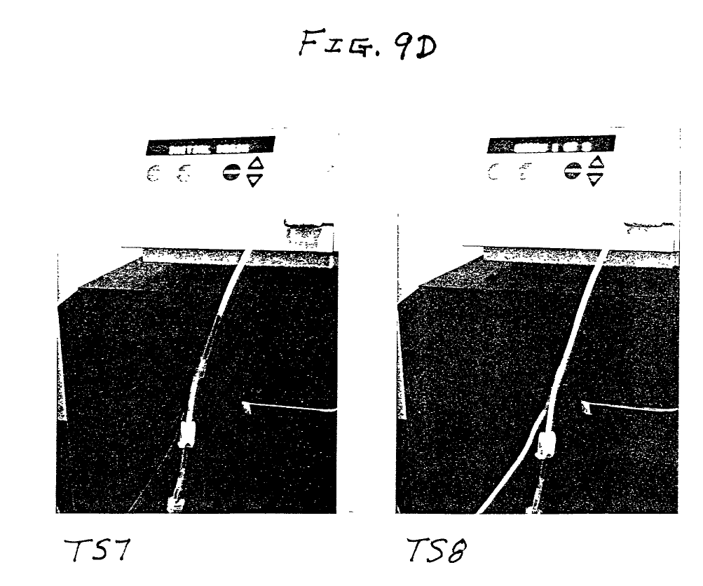

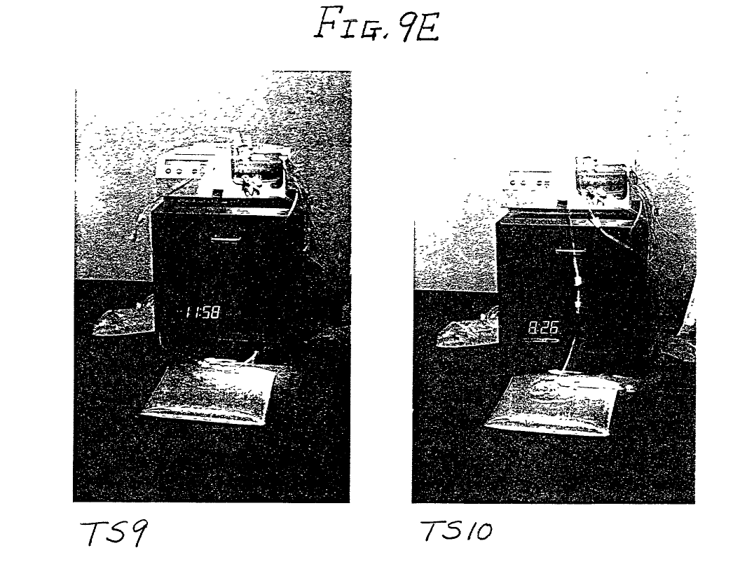

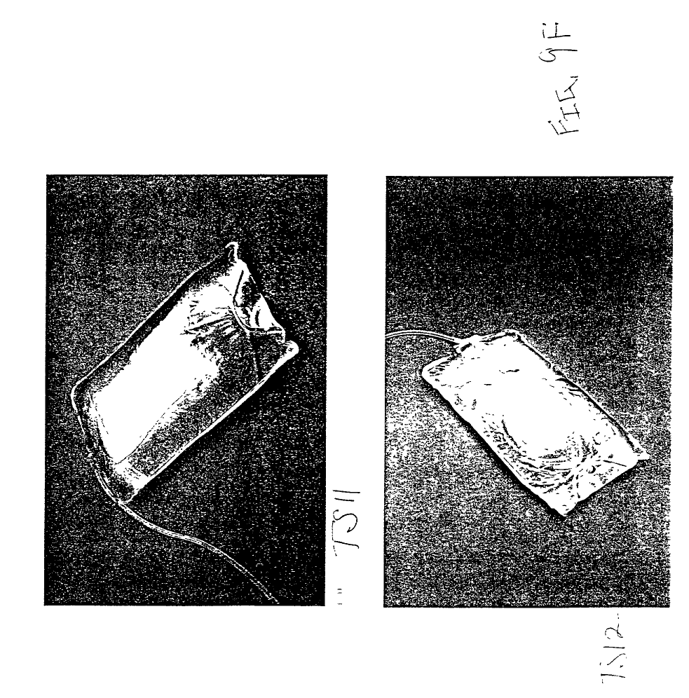

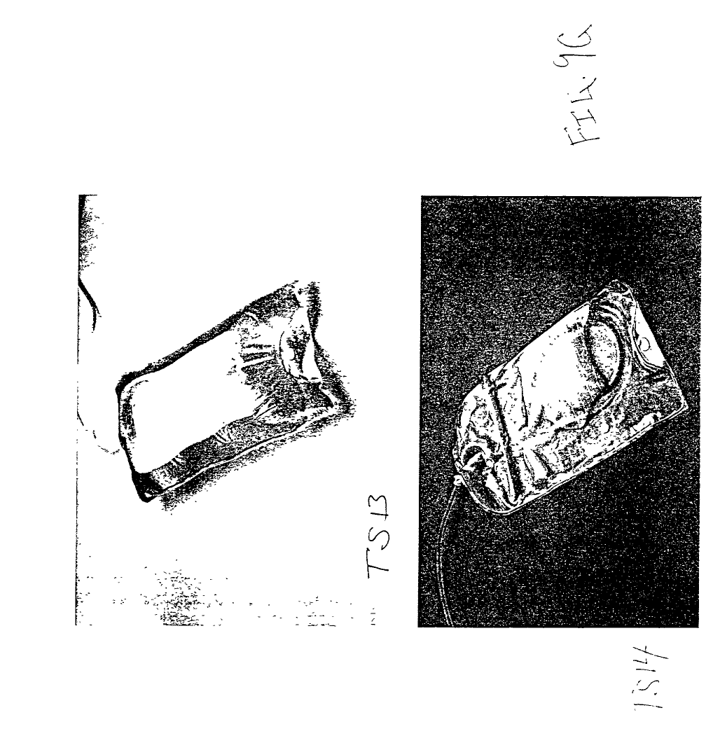

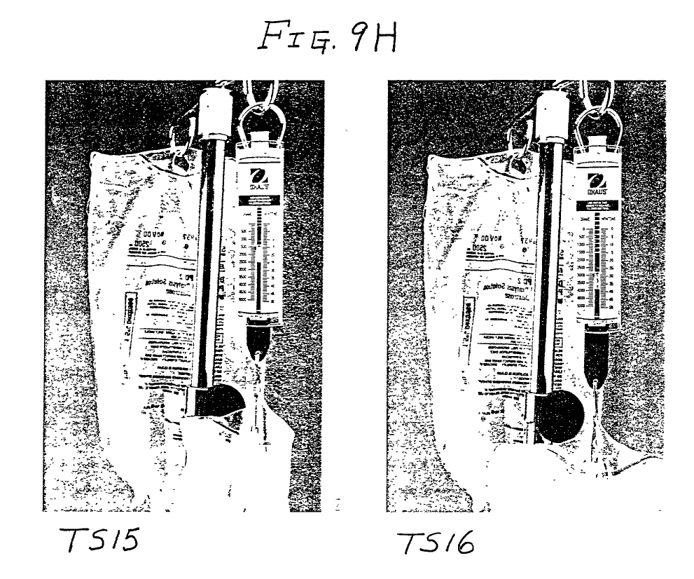

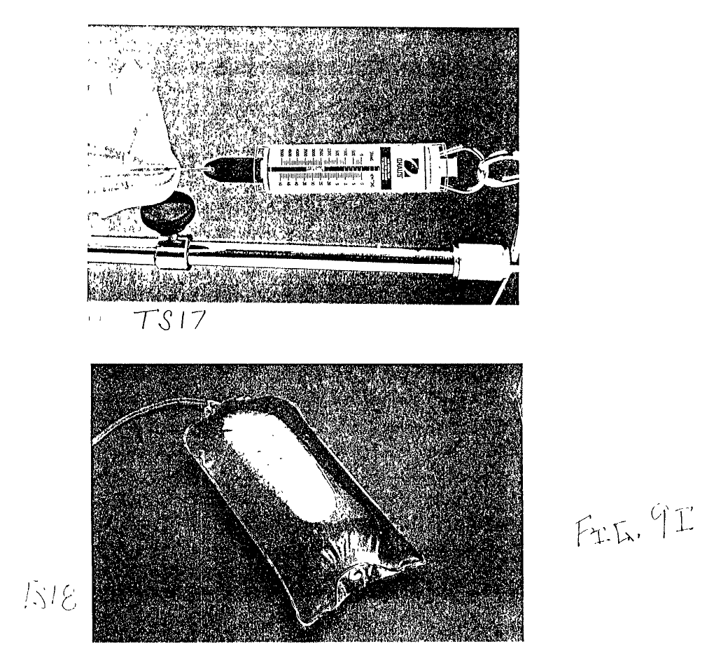

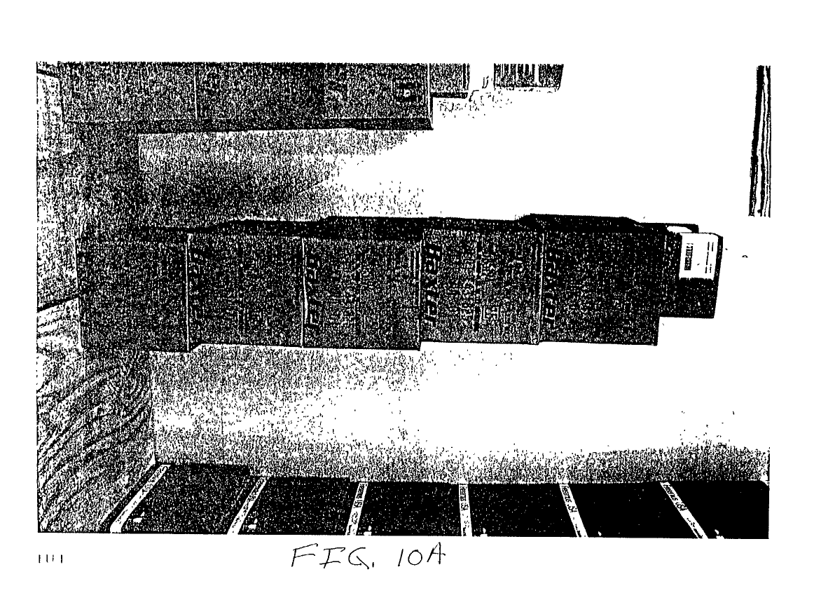

The Ultrafiltration sub-section of the Fluid Balance module is intended to provide the Learner with the ability to be able to identify the critical characteristics of ultrafiltration. Media may include examples and non-examples (FB 19, FIG. 6K; TS 15-16, FIG. 9H), Learner's CAPD/CCPD Flowsheets. The trainer should give a definition of ultrafiltration, i.e., the extra fluid in a drained volume and/or the higher the dextrose concentration the greater the ultrafiltration. The trainer may then present examples and non-examples of items to illustrate ultrafiltration, e.g., these may include pictures of bags with differing volumes on spring scales; and/or verbal scenarios such as: “You filled with 3000. Now your drain bag weighs this (FB 19, FIG. 6K)”; then ask “does this represent ultrafiltration? How much?”; “You filled with 2500. Now your drain bag weighs this (TS 16; FIG. 9H); Does this represent ultrafiltration? How much?” “You filled with 2000. Now your drain bag weighs this (TS 15, FIG. 9H) Does this represent ultrafiltration? Why not?” Show learner's fill and drain volumes from CAPD/CCPD Flowsheets. Calculate ultrafiltration. Usually start with examples/non-examples pairs, then as learner is guessing correctly, present single examples and non-examples. Final examples and non-examples should be very close so learner must make fine discriminations The teacher should give the learner feedback about accuracy of guesses. Ultimately, the learner will formulate a definition of ultrafiltration.

The Dehydration sub-section of the Fluid balance module will preferably provide the learner with the ability to be able to recognize the critical characteristics of dehydration. Picture illustrations of examples and non-examples may be used (see UP17 (FIG. 1E), and FB13, 20-22, 24 (FIGS. 6G, 6J, 6K, 6L and 6N). The trainer will give a definition of dehydration (characteristics: dizziness; decrease in weight; decreased blood pressure; increased pulse; fatigue); and then present examples and non-examples to illustrate dehydration, e.g., a cartoon with dizzy character/cartoon with alert character (not dizzy)(FB 20, FIG. 6K). Picture with fatigued character/cartoon with character full of energy (UP 17, FIG. 1E; FB 22, FIG. 6L). Digital blood pressure monitor showing increased pulse and decreased blood pressure; blood pressure monitor showing normal blood pressure and pulse. Verbal description of person with sunken and dark eye sockets versus person with normal looking eye sockets. Balloon half filled with water, simulating hearts pumping contracted blood volume. Verbal description of weight for patient that might indicate dehydration. The trainer will give the learner feedback about accuracy of guesses. If the learner does not identify the area of the log sheet or transparency to examine, the trainer may have to indicate where to look for the information (BP, weight, pulse). Ultimately, the learner will formulate a definition of concept.

A concept learning lesson plan for a Target Weight sub-section of the Fluid Balance unit/module will preferably provide the learner with the ability to recognize the characteristics of target weight. Preferred media/illustrations may include Pictures of examples and non examples (UP17, FB7-15, FIGS. 6C-6H; FB22, FIG. 6K; FB24-26, FIGS. 6N-O). The learner will ultimately recognize the critical characteristics of target weight. The trainer will give a definition of target weight which definition may include the critical characteristics of: Absence of edema; Acceptable blood pressure; Absence of shortness of breath; Weight within acceptable range; Absence of dehydration; Balance between intake and output. The trainer may then present examples and non-examples of items to illustrate target weight, giving the learner feedback about accuracy of guesses. Suggested Example/Non-Example Pairs (including verbal descriptions, suggested pictures/video-clips, scenarios) may include: Edema pictures (FB 7-12); Puffy guy pictures (FB 25); Someone laying flat and someone lying on three pillows (UP 17/FB 15); a Glass of water, 250 ml; urinal same volume/Glass of water, 250 ml, urinal decreased volume (FB 24/25); Scale—thin person on one—thick on the other (FB 26); Blood pressure displays illustrating dehydration/fluid overload/euvolemia (FB 13,14,22). The learner should continue guessing as examples and non-examples are presented, until the learner is guessing correctly all of the time. Ultimately, the learner will formulate definition of target weight. If definition has been presented at start of lesson, have learner use own words to formulate definition.

A principle learning lesson plan for a Hyperosmolarity sub-section of the Fluid Balance unit/module may then be presented. The objective will be for the learner to be able to link the concepts which lead to hyperosmolar situations in the blood. Preferred media/illustrations may include Verbal scenarios as set forth below. The trainer will preferably first review concepts and state principles (e.g., If you eat too much salty food (or sugary food and do not control your blood sugar), the sodium (sugar) level in your body will rise; If your body sodium (sugar) goes up, your blood will become more concentrated; Concentrated blood attracts water; This means you and your peritoneal membrane are thirsty; You will want to drink more water; Your peritoneal membrane will want to drink more fluid; If your body retains too much fluid, you could go into fluid overload). The teacher presents scenarios and asks patient to guess if the scenarios would lead to hyperosmolar situations. Suggested Scenarios may include:

1. Eating saltine crackers with salty chili, salted french fries with ketchup, corn chips with dip, pickles and olives.

2. Eating ham and sausage for breakfast, a hot dog and chips for lunch, and fast food (list local restaurant) for dinner.

3. Eggs and toast for breakfast, grilled chicken sandwich with lettuce, tomato and mayo for lunch, and grilled salmon with baked potato and green beans for dinner.

4. McDonald's Bacon, egg and cheese for breakfast, soup and crackers for lunch, Freezer Queen TV Dinner with Salisbury Steak for dinner.

5. Unsweetened cereal, milk with toast and butter for breakfast, tuna salad for lunch, roast beef and grilled vegetables for dinner.

6. Breakfast crepe, turkey sandwich for lunch, low sodium spaghetti and meatballs with green salad for dinner.

7. Have learner select photos of foods that could lead to hyperosmolarity and fluid retention.

8. Have learner select photos of foods that would achieve healthy sodium balance.

9. Have learner choose foods on a menu.

The trainer should then give feedback re accuracy of learner's description. This process should continue as scenarios that are examples and non-examples are presented until the learner is guessing correctly most of the time. The learner should then restate the principles linking the concepts in their own words.

A principle learning lesson plan for a Choosing Dialysate sub-section of the Fluid Balance unit may then be presented. The objective will be for the learner to be able to identify the relationships between target weight, ultrafiltration and dialysate concentration. Illustrations may preferably include Verbal scenarios. Ultimately, the learner will state the principles:

1. If I am at target weight, I have a balance between intake and output.

2. If I am above target weight, I may need to lose fluid weight through ultrafiltration.

3. If I am below target weight, I may need to decrease fluid weight loss through ultrafiltration.

4. If I use 1.5%, I will ultrafilter very little fluid

5. If I use 2.5%, I will ultrafilter more fluid.

6. If I use 4.25% I will ultrafilter the most fluid.

The trainer will preferably review concepts and state principles, and then present scenarios and asks patient to guess. A List of Concepts Linked to Form Principles may include those set forth immediately above. Suggested Scenarios may include:

1. Always alternate 1.5% and 2.5% dialysate. At target weight.

2. Below target weight, usually uses all 2.5%. Out of everything but 4.25%.

3. Above target weight, usually uses all 2.5%. Uses 4.25% for next exchange.

4. Below target weight. Chooses 1.5%.

5. Uses all 2.5%. Below target weight. Next exchange, chooses 1.5%.

6. Above target weight. 1.5% is the closest box. Chooses it.

7. Mock CAPD/CCPD flow sheets with weight up, illustrating change in usual pattern of 1.5% and 2.5% alternating.

8. Examine learner's CAPD/CCPD flow sheet, illustrate choice of dialysate dextrose.

The trainer will then give feedback re accuracy of description, and the learner continues guessing as scenarios that are examples and non-examples are presented until learner is guessing correctly most of the time. Ultimately, the learner restates the principles linking the concepts in their own words.

A judgment/decision lesson plan for the Choosing Dialysate sub-section of the Fluid Balance unit/module may be presented with the objective of having the learner be able to identify the need to increase or decrease dextrose concentration of dialysate and state the correct dextrose concentration to use. As usual, the trainer should review associated concepts, and state the principles (from the above lesson plan). Then, the trainer may present what the learner should be looking for and possible action steps that should be taken (note, the purpose of this lesson is to get the learner to memorize where/when judgments should be made and the correct actions that should be taken).

What the Learner should be looking for (Judgments)?; and What choice(s)/possible action steps should be taken (Decisions)? (Note, some judgments will have several action steps.)

1. Weight at target: Judgment/Decision (J/D)—Check blood pressure, check for edema; if blood pressure in range and no edema, continue current prescription; if blood pressure less than 90 systolic, and no edema, choose 1.5%; if edema present and blood pressure high, choose 4.25%; if no edema, blood pressure high, call clinic for advice.

2. Weight above target (J/D)—Check blood pressure, check for edema; if blood pressure in range and no edema, choose 2.5%; if edema present and blood pressure high, choose 4.25%;.if blood pressure less than 90 systolic and no edema, call clinic for advice.

3. Weight below target (J/D)—Check blood pressure, check for edema;.if blood pressure within range or low and no edema, use 1.5%; if blood pressure high or edema present, call clinic for advice. You may need a new target weight.

4. Short of breath (J/D)—Check weight check blood pressure, check for edema; if blood pressure in range and no edema, choose 2.5%; if edema present and blood pressure high, choose 4.25%; if blood pressure less than 90 systolic and no edema, call clinic for advice.

5. Edema in ankles (J/D)—Check weight check blood pressure; if blood pressure and weight in range, choose 2.5%; weight above target and blood pressure high, choose 4.25%; if blood pressure less than 90 systolic and no call clinic for advice.

The trainer should ask the learner to repeat the action steps, and provide feedback until the learner has memorized the principles and appropriate judgments/decisions.

A problem-solving lesson plan for the Choosing Dialysate sub-section may provide the learner the ability to correctly choose dialysate dextrose concentration. The trainer will preferably review associated concepts and state the principles (see above). The trainer/teacher will present scenario(s) and ask learner to identify the and solve the problem. After each scenario, the teacher asks the learner to state the possible problem and describe the appropriate actions to take. The trainer/teacher may need to prompt learner to solve the problem i.e. “What is happening here?”, “What do you know about this?”, and “What do you think you should do?”. If the learner is having difficulty identifying the problem, then go back and review associated concepts. Problem solutions should include unit specific standing orders. The patient/learner will then solve the problems and take correct actions. Problem Scenarios with the associated Problem

Solutions May Be As Follows:

1. Learner is at target weight, blood pressure within range, no edema. Solution: Learner will continue usual PD prescription.

2. Learner is above target weight, 2+ edema, elevated blood pressure. Solution: Learner will increase dextrose concentration.

3. Learner below target weight, blood pressure is low, no edema. Solution: Learner will decrease dextrose concentration.

4. Learner is below target weight, blood pressure is elevated. Solution: Learner calls clinic for advice.

5. Learner attended function with salty food and increased their fluid intake. Solution: Learner checks weight and blood pressure, and checks for edema, And, the Learner chooses correct dialysate for blood pressure and weight.

6. Learner examines own CAPD/CCPD flowsheet. Solution: Learner states correct dextrose concentration for next exchange.

7. Learner examines mock CAPD/CCPD flowsheets representing a need for higher/lower dextrose dialysate. Solution: Learner states correct dextrose concentration for each example.

The trainer should continue presenting scenarios until learner is developing correct solutions and taking correct actions.

A video learning lesson plan for the Fluid Balance unit/module may also be presented. The objective will be to provide the learner with the ability to meet the objectives of all Lesson Plans in the Fluid Balance Unit. The kinds of learning involved may include: Memory, Concept Formation, Judgment/Decision, Principle, Problem Solving. The learner may be prepared as follows. (At the beginning of the video, the announcer gets the learner ready to learn. This might be prefaced with the following.) “At the end of these lessons, you will be able to manage your fluid balance. We will watch the video together, and we may stop from time to time for some short exercises. Pay attention to the video, and do the best you can during the exercises. When you can successfully complete the exercises without help from me, we will know you have learned it.” (NOTE to the trainer: By now, if there may be anticipated difficulty in grasping the content, the Lesson Plans and Media (above and/or below may be used along with the video.) The learner is intended to Pay Attention. The trainer should watch with the learner but may also prepare for possible activities, gauging patient learning level to anticipate possible need for lesson plans.

A sample Video Script follows:

Announcer: At the end of this video you will know how to work with your healthcare team to maintain your fluid balance. We will discuss what fluid balance is, see how it can change, and what measures you can take to ensure that it stays in balance. Pay attention as we go along. Your nurse or teacher may stop the video several times for some short exercises. Don't worry if you make a mistake while doing these. Your nurse will help you as you go along. We will know you have learned how to maintain your fluid balance when you guess correctly at each exercise without any help from your nurse.

Fred: Two seventy-two. I've gained seven pounds since yesterday!

Fred: And my blood pressure is up too! I wonder what happened? Maybe I should check for swelling.

Announcer: Why did Fred's weight go up? To answer that, we need to look at what makes up our weight.

Announcer: Our total weight, the number you get when you step on the scale is divided basically into two components: Solids and Fluids. Solids include: bones, muscles, fat, and organs, such as your heart and brain. Body weight is the weight of the solid parts.

Announcer: About Sixty per cent of your Total weight is fluid. This is your fluid weight. Fluid weight can change rapidly and vary from day to day. Fluid weight changes rapidly.

Announcer: When your kidneys are functioning properly, they help to balance the amount fluid in the body by eliminating any excess fluid.

Announcer starts when patient is back on scale: Unlike fluid weight body weight changes slowly. If you eat more food than your body needs, you will gain weight over time. Similarly, if you eat less than your body needs you could lose weight. For example, if you eat a pound of chocolate every day, you could weigh 10 lbs more by the end of the month. (Note, May want to explain the weight on a scale could be in kilograms versus pounds, and a person on scale, may weight 200, calendar May, same person on scale weight 210, calendar June.)

The trainer may then ask the learner: why has this person's weight changed?; and then discuss the weight change with the learner.

Resuming the Script

Lady: “You have lost weight”

Little lady: “Yes, I have been on a diet. I have lost 5 lbs in the last month.”

The trainer may want to discuss the present question of weight change, and ask learner: Has she lost body weight or fluid weight? If the Learner does not grasp at this point, may repeat video or use the Memory Lesson Plan for Body Weight Compartments and Concept Lesson Plan for Body Weight Changes.

Resuming the Script

Announcer: Let's go back and see how Fred is doing: Why has Fred's weight changed?

Fred: How did I gain seven pounds in one day?

The learner should pay particular attention; watching “Fred's” intake, and the trainer may point out instances of Fred drinking.

Fred: I guess I drank those seven pounds yesterday!”

Announcer: Fluid intake can occur in several ways: Eating and drinking liquids are the most common way. Examples of fluid intake: Eating foods that are mostly liquid like ice cream, soup and jello or eating foods that have a high water content like watermelon or noodles, or ice chips. Intravenous fluid that a patient in a hospital may receive is also an example of fluid intake.

The learner may be asked to guess at examples/non examples of fluid intake, and if the learner does not master this concept, go to Concept Learning Lesson Plan for Fluid Intake.

Resuming Script

Announcer: Which one of these is an example of fluid intake? Glass of water/cracker Soup/hamburger Jello/cookie Ice cream/banana Someone drinking coffee Someone drinking water and taking pills.

Announcer: Fred also realizes that his blood pressure is up: Why is that?

Announcer: The top number, or systolic blood pressure is the pressure in your blood vessels when your heart is pumping. The bottom number, or diastolic blood pressure is the pressure in your blood vessels when your heart is at rest.

Announcer: When your fluid weight is up, there is more fluid in your blood vessels for your heart to pump around. This raises your blood pressure. When your fluid weight is down, there is less fluid in your blood vessels for your heart to pump around. This lowers your blood pressure.

The learner may be asked to state current blood pressure, and/or state higher or lower than normal; e.g., blood pressure that might indicate fluid overload; and lower than normal blood pressure that might indicate dehydration. The trainer may desire a prompt discussion of blood pressure, normal/higher/lower; giving feedback to learner. If learner does not grasp concept at this point, use Concept Learning Lesson Plan for Blood Pressure. (e.g., “What is your blood pressure? What would be a higher or lower blood pressure for you that might mean too much or too little fluid?”)

Resuming Script

Fred: Are my eyes swollen? No. My hands are okay. What about my ankles?

Fred: uh, oh—I have EDEMA.

Announcer: Edema is swelling caused by fluid retention in the body. The presence or absence of edema is an indication of fluid balance. Edema tends to pool in the lowest part of the body. Whether you are lying down or standing up, fluid will to shift to the lowest area, and edema will show up in those areas first. If you have too much fluid in your body, you may notice edema in your face, especially around your eyes, your hands, or your feet or ankles.

The learner may examine pictures of edema; guess which ones indicate fluid overload. The trainer will then give feedback.

The Script Resumes

Announcer: Let's look at some pictures of edema. Try to guess which one is an example of fluid overload.

The learner should pay attention, and examine clay to appreciate gradations of edema. The learner may also examine self for edema. The trainer may pause to use clay to show grades of peripheral edema; 1+ and 4+; and guide the learner through self-exam for edema. If learner does not master concept at this point, go to Concept Learning Lesson Plan for Edema.

Announcer: We refer to different grades of edema, from one to four, to describe how severe it might be. The higher the number the worse the swelling. Watch as your nurse demonstrates.

Fred: My weight is up, my blood pressure is up, and I have edema in my ankles. I have retained too much fluid. I have Fluid Overload.

Announcer: Fred is fluid overloaded. . . Fred has recognized a situation that occurs commonly in people on dialysis. He has taken in too much fluid and has developed fluid overload. He recognized this by noting his increased weight, increased blood pressure and ankle edema. He thought over his activities and realized his fluid intake the day before was more than usual.

Announcer: Worsening edema can lead to fluid accumulation in your lungs as well as under your skin. Fluid fills the air sacks and prevents needed oxygen from getting to your body.

Announcer: Signs that this is happening include: Shortness of breath, especially with activity; Having to add an extra pillow at night; Having to sleep in a chair to catch your breath; Coughing.

The learner may be asked to examine flowsheets, blood pressures and weights; and guess which ones indicate fluid overload. The trainer may point out critical characteristics of fluid status (weight, blood pressures) as necessary, and listen as learner guesses, and give feedback. If learner does not master concept, go to Concept Learning Lesson Plan for Fluid Overload. Similarly, the learner may be asked to state urine production in ml. The trainer then prompts discussion of urine volume. May wish to also inquire about noticeable decrease in production. If learner does not master concept, go to Concept Learning Lesson Plan for Fluid Output.

Announcer: Now that Fred has identified Fluid Overload, what will he do to treat it? He needs to get rid of the excess fluid, but how? We rid our body of fluid in many different ways—Mainly through urine, but also through stool, perspiration, and when not feeling well, vomiting and diarrhea. When the kidneys are not functioning properly, our ability to rid our body of excess fluid by urination is limited. Some people's kidneys continue to produce urine, while other people's urine output decreases or stops rapidly. How much urine are you producing?

Announcer: When kidneys are no longer able to regulate excess fluid, we rely on dialysis to control the amount of fluid in the body using the peritoneum. The peritoneum is semipermeable membrane. This means has small openings. Particles small enough to fit through the openings can pass through the membrane. The openings do not have to be visible to the naked eye.

Announcer: As we said, your peritoneum is a semipermeable membrane. Water moves across the openings of semi permeable membrane through a force called osmosis. Lets look at some examples of osmosis.

Announcer: Watch as Fred prepares these strawberries by sprinkling them with sugar. The sugar pulls the liquid in the strawberries through the strawberries' semipermeable membrane. As the fluid comes out of the strawberries into the sugar, the strawberries lose water and shrink. More sugar removes more fluid. Here are examples of osmosis using 1,2 and 4 tsp.

The learner should examine examples and non-examples, guess, while the trainer gives feedback.

Announcer: Which one of these pictures illustrates osmosis?

Announcer: Peritoneal dialysis removes fluid by using sugar in the dialysate to pull fluid across the peritoneal membrane into the peritoneal cavity. This extra fluid is removed each time you drain your exchange. The sugar in dialysate is called dextrose.

Announcer: Different strengths of this sugar (or dextrose) pull different amounts of water. Dialysate comes in three strengths 1.5%, 2.5%, and 4.25%. Just as we saw that 1 tsp of sugar pulled the least amount of fluid, 2 tsp pulled more, 4 tsp pulled the most, 1.5% will pull the least fluid from your body, 2.5% more and 4.25% the most. 1.5% is color coded yellow, 2.5% is color coded green and 4.25% is color coded red.

The learner may be asked to examine bags and guess. The trainer gives feedback. If learner does not master concept, go to Memory Lesson on Dextrose Concentration and/or Concept Lesson on Choosing Dialysate.

Announcer: Choose the bag with the highest dextrose. Which one of these will pull the most fluid? Which one of these will pull the least fluid?

Announcer: When Fred's friend Ed performs CAPD, he puts in 3000 ml. At the end of his exchange, he drains out 3500 ml. The extra 500 ml he drained is called Ultrafiltration. Ultrafiltration represents the amount of fluid removed from Ed's body.

The learner may be asked to examine equations, and guess ultrafiltration. The trainer should prompt learner to guess; and give feedback; and may provide real fluid examples for patient, ask patient to weigh their own bags, and tell the ultrafiltrate. If learner does not master concept, go to Concept Learning Lesson Plan on Ultrafiltration.

Announcer:—how much ultrafiltration does this represent? 3500−3000=500 UF3200−3000=200 UF3100−3000=100 UF

Announcer: With APD, The Home Choice Cycler calculates the ultrafiltration. Fred uses the Home Choice cycler while he sleeps.

Fred: I need to lose this excess fluid. I am over my target weight by seven pounds.

Fred: Why didn't I lose this weight last night when I dialyzed?

Fred: “Honey, I'm really beat. Would you set up my cycler for me? I just want to get to bed.”

Mrs. Fred: Sure honey! What is your weight and blood pressure?

Fred: I'm too tired to check!

Mrs. Fred: Will a couple of 1.5's do it?

Fred: Sure, I just want to get to sleep.

Announcer: Fred's dialysis prescription is geared to maintain his weight at target level. The Characteristics of Target Weight are: Acceptable blood pressure (blood pressure); Absence of edema; Absence of shortness of breath; Weight within acceptable range; Absence of dehydration; In other words, a BALANCE between intake and output.

The trainer may ask the learner to state target weight, and then prompt discussion of target weight; giving learner feedback. If learner does not master concept, go to Concept Learning Lesson Plan on and Target Weight.

Announcer: Fred's target weight is 265. We saw when he drinks too much and doesn't remove the fluid, he can get fluid overloaded. If he loses too much fluid from vomiting or diarrhea, or too much ultrafiltration, he would be dehydrated. Fred's target weight represents a balance of fluid in his body. What is your target weight?

Fred: Well I didn't record my ultrafiltration off the cycler! Let's see . . . presses down buttons, Total UF −250. I had a negative Ultrafiltration. I did not lose any fluid weight at all! As a matter of fact, I GAINED 250 cc. That is a cup of fluid (hold belly)−a half pound!

Announcer: One point five dialysate did not help Fred lose any of the extra fluid he took in the day before. As a matter of fact, Fred gained a cup of fluid, or half a pound. One reason Fred may have retained fluid is from the extra salt in his food.

If learner does not grasp, go to Principle Learning Lesson Plan for Hyperosmolarity.

Announcer: Remember salt intake can lead to fluid retention. If you eat too much salty food, the sodium level in your blood will rise. When your blood sodium level goes up, it makes your blood more concentrated. Concentrated blood attracts water to regain balance. This means you and your peritoneal membrane are thirsty. You will want to drink more fluid; and your peritoneum will want to drink more fluid, making it harder to loose the fluid weight. If your body retains too much fluid, you could end up with fluid overload.

Trainer may want learner to suggest dextrose dialysis solutions for Fred to use followed with prompt discussion, and feedback.

Announcer: Fred needs to choose a dialysate dextrose concentration that will help him lose the extra fluid weight. He uses two bags. Last night, 1.5% did not ultrafiltrate any fluid weight. Do you have any suggestions for Fred?

Trainer may want learner to suggest dextrose dialysis solutions with a prompt discussion and feedback.

Announcer: Suppose Fred had gained more than 10 lbs. Do you have any suggestions for changes in his dextrose concentration?

Announcer: For patients on CAPD a similar change in dextrose concentration would be needed. The more fluid overloaded you are the higher the dextrose concentration you will need in order to get back to your target weight.

Trainer may want learner to suggest dextrose dialysis solutions, with prompt discussion, and feedback.

Announcer: Let's look at Fred's friend Ed. He is a CAPD patient. He normally uses 2-1.5% and 2-2.5% bags. Ed gained 6 pounds and noticed his blood pressure was elevated, his eyes were swollen, his rings are tight, and ankles are swollen. Do you have any suggestions for Ed?

Announcer: Let's review the concept of fluid overload. The critical characteristics of fluid overload include: edema, increased blood pressure, increased weight, and shortness of breath.

Announcer: Remember Ed is trying to maintain a balance of fluid in his body. He wants to remove the right amount. We have talked about removing too little fluid. What happens if Ed removes too much? This can lead to dehydration.

Announcer: Remember when we talked about fluid output? Losing too much fluid in any of these ways can lead to dehydration. Vomiting/diarrhea; too much ultrafiltration; excessive perspiration.

Announcer: The critical characteristics of dehydration are: Dizziness; Decreased weight; Decreased blood pressure; Increased pulse; and Fatigue.

Announcer: When Fred was ill with the flu, he became dehydrated. He used all 1.5% to decrease the amount of fluid he removed; and drank salty fluids like broth to increase the fluid in his body.

Discuss ways fluid may be lost from the body. Name signs of dehydration. State what you would do for dehydration. Prompt discussion: “What are some ways you could lose too much fluid? What are some signs that you are dehydrated? What would you do to treat dehydration?” If learner does not master, go to Concept Learning Lesson Plan on Dehydration.

Announcer: In this video, you have learned how fluid overload happens when there is too much fluid in the body, how to know when you have fluid overload, and what to do if you are fluid overloaded. You have also learned how to know if you are dehydrated and what to do. Now you will be able to balance the fluid in your body and achieve your target weight.

Announcer: The healthcare team works with you to set a target weight. It will take some practice, but you can hit the target.

A next possible chapter/module could be a chapter on operating a specific peritoneal dialysis machine and associated tubing set and bag system. An example chapter of this sort may be a chapter on the Quantum PD System. Sub-sections therefor follow.

### Chapter Outline

### Quantum PD™ Night Exchange System

Suggested Teaching Order with Requisite Knowledge

| | | Type of | |
|---|---|---|---|
| No. | Lesson Plan | Learning | Requisite Knowledge |
| 1 | Quantum | MS | UltraBag ™ Unit |
| | Introduction | Cognitive | |
| 2 | Components | Memory | None |
| 3 | Placing the | Motor | UltraBag ™ Unit, Components of |
| | Quantum | Skill | Quantum PD ™ System |
| | PD ™ System | | |
| 4 | Gathering | Memory | UltraBag ™ Unit |
| | Supplies | | |
| 5 | Gathering | Principle | Gathering Supplies Memory |
| | Supplies | | |
| 6 | Gathering | Judgment | Gathering Supplies Principle |
| | Supplies | Decision | |
| 7 | Gathering | Problem | Gathering Supplies J/D |
| | Supplies | Solving | |
| 8 | Placing UB | Motor | UB Unit, Components, Placing |
| | into Quantum | Skill | Quantum, Gathering Supplies |
| | PD ™ System | | |
| 9 | Placing UB | Principle | UB Unit, Components, Placing UB |
| | Fill Bag | | |
| 10 | Placing UB | Judgment | Placing UB Fill Bag Principle |
| | Fill Bag | Decision | |
| 11 | Placing UB | Problem | Placing UB Fill Bag Problem |
| | Fill Bag | Solving | Solving |
| 12 | Placing UB | Principle | UB Unit, Components |
| | Drain Bag | | |
| 13 | Placing UB | Judgment | Placing UB Drain Bag Principle |
| | Drain Bag | Decision | |
| 14 | Placing UB | Problem | Placing UB Drain Bag J/D |
| | Drain Bag | Solving | |
| 15 | Connecting | Motor | UB Unit, Components, Gathering |
| | Disposable | Skill | supplies, Placing Quantum PD ™, |
| | Ext Set | | Placing UB into Quantum PD ™ |
| 16 | Connecting | Motor | UB Unit, Components, Gathering |
| | to Quantum | Skill | Supplies, Placing Quantum PD ™, |
| | PD ™ System | | Placing UB into Quantum ™ |
| | | | Connecting Disposable Ext Set |
| 17 | Ending | Motor | UB Unit, Components, Gathering |
| | Therapy/ | Skill | Supplies, Placing Quantum PD ™, |
| | Disconnecting | | Connecting Disposable Ext Set, |
| | | | Connecting to Quantum PD ™ |
| 18 | Quantum PD ™ | Concept | Quantum PD ™ System Setup |
| | System Alarms | | Procedure |
| 19 | Quantum PD ™ | Principle | Quantum PD ™ System Alarms |
| | System Alarms | | Concept |
| 20 | Quantum PD ™ | Judgment | Quantum PD ™ System Alarms |
| | System Alarms | Decision | Principle |
| 21 | Quantum PD ™ | Problem | Quantum PD ™ System Alarms |
| | System Alarms | Solving | J/D |
| 22 | Putting It | Motor | Entire Quantum PD ™ System |
| | All Together | Skill | Unit |

Exposition of these sub-sections will follow.

A Motor Skill Cognitive sub-section for the Quantum PD System will introduce this chapter. The objective is getting the learner to have a picture of what is involved in the Quantum PD System set-up and initiation of therapy. This Lesson Plan is designed to give the learner an overview of the Quantum PD System procedure. The Detailed and Condensed Motor Skill Analyses are included in the phases of the procedure. The Practice portion of this Lesson Plan comes at the end; after the patient has learned each phase of the procedure, and is ready to practice the entire procedure. The learner will have observed the entire Quantum PD System set-up and initiation of therapy from start to finish. There is no intention of testing the learner at this point. Preferred MEDIA may include: Mask, lap pad, clamp, CAPD flow sheet, pen, bleach solution, paper towel, sink, patient's transfer set, antibacterial soap in pump bottle, waste receptacle, Quantum PD System, UltraBag, Patient Extension Line, EZ-Aide (if used). The patient/learner may be prepared thus: “I am going to demonstrate how to use the Quantum PD System for a night exchange. I will demonstrate the procedure as you will normally to do it. All I want you to do at this time is to pay attention and watch what I am doing. You will learn each component of the process later.” Activities may include: Telling the learner to pay attention and watch closely. (If teacher wishes to demonstrate a now exchange, it will be taught separately without using an extension line. Tell learner it's OK if they don't remember everything now, you only want them to get a picture of the entire process, and you will break down components to learn later.) Next, have Demonstrated the procedure from start to finish as it would ordinarily be done, starting at the very beginning with cleaning the work surface and ending with recording the exchange. Conversation should be kept to a minimum. If questions arise, redirect the learner to just watch a this time, questions will be addressed at a later time as components of the process are taught.

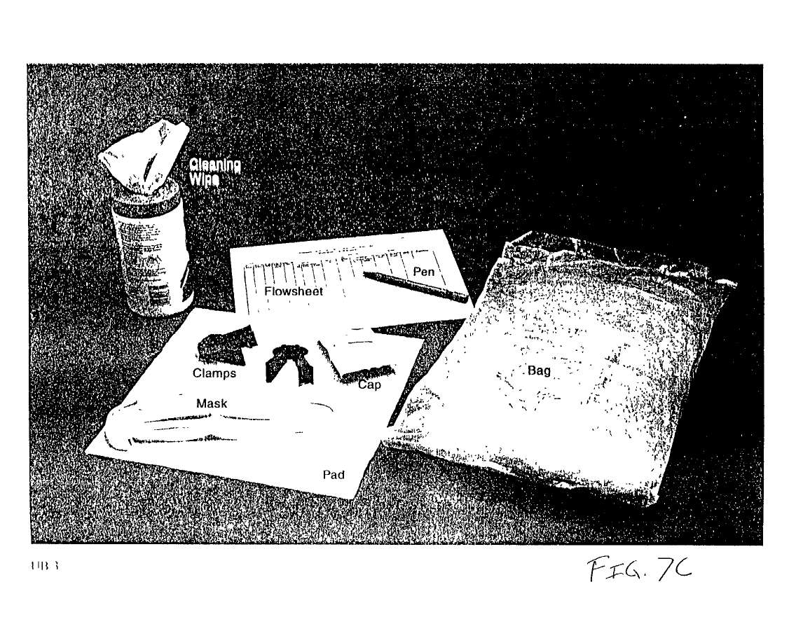

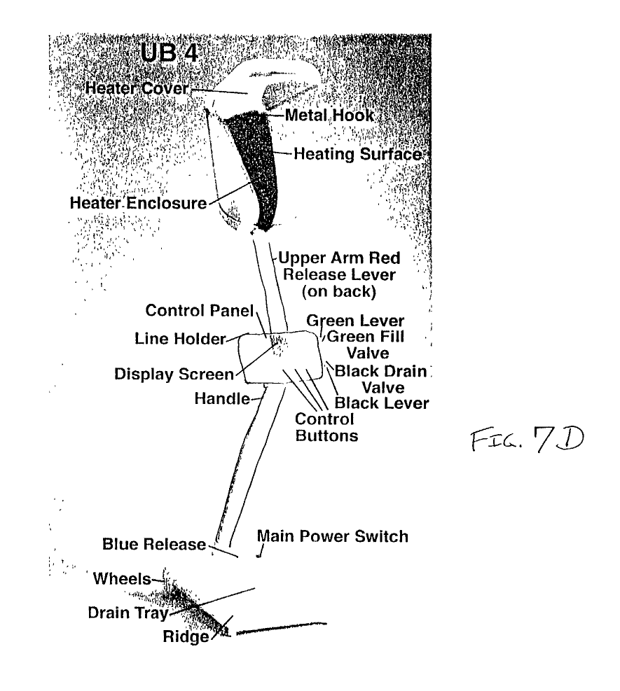

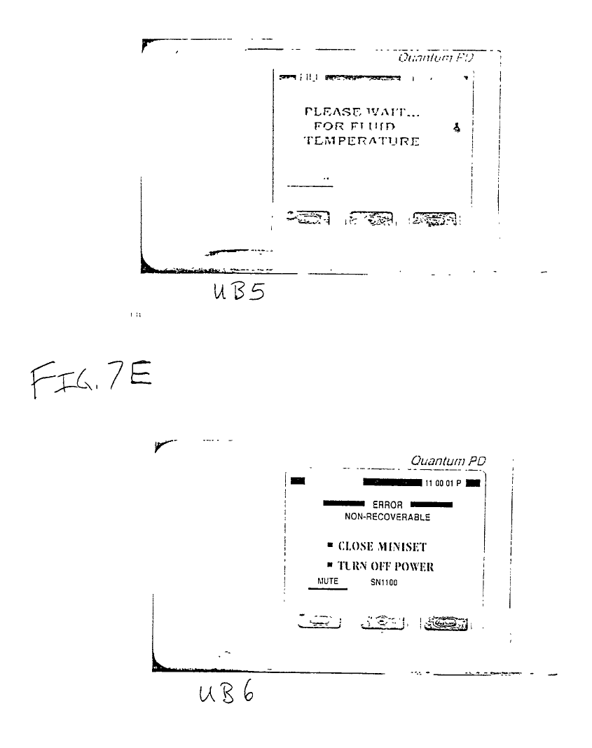

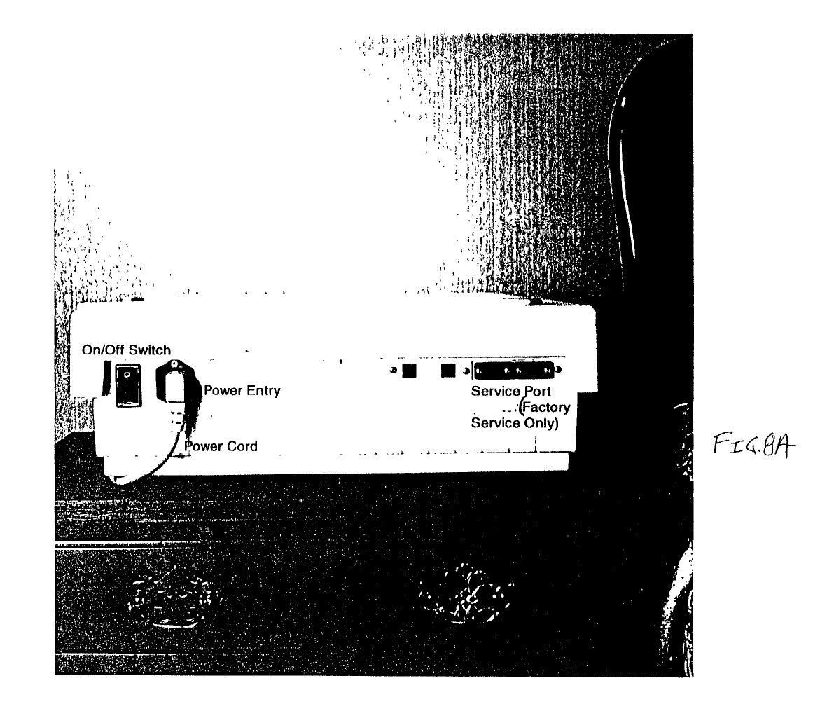

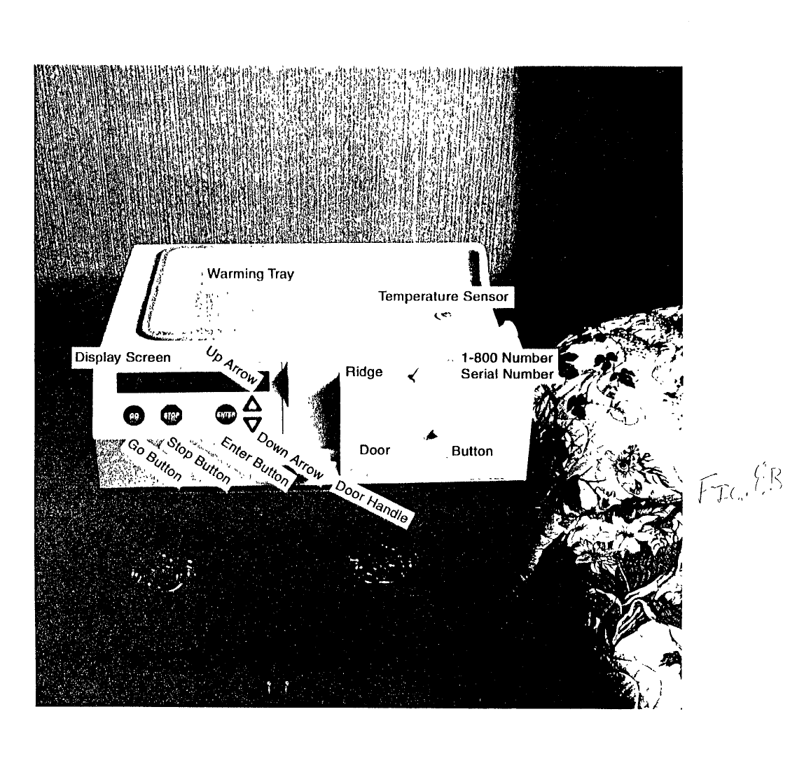

A MEMORY LEARNING LESSON PLAN for the Components of the Quantum PD System and Disposable Extension Set may next be presented for the Learner to be able to name from memory the components of the Quantum PD System and disposable extension set. Preferred MEDIA may include: Picture of the Quantum PD System with the components labeled (UB1-3; FIGS. 7A-7C). Quantum PD System, and disposable extension set. Preparation of the learner may include verbal cues such as: “At the end of this lesson you will know the components of the Quantum PD System and the disposable extension set. I will show you a picture of the Quantum PD System with all the parts labeled and a disposable extension set. I will review the names with you . I want you to repeat them after me. When you think you know them I will ask you to name them. Don't worry if you make a mistake I will help you as you go along. We will know you have learned this when you can repeat all of the components without any help from me.” Activities may include: Showing the picture of the labeled Quantum PD System and Reading the labels and pointing out the component parts. Also, Showing the disposable extension set, pointing out the clamp, each end, and the pull tabs. The learner should Form own associations, Look at the picture of the labeled Quantum PD System and the disposable extension set, and Practice/Test by Naming the components using an unlabeled Quantum PD System and disposable extension set. Test by asking the learner to identify the components on an unlabeled Quantum PD System and disposable extension set.

A sample List of Information to be Memorized may include:

Heater Cover; Heater Enclosure; Heating Surface; Metal Hook; Heating element.

Upper Arm; Release Lever (Allows the system to fold).

Control Panel; Green Fill Valve; Green Lever; Black Drain Valve; Black Lever; Display

Screen; Control Buttons; Line holder (Tells you what to do and gives you information).

Handle (Assists in setting up and folding the Quantum PD System).

Lower Arm.

Main Power Switch; Power Socket (Turns the Quantum PD System on/off).

Blue Release (Allows the lower arm to unfold).

Wheels (Assist in moving the Quantum PD System indoors).

Drain Tray; Ridge (Weigh scale for the drain bag).

Disposable Extension Set; Clear pull tab; Blue pull tab; Clamp (Connects to UltraBag and transfer set).

A MOTOR SKILL—COGNITIVE-LESSON for Placing the Quantum PD System will provide the learner to be able to repeat the critical steps for correctly placing the Quantum PD System. MEDIA: Quantum PD System (UB1-4; FIGS. 7A-7D). Ultimately, The learner will repeat the steps for correctly placing the Quantum PD System. The learner may be prepared thus: “At the end of this lesson you will know the steps for correctly placing the Quantum PD System. I will show you how to correctly place the Quantum PD System. You will pay close attention to what I am doing and explaining. After you watch me several times, I will ask you to repeat the steps back to me. When you can repeat the critical steps for correctly placing the Quantum PD System, I will know that you are ready to practice the procedure yourself.” Activities may include: Demonstration of the procedure as it would be normally performed. The learner should Pay attention and watch closely and “Memorize” pictures of steps. Then, during Repeated demonstrations explaining each step in detail, the learner should Determine the critical steps/nuances. Demonstrator should Talk through what his/her hands are doing, and Use detailed list such as:

Steps to Take (with Tricks of the Trade in Parentheses)

1. Stand next to and facing the Quantum PD System, about equidistant from the display and drain tray. (Start with the Quantum PD System in the folded position in the exchange setting.)

2. Bend down close to the Quantum PD System and using your fingers, feel the red release lever on the upper arm. Make sure it is perpendicular to upper arm. (The downward position is the locked position.)

3. Using right fingers, apply continuous pressure to the lower portion of the blue release. (May use foot to press blue release if desired.)

4. Using left hand, insert fingers downward through the handle.

5. Wrap fingers around the handle so the handle is stabilized against your palm.

6. Pull up on the handle until the display screen is level with the patient's abdomen during therapy.

7. Remove pressure from the blue release.

8. Place right palm to the underside of the upper arm and wrap fingers around the upper arm.

9. Pull upward on the upper arm until it is fully extended.

10. Remove hands from handle. (Ensure Quantum PD System is placed for proper visualization of display screen during therapy.)

A Third demonstration point out the critical steps, using the labels from the condensed list as follows:

Brief Description of Logically Grouped Steps with Associated Label

1. Position Quantum PD System, check red release lever, lock if necessary. Label—Position Quantum PD System.

2. Press blue release, raise lower arm to desired position. Label—Raise lower arm.

3. Raise upper arm. Lock if necessary. Label—Raise upper arm.

The learner should then repeat from memory the critical steps of the procedure; the trainer repeating the information until the learner is able to repeat the steps and the key words without error.

A motor skill practice lesson plan for the placing the Quantum PD system may next be taught with the objective of having the learner correctly place the Quantum PD system. The learner could be prepared thus: “Now it is your turn to practice placing the Quantum PD System. Practice until you feel you can do it without thinking. I will give you feedback about how you are doing. It doesn't matter if you make some mistakes. I will help correct them as you go along. You can practice as long as you need to. When you think you know how to do the procedure, I will ask you to do it on your own without any help from me.” Activities could include: Hands on practice by the learner who may continue to practice, reducing errors to a minimum. Immediate, accurate feedback should be provided focused on what is correct. Correct any errors by stating what the correct steps are. Preferably, this should be a constant commentary about the performance indicating those things that are done correctly and correcting errors by stating what the correct step is. The learner may then Begin to monitor self, detecting errors and correcting them; and Repeating often enough for steps to become smooth error free and automatic. Test for automatic stage by asking the learner to perform the procedure while conversing with them, preferably in a Topic which is unrelated to the procedure.

A MEMORY LESSON PLAN for the Gathering Quantum PD System Supplies sub-section may next be taught with the objective of having the learner be able to name the Quantum PD System supplies, and gather them from a supply cabinet. Preferred MEDIA may include: Quantum PD System, disposable extension set, card with items listed from UltraBag—altered for Quantum PD System. The learner may be prepared thus: “Now you are going to memorize a list of the supplies you will need to for the Quantum PD System. I will show you the supplies needed and tell you what they are. Look carefully at the supplies, repeat the list in your mind. When you feel that you know what supplies you need, I'll ask you to get them from the supply cabinet”. ACTIVITIES may include the Placement of supplies on a table, and Identification of each. A list of information to be memorized (including Mnemonic(s) or other helpful memory aids or memorization strategies) may include:

Mask; Bag; Pad; Cap; Clamps; Cleaning Wipes; CAPD Flowsheet; Pen; Quantum PD System; Disposable Extension Set. (Use “Mother Bakes . . . ” mnemonic from UltraBag Unit, adding Quantum PD System, and Changing the drain line or extension line to Disposable Extension Set; as follows:

Supplies needed:

| | |
|---|---|
| Face mask | Mother |
| bag of dialysate fluid | Bakes |
| lap pad | Perfect |
| Minicap | Chocolate |
| clamps | Chip |
| cleaning wipes | Cookies |
| disposable extension set | Daily |

The learner is asked to and does repeat the list. An illustration card or flashcard may be used with UltraBag items listed, adding Quantum and Disposable Extension Set. The learner should list supplies from memory. Test by asking for the list. Test by sending to the supply shelf for supplies and having bring back the needed items. (Include on the supply shelf items that are not needed.)

A principle learning lesson plan for the Gathering Quantum PD System Supplies sub-section will have the Learner able to identify Quantum PD System supplies that are usable/unusable. MEDIA may include: Disposable extension set with clear tab missing, disposable extension set with blue tab missing, reusable disposable extension set multi-use bag kept in a dirty location, Quantum PD System sticky with spilled betadine. Ultimately, the Learner will state the principle, “If the disposable extension set is not sterile, then it should not be used. If the Quantum PD System is not clean, it should be cleaned before use.” The learner may be prepared: “You have learned about clean and dirty and sterile and unsterile. You also have also memorized the supplies needed to do an UltraBag exchange and can determine whether or not they are safe to use. Now you are going to learn how to determine if the Quantum PD System supplies are usable or not. I will show you some supplies and ask you to guess whether or not they are usable. Don't be afraid to guess wrong, that is how you learn. When you are guessing correctly I will ask you why and if you answer correctly, then we will know you understand how to determine if supplies are OK.” ACTIVITIES may include: Review of concepts and statement of principles (see the Maintaining Asepsis Unit). The teacher presents scenarios and asks learner to guess. Feedback is given re: accuracy of description. A List of Concepts Linked to Form Principle may include:

1. If a supply is not sterile, then it should not be used.

2. If the Quantum PD System is visibly dirty, it should be cleaned before use.

Suggested Scenarios may include:

1. Disposable Extension Set.—A Missing clear pull tab; A Missing blue pull tab; An Open multi-use bag stored in a dirty location (on the floor, on the heater vent, under the sink with cleaning supplies).

2. Quantum PD System.—Visibly dirty with spilled betadine.

The learner will ultimately restate the principles linking the concepts in their own words.

A JUDGMENT/DECISION LEARNING LESSON PLAN for the Gathering Quantum PD System Supplies sub-section will provide for the Learner to be able to state if a supply is usable, and if not state correct action to take. When presented with various supplies, the learner will state if they are usable, and if not states the appropriate action to take. The learner may be prepared: “Now that you can determine if a supply is usable or not, it is time to learn what to do if you come across an unusable supply. I will show you some supplies and suggest some actions for you take if you find supplies like these. You just pay attention and try to memorize the correct actions. We will know that you have learned what to do when you can repeat to me what you should do if you find an usable supply.” ACTIVITIES may include: Review of associated concepts (Maintaining Asepsis Unit); and Statement of the principles. A list of principles used to make the judgments/decisions:

1. If the disposable extension set is not sterile, then it should not be used.

2. If the Quantum PD System is not clean, then it should be cleaned before use.

Presented also are what the learner should be looking for and possible action steps that should be taken (What the Learner should be looking for?(Judgments) What choice(s)/possible action steps should be taken? (Decisions) Some judgments will have several action steps.) may include:

Disposable extension set—the Clear pull tab intact; Blue pull tab intact; Multi-use disposable extension set package visibly dirty, then, Discard supply.; Discard remaining supply in open multi-use disposable set package. Locate a clean storage location to keep supplies.

Quantum PD System—the system is Visibly dirty, then, Clean Quantum PD System with bleach solution.

Learner should repeat the judgment and decision; and, Identify supplies as usable or unusable. And, Give reason that supply was chosen as usable or unusable. Ask the learner to repeat the action steps. Provide feedback. Continue until the learner has memorized.

A problem solving lesson plan may include as an objective having the learner be able to identify usable/unusable supplies and take the appropriate action. When presented with scenarios, the learner will identify usable/unusable supplies and take appropriate action. The learner may be prepared: “You've learned about usable and unusable supplies and what to do if you do find an unusable supply. Now I will give you problem examples, ask you to tell me what you see, what you know about the situation and what you would do if this happened to you. I will help you along in working through the situation, so don't be afraid. When you can take the correct action, then we will know you can solve this problem at home.” ACTIVITIES may include: Review of associated concepts (Maintaining Asepsis Unit), and Statement of the principles, e.g., “If the disposable extension set is not sterile, then it should not be used. If the Quantum PD System is not clean, then it should cleaned before use.” Present scenario(s) and ask learner to identify and solve the problem. Teacher may need to prompt learner to solve the problem i.e. “What is happening here?”, “What do you know about this?”, and “What do you think you should do?”. If the learner is having difficulty identifying the problem then go back and review associated concepts. Problem solutions should include unit/clinic specific standing orders. Suggested Problem Scenarios and Problem Solutions:

1. Present the learner with a disposable extension set that is missing the clear pull tab. Solution—Learner will tell you to discard the supply and get another.

2. Present the learner with a disposable extension set that is missing the blue pull tab. Solution—Learner will tell you to discard the supply and get another.

3. Present the learner a multi-use disposable extension set package that is visibly soiled. Solution—Learner will tell you to discard the open supplies and open another package. Will also tell you an appropriate and clean storage area to keep remaining supplies .

4. Drop betadine onto the Quantum PD System drain tray. Solution—Learner will tell you to clean the drain tray with a bleach and water solution.

Continue presenting scenarios until learner is developing correct solutions and taking correct actions.

A motor skill lesson plan for the Placing the UltraBag into the Quantum PD System sub-section may have the objective of having the learner be able to repeat the critical steps in placing the UltraBag into the Quantum PD System. Preferred MEDIA may include: Quantum PD System, UltraBag, antibacterial pump soap, sink, waste receptacle, paper towels. The learner may be prepared: “At the end of this lesson you will know the steps for placing the UltraBag into the Quantum PD system. I will show you how to place the fill bag into the heater enclosure, and the drain bag onto the drain tray. You will pay close attention to what I am doing and explaining. After you watch me several times, I will ask you to repeat the steps back to me. When you can repeat the critical steps for placing the UltraBag into the Quantum PD System, I will know that you are ready to practice the procedure yourself.” ACTIVITIES may include: Demonstration of the procedure as it would be normally performed, While the learner Pays attention and watches closely, and “Memorizes” pictures of steps. Repeat demonstration explaining each step in detail, Talking through what your hands are doing, and preferably using detailed steps set forth below. The learner determines the critical steps/nuances and is subjected to Repetition. A Third demonstration may point out the critical steps, preferably using the labels from the condensed analysis which follows:

Brief Description of Logically Grouped Steps with an Associated Label:

1. Clean the work surface. Gather and inspect supplies. Open and inspect the UltraBag.—Get Ready.

2. Press the green main power switch.—Turn on the Quantum PD System.

3. Open the heater cover and hang the UltraBag fill bag on the metal hook in the heater enclosure. Close the heater cover.—Place the UltraBag fill bag in the heater enclosure.

4. Place the fill line in the Green Fill Valve.—Load the fill line.

5. Place the drain line in the Black Drain Valve.—Load the drain line.

6. Place the drain bag on the drain tray.—Place the drain bag on the drain tray.

The learner should repeat from memory the critical steps of the procedure until the learner is able to repeat the steps and the key words without error. The detailed steps to be followed may be practiced thus: “Now it is your turn to practice placing the UltraBag into the Quantum PD System Practice until you feel you can do it without thinking. I will give you feedback about how you are doing. It doesn't matter if you make some mistakes. I will help correct them as you go along. You can practice as long as you need to. When you think you know how to do the procedure, I will ask you to do it on your own without any help from me.” ACTIVITIES are Hands on practice.

Steps to Take (with Parenthetical Tricks of the Trade)

1. Clean the work surface. (Previously learned.)

2. Brief handwashing. (Previously learned.)

3. Gather supplies for the Quantum PD System. (Previously learned.)

4. Inspect supplies for the Quantum PD System. (Previously learned.)

5. Open the UltraBag. (Previously learned.)

6. Inspect the UltraBag. (Previously learned.)

7. Press the green main power switch. (When the main power is left ON between treatments, press any control button to begin next treatment.)

8. With your right hand, lift open the heater cover.

9. With left hand, hold the Y-junction of the patient connector.

10. Using both hands pick up the UltraBag and hang the UltraBag fill bag on the metal hook, fitting the bag completely inside the heater enclosure.

11. With right hand, close the heater cover.

12. With right hand, pick up the fill line below the green frangible and follow it down until 8″ away from the Y-junction.

13. Keeping the patient connector in front of the display screen, place the segment of fill line that is between your hands in the top green fill valve and press down until you hear it click.

14. Continue to keep the patient connector in front of the display screen, and with right hand, pick up the drain line 8″ from the Y-junction, and place the segment of fill line that is between your hands in the bottom black drain valve until you hear a click.

15. With both hands, place the drain bag flat in the center of the drain tray with the clear window facing up and the drain line at the front edge of the drain tray. (The drain bag should be away from the edge of the drain tray. The drain line should away from the floor.)

16. With right thumb and forefinger grasp the Y-junction and pull the tubing forward so that the Y-junction is 8″ from the valves.

The learner should continue to practice, reducing errors to a minimum with the trainer providing immediate, accurate feedback focused on what is correct, and correcting any errors by stating what the correct steps are. Should be a constant commentary about the performance indicating those things that are done correctly and correcting errors by stating what the correct step is. The learner then Begins to monitor self, detecting errors and correcting them. These steps should be repeated often enough for steps to become smooth error free and automatic. Test for automatic stage by asking the learner to perform the procedure while conversing with them. The Topics should be unrelated to the procedure.

A principle lesson plan for placing the UltraBag Fill Bag into the Quantum PD System Heater Enclosure for this unit may include the objective of the Learner being able to identify appropriate placement of the UltraBag fill bag in the Quantum PD System heater enclosure and that conditions warrant proceeding with set up. The learner may be prepared by: “You have learned how to place the fill bag in the heater enclosure, and what can cause a failure to flush and trigger an alarm. You have also learned what can cause improper warming of the solution. Let's talk now about some reasons why this may occur when using the Quantum PD System. I will present situations to you and ask you to guess whether or not they may cause an alarm or improper warming. Don't be afraid to guess wrong, that is how you learn. When you are guessing correctly I will ask you why and if you answer correctly, then will know you have learned it.” Activities may include: the trainer reviewing concepts and state principles, presenting scenarios and asking learner to guess, and giving feedback re: accuracy of description. This should be continued until the learner is guessing correctly most of the time. A List of Concepts Linked to Form Principle may include: If the fill bag is not correctly positioned in the heater enclosure, the fluid may not be heated to the proper temperature.; If the fluid is not heated to the proper temperature, then it is unsafe to use and fill will not occur.; and If the fill bag is not correctly positioned in the heater enclosure, the fluid may not flow to complete the flush phase correctly.; and If the fill line is not properly flushed then an alarm will occur. Some Suggested Scenarios may include: 1. Fill bag folded on itself preventing fill bag from completely emptying. 2. Fill bag folded on the tubing to create a partial block. 3. Fill bag is partially inserted into the heater enclosure preventing full contact with heating surface. 4. The fill line is folded on itself creating an obstruction.

A judgment/decision plan for placing the UltraBag into the Quantum PD System Heater Enclosure may give the Learner the ability to be able to identify inappropriate placement of the UltraBag fill bag in the Quantum PD System heater enclosure and state the appropriate action to take. The learner may be prepared using: “Now that you know what can happen if the fill bag is not placed correctly in the heater enclosure, it is time to learn what you can do if this accidentally happens at home. I will present situations to you and suggest some actions for you take if this happens to you. You just pay attention and try to memorize the correct actions. We will know you have learned when you can repeat to me what you should do if this happens.” ACTIVITIES may include: Review of associated concepts, and Statement of the principles, as in the following LIST OF PRINCIPLES USED TO MAKE THE JUDGMENT/DECISON:

1. If the fill bag is not correctly positioned in the heater enclosure, the fluid may not be heated to the proper temperature.

2. If the fluid is not heated to the proper temperature, then it is unsafe to use and fill will not occur.

3. If the fill bag is not correctly positioned in the heater enclosure, the fluid may not flow to complete the flush phase correctly.

4. If the fill line is not properly flushed then an alarm will occur.

Presentation of what the learner should be looking for and possible action steps that should be taken (the purpose of this lesson is to get the learner to memorize where/when judgments should be made and the correct actions that should be taken). What the Learner should be looking for?(Judgment) and What choice(s)/possible action steps should be taken (Decisions) (some judgments will have several action steps):

1. The fill bag is hanging from the metal hook inside the heater enclosure. Response—Reposition the fill bag onto the metal hook.

2. The fill bag is placed flush against the heating surface to maximize fluid contact. Response—No action necessary.

3. The fill bag is placed folded against the heating surface. Response—Reposition the fill bag.

4. The fill line is obstructed at the bottom of the heater enclosure. Response—Reposition the fill line.

Ask the learner to repeat the action steps. And the learner repeats the judgment and decision. Provide feedback. Continue until the learner has memorized.

A problem solving plan for placing the UltraBag Fill Bag into the Quantum PD System Heater Enclosure may have the objective of providing the Learner to be able to identity improper placement of the UltraBag fill bag in the Quantum PD System heater enclosure and take the appropriate action. The learner may be prepared using: “You've learned about proper positioning of the fill bag in the heater enclosure and how improper placement can lead to problems flushing, filling and warming of the solution. Now I will give you some problem examples, ask you to tell me what you see, what you know about the situation and what you would do if this happened to you. I will help as you work through the situation, so don't be afraid if you make a mistake. When you can take the correct action, then we will know you can solve this problem at home.” ACTIVITIES may include: Review of associated concepts, and Statement of the principles (e.g.,

1. If the fill bag is not correctly positioned in the heater enclosure, the fluid may not be heated to the proper temperature.

2. If the fluid is not heated to the proper temperature, then it is unsafe to use and fill will not occur.

3. If the fill bag is not correctly positioned in the heater enclosure, the fluid will not flow to complete the flush phase correctly.

4. If fill line is not properly flushed, then an alarm will occur.)

Presentation of scenario(s) and ask the learner to identify and solve the problem. The teacher may need to prompt learner to solve the problem i.e. “What is happening here”, “What do you know about this?, and “What do you think you should do?” If the learner is having difficulty identifying the problem then go back and review associated concepts.

Suggested Problem Description: Improper Placement of the UltraBag Fill Bag in the Quantum PD System Heater Enclosure.

Problem Scenarios and Problems Solutions

1. The fill bag is properly placed on the metal hook, flush against the warming surface, with no folds, and fill line freely extends from the heater enclosure. 1. Continue with set up.

2. The fill bag is inside the heater enclosure and not hanging from the metal hook. 2. Reposition the fill bag onto the metal hook.

3. The fill bag is partially placed inside the heater enclosure allowing some fluid to remain outside of the heater enclosure. 4. Reposition the fill bag.

4. The fill bag is twisted inside the heater enclosure creating folds large enough to obstruct flow. 4. Reposition the fill bag.

5. The fill line is extending out the bottom of the heater enclosure but it is folded upon itself. 5. Reposition the fill line.

The Learner Solve problems and take correct actions. Continue feedback and Continue presenting scenarios until learner is developing correct solutions and taking correct actions.

A principle lesson plan for Placing the UltraBag Drain Bag on the Quantum PD System Drain Tray may provide the Learner to be able to identify appropriate placement of the UltraBag drain bag on the Quantum PD System drain tray and that conditions warrant proceeding with set up. MEDIA: Quantum PD System, UltraBag. Ultimately, Learner will appropriately place the UltraBag drain bag on the Quantum PD System drain tray. Learner states the principles: “If the drain bag is not correctly placed on the drain tray then the bag may not fill correctly”, “If the drain bag is not properly placed on the drain tray then the drain volume will not be correctly recorded.”, “If the drain volume is not properly recorded, an alarm may sound,” “If the drain volume is not correctly recorded then improper adjustments in fluid balance may occur.” Learner preparations may include: “You have learned how to place the drain bag on the drain tray, the importance of weighing and recording your drain volume with each exchange, and how improper placement of the drain bag can hinder flow. Let's talk now about some reasons why this may occur when using the Quantum PD System. I will present situations to you and ask you to guess whether or not they may cause a problem . Don't be afraid to guess wrong, that is how you learn. When you are guessing correctly I will ask you why and if you answer correctly, then will know you have learned it.” ACTIVITIES may include: Review of concepts and statement of principles (see above). Teacher presents scenarios and asks learner to guess. Give feedback re: accuracy of description.

Suggested Scenarios May Include:

1. Drain bag properly placed on the drain tray.

2. Drain bag with drain line extending over the ridge on the drain tray and touching the floor.

3. Drain bag placed with the drain line extending off the side of the drain tray.

4. Drain bag placed folded in half on the drain tray.

5. Drain line pulled too far forward through black drain valve, pulling drain bag partially up off drain tray.

Learner Continues guessing as scenarios that are examples and non-examples are presented. Continue presentation of examples and non-examples until the learner is guessing correctly most of the time. Have the learner restate the principles linking the concepts in their own words.

A JUDGEMENT/DECISION LEARNING LESSON PLAN for a Placing the UltraBag Drain Bag on the Quantum PD System Drain Tray may provide the Learner with the ability to identify inappropriate placement of the UltraBag drain bag on the Quantum PD System drain tray and state the appropriate action to take. LEARNER preparation may include: “Now that you know what can happen if the drain bag is not placed correctly on the drain tray, it's time to learn what you can do if this accidentally happens at home. I will present situations to you and suggest some actions for you take if this happens to you. You just pay attention and try to memorize the correct actions. We will know you have learned this when you can repeat to me what you should do if this happens.” ACTIVITIES may include: Review associated concepts and State the principles.; e.g.,

1. If the drain bag is not correctly placed on the drain tray, then the drain bag may not fill correctly.

2. If the drain bag is not properly placed on the drain tray then the drain volume will not be correctly recorded.

3. If the drain volume is not correctly recorded, then an alarm may sound.

4. If the drain volume is not correctly recorded, then improper adjustments in fluid balance may occur.

Present what the learner should be looking for and possible action steps that should be taken. The purpose of this lesson is to get the learner to memorize where/when judgments should be made and the correct actions that should be taken, e.g.,

What the Learner should be looking for?(Judgment) What choice(s)/possible action steps should be taken (Decisions) (some judgments will have several action steps)

1. Drain bag properly placed on the drain tray. Completely unfolded, the edge of the bag along the ridge of the tray and the drain line extending off the drain tray and hanging freely from the control panel. 1. Continue with set up.

2. Drain bag folded in half placed on the drain tray. 2. Reposition the drain bag.

3. Drain bag placed on the drain tray with the drain line extending off the side of the drain tray. 3. Reposition the drain bag.

4. Drain bag placed on the drain tray with the edge of the bag touching the ridge on the drain tray, drain line extending off the drain tray and touching the floor. 4. Reposition the drain bag.

Repeat the judgment and decision. Ask the learner to repeat the action steps. Provide feedback. Continue until the learner has memorized.

A PROBLEM SOLVING LESSON PLAN for Placing the UltraBag Drain Bag on the Quantum PD System Drain Tray may give the Learner the ability to identity improper placement of the UltraBag drain bag on the Quantum PD System drain tray and take the appropriate action. Preparation: “You've learned about proper positioning of the drain bag on the drain tray and how improper placement can lead to problems draining and measuring the volume. Now I will give you some problem examples, ask you to tell me what you see, what you know about the situation and what you would do if this happened to you. I will help as you work through the situation, so don't be afraid if you make a mistake. When you can take the correct action, then we will know you can solve this problem at home.” Then Review associated concepts and State the principles as above. The, Present scenario(s) and ask the learner to identify and solve the problem. Teacher may need to prompt learner to solve the problem i.e. “What is happening here”, “What do you know about this?, and “What do you think you should do?” If the learner is having difficulty identifying the problem then go back and review associated concepts.

Suggested Problem Description: Improper Placement of the UltraBag Drain Bag on the Quantum PD System Drain Tray.

Problem Scenario and Problems Solutions

1. Drain bag properly placed on the drain tray. Completely unfolded, the edge of the bag along the ridge of the tray and the drain line extending off the drain tray and hanging freely from the control panel. Then, Continue with set up.

2. Drain bag folded in half placed on the drain tray. Then, Reposition the drain bag.

3. Drain bag placed on the drain tray with the drain line extending off the side of the drain tray. Then, Reposition the drain bag.

4. Drain bag placed on the drain tray with the edge of the bag touching the ridge on the drain tray, drain line extending off the drain tray and touching the floor. Then, Reposition the drain bag.

Continue presenting scenarios until learner is developing correct solutions and taking correct actions.

A MOTOR SKILL—COGNITIVE-LESSON PLAN for a Connecting the Disposable Extension Set to UltraBag sub-section may involve: the learner being able to repeat the critical steps in connecting the disposable extension set to the UltraBag.

MEDIA: Quantum PD System, UltraBag, disposable extension set, mask, antibacterial pump soap, sink, waste receptacle, paper towels. LEARNER preparation may include:

“At the end of this lesson you will know the steps for connecting the disposable extension set to the UltraBag. I will show you how to connect the disposable extension set to the UltraBag. You will pay close attention to what I am doing and explaining. After you watch me several times, I will ask you to repeat the steps back to me. When you can repeat the critical steps for connecting the disposable extension set to the UltraBag, I will know that you are ready to practice the procedure yourself.” ACTIVITIES may include:

Demonstration of the procedure as it would be normally performed. Repeat demonstration explaining each step in detail. Talk through what your hands are doing.

Use detailed Motor Skill Steps as follows.

Steps to Take Tricks of the Trade

1. Prepare self. 1. Previously learned.

2. Sit down and place the lap pad in your lap. 2. Sit down positioned in front of the Quantum PD System.

3. Grasp the disposable extension set package with both hands at the perforated line. Tear the package open at the perforated line and remove one disposable extension set from the package. 3. Skip this step for a NOW exchange.

4. With the right thumb and forefinger tear off the paper tab on the disposable extension set and discard. Let the extension set coil rest in your lap on the lap pad.

5. Position the disposable extension set so the clear pull tab on the disposable extension set points toward your knees.

6. Grasp the Y-junction of the UltraBag with left thumb and forefinger.

7. Place right forefinger through the rubber pull ring and pull straight off. Discard.

8. Drop the pull ring and let go of the patient connector.

9. Using left thumb and forefinger, grasp the blue finger grip of the disposable extension set connector.

10. Wrap the remaining fingers around the disposable extension set.

11. Place your right forefinger through the loop of the clear pull tab and pull straight off. Discard.

12. Find the Y-junction of the UltraBag with right thumb and forefinger. Hold with forefinger on top and thumb on bottom Slide your fingers up to the dark blue circular flange.

13. Move left hand to the UltraBag patient connector and attach the disposable extension set by twisting the to the right.

14. Place the disposable extension set in the line holder with the patient connector end extending about 2-3″ from the line holder and on the same side as the display screen.

Then, Repetition. Third demonstration point out the critical steps. Use the labels as follows.

Brief Description of Logically Grouped Steps Label

1. Prepare self. Place a lap pad on lap. 1. Prepare self.

2. Open the extension. Remove paper tabs. Place on lap pad. 2. Prepare the disposable extension set.

3. Connect the extension to the UltraBag. 3. Connect.

4. Place the patient connector end in the line holder. 4. Place in line holder.

Repeat from memory the critical steps of the procedure. Repeat until the learner is able to repeat the steps and the key words without error.

A MOTOR SKILL—PRACTICE-LESSON PLAN for Connecting the Disposable Extension Set to UltraBag may then be taught. Preparation: “Now it is your turn to practice connecting the disposable extension set to the UltraBag. Practice until you feel you can do it without thinking. I will give you feedback about how you are doing. It doesn't matter if you make some mistakes. I will help correct them as you go along. You can practice as long as you need to. When you think you know how to do the procedure, I will ask you to do it on your own without any help from me.” ACTIVITIES include Hands on practice. Continue to practice, reducing errors to a minimum. Provide immediate, accurate feedback focused on what is correct. Correct any errors by stating what the correct steps are. Should be a constant commentary about the performance indicating those things that are done correctly and correcting errors by stating what the correct step is. Begin to monitor self, detecting errors and correcting them. Repeat often enough for steps to become smooth error free and automatic. Test for automatic stage by asking the learner to perform the procedure while conversing with them. Topic should be unrelated to the procedure.

A MOTOR SKILL—COGNITIVE-LESSON PLAN for Connecting to the Quantum PD System and Initiating Therapy provides for the learner to be able to repeat the critical steps for connecting to the Quantum PD System and initiating therapy. MEDIA: Quantum PD System, UltraBag, disposable extension set, mask, antibacterial pump soap, sink, waste receptacle, paper towels, practice apron with transfer set attached to a full saline bag. Preparation: “At the end of this lesson you will know the steps for connecting to the Quantum PD System and initiating therapy. I will show you how to connect to the Quantum PD System and initiate therapy. You will pay close attention to what I am doing and explaining. After you watch me several times, I will ask you to repeat the steps back to me. When you can repeat the critical steps for connecting to the Quantum PD System and initiating therapy, I will know that you are ready to practice the procedure yourself.” ACTIVITIES include: Demonstrate the procedure as it would be normally performed (Use practice apron with transfer set attached to saline bag). Repeat demonstration explaining each step in detail. Talk through what your hands are doing. Use detailed Steps as follows:

Steps to Take with the Tricks of the Trade

1. Prepare self. 1. Previously learned.

2. Sit down positioned in front of the Quantum PD System and place the lap pad in your lap.

3. With the left thumb and forefinger palm side down, grasp the white finger grip of the patient connector.

4. Place the left middle finger on top of the line in the line holder to stabilize.

5. Place the right forefinger through the blue pull tab and pull straight off. Drop the pull tab to the right side.

6. Let go of the patient connector.

7. With your left thumb and forefinger, grasp the light blue finger grip area of the transfer set and wrap the remaining fingers around the white twist clamp, keeping the Minicap pointed in a downward direction.

8. Using the right thumb and forefinger, grasp the Minicap by the grooves. Twist the Minicap off to remove it. Place the Minicap on the lap pad.

9. Using your right thumb and forefinger and palm side down, grasp the white patient connector of the extension line behind the circular flange and take the line out of the line holder

10. Screw the disposable extension set onto the transfer set until it is secure and you cannot turn it any further.

11. Press “GO”.

12. Verify the display screen says “Break Frangibles”.

13. Break green and blue frangibles. 13. Previously learned.

14. Verify the display screen says “Priming Fill Line”.

15. Verify the display screen says “Open Miniset”

16. Open your transfer set. 16. Previously learned.

17. Verify the display screen says “Flushing Drain Line”.

18. Verify the display screen says “Good Night. Drain will start at xx:xxAM”.

18. The exchange will begin at the programmed time.

19. Tape the transfer set to your abdomen. 19. Previously learned.

The learner Determines the critical steps/nuances, particularly through Repetition. A Third demonstration may be used to point out the critical steps, preferably Using the labels from the condensed analysis as follows:

Brief Description of Logically Grouped Steps Label

1. Prepare self. Place a lap pad on lap. 1. Prepare self.

2. Keeping the disposable extension set in the line holder on the control panel remove the blue pull tab. 2. Remove blue pull tab.

3. Remove the Minicap from the transfer set. 3. Remove the Minicap.

4. Connect to the patient connector on the patient extension line. 4. Connect.

5. Press “GO” and verify the display changes to “Break Frangibles” 5. Press “GO.”

6. Break green and blue frangibles. Verify the displays to “Priming Fill Line” then to “Open Miniset”. 6. Break the frangibles.

7. Open the transfer set, tape to abdomen. 7. Open the transfer set, tape.

The learner Repeats from memory the critical steps of the procedure. Repeat until the learner is able to repeat the steps and the key words without error.

A MOTOR SKILL—PRACTICE-LESSON PLAN for Connecting to the Quantum PD System and Initiating Therapy will have the learner will be able to safely connect to the Quantum PD System and initiate therapy. “Now it is your turn to practice connecting to the Quantum PD System and initiating therapy. Practice until you feel you can do it without thinking. I will give you feedback about how you are doing. It doesn't matter if you make some mistakes. I will help correct them as you go along. You can practice as long as you need to. When you think you know how to do the procedure, I will ask you to do it on your own without any help from me.” ACTIVITIES include: Hands on practice. Continued practice, reducing errors to a minimum. Provide immediate, accurate feedback focused on what is correct. Correct any errors by stating what the correct steps are. Should be a constant commentary about the performance indicating those things that are done correctly and correcting errors by stating what the correct step is. Begin to monitor self, detecting errors and correcting them. Continue to provide feedback. Repeat often enough for steps to become smooth error free and automatic. Test for automatic stage by asking the learner to perform the procedure while conversing with them. Topic should be unrelated to the procedure.

A motor skill lesson for an Ending Therapy and Disconnecting from the Quantum PD System may provide for the learner to be able to repeat the critical steps for ending therapy and disconnecting from the Quantum PD System. MEDIA may include: Quantum PD System set up, mask, antibacterial pump soap, sink, waste receptacle, paper towels, practice apron with transfer set attached to a saline bag, CAPD flow sheets, pencil. The learner may be prepared thus: “At the end of this lesson you will know the steps for ending therapy and disconnecting from the Quantum PD System. I will show you how to end the therapy and disconnect yourself from the Quantum PD System. You will pay close attention to what I am doing and explaining. After you watch me several times, I will ask you to repeat the steps back to me. When you can repeat the critical steps for ending therapy and disconnecting from the Quantum PD System, I will know that you are ready to practice the procedure yourself.” ACTIVITIES Demonstration of the procedure as it would be normally performed using the practice apron with transfer set attached to a saline bag. The learner Pays attention and watches closely, and “Memorizes” pictures of steps. Repeat demonstration explaining each step in detail. Talk through what your hands are doing. And, preferably Use detailed Motor Skill steps as follows:

Steps to Take with Tricks of the Trade in Parens:

1. Verify the display screen reads “Disconnect”.

2. Verify the fill bag is empty.

3. Clamp the disposable extension set by grasping the clamp between the thumb and forefinger of the right hand and squeezing to close. (For a NOW exchange attach an outlet port clamp to both the fill and drain lines.)

4. Close the transfer set. (Previously learned.)

5. Prepare self. (Previously learned.)

6. Disconnect. (Previously learned.)

7. Press “GO”.

8. Verify the display screen reads “Unload”.

9. Record drain volume.

10. With right forefinger hold the green lever down.

11. With left hand lift the fill line out of the green fill valve.

12. With right forefinger hold the black lever down.

13. With left hand lift the drain line out of the black drain valve.

14. Dispose of the UltraBag. (Previously learned.)

The learner Determines the critical steps/nuances, particularly through Repetition. A Third demonstration may be used to point out the critical steps, preferably Using the labels from the condensed analysis as follows: Brief Description of Logically Grouped

Steps with Associated Label:

1. Verify that the Display reads “Disconnect” and that the fill bag is empty; Label—Verify the exchange is finished.

2. Clamp the disposable extension set and close the transfer set; Label—Clamp.

3. Prepare Self; Label—Prepare Self.

4. Disconnect; Label—Disconnect.

5. Press “GO” and verify the display changes to “Unload”; Label—Press “GO”.

6. Record the drain volume; Label—Record the drain volume.

7. Remove the fill and drain lines from the valves, and remove the fill bag from the heater enclosure; Label—Remove the UltraBag.

8. Dispose of the UltraBag; Label—. Dispose.

The learner Repeats from memory the critical steps of the procedure. Repeat until the learner is able to repeat the steps and the key words without error.

A motor skill practice plan may now be taught. Preparation: “Now it is your turn to practice ending therapy and disconnecting from the Quantum PD System. Practice until you feel you can do it without thinking. I will give you feedback about how you are doing. It's OK to make mistakes, I will correct them as you go along. You can practice as long as you need to. When you think you know how to do the procedure, I will ask you to do it on your own without any help from me.” ACTIVITIES include: Hands on practice, and Continued practice, reducing errors to a minimum. Immediate, accurate feedback should be provided focused on what is correct. Correct any errors by stating what the correct steps are. Should be a constant commentary about the performance indicating those things that are done correctly and correcting errors by stating what the correct step is. Learner Begins to monitor self, detecting errors and correcting them. Repeat often enough for steps to become smooth error free and automatic. Test for automatic stage by asking the learner to perform the procedure while conversing with them in a Topic which should be unrelated to the procedure.

A sub-section on Quantum PD™ System Alarms may include a CONCEPT LEARNING LESSON PLAN where the learner will be able to identify Flashing Signal, Recoverable Alarm and Non-Recoverable Alarm situations. MEDIA: Quantum PD™ System, Quantum PD™ System disposables, Pictures of Alarm Displays (UB 5-6; FIG. 7E). “At the end of this lesson you will be able to identify different alarm situations. I will create problem situations with the Quantum PD™ System setup and treatment that cause alarms. I will ask you to guess whether the alarm is a Flashing Signal, Recoverable Alarm or Non-Recoverable Alarm situation. I will tell you if you are right or wrong and why. It is OK if you make a mistake, that is how you learn. We will keep doing this until you are guessing correctly all of the time. Then we will know you got it.” ACTIVITIES Give definition of concept (May delay giving definition of concept to end of lesson). A suggested Definition (critical characteristics) may include:

1. Quantum PD™ System finds a problem with the therapy, displays a flashing signal, sounds an alarm, displays the type of alarm, lights the display screen, and pauses or stops the therapy.

2. Flashing Signal—These messages will flash and beep to remind you of what needs to be done before you can continue the therapy.

3. Recoverable Alarm—Errors you can correct yourself. Display message starts with “attention”.

4. Non-Recoverable Alarm—Errors that will require technical assistance to correct. Display message reads “Error Non-Recoverable”.

Present examples and non-examples of items to illustrate concept. Give learner feedback about accuracy of guesses. Usually start with example/non-example pairs, then as learner is guessing correctly, present single examples and non-examples. Final examples and non-examples should be very close so learner must make fine discriminations.

Suggested Example/Non-Example Pairs(Verbal Descriptions, Suggested Pictures/video-clips, Scenarios):

1. The Non-Examples would be any non-alarm condition.

2. During Setup do not break the green frangible on the UltraBag.

3. Correct (2.) above and then do not open MiniSet.

4. Correct (3.) above, but have the learner's peritoneal cavity positioned 1 foot below the control panel.

5. After Setup remove drain tubing from valve.

6. Leave Quantum PD™ System unplugged from electrical outlet and attempt to heat bag. Note: Heating occurs about 1 hour before fill is scheduled to start.

7. At the start of a fill, clamp the fill line. Note: it will take about 40 minutes for this alarm to occur; this alarm will not occur in the NOW Exchange mode.

8. At the start of a drain, clamp the drain line.

9. A Picture of a Quantum PD™ System thermometer showing too cool and display reading “PLEASE WAIT FOR FLUID TEMPERATURE”(UB 5; FIG. 7E).

10. During drain, place a book on the drain tray on the weigh scale.

11. A picture of a display showing a Non-Recoverable alarm (UB 6; FIG. 7E).

Continue to present examples and non-examples until learner is guessing correctly all of the time. Continue guessing as examples and non-examples are presented. Have learner formulate definition of concept. If definition has been presented at start of lesson, have learner use own words to formulate definition.

Other alarm sub-sections may include a PRINCIPLE LEARNING LESSON PLAN where a Learner will recognize situations that may lead to Quantum PD™ System Alarms. MEDIA: Quantum PD™ System, Quantum PD™ System disposables, Pictures of Alarm Displays(UB 5-6; FIG. 7E). Ultimately, the Learner states the principles: “If frangibles are unbroken or the extension line clamp is closed or the drain bag is not on the drain tray or the solution bag is not in the heater enclosure when you press GO and the displays reads “BREAK FRANGIBLES (SEAL)” during setup, then a Flashing Signal “BREAK FRANGIBLES (SEAL)” will occur”, “If the solution bag tubing is not in the top fill valve (green) and/or the drain bag tubing is not in the bottom drain valve (black) or the MiniSet is closed or the tubing is clogged with fibrin or the extension line clamp is closed or your peritoneal cavity is below the control panel when the display reads “OPEN MINISET”, then a Flashing Signal “OPEN MINISET” will occur”, “If the tubing is clogged with fibrin or if the peritoneal cavity is below the control panel when the display reads “FLUSHING DRAIN LINE”, then a Flashing Signal “FLUSHING DRAIN LINE” will occur”, “If the Quantum PD™ System is not sensing tubing in the valves, then a Recoverable Alarm—“ATTENTION DRAIN TUBING NOT LOADED” or “ATTENTION FILL TUBING NOT LOADED”—will occur”, “If the Quantum PD™ System battery level is low, then a Recoverable Alarm—“ATTENTION LOW BATTERY”—will occur”, “If the Quantum PD™ System detects fluid in the solution bag after the fill duration has passed (about 40 minutes), then a Recoverable Alarm—“ATTENTION LOW FILL, CHECK TUBING CHECK FILL BAG”—will occur”, “If the drain rate has slowed down and the weigh scale is not detecting that you have drained enough, then a Recoverable Alarm—“ATTENTION LOW FLOW, CHECK TUBING”—will occur”, “If the temperature of the solution is not at the correct temperature, then a Recoverable Alarm—“PLEASE WAIT FOR FLUID TEMPERATURE”—will occur”, “If the weigh scale senses a sudden change in weight on the drain tray, then a Recoverable Alarm—“ATTENTION WEIGH SCALE DISTURBED”—will occur”, and “If a problem occurs inside the Quantum PD™ System, then a Non-Recoverable Alarm will occur.” LEARNER Preparation may include: “You have learned the characteristics of the Quantum PD™ System alarms. Let's talk now about some causes of these alarms. I will present situations to you and ask you to guess whether or not they may cause an alarm. Don't be afraid to guess wrong, that is how you learn. When you are guessing correctly I will ask you why and if you answer correctly, then we will know you understand what causes Quantum PD™ System alarms. ACTIVITIES may include: Review concepts and state principles. Teacher presents scenarios and asks patient to guess. Give feedback re accuracy of description.

Suggested Scenarios May Include

1. During Setup do not break green frangible on UltraBag. Alarm beeps and display flashes “BREAK FRANGIBLES (SEALS)”.

2. Correct 2. above and then do not open MiniSet. Alarm beeps and display flashes “OPEN MINISET.”

3. Correct 3. above, but have the learner's peritoneal cavity positioned 1 foot below the control panel. Alarm beeps and display flashes “FLUSHING DRAIN LINE.”

4. After Setup remove drain tubing from valve. Alarm beeps continuously and display reads “ATTENTION DRAIN TUBING NOT LOADED.”

5. Repeat 4. above with fill tubing.

6. Leave Quantum PD™ System unplugged from electrical outlet and attempt to heat bag. Alarm beeps continuously and display reads “ATTENTION LOW BATTERY.” Battery icon shows on the display screen. Note: Heating occurs about 1 hour before fill is scheduled to start.

7. At the start of a fill, clamp the fill line. After about 40 minutes alarm beeps continuously and display reads “ATTENTION LOW FILL, CHECK TUBING, CHECK FILL BAG” Note: This alarm does not work in the NOW Exchange mode. The alarm may not detect a low fill in the following conditions: The temperature outside the heater enclosure is higher than 32.3° C. (90° F.) or the volume remaining in the solution bag is less than 700 ml.

8. At the start of a drain, clamp the drain line. Alarm beeps 3 times; display reads “ATTENTION LOW FLOW, CHECK TUBING.”

9. Do not correct 8. above. After 5 minutes alarm beeps 3 more times, louder. Display continues to read “ATTENTION LOW FLOW, CHECK TUBING.”

10. Do not correct 9. above. After 5 minutes alarm beeps continuously. Display continues to read “ATTENTION LOW FLOW, CHECK TUBING.”

11. Show a picture of a Quantum PD™ System thermometer showing too cool and display reading “PLEASE WAIT FOR FLUID TEMPERATURE” (UB 5) Tell the learner that there will be no alarm beep. Display only.

12. During drain, place a book on the drain tray on the weigh scale. No alarm beep. Display reads “ATTENTION WEIGH SCALE DISTURBED.”

13. Show a picture of a display showing a Non-Recoverable alarm. Tell the learner that the alarm would beep continuously; display will read “ERROR NON-RECOVERABLE” (UB 6).

Continue to present examples and non examples until learner is guessing correctly most of the time. Restate the principles linking the concepts in their own words.

Another alarm sub-section for JUDGEMENT/DECISION LEARNING LESSON PLAN may provide for the Learner to be able to recognize situations that may lead to Quantum PD™ System Alarms and state the appropriate actions to take to correct the alarm condition. LEARNER Preparation: “Now that you understand what causes Quantum PD™ System Alarms, it is time to learn what you can do if this happens to you at home. I will present situations to you and suggest some actions for you take if these happen to you. You just pay attention and try to memorize the correct actions. We will know that you have learned what to do when you can repeat to me what you should do if you have an alarm on the Quantum PD™ System.” ACTIVITIES may include: Review associated concepts. Re-State the principles (as in above lesson. Presentation of what the learner should be looking for and possible action steps that should be taken. The purpose of this lesson is to get the learner to memorize where/when judgments should be made and the correct actions that should be taken.

What the Learner Should be Looking for?(Judgments) What Choice(s)/possible Action Steps Should be Taken? (Decisions) (Some Judgments Will Have Several Action Steps)

1. “BREAK FRANGIBLES (SEALS)” Flashing Signal situation. 1. Check that the frangibles are broken, the extension line clamp is open, the drain bag is on the tray and the solution bag is in the heater enclosure. Correct any of those situations. Fluid should then flow from the solution bag to the drain bag and the display should read “PRIMING FILL LINE . . . ”

2. “OPEN MIMSET” Flashing Signal situation. 2. Check that the solution bag tubing is in the top fill valve (green) and the drain bag tubing is in the bottom drain valve (black). Check that the MiniSet is open, the tubing is clear of fibrin, and the extension line clamp is open. Correct any of these situations. Change positions. Make sure the peritoneal cavity is at the same height as the control panel. The display should then read “FLUSHING DRAIN LINE . . . ”

3. “FLUSHING DRAIN LINE” Flashing Signal situation. 3. Check that the tubing is clear of fibrin and the peritoneal cavity is at the same height as the control panel. Correct either of those situations. A small amount of fluid should run from your peritoneal cavity to the drain bag and display will then read “GOOD NIGHT.”

4. “ATTENTION DRAIN TUBING NOT LOADED” or “ATTENTION FILL TUBING NOT LOADED” Recoverable alarm situation. 4. Press MUTE. Close MiniSet. Clamp fill line with an outlet port clamp. Continue to follow the messages on the display screen. Press GO. Press GO to open (fill/drain valve opens). Load Tubing, Press Go to continue. Remove outlet port clamp on fill line, Open MiniSet. Press Go to continue. Return to treatment.

5. “ATTENTION LOW BATTERY” Recoverable Alarm situation. 5a. Follow these steps in case of a loose fitting plug: Press MUTE. Check to make sure the power cord is securely plugged into the Quantum PD™ System and the grounded outlet. Once securely plugged, the picture of the battery should leave the display screen. Press GO to continue the exchange. Leave the system on and plugged in for at least six hours to recharge the battery. 5b. If you get this alarm during a power failure, follow these steps to do a manual exchange: Press MUTE. Close MiniSet. Clamp fill line with an outlet port clamp. Turn the main switch OFF and then back ON. Wait until “TUBING FOUND” screen is shown and press OPEN to unload tubing. DO NOT DISCONNECT your MiniSet from the extension line. Remove the bags from the Quantum PD™ System. Check the solution bag temperature and follow your normal manual exchange procedure. Once the power is restored, leave the system ON and plugged in for at least 6 hours to recharge the battery. (Caution learner to ensure enough light is available to perform the exchange safely).

6. “ATTENTION LOW FILL, CHECK TUBING, CHECK FILL BAG” Recoverable Alarm situation. 6. Press MUTE. Check to see if the solution bag is full or empty. If the solution bag is full: Check the fill line is not blocked by fibrin, kinked tubing, a closed valve, etc. Correct any of those situations. When the fluid begins to flow, press GO to return to the fill state. If the fluid does not begin to flow, call 800 number or clinic for advice. If the solution bag is empty: Press GO to return to the fill state screen. Press GO to disconnect and unload the bags. Call the 800 number to report the alarm.

7. “ATTENTION LOW FLOW, CHECK TUBING” Recoverable Alarm situation. 7. Press MUTE. Change your position. Straighten out any kinked tubing. Loosen any fibrin located in the tubing by rolling the blocked area around in your fingers. Assess bowel patterns, enema if necessary. Check to see that the previous fill volume is programmed correctly. The alarm will go away once the drain flow rate has gotten fast enough. NOTE: if the situation cannot be corrected but you have drained half of your previous fill volume, the system will allow you to BYPASS and start the fill mode. However, if you have drained less than half of your previous fill volume, the system will NOT show the BYPASS button and will NOT move to the fill mode. In this case, you will need to contact your clinic for instructions.

8. “PLEASE WAIT FOR FLUID TEMPERATURE” display situation. 8. In the case where the thermometer icon show the solution to be too cold make sure the heater cover is closed. The solution will take up to one hour to warm up. In the unlikely case the thermometer icon shows the temperature of the solution to be too hot, then open the heater cover until the message is gone.

9. “ATTENTION WEIGH SCALE DISTURBED” display situation. 9. Remove the extra item from the drain tray; keep the drain bag on the tray. After one minute, if the item is not removed, the system will correct the disturbance by subtracting the item's weight. Press GO to continue.

10. “ERROR NON-RECOVERABLE” alarm situation. 10. Press MUTE. Close your transfer set clamp. Clamp the fill line with an outlet port clamp. Write down the message, title, and serial number that appears on the screen. Turn the main power switch off. Call the 800 number to report the alarm.

Ask to Repeat the judgment and decision. Provide feedback. Continue until the learner has memorized.

Another alarm sub-section may be a PROBLEM SOLVING LEARNING LESSON PLAN for the Learner to be able to take appropriate actions when faced with Quantum PD™ System alarm conditions. LEARNER preparation may include: “You've learned about Quantum PD™ System alarms and what to do if you have one. Now I will give you problem examples, ask you to tell me what you see, what you know about the situation and what you would do if this happened to you. I will help you along in working through the situation, so don't be afraid. When you can take the correct action, then we will know you can trouble shoot the Quantum PD™ System Alarms at home.” ACTIVITIES may include: Review associated concepts and State the principles (rules) and Present problem scenarios and ask learner to solve.

Problem Scenario (Include Suggestions for Simulating Scenario, i.e. Demo, Created Situations, Verbalized Descriptions) Problem Solution

1. During Setup do not break green frangible on UltraBag. “BREAK FRANGIBLES (SEALS)” Flashing Signal occurs. 1. Learner checks that the frangibles are broken, the extension line clamp is open, the drain bag is on the tray and the solution bag is in the heater enclosure. Learner breaks the frangible. Learner checks for fluid should flow from the solution bag to the drain bag and waits for the display to read “PRIMING FILL LINE . . . ”

2. During setup when display reads “OPEN MINISET”—do not open. “OPEN MINISET” Flashing Signal occurs. 2. Learner checks that the solution bag tubing is in the top fill valve (green) and the drain bag tubing is in the bottom drain valve (black). Check that the MiniSet is open, the tubing is clear of fibrin, and the extension line clamp is open. Learner opens MiniSet. Learner checks for the display to read “FLUSHING DRAIN LINE . . . ”

3. Move directly from 2. scenario and have learner position self with peritoneal cavity positioned 1 foot below the control panel. “FLUSHING DRAIN LINE” Flashing Signal occurs. 3. Learner checks that the tubing is clear of fibrin and the peritoneal cavity is at the same height as the control panel. Learner repositions self. And checks to see if a small amount of fluid should runs from their peritoneal cavity to the drain bag and display changes to read “GOOD NIGHT.”

4. After Setup remove drain tubing from valve . . . “ATTENTION DRAIN TUBING NOT LOADED” or “ATTENTION FILL TUBING NOT LOADED” Recoverable Alarm occurs. 4. Learner presses MUTE. Closes MiniSet. Clamps fill line with an outlet port clamp. Continue to follow the messages on the display screen. Press GO. Press GO to open (fill/drain valve opens). Load Tubing, Press Go to continue. Remove outlet port clamp on fill line, Open MiniSet. Press Go to continue. Return to treatment.

5. Leave Quantum PD™ System unplugged from electrical outlet and attempt to heat bag. Note: Heating occurs about 1 hour before fill is scheduled to start. “ATTENTION LOW BATTERY” Recoverable Alarm occurs. 5. Learner presses MUTE. Checks to make sure the power cord is securely plugged into the Quantum PD™ System and the grounded outlet. Learner securely plugs power cord into electrical outlet and checks that the picture of the battery leaves the display screen. Learner presses GO to continue the exchange. Learner states that they would leave the system on and plugged in for at least six hours to recharge the battery. NOTE: teacher may have learner verbalize or demonstrate the procedure for power failure.

6. At the start of a fill, clamp the fill line. “ATTENTION LOW FILL, CHECK TUBING, CHECK FILL BAG” Recoverable Alarm occurs. Note: it will take about 40 minutes for this alarm to occur; this alarm will not occur in the NOW Exchange mode. 6. Learner presses MUTE. Checks to see if the solution bag is full or empty. Teacher may choose to create both scenarios. If the solution bag is full: Learner checks the fill line is not blocked by fibrin, kinked tubing, a closed valve, etc. Learner unclamps fill line. When the fluid begins to flow, presses GO to return to the fill state. Learner states: If the fluid does not begin to flow, call 800 number or clinic for advice. If the solution bag is empty: learner presses GO to return to the fill state screen. Presses GO to disconnect and unload the bags. Calls the 800 number to report the alarm.

7. At the start of a drain, clamp the drain line . . . “ATTENTION LOW FLOW, CHECK TUBING” Recoverable Alarm occurs. 7. learner presses MUTE. Changes position. Checks for kinks and fibrin. Removes clamp from drain line. Verbalizes that they would also assess bowel patterns, enema if necessary or check to see that the previous fill volume is programmed correctly. Learner checks that the alarm goes away once the drain flow rate has gotten fast enough. If teacher desires have learner demonstrate the noncorrected situation below: NOTE: if the situation cannot be corrected but you have drained half of your previous fill volume, the system will allow you to BYPASS and start the fill mode. However, if you have drained less than half of your previous fill volume, the system will NOT show the BYPASS button and will NOT move to the fill mode. In this case, you will need to contact your clinic for instructions.

8. Show the learner a Picture of a Quantum PD™ System thermometer showing too cool and display reading “PLEASE WAIT FOR FLUID TEMPERATURE.” 8. Learner verbalizes and demonstrates: In the case where the thermometer icon show the solution to be too cold make sure the heater cover is closed. The solution will take up to one hour to warm up. In the unlikely case the thermometer icon shows the temperature of the solution to be too hot, then open the heater cover until the message is gone.

9. During drain, place a book on the drain tray on the weigh scale. “ATTENTION WEIGH SCALE DISTURBED” display occurs. 9. Learner removes the extra item from the drain tray; keep the drain bag on the tray. After one minute, if the item is not removed, the system will correct the disturbance by subtracting the item's weight. Learner presses GO to continue.

10. Show the learner a picture of a display showing a Non-Recoverable alarm. 10. Learner verbalizes they would: Press MUTE. Close your transfer set clamp. Clamp the fill line with an outlet port clamp. Write down the message, title, and serial number that appears on the screen. Turn the main power switch off. Call the 800 number to report the alarm.

The teacher needs to coach the learner to go through the 3 stages of the problem solving process, giving the learner more coaching at early attempts to problem solve, gradually decreasing the coaching as the learner begins to problem solve effectively. Questions such as “What do you see in this picture?”, “What do you know about . . . ?”, “Do you think that will work to solve the problem?” are examples of coaching in each stage of the problem solving process. You are guiding the learners thinking in the correct direction. In order to learn problem solving effectively the learner must see as many varied problems as possible. Continue presenting scenarios until learner is developing correct solutions and taking correct actions.

A motor skill cognitive lesson plan for the Quantum PD System “Putting It All Together” may include the objective of getting the learner to be able to repeat the critical steps for the Quantum PD System Unit from start to finish. Preferred MEDIA may include: Mask, Minicap, clamp, hand wipes, sink, paper towels, antibacterial pump soap, Quantum PD System, disposable extension set, UltraBag, practice apron with transfer set attached to saline bag, CAPD flow sheet, pencil, waste receptacle. Ultimately, the learner will repeat the critical steps for the Quantum PD System Unit. Preparation of the learner may include: “This lesson will focus on putting all of the Quantum PD System procedures together. I will demonstrate inserting the UltraBag, connecting the extension, connecting to the Quantum PD System and disconnecting from start to finish. Pay attention to what I am doing. When I am finished I will ask you to repeat the steps of the procedures. When you can repeat the steps without error it will be your turn to practice.” Activities will include: The learner Paying Attention and “Memorizing” pictures of steps. First Demonstration. (May use patient's own transfer set for demonstration if dialysis needed.) Second Demonstration—Point out critical steps, nuances (talk through what your hands are doing). Use condensed Motor Skill list as follows:

Brief Description of Logically Grouped Steps Label

1. Gather and inspect supplies. Gather and inspect supplies.

2. Position Quantum PD System, check red lever, lock if necessary. Raise lower arm. Raise upper arm, lock if necessary. Place the Quantum PD System.

3. Turn on the Quantum PD System. Place the UltraBag in the heater enclosure. Load the fill line and drain line. Place the drain bag on the drain tray. Place the UltraBag into the Quantum PD System.

4. Verify that the UltraBag fill bag is correctly placed inside the heater enclosure. J/D.

5. Verify that the UltraBag drain bag is correctly placed on the drain tray. J/D

6. Prepare self. Prepare the disposable extension set. Connect. Place the patient connector end in the line holder. Connect the disposable extension set to the UltraBag.

7. Remove the blue pull tab, remove the Minicap and connect. Press “GO”. Break the frangibles. Open the transfer set. Tape to abdomen. Connect to the Quantum PD System and initiate therapy.

8. Verify the exchange is finished. Clamp the lines. Prepare self. Disconnect. Press “GO”. Record the drain volume. Remove the UltraBag and dispose. End therapy and Disconnect from the Quantum PD System.

Then, Repetition. Third Demonstration—Shorten description—use labels from above. The learner should be able to Repeat labels from memory. If learner unable to repeat steps perform demonstration similar to demonstration #3.

A MOTOR SKILL—PRACTICE-LESSON PLAN for Quantum PD System “Putting It All Together” may provide for the learner to be able to correctly demonstrate the procedure for the Quantum PD System from start to finish. ACTIVITIES include: Using the supplies provided set up the Quantum PD System including connect and disconnect procedures. “Go ahead. It is your turn to practice.” Have adequate supplies for multiple practices. Continue to practice reducing errors to a minimum. Give feedback about what is being done correctly, stating the correct steps if needed. Constant commentary indicating those things that are done correctly and correcting errors by stating what should be done. Begin to monitor self, detecting errors and correcting them. Continue feedback. Repeat often enough for steps to become smooth, error free and automatic. Test for the automatic stage by asking the learner to perform the procedure while conversing with them. Topics should be unrelated to the procedure.

A next possible chapter/module could be a chapter on operating a specific peritoneal dialysis machine and associated tubing set and bag system. An example chapter of this sort may be a chapter on the Home Choice System. Sub-sections therefor follow.

### Chapter Introduction

### Home Choice™ Treatment

Suggested Teaching Order with Requisite Knowledge

| | | Type of | |
|---|---|---|---|
| No. | Lesson Plan | Learning | Requisite Knowledge |
| 1. | Home Choice ™ | MS | None |
| | Introduction | Cognitive | |
| 2. | Components of | Memory | None |
| | Home Choice ™ | | |
| | and Disposables | | |
| 3. | Placing the Home | Memory/ | Components |
| | Choice ™ | Habit | |
| | Cycler | | |
| 4. | Gathering | Memory | None |
| | Supplies | | |
| 5. | Gathering | Principle | Maintaining Asepsis, Gathering |
| | Supplies | | Supplies Memory |
| 6. | Gathering | Judgment/ | Gathering Supplies Principle |
| | Supplies | Decision | |
| 7. | Gathering | Problem | Gathering Supplies J/D |
| | Supplies | Solving | |
| 8. | Components of | Memory | None |
| | the Solution | | |
| | Bag | | |
| 9. | Opening | Motor | Solution Bag Components, Clamps |
| | Solution Bag | Skill | |
| 10. | Inspecting | Principle | Maintaining Asepsis, Components |
| | Solution Bag | | of Solution Bag |
| 11. | Inspecting | Decision/ | Inspecting Solution Bag Principle |
| | Solution Bag | Decision | |
| 12. | Inspecting | Problem | Inspecting Solution Bag J/D |
| | Solution Bag | Solving | |
| 13. | Prepare for Home | Motor | Maintaining Asepsis, Clamps, |
| | Choice ™ Set Up | Skill | Solution Bag Components, |
| | | | Gathering Supplies, Inspecting |
| | | | the Solutions Bag, Opening |
| | | | Opening the Solution Bag. |
| 14. | Turn Machine | Motor | Preparing for Home Choice ™ |
| | On Load | Skill | Set Up |
| | Cassette | | |
| 15. | Spiking the | Motor | Maintaining Asepsis, Clamps, |
| | Solution Bags | Skill | Components of Home Choice ™ |
| | | | and Disposables |
| 16. | Components of | Memory | None |
| | the CXD II ™ | | |
| 17. | Spiking the | Motor | Maintaining Asepsis, Clamps, |
| | Solution Bags | Skill | Components of CXD II ™, |
| | using the | | Components of Home Choice ™ |
| | CXD II ™ | | and Disposables. |
| 18. | Priming Cassette | Motor | Components of Home Choice ™ |
| | | Skill | and Disposables, Maintaining |
| | | | Asepsis. |
| 19. | Prepare Self | Simple | Transfer Set, Masking/Washing |
| | | Motor | Hands |
| | | Skill | |
| 20. | Connecting to | Motor | Maintaining Asepsis, Components |
| | the Home | Skill | of the Home Choice ™ |
| | Choice ™ and | | and Disposables, Prepare Self, |
| | Initiating | | Components of Transfer Set. |
| | Therapy | | Opening/Closing Transfer Set |
| 21. | EZ-Aide ™ | Motor | Maintaining Asepsis, Transfer |
| | Connect | Skill | Set/Clamps, Components of the |
| | | | Home Choice ™ and Disposables, |
| | | | Gathering Supplies, Prepare Self |
| 22. | Ending the | Motor | Maintaining Asepsis, Components |
| | Therapy | Skill | of the Home Choice ™ and |
| | | | Disposables, Components of |
| | | | Transfer Set, Opening/Closing |
| | | | Transfer Set. |
| 23. | EZ-Aide ™ | Motor | Maintaining Asepsis, Transfer |
| | Disconnect | Skill | Set/Clamps, Components of the |
| | | | Home Choice ™ and Disposables, |
| | | | Gathering Supplies, Prepare Self |
| 24. | Home Choice ™ | Memory | Components of Home Choice ™/ |
| | Recordkeeping | Habit | Disposables. |
| 25. | Disposal of | Memory | Components of Home Choice ™/ |
| | Effluent | Habit | Disposables. |
| 26. | Home Choice ™ | Memory | Maintaining Asepsis, Transfer Set/ |
| | Judgment/ | | Clamps, Prepare HC Set Up, turn |
| | Decision Points | | On Load Cassette, Spiking |
| | | | Solution Bags, Priming Cassette, |
| | | | Prepare Self, Connect to Home |
| | | | Choice ™ Cycler, |
| | | | Ending HC Therapy. |
| 27. | Incomplete Prime | Principle | Home Choice ™ Prepare HC |
| | | | Set Up, Turn On Load Cassette, |
| | | | Spiking, Priming Cassette, HC |
| | | | JD Memory Lesson, Air Infusion |
| | | | Problem Solving Lesson. |
| 28. | Incomplete Prime | Judgment/ | Incomplete Prime Principle |
| | | Decision | Lesson. |
| 29. | Incomplete Prime | Problem | Incomplete Prime J/D Lesson |
| | | Solving | |
| 30. | Home Choice ™ | Concept | Home Choice ™ Set Up |
| | Alarms | | Procedures |
| 31. | Home Choice ™ | Principle | Home Choice ™ Setup |
| | | | Procedures, Home |
| | Alarms | | Choice Alarm Concept |
| 32. | Home Choice ™ | Judgment/ | HC Alarms Principle Lesson |
| | Alarms | Decision | |
| 33. | Home Choice ™ | Problem | HC Alarms J/D Lesson |
| | Alarms | Solving | |
| 34. | Home Choice ™ | Motor | Entire Home Choice ™ |
| | Putting It | Skill | Unit |
| | All Together | | |
| 35. | Disconnecting | Motor | Maintaining Asepsis, Components |
| | During Therapy | Skill | of Home Choice ™, |
| | | | Transfer Set/Clamps. |
| 36. | Reconnecting | Motor | Maintaining Asepsis, Components |
| | During Therapy | Skill | of Home Choice ™, |
| | | | Transfer Set/Clamps. |
| 37. | Collecting an | Motor | Home Choice ™ Unit, |
| | Effluent Sample | Skill | Maintaining Asepsis |
| | | | Unit, Peritonitis Concept. |

These sub-sections are set forth below.

MOTOR SKILL—COGNITIVE-LESSON PLAN

Introduction.

OBJECTIVE: The learner will have a picture of what is involved in the Home Choice set-up and initiation of therapy.

KIND OF LEARNING: Motor Skill—Cognitive

This Lesson Plan is designed to give the learner an overview of the Home Choice procedure. The Detailed and condensed Motor Skill Analyses are separated into the phases of the procedure. The Practice portion of this Lesson Plan comes at the end—after the patient has learned each phase of the Home Choice procedure, and is ready to practice the entire procedure.

MEDIA: Mask, lap pad, clamp, CCPD flow sheet, pen, bleach solution, paper towel, sink, patient's transfer set, antibacterial soap in pump bottle, waste receptacle, Home Choice, Solution bags, Cassette, Drain line or bag, CXD (if to be used),

HOW WILL I EVALUATE WHETHER LEARNING HAS OCCURRED? The learner will have observed the entire Home Choice set-up and initiation of therapy from start to finish. There is no intention of testing the learner.

GETTING PATIENT READY TO LEARN: “I am going to begin your PD with the Home Choice cycler. I will demonstrate the procedure from set-up to initiation, as you will learn to do it. All I want you to do at this time is to pay attention and watch what I am doing. You will learn each component of the process at a later time.”

LEARNER ACTIVITY TEACHER ACTIVITY NOTES

1. Pay attention and watch closely. 1. Tell the learner to pay attention and watch closely. 1. Tell learner it's OK if they don't remember everything now, you only want them to get a picture of the entire process, and you will break down components to learn later.

2. Demonstrate the procedure from start to finish as it would ordinarily be done, starting at the very beginning with cleaning the work surface and ending with pressing “GO” to initiate therapy. 2. Keep conversation to a minimum. If questions arise, redirect the learner to just watch a this time, questions will be addressed at a later time as components of the process are taught.

MEMORY LEARNING LESSON PLAN

SUBJECT: Components of the Home Choice and Disposables

OBJECTIVE: The learner will be able to name the components of the Home Choice System.

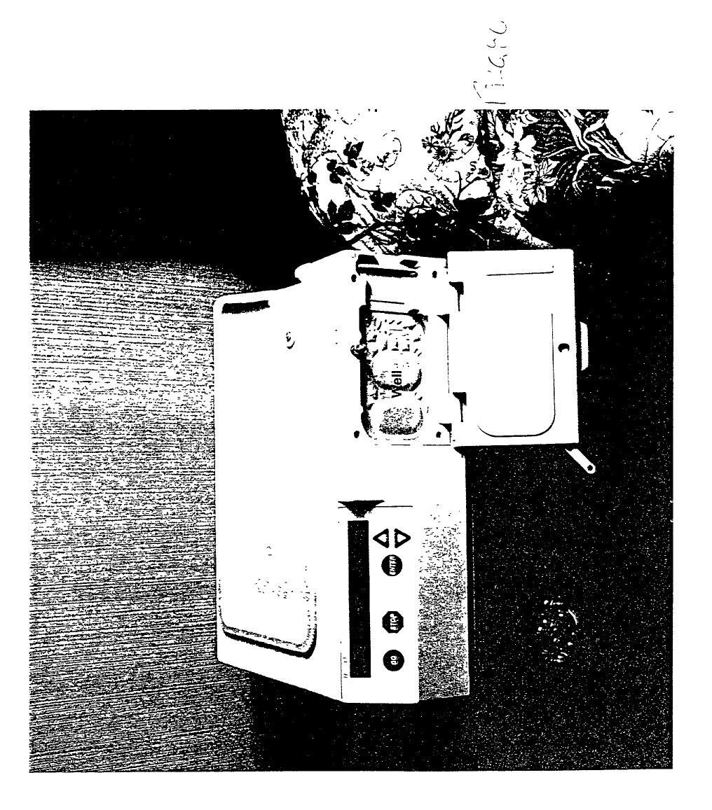

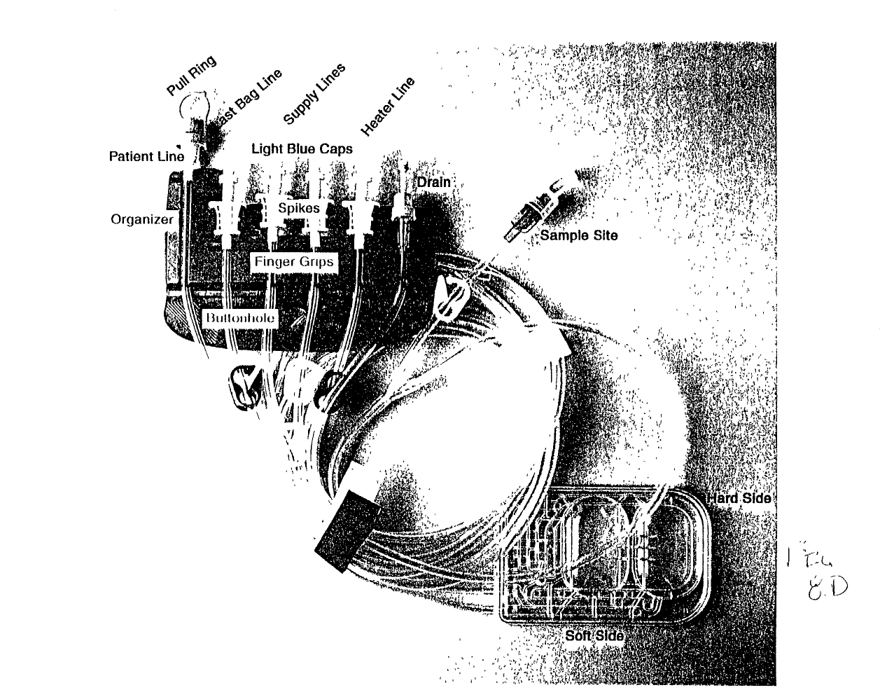

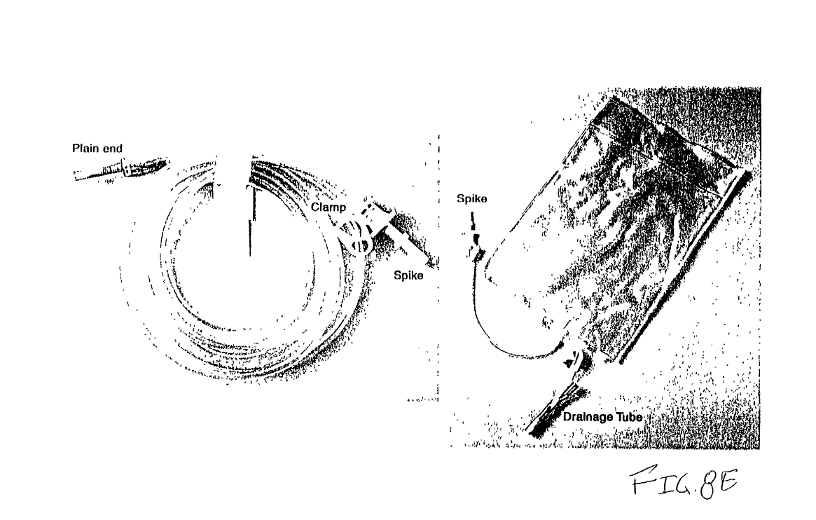

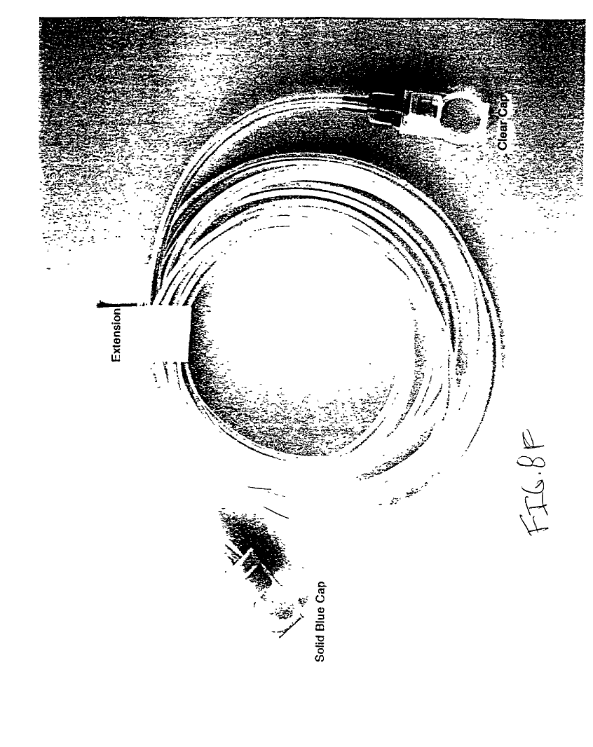

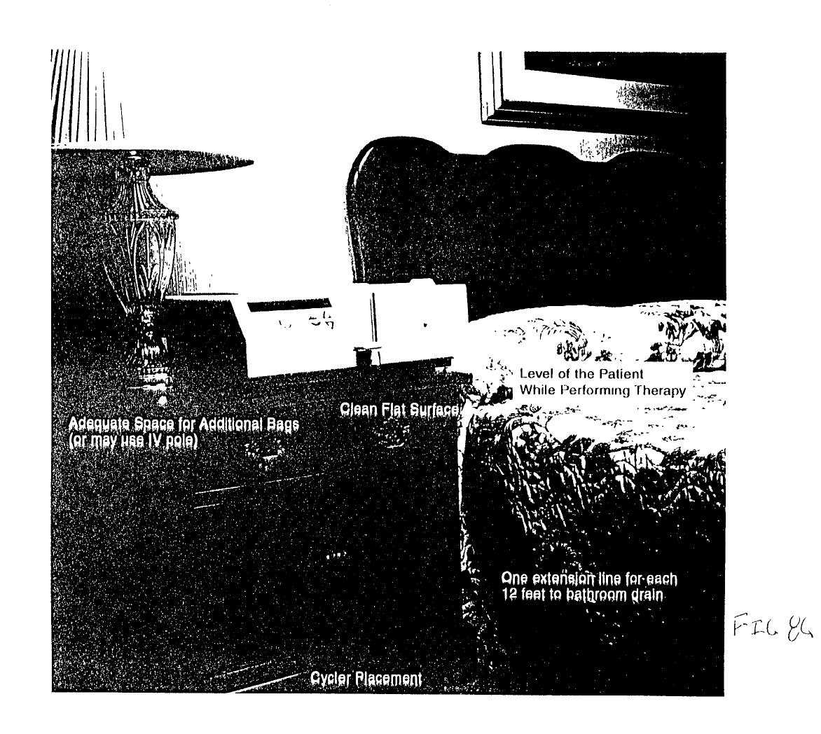

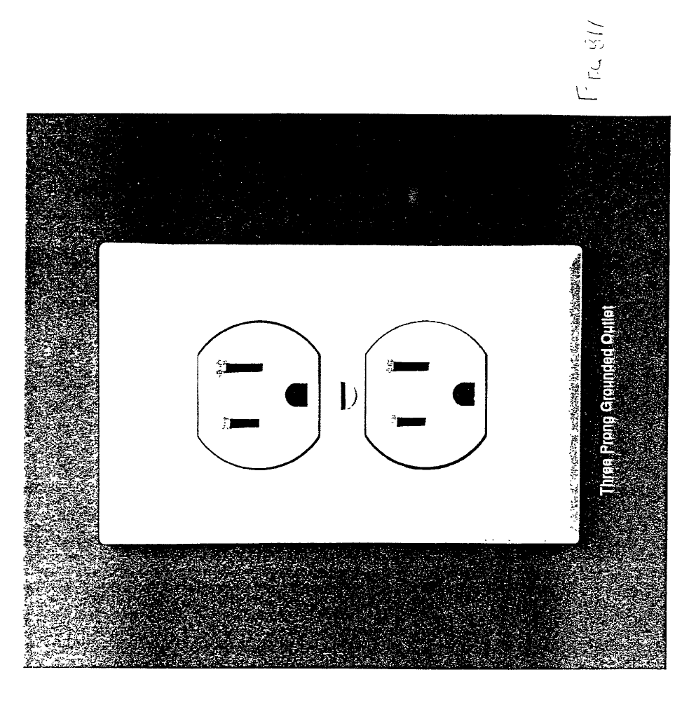

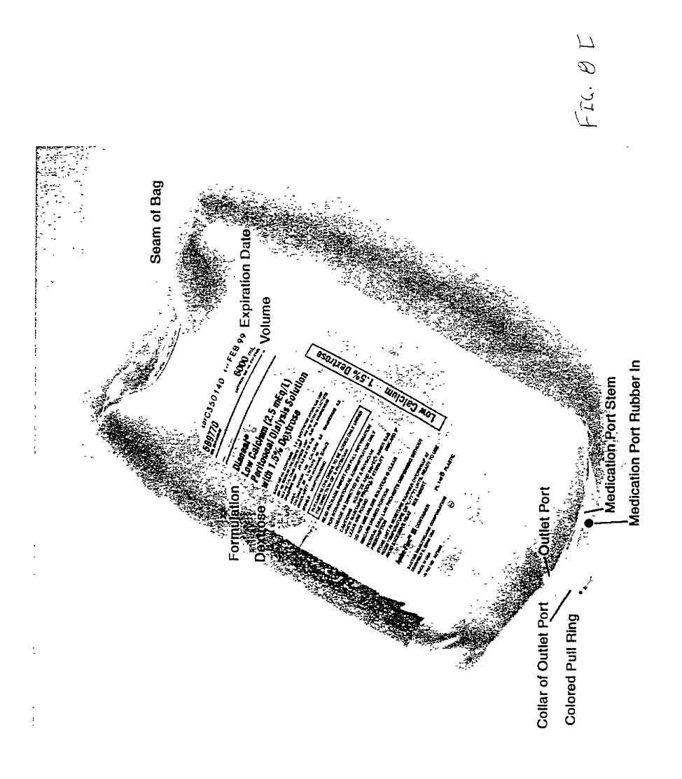

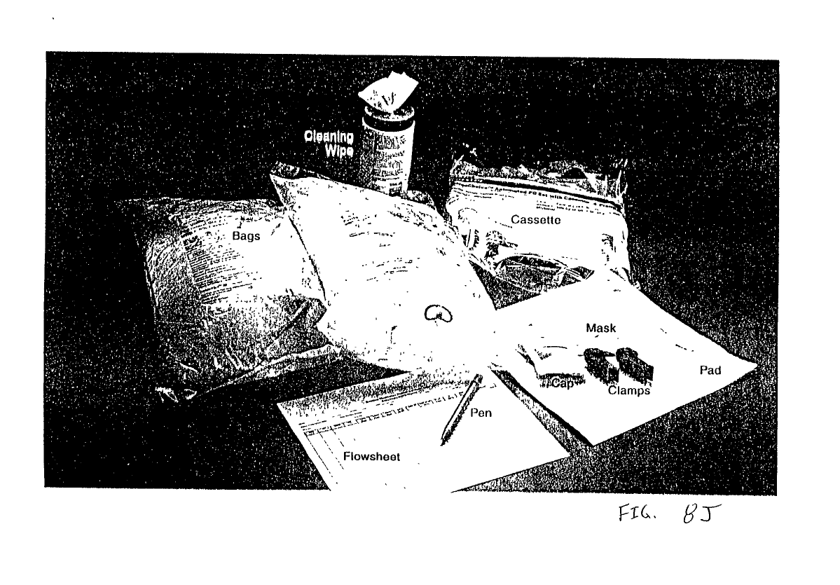

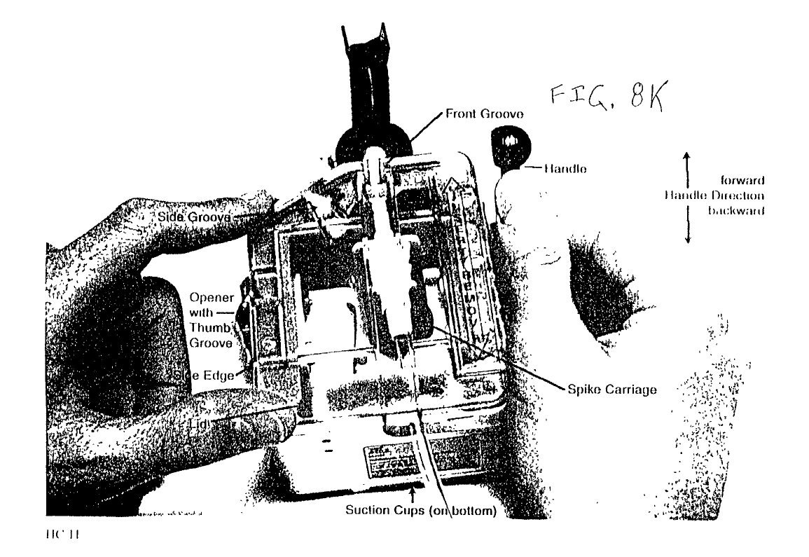

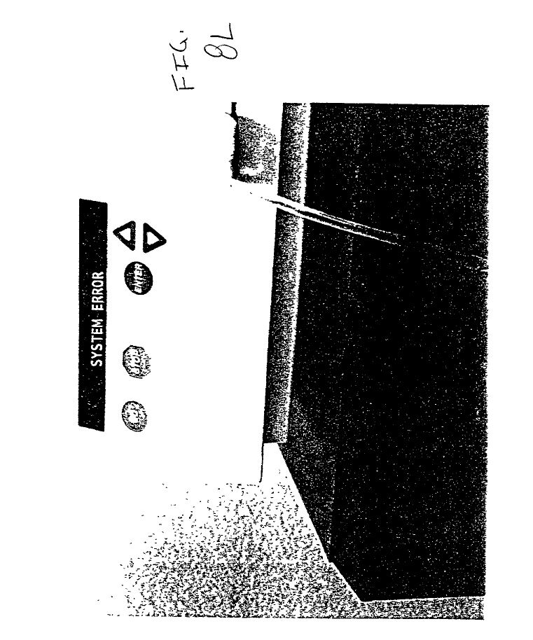

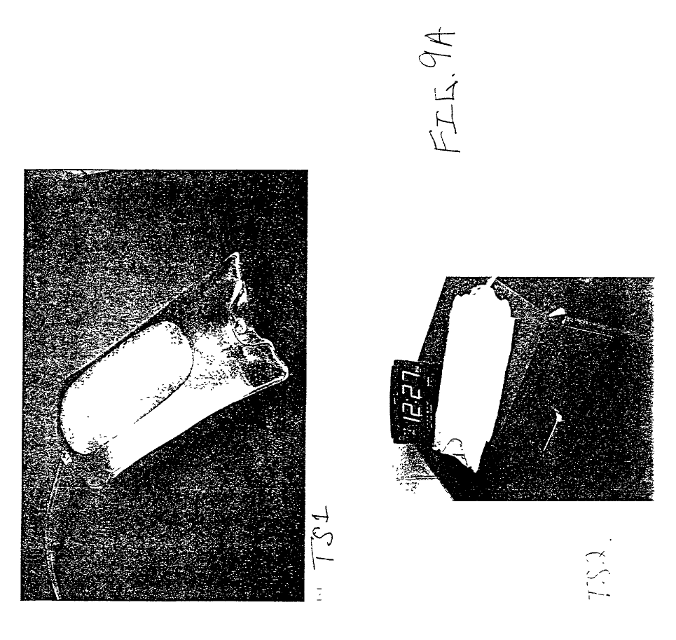

MEDIA: Picture labeled with the names of the components of the Home Choice Cycler, the disposable set, the optional patient extension line and the drain options(HC 1-6; FIGS. 8A-8F). An actual cycler, disposable set, patient extension line, and drain options or unlabeled pictures of each.

HOW WILL I EVALUATE WHETHER LEARNING HAS OCCURRED? The learner will correctly identify the components of the Home Choice. GETTING THE LEARNER READY TO LEARN: “At the end of this lesson you will know the parts of the cycler system. I'm going to show you the parts and give you the names of each one. I'll also show you pictures with all the parts labeled. Repeat the names either out loud or to yourself to help you remember them. When you feel you know all the names, we'll look at the actual components and I'll ask you to name them. We'll know you've learned it when you can name each part correctly.”

MEMORY LEARNING LESSON PLAN

SUBJECT: Placing the Home Choice Cycler

OBJECTIVE: The learner will be able to place the cycler correctly.

KIND OF LEARNING: Memory/ habit

MEDIA: Pictures showing Home Choice cycler correctly placed(HC 7-8; FIGS. 8G-8H).

REQUISITE KNOWLEDGE: Components of the Home Choice Cycler

HOW WILL I EVALUATE WHETHER LEARNING HAS OCCURRED? The learner will repeat the critical elements of proper cycler placement.

GETTING THE LEARNER READY: “Now you will learn how and where to place the cycler. I will show you some cards that describe the important points of cycler placement, and tell you about them. Pay attention to the features on the cards, and listen as I describe them. When you are ready, I will ask you to describe the proper cycler placement. We'll know that you've learned it when you can tell me the important points of cycler placement.”

LEARNER ACTIVITIES TEACHER ACTIVITIES NOTES

1. Repeat the information several times. 1. Present information to be memorized. Tell the learner to ask questions or “say after me”. 1. May wish to point out applicable features in the clinic, such as table height, grounded outlet. May wish to review the lesson in the patient's home.

2. Form own associations. 2. Present mnemonics—may ask patient questions to form own associations.

3. Practice/Test. 3. Question and provide feedback.

MEMORY LEARNING ANALYSIS

SUBJECT: Placing the Home Choice Cycler

List of information to be memorized Mnemonics(s) or other helpful memory aids or memorization strategies

1. Home Choice should be placed on a clean flat surface at the level of the patient while performing the therapy. 1. Picture showing proper positioning of Home Choice(HC 7).

2. Space should be adequate to support additional bags for therapy either on the surface, atop the heater bag, or if space does not permit, an IV pole may be used.

3. Home Choice should be plugged into a three prong grounded outlet. (HC 8)

4. If patient desires to use drain lines, one should be used for each 12 feet from drain source. 4. Placement in sink, toilet, or tub to be covered in Home Choice setup lesson.

5 If patient desires to use a drain bag, it should be placed close to the cycler.

MEMORY LEARNING LESSON PLAN

SUBJECT: Gathering Supplies

OBJECTIVE: The learner will be able to name the supplies needed for a Home Choice treatment, and gather them from a supply cabinet.

MEDIA: Face mask, solution bag, cassette, outlet port clamp, drain line or extension, mini cap, lap pad, CCPD flowsheet, pen, Patient extension (optional), cleaning wipes, CXD (if used), gloves if instructed. Card with items listed. Photo of materials labeled (HC 10; FIG. 8J).

HOW WILL I EVALUATE WHETHER LEARNING HAS OCCURRED? The learner will name the supplies are needed. The learner will choose correct supplies from a large grouping of supplies (begins behavior pattern).

GETTING THE LEARNER READY: “Now you are going to memorize a list of the supplies you will need to for a cycler session. I will show you the supplies needed and tell you what they are. Look carefully at the supplies, repeat the list in your mind. When you feel that you know what supplies you need, I'll ask you to get them from the supply cabinet”.

LEARNER ACTIVITIES TEACHER ACTIVITIES NOTES

1. Look at the supplies. 1. Place supplies on the table. Identify each. Supplies: Face mask, solution bag, cassette, outlet port clamp, drain line or bag, mini cap, lap pad, pt extension (optional), cleaning wipes, gloves if instructed, CXD if used.

2. Repeat the list. 2. Ask the learner to repeat.

3. Use the flash cards. 3. Use the cards with all items listed and cards with missing items. Ask the pt to name the missing item.

4. Use “Mother Bakes Perfect Crunchy Chocolate Chip Cookies Daily”. 4. Help them use the mnemonic, mother bakes perfect crunchy chocolate chip cookies daily for people. 4. If the patient is using an extension line, the mnemonic becomes mother bakes perfect crunchy chocolate chip cookies every day. If the patient is using the integrated set the mnemonic becomes mother bakes perfect crunchy chocolate chip cookies for people.

5. List supplies from memory. 5. Test by asking for the list.

6. Go to the supply shelf and bring back the needed items. 6. Test by sending to the shelf for supplies. 6. Include on the supply shelf items that are not needed.

MEMORY LEARNING ANALYSIS

SUBJECT: Gathering Supplies for Home Choice Cycler

List of information to be memorized Mnemonic(s) or other helpful memory aids or memorization strategies

Face Mask; Solution Bags; Lap Pad; Home Choice Cassette; Mini Cap; Outlet Port Clamp; Cleaning wipes; Flowsheet; Pen; Drain line or Drain Bag; Patient Extension Line (optional)gloves—if instructed CXD (if used) MotherBakes PerfectCrunchyChocolate ChipCookiesFor PeopleDailyIf patient uses an extension—mnemonic becomes “Mother bakes perfect crunchy chocolate chip cookies for people every day.” If patient uses the integrated cassette—mnemonic becomes “Mother bakes perfect crunchy chocolate chip cookies for people.”

PRINCIPLE LEARNING LESSON PLAN

SUBJECT: Gathering Supplies

OBJECTIVE: Learner will be able to identify supplies that are unacceptable/acceptable to use.

MEDIA: solution bag with outside wrapper intact, solution bag with outer wrapper that is soiled and/or torn, solution bag with obvious fluid in the outer bag, soiled pad, minicap that past expiration date, cassette with sterile caps dislodged, cassette with damaged “soft side”, patient extension with caps dislodged.

REQUISITE KNOWLEDGE: Maintaining Asepsis Unit, Memory Lesson Gathering Supplies.

HOW WILL I EVALUATE WHETHER LEARNING HAS OCCURRED? Learner will state the principle, “If a supply is not sterile or clean, then it should not be used.”

GETTING THE LEARNER READY: “You have learned about clean and dirty and sterile and unsterile. You have also memorized the supplies needed to do a Home Choice Treatment. Now you are going to learn how to determine if the supplies are usable or not. I will show you some supplies and ask you to guess whether or not they are usable. Don't be afraid to guess wrong, that is how you learn. When you are guessing correctly I will ask you why and if you answer correctly, then we will know you understand how to determine if supplies are OK.”

LEARNER ACTIVITY TEACHER ACTIVITY NOTES

1. Pay attention to concepts. 1. Review concepts and state principles.

2. Guess. 2. Teacher presents scenarios and asks learner to guess. Give feedback re: accuracy of description.

3. Continue guessing as scenarios that are examples and non-examples are presented. 3. Continue to present examples and non-examples until learner is guessing correctly most of the time.

4. Restate the principles linking the concepts. 4. Have learner restate the principle in their own words.

PRINCIPLE LEARNING ANALYSIS

List of Concepts Linked to Form Principle

If a supply is not sterile or clean, then it should not be used.

Suggested Scenarios

Face mask intact and unused. Solution Bag1. Outside wrapper clean and intact.2. Outside wrapper without sloshy fluid inside.3. Correct dextrose.4. Correct volume.5. Correct formulation.6. Current expiration. Lap pad clean and unused. Minicap(s)1. Current expiration.2. Unopened and unsoiled.Clamps1. Clean and dry.2. In good working condition. Cleaning wipes1. Inside of the container.2. Clean and unused.Cassette1. Intact.2. Lines in appropriate slots.3. Spike covers in place.4. Pull tabs in place.5. Clamps present and open.

Suggested Scenarios

Drain line/Drain Bag1. Packaging intact.2. Pull tabs in place. Patient Extension Line1. Packaging intact.2. End caps in place.

JUDGMENT/DECISION LEARNING LESSON PLAN

SUBJECT: Gathering Supplies

OBJECTIVE: Learner will be able to state if a supply is usable and if not, state correct action to take.

MEDIA: See Gathering Supplies Principle Learning Lesson

REQUISITE KNOWLEDGE: Gathering Supplies Principle Learning Lesson

HOW WILL I EVALUATE WHETHER LEARNING HAS OCCURRED? When presented with various supplies, learner states if they are usable, and if not, states appropriate action to take.

GETTING THE LEARNER READY: “Now that you can determine if a supply is usable or not, it is time to learn what to do if you come across an unusable supply. I will show you some supplies and suggest some actions for you take if you find supplies like these. You just pay attention and try to memorize the correct actions. We will know that you have learned what to do when you can repeat to me what you should do if you find an usable supply.”

LEARNER ACTIVITIES TEACHER ACTIVITIES NOTES

1. Pay attention and recall the concepts of maintaining asepsis. 1. Review associated concepts. 1. Maintaining Asepsis Unit.

2. Pay attention. 2. State the principles.

3. Pay attention. 3. Present what the learner should be looking for and possible action steps that should be taken. 3. Supplies: include supplies that are not usable because of past expiration dates, etc.

4. Repeat the judgment and decision. Identify supplies as usable or unusable. Give reason that supply was chosen as usable or unusable. 4. Ask the learner to repeat the action steps.

5. Process feedback. 5. Provide feedback. 5. Continue until the learner has memorized.

JUDGMENT/DECISION LEARNING ANALYSIS

LIST OF PRINCIPLES USED TO MAKE THE JUDGEMENT/DECISION:

If a supply is not sterile or clean, then it should not be used.

What the Learner should be looking for?(Judgments) What choice(s)/possible action steps should be taken? (Decisions) Some judgments will have several action steps.

Face mask intact and unused. Discard supply. Solution Bag1. Outside wrapper clean and intact.2. Outside wrapper without sloshy fluid inside.3. Correct dextrose.4. Correct volume.5. Correct formulation.6. Current expiration. Discard supply. Return to supply closet for correct solution.

Lap pad clean and unused. Discard supply. Minicap(s)1. Current expiration.2. Unopened and unsoiled. Discard supply. Clamps1. Clean and dry.2. In good working condition. Discard supply. Clean supply with bleach solution. Let air dry.

Cleaning wipes1. Inside of the container.2. Clean and unused. Discard supply. Pull out another cleaning wipe.

Cassette1. Packaging and cassette intact.2. Lines in appropriate slots.3. Spike covers in place.4. Pull tabs in place.5. Clamps present and open. Discard supply. Return to supply closet for intact supply. Place lines in appropriate slots. Discard supply. Return to supply closet for intact supply.

Drain Line/Drain Bag1. Packaging intact.2. Pull tabs in place. Discard supply. Return to supply closet for intact supply.

What the Learner should be looking for?(Judgments) What choice(s)/possible action steps should be taken? (Decisions) Some judgments will have several action steps.

Patient Extension Line1. Packaging intact.2. End caps in place. Discard supply. Return to supply cabinet for intact supply.

PROBLEM SOLVING LESSON PLAN

SUBJECT: Gathering Supplies

OBJECTIVE: The learner will be able to identify usable/unusable supplies and take the appropriate action.

MEDIA: See Gathering Supplies Principle Lesson

REQUISITE KNOWLEDGE: Gathering Supplies Judgment/Decision Lesson

HOW WILL I EVALUATE WHETHER LEARNING HAS OCCURRED? When presented with scenarios, the learner will identify usable/unusable supplies and take appropriate action.

GETTING THE LEARNER READY: “You've learned about usable and unusable supplies and what to do if you do find an unacceptable supply. Now I will give you problem examples, ask you to tell me what you see, what you know about the situation and what you would do if this happened to you. I will help you along in working through the situation, so don't be afraid. When you can take the correct action, then we will know you can solve this problem at home.”

LEARNER ACTIVITY TEACHER ACTIVITY NOTES

1. Pay attention and recall the concepts. 1. Review associated concepts. 1. Maintaining Asepsis/Gathering Supplies

2. Pay attention. 2. State the principles. 2. “If a supply is not sterile or clean, then it should not be used.”

3. Solve problems and take correct actions. 3. Present scenario(s) and ask learner to identify the and solve the problem. 3. Teacher may need to prompt learner to solve the problem i.e.” What is happening here?”, “What do you know about this?”, and “What do you think you should do?”. If the learner is having difficulty identifying the problem then go back and review associated concepts. ** Problem solutions to include unit specific standing orders.

4. Process feedback. 4. Continue feedback. 4. Continue presenting scenarios until learner is developing correct solutions and taking correct actions.

PROBLEM SOLVING LEARNING ANALYSIS

LIST OF PRINCIPLES USED TO SOLVE THE PROBLEM:

If a supply is not sterile or clean, then it should not be used.

Problem Scenario Problem Solution

1. After an exchange hang your mask on the IV pole and tell the learner you will use it again. 1. Learner will tell you to discard mask.

2. Give the learner a solution bag with obvious fluid in the outer wrapper. 2. Learner discards bag and returns to supply closet for another.

3. Give the learner a solution bag with soiled/torn outer wrapper. 3. Learner discards bag and returns to supply closet for another.

4. Give the learner an expired Dianeal to use for an exchange. 4. Learner discards expired bag and returns to supply closet for correct solution.

5. Give the learner the incorrect dextrose for an exchange. 5. Learner does not use bag and returns to supply closet for correct solution.

6. Give the learner the incorrect volume for an exchange. 6. Learner does not use bag and returns to supply closet for correct solution.

7. Give the learner a dirty lap pad to use for an exchange. 7. Learner discards pad and gets a clean one.

8. Drop a clamp on the floor and return it to the supply closet (in view of learner). 8. Learner retrieves clamp and washes it.

9. Ask the learner to save his hand wipe to use again. 9. Learner refuses and discards wipe.

10. Give the learner cassette with sterile caps dislodged. 10. Learner discards cassette and returns to supply closet for new one.

11. Give learner cassette with damaged “soft side”. 11. Learner discards cassette and returns to supply closet for new one.

12. Give learner a patient extension line with caps dislodged inside wrapper. 12. Learner discards extension and returns to supply closet for new one.

MEMORY LEARNING LESSON PLAN

SUBJECT: Components of the Solution Bag

OBJECTIVE: The learner will be able to name from memory all components of the Solution Bag.

MEDIA: Picture of Solution Bag with components labeled (HC9), unlabeled solution bag.

HOW WILL I EVALUATE WHETHER LEARNING HAS OCCURRED? The learner will name all component parts of an unlabeled Solution Bag.

GETTING THE LEARNER READY: “Now you are going to learn the components of the Solution Bag. I will show you a labeled Solution Bag and tell you the names of the component parts. I will ask you to repeat the names of the components. We will know you have learned this when you can name all the parts of an unlabeled bag.”

LEARNER ACTIVITIES TEACHER ACTIVITIES NOTES

1. Repeat the names of the component parts. 1. Show labeled Solution Bag picture, read the labels and point out component parts.

2. Form own associations. Look at the picture and the unlabeled Solution Bag. 2. Listen to learner repeat the parts and provide feedback.

3. Practice/Test. Name the components using an unlabeled Solution Bag. 3. Test by asking learner to identify components on Solution Bag.

MEMORY LEARNING ANALYSIS

SUBJECT: Components of the Solution Bag

List of Information to be Memorized Mnemonic(s) or other helpful memory aids or memorization strategies.

Seam of Bag Expiration Date VolumeFormulationDextroseMedication Port Rubber End Medication Port Stem Colored pull ring Outlet Port Collar of outlet port Use visual picture of labeled Solution Bag (HC 9; FIG. 8I) and compare to unlabeled Solution Bag.

MOTOR SKILL—COGNITIVE-LESSON PLAN

SUBJECT: Opening Solution Bag

OBJECTIVE: The learner will be able to repeat steps of opening the Solution Bag.

MEDIA: Unopened Solution Bag, Clamp.

REQUISITE KNOWLEDGE: Solution Bag Components, Clamps.

HOW WILL I EVALUATE WHETHER LEARNING HAS OCCURRED? The learner will repeat critical steps of opening the Solution Bag.

GETTING THE LEARNER READY: “In this lesson you will learn how to open the Solution Bag. I will show you how to open the Solution Bag. Watch closely to what I do until you are able to repeat them without any errors.”

LEARNER ACTIVITIES TEACHER ACTIVITIES NOTES

1. Pay attention. “Memorize” critical steps. 1. First Demonstration. 1. Learner may also open wrapper by tearing it at the slits.

2. Determine “critical steps”. 2. Second Demonstration—Point out critical steps, talk through what your hands are doing. 2. Reassure learner that clamp will not damage the Solution Bag. Use detailed Motor Skill Analysis.

3. Repetition. 3. Third Demonstration—Shorten description, use labels from condensed version.

4. Repeat labels from memory. 4. Give feedback.

MOTOR SKILL—PRACTICE-LESSON PLAN

SUBJECT: Opening Solution Bag

OBJECTIVE: The learner will be able to open Solution Bag wrapper.

MEDIA: Same as for Cognitive Lesson Plan for this Motor Skill.

REQUISITE KNOWLEDGE: Cognitive Lesson for this motor skill.

HOW WILL I EVALUATE WHETHER LEARNING HAS OCCURRED? The learner successfully opens the Solution Bag.

GETTING THE LEARNER READY: “Now it is your turn to practice opening the Solution Bag. I will give you Solution Bags to practice with. It's O.K. to make mistakes, that's how you learn. Go ahead and open the bags until you can do it successfully each time.”

LEARNER ACTIVITIES TEACHER ACTIVITIES NOTES

1. Practice opening the bags. 1. Tell learner to go ahead and practice. 1. Provide bags for practice. Expired bags of solution may be used for practice.

2. Reduce errors to a minimum. 2. Provide immediate, accurate feedback focused on what is correct.

3. Correct errors. 3. Continue feedback.

4. Repeat often enough until steps become smooth and without error. 3. Test for the automatic stage.

MOTOR SKILL ANALYSIS—DETAILED

SUBJECT: Opening Solution Bag

Steps to Take Tricks of the Trade

1. Place Solution Bag lengthwise on work surface directly in front of you.

2. Pick up a clamp with your right hand and close it. Previously learned motor skill.

3. Grasp the upper left hand corner of the Solution Bag wrapper with your left hand. Hold the clamp so the ends of the clamp touch the upper left hand corner of the wrapper below where your are holding the wrapper with your left hand. Firmly drag the clamp across the wrapper diagonally to the lower right hand corner, ripping the wrapper. Learner may also open wrapper by tearing open at slits on the wrapper.

4. Open the clamp and put it down. Previously learned motor skill.

5. Tear the wrapper open at the rip and remove the Solution Bag.

MOTOR SKILLS ANALYSIS—CONDENSED

SUBJECT: Opening Solution Bag

Brief Description of Logically Grouped Steps Label

1. Place Solution Bag on clean work surface. Close clamp. Drag clamp across bag. Remove Solution Bag from wrapper.Remove Solution Bag from wrapper.

PRINCIPLE LEARNING LESSON PLAN

SUBJECT: Inspecting Solution Bags

OBJECTIVE: Learner will be able to identify solution bags that are unacceptable/acceptable to use.

MEDIA: Solution bag intact, solution bags with rubber pull ring partially removed, cloudy fluid, obvious fluid in outer wrapper. Card listing Critical Features.

REQUISITE KNOWLEDGE: Maintaining Asepsis Unit, Memory Lesson Gathering Supplies.

HOW WILL I EVALUATE WHETHER LEARNING HAS OCCURRED? Learner will state the principle, “If dialysate is not sterile, then it should not be used.”

GETTING THE LEARNER READY: “You have learned about sterile and unsterile. You have also memorized the components of the solution bag. Now you are going to learn how to determine if the solution bag are usable or not. I will show you some solution bags and ask you to guess whether or not they are usable. Don't be afraid to guess wrong, that is how you learn. When you are guessing correctly I will ask you why and if you answer correctly, then we will know you understand how to determine if supplies are OK.”

LEARNER ACTIVITY TEACHER ACTIVITY NOTES

1. Pay attention to concepts. 1. Review concepts and state principles.

2. Guess. 2. Teacher presents scenarios and asks learner to guess. Give feedback re: accuracy of description.

3. Continue guessing as scenarios that are examples and non-examples are presented. 3. Continue to present examples and non-examples until learner is guessing correctly most of the time.

4. Restate the principles linking the concepts. 4. Have learner restate the principle in their own words.

PRINCIPLE LEARNING ANALYSIS

SUBJECT: Inspecting Solution Bags

List of Concepts Linked to Form Principle

If a dialysate is not sterile, then it should not be used.

Suggested Scenarios

1. Solution bag intact. 2. Solution bags with rubber pull ring partially removed. 3. Solution bag with cloudy fluid. 4. Solution bag with obvious fluid in outer wrapper.

PRINCIPLE LEARNING LESSON PLAN

SUBJECT: Inspecting Solution Bags

OBJECTIVE: Learner will be able to identify solution bags that are unacceptable/acceptable to use.

MEDIA: Solution bag intact, solution bags with rubber pull ring partially removed, cloudy fluid, obvious fluid in outer wrapper. Card listing Critical Features.

REQUISITE KNOWLEDGE: Maintaining Asepsis Unit, Components of Solution Bag.

HOW WILL I EVALUATE WHETHER LEARNING HAS OCCURRED? Learner will state the principle, “If dialysate is not sterile, then it should not be used.”

GETTING THE LEARNER READY: “You have learned about sterile and unsterile. You have also memorized the components of the solution bag. Now you are going to learn how to determine if the solution bag are usable or not. I will show you some solution bags and ask you to guess whether or not they are usable. Don't be afraid to guess wrong, that is how you learn. When you are guessing correctly I will ask you why and if you answer correctly, then we will know you understand how to determine if supplies are OK.”

LEARNER ACTIVITY TEACHER ACTIVITY NOTES

1. Pay attention to concepts. 1. Review concepts and state principles.

2. Guess. 2. Teacher presents scenarios and asks learner to guess. Give feedback re: accuracy of description.

3. Continue guessing as scenarios that are examples and non-examples are presented. 3. Continue to present examples and non-examples until learner is guessing correctly most of the time.

4. Restate the principles linking the concepts. 4. Have learner restate the principle in their own words.

PRINCIPLE LEARNING ANALYSIS

SUBJECT: Inspecting Solution Bags

List of Concepts Linked to Form Principle

If a dialysate is not sterile, then it should not be used.

Suggested Scenarios

1. Solution bag intact. 2. Solution bags with rubber pull ring partially removed. 3. Solution bag with cloudy fluid. 4. Solution bag with obvious fluid in outer wrapper.

JUDGMENT/DECISION LEARNING LESSON PLAN

SUBJECT: Inspecting Solution Bags

OBJECTIVE: Learner will be able to state if a solution bag is usable and if not, state correct action to take.

MEDIA: See Inspecting Solution Bags Principle Learning Lesson

REQUSITE KNOWLEDGE: Inspecting Solution Bags Principle Learning Lesson

HOW WILL I EVALUATE WHETHER LEARNING HAS OCCURRED? When presented with solution bags, learner states if they are usable, and if not, states appropriate action to take.

GETTING THE LEARNER READY: “Now that you can determine if a solution bag is usable or not, it is time to learn what to do if you come across an unusable solution bag. I will show you some solution bags and suggest some actions for you take if you find solution bags like these. You just pay attention and try to memorize the correct actions. We will know that you have learned what to do when you can repeat to me what you should do if you find an usable supply.”

LEARNER ACTIVITIES TEACHER ACTIVITIES NOTES 1. Pay attention and recall the concepts of maintaining asepsis. 1. Review associated concepts. 1. Maintaining Asepsis Unit. 2. Pay attention. 2. State the principles. 3. Pay attention. 3. Present what the learner should be looking for and possible action steps that should be taken.

4. Repeat the judgment and decision. Identify supplies as usable or unusable. Give reason that supply was chosen as usable or unusable. 4. Ask the learner to repeat the action steps.

5. Process feedback. 5. Provide feedback. 5. Continue until the learner has memorized.

JUDGMENT/DECISION LEARNING ANALYSIS

SUBJECT: Inspecting Solution Bags

LIST OF PRINCIPLES USED TO MAKE THE JUDGEMENT/DECISION:

If a dialysate is not sterile, then it should not be used.

What the Learner should be looking for?(Judgments) What choice(s)/possible action steps should be taken? (Decisions) Some judgments will have several action steps.

1. Solution bag intact. 1. Okay to use.

2. Solution bag with rubber pull ring partially removed. 2. Discard, obtain new solution bag.

3. Solution bag with cloudy fluid. 3. Discard, obtain new solution bag.

4. Solution bag with obvious fluid leak. 4. Discard, obtain new solution bag.

JUDGMENT/DECISION LESSON PLAN

SUBJECT: Inspecting the Solution Bag

OBJECTIVE: The learner will be able to inspect a Solution Bag and make a decision whether it is usable or unusable.

MEDIA: Solution Bags that are usable and unusable:

1. Rubber pull ring intact and partially removed.

2. Expiration date past.

3. Cloudy fluid.

4. Card with critical features of inspection.

REQUISITE KNOWLEDGE: Solution Bag Components, Maintaining Asepsis Unit, Opening the Solution Bag.

HOW WILL I EVALUATE WHETHER LEARNING HAS OCCURRED? The learner will choose the usable bag when given a scenario by the teacher.

GETTING THE LEARNER READY: “Now you are going to learn to inspect a Solution Bag and decide if it is OK to use or not. I'm going to tell you the things you need to check. I will show you some examples of usable and unusable bags. I will tell you when you need to discard the bag and when you will return the bag and select a different one. Listen carefully to the items that need to be checked because I will ask you to repeat them back to me. Then I will give you Solution Bags for you to check and you tell me if the bag is usable or not. If the Solution Bag is not usable you will either return it and get a different bag or you will discard it.”

LEARNER ACTIVITIES TEACHER ACTIVITIES NOTES

1. Pay attention and recall the concepts of asepsis. 1. Review associated concepts. 1. Maintaining Asepsis Unit.

2. Pay attention. 2. State the principles.

3. Pay attention. 3. Present what the learner should be looking for and possible action steps that should be taken. Show the card that describes the critical features. Have the learner pick up a Solution Bag and find the critical features. 3. The purpose of this lesson is to et the learner to memorize when judgments should be made and the correct actions that should be taken.

4. Repeat the judgment and decision. 4. Ask the learner to repeat the action steps.

5. Process feedback. 5. Provide feedback. 5. Continue until the learner has critical features memorized.

JUDGEMENT/DECISION LEARNING ANALYSIS

SUBJECT: Inspecting the Solution Bag

What should the learner be looking for?(Judgments) What choice(s)/possible action steps should be taken?

1. Solution Bag a. No Leaks b. Fluid Clear. 1. Return supply to closet. Use supply. Discard supply. Call clinic to question prescription.

1. Rubber Pull Ring a. Intact. b. Completely covering patient connector end.

2. Either use supply or discard supply.

3. Medication Port Rubber End and Stem—In place and intact. 3. Either use supply or discard supply.

PROBLEM SOLVING LESSON PLAN

SUBJECT: Inspecting Solution Bags

OBJECTIVE: The learner will be able to identify usable/unusable solution bags and take the appropriate action.

MEDIA: See Inspecting Solution Bags Principle Lesson

REQUISITE KNOWLEDGE: Inspecting Solution Bags Judgment/Decision Lesson

HOW WILL I EVALUATE WHETHER LEARNING HAS OCCURRED? When presented with scenarios, the learner will identify usable/unusable solution bags and take appropriate action.

GETTING THE LEARNER READY: “You've learned about usable and unusable solution bags and what to do if you do find an unacceptable solution bag. Now I will give you problem examples, ask you to tell me what you see, what you know about the situation and what you would do if this happened to you. I will help you along in working through the situation, so don't be afraid. When you can take the correct action, then we will know you can solve this problem at home.”

LEARNER ACTIVITY TEACHER ACTIVITY NOTES

1. Pay attention and recall the concepts. 1. Review associated concepts. 1. Maintaining Asepsis/Gathering Supplies

2. Pay attention. 2. State the principles. 2. “If a supply is not sterile or clean, then it should not be used.”

3. Solve problems and take correct actions. 3. Present scenario(s) and ask learner to identify the and solve the problem. 3. Teacher may need to prompt learner to solve the problem i.e.” What is happening here?”, “What do you know about this?”, and “What do you think you should do?”. If the learner is having difficulty identifying the problem then go back and review associated concepts. ** Problem solutions to include unit specific standing orders.

4. Process feedback. 4. Continue feedback. 4. Continue presenting scenarios until learner is developing correct solutions and taking correct actions.

PROBLEM SOLVING LEARNING ANALYSIS

SUBJECT: Gathering Supplies

PROBLEM DESCRIPTION: Unusable supplies

LIST OF PRINCIPLES USED TO SOLVE THE PROBLEM:

If a supply is not sterile or clean, then it should not be used.

Problem Scenario Problem Solution

1. After an exchange hang your mask on the IV pole and tell the learner you will use it again. 1. Learner will tell you to discard mask.

2. Give the learner a solution bag with obvious fluid in the outer wrapper. 2. Learner discards bag and returns to supply closet for another.

3. Give the learner a solution bag with soiled/torn outer wrapper. 3. Learner discards bag and returns to supply closet for another.

4. Give the learner an expired Dianeal to use for an exchange. 4. Learner discards expired bag and returns to supply closet for correct solution.

5. Give the learner the incorrect dextrose for an exchange. 5. Learner does not use bag and returns to supply closet for correct solution.

6. Give the learner the incorrect volume for an exchange. 6. Learner does not use bag and returns to supply closet for correct solution.

7. Give the learner a dirty lap pad to use for an exchange. 7. Learner discards pad and gets a clean one.

8. Drop a clamp on the floor and return it to the supply closet (in view of learner). 8. Learner retrieves clamp and washes it.

9. Ask the learner to save his hand wipe to use again. 9. Learner refuses and discards wipe.

10. Give the learner cassette with sterile caps dislodged. 10. Learner discards cassette and returns to supply closet for new one.

11. Give learner cassette with damaged “soft side”. 11. Learner discards cassette and returns to supply closet for new one.

12. Give learner a patient extension line with caps dislodged inside wrapper. 12. Learner discards extension and returns to supply closet for new one.

MOTOR SKILL—COGNITIVE-LESSON PLAN

SUBJECT: Prepare for Home Choice set up

OBJECTIVE: The learner will be able to repeat all the necessary steps to prepare for Home Choice set up.

This Lesson Plan only includes a Condensed Motor Skill Analysis. The Detailed Motor Skill Analysis can be found in the previously learned Motor Skill Lesson Plans for each task.

MEDIA: Solution Bags, Clamps, Mask, Minicaps, Lap pad, work surface, bleach/water solution, Home Choice, Home Choice Cassette, Drain Bag or Drain Line, CXD (if needed) Patient Extension Line (if needed).

REQUISITE KNOWLEDGE: Maintaining Asepsis Unit, Clamps Unit, Solution Bag Components, Gathering Supplies, Inspecting the Solution Bag, Opening the Solution Bag.

HOW WILL I EVALUATE WHETHER LEARNING HAS OCCURRED? The learner will repeat the critical steps for preparing for a Home Choice set up.

GETTING THE LEARNER READY: “You have learned all the steps necessary before you actually start the setting up the Home Choice. Let's put them together. First I will show you what it looks like. Watch carefully to the sequence, later I'll ask you to repeat the critical steps. Once you can say them, then you can try yourself.”

LEARNER ACTIVITY TEACHER ACTIVITY NOTES

1. Pat attention. “Memorize” pictures of steps. 1. First Demonstration

2. Determine “critical” steps and repetition. 2. Second Demonstration—Shorten description—use labels from condensed analysis. 2. This combines the second and third demonstrations. The step by step details can be found in the previous Motor Skill Lesson Plans according to task.

3. Repeat labels from memory. 3. Give feedback.

MOTOR SKILL—PRACTICE-LESSON PLAN

SUBJECT: Prepare for Home Choice set up

OBJECTIVE: The learner will be able to put together all the steps necessary to prepare for Home Choice set up.

This lesson Plan only includes a Condensed Motor Skill Analysis. The Detailed Motor Skill analysis can be found in the previous Motor Skill Lesson Plans for each task.

MEDIA: Same as for Cognitive Lesson Plan for this Motor Skill.

REQUISITE KNOWLEDGE: Cognitive Lesson for this Motor Skill

HOW WILL I EVALUATE WHETHER LEARNING HAS OCCURRED? The learner will demonstrate the proper sequence for preparing for Home Choice set up.

GETTING THE LEARNER READY: “Now that you can tell me the critical steps for preparing for Home Choice set up it's time to practice. You can practice as many times as it takes until the steps become smooth. As you practice, I will be giving you feedback, it's OK to make mistakes, that's how you learn. We will know that you have learned this when you can prepare everything you need without error.”

LEARNER ACTIVITY TEACHER ACTIVITY NOTES

1. Hands on practice. 1. Tell the learner to go ahead and practice.

2. Reduce errors to a minimum. 2. Provide immediate, accurate feedback focused on what is correct. 2. The learner should have each task mastered at this point, they are only learning the sequence. If errors are made within a task, go back and review the individual lesson plan.

3. Correct errors. 3. Continue feedback.

4. Repeat often enough until steps become smooth and without error. 4. Test for automatic stage.

MOTOR SKILL ANALYSIS—CONDENSED

SUBJECT: Prepare for Home Choice set up

Brief Description of Logically Grouped Steps Label

1. Clean the work surface. 1. Clean the surface.

2. Brief hand washing. 2. Life lesson.

3. Gather all supplies. 3. Gather supplies.

4. Inspect all supplies. 4. Inspect supplies.

5. Open Solution Bags, drop onto work surface. 5. Open Solution Bag.

6. Proceed with Home Choice Set up

MOTOR SKILL—COGNITIVE-LESSON PLAN

SUBJECT: Turn the Machine On—Load the Cassette

OBJECTIVE: The learner will be able to repeat the critical steps in turning the machine on and loading the cassette.

MEDIA: Home Choice cycler, cassette, drain option, (2) solution bags, tape, clamp.

REQUISITE KNOWLEDGE: Preparing for Home Choice set up.

HOW WILL I EVALUATE WHETHER LEARNING HAS OCCURRED? The learner will repeat the steps for turning the machine on and loading the cassette.

GETTING THE LEARNER READY TO LEARN: “At the end of this lesson you will know the steps for turning the machine on and loading the cassette. I will show you how to turn the machine on and load the cassette. I will first demonstrate the procedure as you would usually do it. Then I will demonstrate the procedure, explaining what I am doing at each point of the procedure. I want you to pay close attention to what I am doing. After you watch me do the procedure several times, I will ask you to tell me the steps in the procedure. When you can repeat the steps of the procedure to me without error I will know that you are ready to practice the procedure yourself.”

LEARNER ACTIVITY TEACHER ACTIVITY NOTES

1. Pay attention and watch closely. “Memorize” pictures of steps. 1. Demonstrate the procedure as it would normally be performed.

2. Determine “critical” steps/nuances/etc. 2. Repeat demonstration explaining in detail each step. Point out critical steps, nuances (talk through what your hands are doing). 2. Use detailed Motor Skill Analysis.

3. Repetition. 3. Third demonstration—shorten description—use labels from condensed analysis

4. Repeat back the critical steps in the procedure from memory. 4. Ask the patient to tell you the critical steps of the procedure. Repeat the procedure and provide feedback to the patient until he is able to repeat the steps without error.

MOTOR SKILL—PRACTICE-LESSON PLAN

SUBJECT: Turn the Machine On—Load the Cassette

OBJECTIVE: The learner will be able to turn the machine and load the cassette.

MEDIA: Same as for Cognitive Lesson Plan for this Motor Skill

REQUISITE KNOWLEDGE: Cognitive Lesson for this Motor Skill.

HOW WILL I EVALUATE WHETHER LEARNING HAS OCCURRED? The learner will turn the machine on and load the cassette.

GETTING THE LEARNER READY: “Now that you are able to repeat the steps of the procedure to me it is time for you to practice it. I would like you to practice turning the machine on and loading the cassette until you can do it without thinking. I will give you feedback about how you are doing as you practice. Don't worry about making mistakes, as I will help correct you as you go along. You may practice as long as you need to. When you feel you know the procedure, I will ask you to do the procedure on your own without any help from me.”

LEARNER ACTIVITY TEACHER ACTIVITY NOTES

1. Hands on practice. 1. Tell the learner to go ahead, it is their turn to practice.

2. Continue practicing. Reduce errors to a minimum. 2. Provide immediate, accurate feedback focused on what is correct.

3. Correct errors. 3. Continue feedback.

4. Repeat often enough until steps become smooth and without error. 3. Engage learner in un-related conversation while watching them perform skill, to ascertain that skill is at automatic stage.

MOTOR SKILL ANALYSIS—DETAILED

SUBJECT: Turn the Machine On—Load the Cassette

Steps to Take Tricks of the Trade

1. Prepare for Home Choice set up. 1. Previously learned.

2. Place one bag on the heater with the writing side up and the pull ring exiting to the right. The solution must cover the temperature sensor. The remaining bags are placed next to the cycler. 2. May adapt supply bag arrangement to learner's home environment. Do not stack bags on top of each other until “Priming” is complete. Stacked bags should lay perpendicular to each other.

3.Turn the machine on. Facing the front of the machine, reach with the R. hand to the rear upper right corner of the machine and flip the power switch up to turn the machine on. 3. When the machine is turned on the machine will sound an audible alarm one time and the informational display will read “PLEASE WAIT”.

4. When the informational display reads “PRESS GO TO START”, press GO. 4. Previously learned informational display.

5. When the informational display reads “Load the Set” load the cassette. Grasp the cassette package with both hands at the perforated line. 5. Loading the cassette may be done prior to masking and washing hands. b. Tear the package open at the perforated line, and remove the cassette from the package. c. Examine the cassette. 5c. Previously learned. d. Close all clamps (6) by grasping each clamp between the thumb and forefinger of the R. hand and squeezing to close. e. Open the door on the front of the machine by lifting up on the door handle, allowing the door to drop open. f. Hold the cassette in the R. hand at the point where the lines exit the cassette, with the hard surface of the cassette facing you. 5f. The square corner of the cassette will now be positioned at the upper right corner of the cassette. g. Install the cassette firmly in the well inside the door with the lines exiting to the right. 5g. The cassette will only fit into the well in one position. h. Lift the door up to close, and lock by pushing the handle down. 5h. If the door does not close easily, push the cassette more securely into the well. i. Hold the blue organizer in front of you with the spikes pointing up and the lines facing toward you. j. Hang the organizer on the front of the door and snap into place. 5j. The slit of the organizer fits onto the ridge of the door and the buttonhole snaps onto the button on the front of the door. k. Tear off the blue paper tapes from the lines and discard.

6. Open the drain line extension or drain bag package in the same manner as the cassette. If using a drain bag close the large clamp on the drainage tube. 6. Line may be double clamped if desired.

7. Slide the clamp on the drain line extension up the line to position it just below the spike.

8. Remove the drain line from the organizer. 8. Previously learned memory lesson “Components of the Home Choice”.

9. Hold the end of the drain line in the R. hand and pull the blue protective plastic end off the line with the L. hand and discard. Move the line to the L. hand.

10. Hold the spike of the drain line extension(or bag) in the right hand at the finger grip area. Remove the protective covering from the spike and discard.

11. Insert the spike from the drain line extension (or bag) into the end of the drain line from the machine.

12. Place the drain line extension in the toilet above the water level and secure in place with tape. Place drain bag on the floor or in the bathtub. 12. Drain bags are normally used when collecting samples for kinetics.

13. Press “GO” to advance to the next step. 13. The machine will now display “SELF TESTING”, and then “CONNECT BAGS”.

MOTOR SKILL ANALYSIS—DETAILED

SUBJECT: Turn the Machine On—Load the Integrated Cassette

Steps to Take Tricks of the Trade

1. Prepare for Home Choice set up. 1. Previously learned.

2. Place one bag on the heater with the writing side up and the pull ring exiting to the right. The solution must cover the temperature sensor. The remaining bags are placed next to the cycler. 2. May adapt supply bag arrangement to learner's home environment. Do not stack bags on top of each other until “Priming” is complete. Stacked bags should lay perpendicular to each other.

3.Turn the machine on. Facing the front of the machine, reach with the R. hand to the rear upper right corner of the machine and flip the power switch up to turn the machine on. 3. When the machine is turned on the machine will sound an audible alarm one time and the informational display will read “PLEASE WAIT”.

4. When the informational display reads “PRESS GO TO START”, press GO. 4. Previously learned informational display.

5. When the informational display reads “Load the Set” load the cassette. Grasp the cassette package with both hands at the perforated line. 5. Loading the cassette may be done prior to masking and washing hands. b. Tear the package open at the perforated line, and remove the cassette from the package. c. Examine the cassette. 5c. Previously learned. d. Close all clamps (5) by grasping each clamp between the thumb and forefinger of the R. hand and squeezing to close. e. Open the door on the front of the machine by lifting up on the door handle, allowing the door to drop open. f. Hold the cassette in the R. hand at the point where the lines exit the cassette, with the hard surface of the cassette facing you. 5f. The square corner of the cassette will now be positioned at the upper right corner of the cassette. g. Install the cassette firmly in the well inside the door with the lines exiting to the right. 5g. The cassette will only fit into the well in one position. h. Lift the door up to close, and lock by pushing the handle down. 5h. If the door does not close easily, push the cassette more securely into the well. i. Hold the blue organizer in front of you with the spikes pointing up and the lines facing toward you. j. Hang the organizer on the front of the door and snap into place. 5j. The slit of the organizer fits onto the ridge of the door and the buttonhole snaps onto the button on the front of the door. k. Tear off the blue paper tapes from the lines and discard.

6. Remove the drain line from the organizer. 6. Previously learned memory lesson “Components of the Home Choice”.

7. Pull the blue protective plastic end off the line.

8. Place the drain line in the toilet above the water level and secure in place with tape.

9. Press “GO” to advance to the next step. 9. The machine will now display“SELF TESTING”, and then “CONNECT BAGS”.

MOTOR SKILL ANALYSIS—CONDENSED

SUBJECT: Turn the Machine on—Load the Cassette

Brief Description of Logically Grouped Steps Label

1. Place one solution bag on the heater and the other bags next to the cycler. 1. Place bags.

2. Turn the power on. 2. Turn on.

3. Press “GO” 3. Press GO.

4. Load the cassette. 4. Load the set.

5. Attach the drain option. 5. Attach drain option.

6. Press “GO” 6. Press GO

MOTOR SKILL—COGNITIVE-LESSON PLAN

SUBJECT: Turn the Machine On—Load the Cassette

OBJECTIVE: The learner will be able to repeat the critical steps in turning the machine on and loading the cassette.

MEDIA: Home Choice cycler, cassette, drain option, (2) solution bags, tape, clamp.

REQUISITE KNOWLEDGE: Preparing for Home Choice set up.

HOW WILL I EVALUATE WHETHER LEARNING HAS OCCURRED? The learner will repeat the steps for turning the machine on and loading the cassette.

GETTING THE LEARNER READY: “At the end of this lesson you will know the steps for turning the machine on and loading the cassette. I will show you how to turn the machine on and load the cassette. I will first demonstrate the procedure as you would usually do it. Then I will demonstrate the procedure, explaining what I am doing at each point of the procedure. I want you to pay close attention to what I am doing. After you watch me do the procedure several times, I will ask you to tell me the steps in the procedure. When you can repeat the steps of the procedure to me without error I will know that you are ready to practice the procedure yourself.”

LEARNER ACTIVITY TEACHER ACTIVITY NOTES

1. Pay attention and watch closely. “Memorize” pictures of steps. 1. Demonstrate the procedure as it would normally be performed.

2. Determine “critical” steps/nuances/etc. 2. Repeat demonstration explaining in detail each step. Point out critical steps, nuances (talk through what your hands are doing). 2. Use detailed Motor Skill Analysis.

3. Repetition. 3. Third demonstration—shorten description—use labels from condensed analysis

4. Repeat back the critical steps in the procedure from memory. 4. Ask the learner to tell you the critical steps of the procedure. Repeat the procedure and provide feedback to the learner until he is able to repeat the steps without error.

MOTOR SKILL—PRACTICE-LESSON PLAN

SUBJECT: Turn the Machine On—Load the Cassette

OBJECTIVE: The learner will be able to turn the machine and load the cassette.

MEDIA: Same as for Cognitive Lesson Plan for this Motor Skill

REQUISITE KNOWLEDGE: Cognitive Lesson for this Motor Skill.

HOW WILL I EVALUATE WHETHER LEARNING HAS OCCURRED? The learner will turn the machine on and load the cassette.

GETTING THE LEARNER READY: “Now that you are able to repeat the steps of the procedure to me it is time for you to practice it. I would like you to practice turning the machine on and loading the cassette until you can do it without thinking. I will give you feedback about how you are doing as you practice. Don't worry about making mistakes, as I will help correct you as you go along. You may practice as long as you need to. When you feel you know the procedure, I will ask you to do the procedure on your own without any help from me.”

LEARNER ACTIVITY TEACHER ACTIVITY NOTES

1. Hands on practice. 1. Tell the learner to go ahead, it is their turn to practice.

2. Continue practicing. Reduce errors to a minimum. 2. Provide immediate, accurate feedback focused on what is correct.

3. Correct errors. 3. Continue feedback.

4. Repeat often enough until steps become smooth and without error. 3. Engage learner in an unrelated conversation while watching them perform skill, to ascertain that skill is at automatic stage.

MOTOR SKILL ANALYSIS—DETAILED

SUBJECT: Turn the Machine On—Load the Cassette

Steps to Take Tricks of the Trade

1. Prepare for Home Choice set up. 1. Previously learned.

2. Place one bag on the heater with the writing side up and the pull ring exiting to the right. The solution must cover the temperature sensor. The remaining bags are placed next to the cycler. 2. May adapt supply bag arrangement to learner's home environment. Do not stack bags on top of each other until “Priming” is complete. Stacked bags should lay perpendicular to each other.

3.Turn the machine on. Facing the front of the machine, reach with the R. hand to the rear upper right corner of the machine and flip the power switch up to turn the machine on. 3. When the machine is turned on the machine will sound an audible alarm one time and the informational display will read “PLEASE WAIT”.

4. When the informational display reads “PRESS GO TO START”, press GO. 4. Previously learned informational display.

5. When the informational display reads “Load the Set” load the cassette. Grasp the cassette package with both hands at the perforated line. 5. Loading the cassette may be done prior to masking and washing hands. b. Tear the package open at the perforated line, and remove the cassette from the package. c. Examine the cassette. 5c. Previously learned. d. Close all clamps (6) by grasping each clamp between the thumb and forefinger of the R. hand and squeezing to close. e. Open the door on the front of the machine by lifting up on the door handle, allowing the door to drop open. f. Hold the cassette in the R. hand at the point where the lines exit the cassette, with the hard surface of the cassette facing you. 5f. The square corner of the cassette will now be positioned at the upper right corner of the cassette. g. Install the cassette firmly in the well inside the door with the lines exiting to the right. 5g. The cassette will only fit into the well in one position. h. Lift the door up to close, and lock by pushing the handle down. 5h. If the door does not close easily, push the cassette more securely into the well. i. Hold the blue organizer in front of you with the spikes pointing up and the lines facing toward you. j. Hang the organizer on the front of the door and snap into place. 5j. The slit of the organizer fits onto the ridge of the door and the buttonhole snaps onto the button on the front of the door. k. Tear off the blue paper tapes from the lines and discard.

6. Open the drain line extension or drain bag package in the same manner as the cassette. If using a drain bag close the large clamp on the drainage tube. 6. Line may be double clamped if desired.

7. Slide the clamp on the drain line extension up the line to position it just below the spike.

8. Remove the drain line from the organizer. 8. Previously learned memory lesson “Components of the Home Choice”.

9. Hold the end of the drain line in the R. hand and pull the blue protective plastic end off the line with the L. hand and discard. Move the line to the L. hand.

10. Hold the spike of the drain line extension(or bag) in the right hand at the finger grip area. Remove the protective covering from the spike and discard.

11. Insert the spike from the drain line extension (or bag) into the end of the drain line from the machine.

12. Place the drain line extension in the toilet above the water level and secure in place with tape. Place drain bag on the floor or in the bathtub. 12. Drain bags are normally used when collecting samples for kinetics.

13. Press “GO” to advance to the next step. 13. The machine will now display “SELF TESTING”, and then “CONNECT BAGS”.

MOTOR SKILL ANALYSIS—CONDENSED

SUBJECT: Turn the machine on—Load the cassette

Brief Description of Logically Grouped Steps Label

1. Place one solution bag on the heater and the other bags next to the cycler 1. Place bags.

2. Turn the power on. 2. Turn on.

3. Press “GO” 3. Press GO.

4. Load the cassette. 4. Load the set.

5. Attach the drain option. 5. Attach drain option.

6. Press “GO” 6. Press GO

MOTOR SKILL—COGNITIVE-LESSON PLAN

SUBJECT: Spiking the Solution Bags

OBJECTIVE: The learner will be able to repeat the critical steps in spiking the solution bags.

MEDIA: Solution bags, outlet port clamp, organizer with lines only—without cassette, mask.

REQUISITE KNOWLEDGE: Maintaining Asepsis, Clamps, Components of Home Choice and Disposables.

HOW WILL I EVALUATE WHETHER LEARNING HAS OCCURRED? The learner will repeat the steps for spiking the solution bags.

GETTING THE LEARNER READY: “At the end of this lesson you will know the steps for connecting the solution bags. I will show you how to connect the solution bags. I will first demonstrate the procedure as you would usually do it. Then I will demonstrate the procedure, explaining what I am doing at each point of the procedure. I want you to pay close attention to what I am doing. After you watch me do the procedure several times, I will ask you to tell me the steps in the procedure. When you can repeat the steps of the procedure to me without error I will know that you are ready to practice the procedure yourself.”

LEARNER ACTIVITY TEACHER ACTIVITY NOTES

1. Pay attention and watch closely. “Memorize” pictures of steps. 1. Demonstrate the procedure using the practice organizer as it would normally be performed 1. Use an organizer with lines attached for repeated practice. Could cut off lines 2-3 “below the clamps and reuse.

2. Determine the critical steps in the procedure. 2. Repeat demonstration for the second time explaining in detail each step. 2. Use detailed Motor Skill Analysis.

3. Repetition. 3. Third demonstration. Point out the critical steps of the procedure using the labels from the condensed analysis.

4. Repeat the labels from memory. 4. Repeat the procedure and provide feedback to the patient until he is able to repeat the steps without error

MOTOR SKILL—PRACTICE-LESSON PLAN

SUBJECT: Spiking the Solution Bags.

OBJECTIVE: The learner will safely spike the solution bags as part of the Home Choice set-up.

MEDIA: Same as for Cognitive Lesson Plan for this Motor Skill

REQUISITE KNOWLEDGE: Cognitive Lesson for this Motor Skill

HOW WILL I EVALUATE WHETHER LEARNING HAS OCCURRED? The learner will safely spike the solution bags.

GETTING THE LEARNER READY: “Now that you are able to repeat the steps of the procedure to me it is time for you to practice it. I would like you to practice the procedure until you feel you can do it without thinking. I will give you feedback about how you are doing as you practice. Don't worry about making mistakes, I will correct you as you go along. You may practice as long as you need. When you feel you know the procedure, I will ask you to do the procedure on your own without any help from me.”

LEARNER ACTIVITY TEACHER ACTIVITY NOTES

1. Practice the previously learned steps of connecting the solution bags. 1. Tell the learner to go ahead, it is their turn to practice

2. Continue practicing until the skill reducing errors to a minimum. 2. Provide immediate, accurate feedback focused on what is correct.

3. Correct errors. 3. Continue feedback.

4. Repeat often enough until steps become smooth and without error. 3. Engage learner in un-related conversation while watching them perform skill, to ascertain that skill is at automatic stage.

MOTOR SKILL ANALYSIS—DETAILED

SUBJECT: Spiking the Solution Bags

Steps to Take Tricks of the Trade

1. Mask and wash hands 1. Previously learned.

2. Position yourself with the two ports of the bag facing you, with the print side of the bag up, and with just the ports of the bag extending 3″ over the edge of your work surface. 2. The bag may be positioned either on the heater of the machine or on a table.

3. Pick up the blue outlet port clamp in your R. hand with the blue circle facing you.

4. Hold the colored pull ring on the outlet port of the bag in your L. hand.

4. Slide the clamp around the outlet port, making sure that the port sits in the depression of the clamp and the round flat circle of the clamp touches the collar of the outlet port.

5. Close the clamp. 5. Previously learned.

6. Grasp the outlet port clamp in your L. hand with your thumb on the bottom of the clamp, your forefinger on the top of the clamp, and your remaining 3 fingers pointed away from you and resting on the bag.

7. Grasp the pull ring of the colored cap with the thumb and forefinger of your R. hand.

8. Pull the cap straight off.

9. Drop the cap on the table.

10. Let go of the outlet port clamp.

11. Remove the appropriate line from the organizer with your R hand.

12. Grasp the finger grip area of the line between the thumb and forefinger of the R. hand with your thumb in front and the spike pointing up. 12. Keep fingers behind the white collar area of the finger grip

13. Grasp the spike protector above the flange between the thumb and forefinger of your L. hand and pull it straight off.

14. Place the spike protector on the table.

15. Grasp the outlet port clamp in the L hand. 15. See Step #6

16. Insert the spike into the outlet port twisting as you push until the hub of the spike meets the end of the outlet port. 16. Requires firm pressure to penetrate the membrane inside the port and enter the solution.

17. Remove the outlet port clamp. 17. Previously learned.

18. Place spiked bag in appropriate place for Home Choice treatment. Support both ends of the bag when moving. 18. Heater cradle, etc.

19. Repeat for all other bags to be spiked.

MOTOR SKILL ANALYSIS—CONDENSED

SUBJECT: Spiking the Solution Bags

Brief Description of Logically Grouped Steps Label

1. Mask and wash hands. 1. Prepare self.

2. Place the solution bag directly in front of you with the ports extending 3″ over the edge of the work surface. 2. Position bag.

3. Place the blue outlet port clamp on the outlet port. 3. Clamp bag.

4. Remove the colored pull ring. 4. Remove pull ring.

5. Remove the appropriate line from the organizer. 5. Remove line.

6. Remove the spike protector. 6. Remove protector.

7. Grasp the blue outlet port clamp. 7. Hold clamp.

8. Insert the spike. 8. Spike.

9. Remove outlet port clamp. 9. Remove clamp.

10. Put bag in appropriate place. 10. Place bag.

MEMORY LEARNING LESSON PLAN

SUBJECT: Components of Compact Exchange Device (CXD II)

OBJECTIVE: The learner will be able to name from memory the components of the CXD II.

MEDIA: Picture of CXD II with components labeled(HC 11; FIG. 8K), CXD II.

HOW WILL I EVALUATE WHETHER LEARNING HAS OCCURRED? The learner will name the component parts of the CXD II.

GETTING THE LEARNER READY: “This is called a compact exchange device. Right now you will learn the components of the compact exchange device. I will show you a compact exchange device and tell you about the different parts. Pay attention to the special features. I will ask you to study and repeat the names of each part. We will know you have learned this when you can name all the parts of an unlabeled compact exchange device correctly.”

LEARNER ACTIVITY TEACHER ACTIVITY NOTES

1. Pay attention. Repeat the information several times. 1. Present the information to be memorized. Tell the learner to ask questions or “say after me”. Show labeled picture of compact exchange device and name all the parts.

2. Look at the labeled CXD II picture. Form own associations. 2. Show the labeled picture of the CXD II. May ask patient to form own associations.

3. Practice/Test 3. Show the learner a CXD II and have them identify the components by name. Provide positive feedback when learner correctly identifies the components. If applicable, give the learner a blank picture of the CXD II and have him label the parts from memory.

MEMORY LEARNING ANALYSIS

SUBJECT: Components of the CXD II

List of information to be memorized Mnemonic(s) or other helpful memory aids or memorization strategies

External Movable Parts: Opener with thumb groove Handle Lid Internal Movable Parts: Spike Carriage Black. Locks and unlocks lid. Black. Has a flat square portion. Opens and closes. Clear to view internal parts.

Grooves: Front Groove next to the hinge Side Groove Holds collar of the outlet port on the solution bag Holds flange of spike protector.

Side Edge Allows for easy opening of lid.

Handle Directions Insert—forward Remove—backward

Suction Cups On Bottom

MOTOR SKILL—COGNITIVE-LESSON PLAN

SUBJECT: Spiking the Solution bags using the Compact Exchange Device (CXD II).

OBJECTIVE: The learner will be able to repeat the critical steps to spiking the solution bags using the CXD II as an option to the Home Choice set-up.

MEDIA: Solution bags, outlet port clamp, mask, CXD II, organizer with lines only—without cassette.

REQUISITE KNOWLEDGE: Maintaining Asepsis, Clamps, Components of CXD II, Components of Home Choice and Disposables.

HOW WILL I EVALUATE WHETHER LEARNING HAS OCCURRED? The learner will repeat the steps for spiking the solution bags using the CXD II.

GETTING THE LEARNER READY: “At the end of this lesson you will be able to repeat the steps for connecting the solution bags using the compact exchange device. I will show you how to connect the solution bags by demonstrating the procedure as you would usually do it. Then I will repeat the procedure, explaining what I am doing at each step. I want you to pay close attention to what I am doing. After you watch me connect the solution bags several times, I will ask you to tell me the steps in the procedure. When you can repeat the steps of the procedure to me without error, I will know you are ready to practice connecting the solution bags yourself.”

LEARNER ACTIVITY TEACHER ACTIVITY NOTES

1. Pay attention and watch closely.“Memorize” pictures of steps. 1. Demonstrate the procedure as it would normally be performed. 2. Determine the “critical” steps/nuances 2. Repeat demonstration explaining each step in detail. Talk through what your hands are doing. 2. Use detailed Motor Skill Analysis.

3. Repetition 3. Repeat demonstration again pointing out only the critical steps of the procedure. Use the labels from the condensed analysis

4. Repeat from memory the critical steps in the procedure. 4. Ask the learner to tell you the critical steps of the procedure. Repeat the procedure and provide positive feedback to the patient until learner is able to tell you the steps without error.

MOTOR SKILL—PRACTICE-LESSON PLAN

SUBJECT: Spiking the Solution Bags using the Compact Exchange Device (CXD II).

OBJECTIVE: The learner will be able to safely spike the solution bags using the CXD II as an option to the Home Choice set-up.

MEDIA: Same as Cognitive Lesson Plan for this Motor Skill

REQUISITE KNOWLEDGE: Cognitive Lesson for this Motor Skill

HOW WILL I EVALUATE WHETHER LEARNING HAS OCCURRED? The learner will safely spike the solution bags using CXD II.

GETTING THE LEARNER READY: “Now that you can repeat the steps of the procedure, it's time to practice. I would like you to practice the procedure until you feel you can do it without thinking. I will give you feedback about how you are doing as you practice. Don't worry about making mistakes, I will correct you as you go along. You may practice as long as you need and when you feel you know the procedure, I will ask you to do the procedure on your own without help from me.”

LEARNER ACTIVITY TEACHER ACTIVITY NOTES

1. Hands on practice. 1. Tell the learner it's time to practice.

2. Continue practicing reducing errors to a minimum. 2. Provide immediate, accurate feedback focused on what is correct.

3. Correct errors 3. Continue feedback.

4. Repeat often enough until steps become smooth and without error. 4. Test for the automatic stage by engaging the learner in an unrelated conversation while performing the skill.

MOTOR SKILL ANALYSIS—DETAILED

SUBJECT: Spiking the Solution Bags using the Compact Exchange Device (CXD II).

Steps to Take Tricks of the Trade

1. Mask and wash hands. 1. Previously learned.

2. Lay bag horizontal on the work surface with the two ports pointing right and the print side of the bag up. Position yourself in front of the bag. Move the bag to the left side of your work surface. 2. When choosing a location, enough space needs to be available for the horizontal solution bag and CXD II.

3. Pick up the blue outlet port clamp in your R hand with the blue circle pointing R.

4. Slide the clamp around the port with the hinge positioned closest to you until the port sits in the depression of the clamp. The straight edge of the clamp opposite the circle should touch the seam of the solution bag where the outlet port is located. 4. Make sure the port is unattached from the solution bag.

5. Rotate the clamp upward until the long flat sides of the clamp are positioned vertically.

6. Close the clamp. 6. Previously learned.

7. Place the CXD II on the work surface to the R of the solution bag approx. 3 inches from the outlet port so the front groove next to the hinge faces the bag. 7. Make sure the handle is in the “insert” position.

8. Place L thumb in the thumb groove of the opener and push downward.

9. Place R thumb under the R corner of the lid edge and open the lid by pushing up and away from you until the lid falls open. 9. This keeps hand at the furthest distance from where the sterile connection will be made.

10. Release L thumb from the opener.

11. Remove the line from organizer by grasping the ridges on the finger grip with the right thumb and index finger. 11. Make sure the line clamp is closed.

12. Insert the spike into the spike carriage with the bump on the spike positioned away from you toward the hinge. The flange on the spike protector fits into the side groove.

13. With L thumb and index finger, grasp the long flat sides of the outlet port clamp and tilt clamp backward until it slightly touches the solution bag. 13. Tilt clamp back so the port points at a 45 degree angle from table.

14. Using R hand, position the CXD II closer to the outlet port so that the front groove next to the hinge is directly under the collar of the outlet port on the solution bag.

15. Using R index finger, press the collar on the outlet port snugly into the groove.

16. Hook R index finger over and through center of colored pull ring.

17. Pull ring off and drop ring on work surface.

18. With R index finger, reach behind the R corner of the lid edge and pull lid toward you applying pressure to the lid until it snaps shut.

19. Remove L hand from outlet port clamp.

20. Place 4 fingers of L hand directly on top of the lid. Apply enough pressure to the lid to secure the suction cups.

21. Using R thumb and index finger, grasp the flat square portion on the handle.

22. Pull handle over to the R until it stops.

23. Push handle forward to the L firmly. Adjust the position of L fingers and watch the spike penetrate the outlet port.

24. Remove both hands from CXD II.

25. Place L thumb on thumb groove of opener and push downward.

26. Place R thumb under the R corner of the lid edge and open the lid by pushing up and away from you until the lid falls open.

27. With L thumb and index finger, grasp the long flat sides of the outlet port clamp.

28. With R thumb and index finger, grasp the tubing behind the finger grip area of the spike resting in the spike carriage.

29. Lift up with both hands simultaneously, removing spiked bag from carriage.

30. Remove the outlet port clamp. 30. Previously learned.

31. Place spiked bag in appropriate place for Home Choice treatment. Support both ends of the bag when moving. 31. Heater cradle/side of Home Choice etc

32. Repeat steps 2-30 for all other bags to be spiked.

33. Slide CXD II away from immediate work area.

MOTOR SKILL ANALYSIS—CONDENSED

SUBJECT: Spiking the Solution Bags using the Compact Exchange Device (CXD II).

Brief Description of Logically Grouped Steps Label

1. Mask and wash hands, prepare equipment. 1. Prepare.

2. Pick up clamp, slide around port, position vertically and close. 2. Clamp solution bag.

3. Place thumb on opener, place finger on edge, lift lid. 3. Open CXD II.

4. Locate correct tubing, take out of organizer, insert spike into spike carriage. 4. Position spike in carriage.

5. Grasp outlet port clamp, tilt clamp, position CXD II, press collar of outlet port into front groove. 5. Insert port collar in front groove.

6. Hold clamp, hook finger through ring, pull to right, drop ring. 6. Remove pull ring.

7. Stabilize CXD II, pull handle back and forth. 7. Spike solution bag.

8. Open lid, grasp clamp on solution bag and tubing in spike carriage, lift. 6. Remove connection out of spike carriage.

9. Place hands to top and under solution bag, lift bag onto cycler heater cradle. 9. Place onto heater cradle.

10 Repeat for additional bags. 10. Repeat with next bag.

MOTOR SKILL—COGNITIVE-LESSON PLAN

SUBJECT: Priming Cassette

OBJECTIVE: The learner will be able to repeat the critical steps to prime the cassette.

MEDIA: Home Choice Cycler with informational display reading “Connect Bags” and bags to be spiked.

REQUISITE KNOWLEDGE: Home Choice/Disposables Components, Asepsis

HOW WILL I EVALUATE WHETHER LEARNING HAS OCCURRED? The learner can repeat the critical steps unassisted.

GETTING THE LEARNER READY: “At the end of this lesson you will know the steps for priming the cassette. I will show you how to prime the cassette. I will first demonstrate the procedure as you would usually do it. Then I will demonstrate the procedure, explaining what I am doing at each point of the procedure. I want you to pay close attention to what I am doing. After you watch me do the procedure several times, I will ask you to tell me the steps in the procedure. When you can repeat the steps of the procedure to me without error I will know that you are ready to practice the procedure yourself.”

LEARNER ACTIVITIES TEACHER ACTIVITIES NOTES

1. Pay attention and watch closely. 1. Demonstrate the procedure as it would normally occur.

2. Memorize the steps. 2. Repeat demonstration explaining in detail each step. 2. Use detailed Motor Skill Analysis.

3. Determine the critical steps of the procedure. 3. Point out the critical steps of the procedure.

4. Repeat back the critical steps. 4. Ask the learner to tell you the steps.

5. Repeat the procedure and provide feedback until learner repeats it without error.

MOTOR SKILL—PRACTICE-LESSON PLAN

SUBJECT: Priming Cassette

OBJECTIVE: The learner will be able to prime the cassette.

MEDIA: Same as for Cognitive Lesson Plan for this Motor Skill.

REQUISITE KNOWLEDGE: Cognitive Lesson for this Motor Skill.

HOW WILL I EVALUATE WHETHER LEARNING HAS OCCURRED? The learner will prime the cassette.

GETTING THE LEARNER READY: “Now that you can repeat the steps to prime the cassette, you're ready to practice. I would like you to practice the procedure until you can do it without thinking. I will give you feedback about how you are doing as you practice. Don't worry about making mistakes, I will correct you as you go along. Practice as long as you need. When you feel you know the procedure, I will ask you to do it on your own without any help. When you can do this without error, we'll know you've got it.”

LEARNER ACTIVITY TEACHER ACTIVITY NOTES

1. Hands on practice. 1. Tell the learner to go ahead, it is their turn to practice.

2. Continue practicing reducing errors to a minimum. 2. Provide immediate, accurate feedback focused on what is correct.

3. Correct errors. 3. Continue feedback.

4. Repeat often enough until steps become smooth and without error. 4. Test for automatic stage.

MOTOR SKILL ANALYSIS—DETAILED

SUBJECT: Priming Cassette

Steps to Take Tricks of the Trade

1. Verify information display on Home Choice reads “Connect Bags” and bags are spiked and in appropriate location. 1. If using patient extension line remove blue pull ring top from patient connector. Grasp blue finger grip behind circular flange in right thumb and fingers. Use left ring finger to pull ring and remove cap. Grasp white finger grip of patient line in left hand between thumb and fingers. Twist blue cap over white cap in a clockwise motion until it is seated. Place white end of patient extension in organizer

2. Grasp red heater bag clamp in right hand supporting it with four fingers, thumb on top. With right thumb push up on clamp to open. 2. Some patients will need to support with 2 hands secondary to strength/dexterity.

3. Continue unclamping each spiked bag in same manner. 3. Only open line clamps attached to bags.

4. Unclamp patient line in same manner. Tear white tape from patient line.

5. Press GO. The informational display will then read “PRIMING”. 5. Priming is complete when display reads” Connect yourself.”

MOTOR SKILL ANALYSIS—CONDENSED

SUBJECT: Priming Cassette

Brief Description of Logically Grouped Steps Label

1. Verify readiness to prime 1. Readiness.

2. Unclamp clamps. 2. Unclamp.

3. Press “GO” to prime. 3. Press “GO”.

SIMPLE MEMORY/HABIT LESSON PLAN

SUBJECT: Prepare Self

OBJECTIVE: The learner will be able to prepare self for a Home Choice Cycler session.

KIND OF LEARNING: Simple Motor Skill

Because of the ease of this motor skill, this is the only Lesson Plan. The complete Lesson Plan (Cognitive/Practice) and Analysis (Detailed/Condensed) are not included.

MEDIA: Sink, paper towels, pump antibacterial soap, mask, waste receptacle, transfer set.

REQUISITE KNOWLEDGE: Transfer Set Components, Masking/Washing Hands.

HOW WILL I EVALUATE WHETHER LEARNING HAS OCCURRED? The learner will prepare self for a Home Choice Cycler session.

GETTING THE LEARNER READY: “At the end of this lesson you will be able to prepare yourself before connecting to the cycler. I will show you how to remove your transfer set and review masking and handwashing. Then you will have a chance to practice. We will know you have learned this when you can prepare yourself without error.”

LEARNER ACTIVITY TEACHER ACTIVITY NOTES

1. Pay attention and “Memorize” steps. 1. First Demonstration—Demonstrate following the catheter from your belly away from you until you grasp the light blue finger grip area between your thumb and forefinger. Gently remove the catheter from your clothing. 1. Learner may have tape attached from catheter or transfer set onto skin. Remove gently.

2. Determine critical steps. 2. Second Demonstration—Point out critical steps, talk through what your hands are doing.

3. Hands on practice. 3. Tell the learner to go ahead and practice.

4. Reduce errors to a minimum. 4. Provide immediate, accurate feedback focused on what is correct.

5. Correct errors. 5. Continue feedback.

MOTOR SKILL—COGNITIVE-LESSON PLAN

SUBJECT: Connecting to the Home Choice and Initiating Therapy.

OBJECTIVE: The learner will be able to repeat the critical steps in connecting to the Home Choice and initiating therapy.

MEDIA: Home Choice Cycler, solution bag (saline bag for use with the practice apron), cassette, drain line or bag, lap pad, mask, practice apron with transfer set. The cycler should be set up with display reading “Connect Yourself”

REQUISITE KNOWLEDGE: Maintaining Asepsis, Components of the Home Choice, Prepare self, Components of transfer set, Opening/closing the transfer set.

HOW WILL I EVALUATE WHETHER LEARNING HAS OCCURRED? The learner will repeat the steps for connecting to the Home Choice and initiating therapy.

GETTING THE LEARNER READY: “At the end of this lesson you will know the steps of connecting to the Home Choice and initiating therapy. I will show you how to connect to the cycler and how to initiate the therapy. You will pay close attention to what I am doing and explaining. After you watch me several times, I will ask you to repeat the steps back to me. When you can repeat the critical steps, we will know that you are ready to practice.”

LEARNER ACTIVITIES TEACHER ACTIVITIES NOTES

1. Pay attention and watch closely. “Memorize” pictures of steps. 1. Demonstrate the procedure using the practice apron as it would be normally performed. 1. Cycler is set up with display reading “Connect Yourself”. Use saline with the practice apron.

2. Determine the critical steps/nuances 2. Repeat demonstration explaining each step in detail. Talk through what your hands are doing. 2. Use detailed Motor Skill Analysis.

3. Repetition. 3. Third demonstration point out the critical steps. Use the labels from the condensed analysis.

4. Repeat from memory the critical steps of the procedure. 4 Repeat until the learner is able to repeat the steps and the key words without error.

MOTOR SKILL—PRACTICE-LESSON PLAN

SUBJECT: Connecting to the Home Choice and Initiating Therapy.

OBJECTIVE: The learner will be able to connect to the Home Choice and initiate therapy.

MEDIA: Same as for the Cognitive Lesson Plan for this Motor Skill

REQUISITE KNOWLEDGE: Cognitive Lesson for this Motor Skill

HOW WILL I EVALUATE WHETHER LEARNING HAS OCCURRED? The learner will safely connect to the Home Choice and initiate therapy.

GETTING THE LEARNER READY: “Now it is your turn to practice connecting to the cycler and initiating therapy. Practice until you feel you can do it without thinking. I will give you feedback about how you are doing. It doesn't matter if you make some mistakes. I will help correct them as you go along. You can practice as long as you need to. When you think you know how to do the procedure, I will ask you to do it on your own without any help from me.”

LEARNER ACTIVITIES TEACHER ACTIVITIES NOTES

1. Hands on practice. 1. “Go ahead. It is your turn to practice.” 1. Have the cycler set up for the patient to practice with.

2. Continue to practice, reducing errors to a minimum 2. Provide immediate, accurate feedback focused on what is correct. Correct any errors by stating what the correct steps are. 2. Should be a constant commentary about the performance indicating those things that are done correctly and correcting errors by stating what the correct step is.

3. Begin to monitor self, detecting errors and correcting them.

4. Repeat often enough for steps to become smooth error free and automatic. 4. Test for automatic stage by asking the learner to perform the procedure while conversing with them 4. Topic should be unrelated to the procedure.

MOTOR SKILL ANALYSIS—DETAILED

SUBJECT: Connecting to the Home Choice and Initiating Therapy.

Steps to Take Tricks of the Trade

1. Verify that the Home Choice display reads “Connect Self”. 1. Previously learned.

2. Prepare self. Mask and wash hands. 2. Previously learned.

3. Sit down and place a pad on your lap.

4. Place your transfer set on the pad with the tip pointed toward your knees.

5. For original connection follow steps 8-14.

6. For 2-handed connection follow steps 15-21.

7. For 2-finger connection follow steps 22-27.

For Original Connection:

8. Stabilize the patient line in the organizer with the thumb and forefinger of your left hand by grasping the patient line at the ridges located just below the circular flange. 8. Previously learned.

9. Place index finger of your right hand through the light blue pull tab on the patient line. Pull the tab straight off and drop it to the right side.

10. Grasp the light blue finger grip area of the transfer set with your left thumb and forefinger and pick it up keeping the tip pointed in a downward direction. 10. Previously learned.

11. Using the thumb and forefinger of your right hand, grasp the Minicap by the grooves. Twist the Minicap in a clockwise direction to remove it. Place the Minicap on the lap pad.

12. Using the thumb and forefinger of your right hand grasp the patient line at the ridges located just below the circular flange. Take the line out of the organizer.

13. Screw the patient line onto the transfer set in a clockwise direction until is secure (you cannot turn it any further).

14. Follow steps 28-31.

For 2-handed Connection:

15. Grasp the patient line by the ridges located below the circular flange between the thumb and forefinger of the right hand and remove from organizer. Wrap remaining three fingers around patient line, securing it in the hand.

16. Place your left forefinger through the light blue pull tab and pull straight off. Drop the pull tab at your left side.

17. Grasp light blue finger grip area of your transfer set with your left thumb and forefinger. Pick it up keeping the tip pointed in a downward direction.

18. Continue to hold the patient line in your right hand with your last three fingers and palm, freeing your forefinger and thumb.

19. Using the thumb and forefinger of your right hand, grasp the Minicap by the grooves. Twist the Minicap in a clockwise direction and remove it. Place the Minicap on the lap pad.

20. Screw the patient line onto the transfer set in a counter-clockwise direction until is secure (you cannot turn it any further).

21. Follow steps 28-31.

For 2-finger Hold:

22. With the right palm facing the floor slide your forefinger and middle finger just under the ridges of the flange on the patient line, grasp the line with those fingers, and remove the line from the organizer. 22. This resembles a cigarette hold.

23. Place your left forefinger through the light blue pull tab and pull straight off. Drop the pull tab at your left side. Continue to hold the patient line between your fingers.

24. Grasp light blue finger grip area of your transfer set with your left thumb and forefinger. Pick it up keeping the tip pointed in a downward direction.

25. Using the thumb and forefinger of your right hand, grasp the Minicap by the grooves. Twist the Minicap in a clockwise direction and remove it. Place the Minicap on the pad on your lap.

26. Rotate your right hand so the patient line moves to the transfer set and screw the patient connector onto the transfer set in a counter clockwise direction.

27. Follow steps 28-31.

28. Open the twist clamp on the transfer set. 28. Previously learned.

29. Open clamp on patient line. 29. Previously learned.

30. Press “GO”. Verify the informational display reads “Initial Drain.” 30. Previously learned.

31. Tape the transfer set to your abdomen. Remove face mask. 31. Secure the transfer set in some way to prevent pulling during sleep.

MOTOR SKILL ANALYSIS—CONDENSED

SUBJECT: Connecting to the Home Choice and Initiating Therapy.

Brief Description of Logically Grouped Steps Label

1. Verify display reads “Connect Self”. 1. Check Home Choice Display.

2. Prepare self. Mask and wash hands. 2. Prepare.

3. Remove the tab on the patient line and the minicap from the transfer set. 3. Remove caps.

4. Connect patient line to your transfer set. 4. Connect.

5. Open the transfer set and patient line. 5. Open clamps.

6. Press “Go”. 6. Start Therapy.

MOTOR SKILL—COGNITIVE-LESSON PLAN

SUBJECT: Connecting to the Home Choice using the EZ-Aide Assist Device and Initiating Therapy.

OBJECTIVE: The learner will be able to connect to the Home Choice using the EZ-Aide assist device and initiate therapy.

MEDIA: EZ-Aide, lap pad, mask, practice apron with transfer set, clamp, Minicap, Home Choice, cassette, solution bags (saline bag for use with practice apron), drain line or bag. The cycler should be set up with display reading ‘Connect Yourself’.

REQUISITE KNOWLEDGE: Maintaining Asepsis, Transfer Set/Clamps Unit, Home Choice/Disposable Components, Gathering Supplies, Prepare Self.

HOW WILL I EVALUATE WHETHER LEARNING HAS OCCURRED? The learner will repeat the steps for connecting to the Home Choice using the EZ-Aide assist device and initiate therapy.

GETTING THE LEARNER READY: “At the end of this lesson you will know the steps of connecting to the Home Choice using the EZ-Aide assist device and initiate therapy. I will show you how to use the EZ-Aide to make your connection and then start the therapy. You will pay close attention to what I am doing and explaining. After you watch me several times, I will ask you to repeat the steps back to me. When you can repeat the critical steps, we will know that you are ready to practice.”

LEARNER ACTIVITIES TEACHER ACTIVITIES NOTES

1. Pay attention and watch closely. “Memorize” pictures of steps. 1. Demonstrate the procedure using the practice apron as it would be normally performed.

2. Determine the critical steps/nuances 2. Repeat demonstration explaining each step in detail. Talk through what your hands are doing. 2. Use detailed Motor Skill Analysis.

3. Repetition. 3. Third demonstration point out the critical steps. Use the labels from the condensed analysis.

4. Repeat from memory the critical steps of the procedure. 4 Repeat until the learner is able to repeat the steps and the key words without error.

MOTOR SKILL—PRACTICE-LESSON PLAN

SUBJECT: Connecting to the Home Choice using the EZ-Aide Assist Device and Initiating Therapy.

OBJECTIVE: The learner will be able to connect to the Home Choice using the EZ-Aide assist device and initiate therapy.

MEDIA: Same as for the Cognitive Lesson Plan for this Motor Skill

REQUISITE KNOWLEDGE: Cognitive Lesson for this Motor Skill

HOW WILL I EVALUATE WHETHER LEARNING HAS OCCURRED? The learner will safely connect to the Home Choice using the EZ-Aide and initiate therapy.

GETTING THE LEARNER READY: “Now it is your turn to practice connecting to the Home Choice using the EZ-Aide assist device and initiate the therapy. Practice until you feel you can do it without thinking. I will give you feedback about how you are doing. It doesn't matter if you make some mistakes. I will help correct them as you go along. You can practice as long as you need to. When you think you know how to do the procedure, I will ask you to do it on your own without any help from me.”

LEARNER ACTIVITIES TEACHER ACTIVITIES NOTES

1. Hands on practice. 1. “Go ahead. It is your turn to practice.”

2. Continue to practice, reducing errors to a minimum 2. Provide immediate, accurate feedback focused on what is correct. Correct any errors by stating what the correct steps are. 2. Should be a constant commentary about the performance indicating those things that are done correctly and correcting errors by stating what the correct step is.

3. Begin to monitor self, detecting errors and correcting them.

4. Repeat often enough for steps to become smooth error free and automatic. 4. Test for automatic stage by asking the learner to perform the procedure while conversing with them 4. Topic should be unrelated to the procedure.

MOTOR SKILL ANALYSIS—DETAILED

SUBJECT: Connecting to the Home Choice using the EZ-Aide Assist Device and Initiating Therapy.

Steps to Take Tricks of the Trade

1. Verify that the Home Choice display reads “Connect Yourself”. 1. Previously learned.

2. Secure the EZ-Aide directly in front of you on the work surface, lock the arm in place. 2. Previously learned.

3. Clean the work surface. 3. Previously learned. In this motor skill the work surface includes the top surface of the EZ-Aide.

4. Prepare self, mask and wash hands. 4. Previously learned.

5. Sit down.

6. With your right hand grasp the transfer set between your thumb and forefinger at the light blue finger grip area.

7. Insert the Minicap into the left front well going all the way into the well with the grooves on the sides of the Minicap at 9:00 and 3:00.

8. Release the light blue finger grip area.

9. Clamp the patient line.

10. Using your right thumb and forefinger remove the patient line from the organizer.

11. With the light blue pull tab pointed up slide the patient line into and to the rear of the patient connector slot.

12. Pull down on the patient line, removing the light blue pull tab and seating the circular connector flange into the grooves of the patient connector slot.

13. Pull the patient line toward you sliding the circular flange along the groove until it cannot go any further.

14. Remove your right hand.

15. With the thumb and forefinger of your right hand grasp the transfer set at the light blue finger grip area.

16. Wrap your remaining fingers around the transfer set.

17. Twist the transfer set to the left unscrewing it from the Minicap.

18. Remove the transfer set from the Minicap.

19. Place the dark blue tip of the transfer set into the patient connector.

20. Twist the transfer set to the right until it is secure. 20. If the patient has sufficient manual dexterity and to avoid twisting the catheter, they may lift the connection out of the EZ-Aide and twist the connector to the transfer set.

21. Slide the patient connector to the rear of the patient connector slot and lift it out.

22. Open the transfer set.

23. Unclamp the patient line.

24. Press ‘GO’, verify the display screen reads “Initial Drain”.

25. Tape the transfer set to your abdomen and remove face mask. 25. Secure the transfer set in some way to prevent pulling during sleep.

26. Remove the used Minicap from the front well, and place outside the work area.

MOTOR SKILL ANALYSIS—CONDENSED

SUBJECT: Connecting to the Home Choice using the EZ-Aide Assist Device and Initiating Therapy.

Brief Description of Logically Grouped Steps Label

1. Verify Home Choice reads “Connect Yourself”, secure the EZ Aide and lock the arm. Clean work surface, prepare self. 1. Prepare.

2. Put the transfer set in the right front well in the EZ Aide, clamp the patient line and slide into the EZ-Aide, remove light blue pull tab. 2. Remove tab.

3. Unscrew transfer set from the Minicap. 3. Remove Minicap

4. Screw the dark blue sterile tip into the patient connector line. 4. Connect.

5. Remove connection from the EZ-Aide. 5. Remove.

6. Unclamp patient line, open the transfer set. 6. Open clamps.

7. Press “GO”.

8. Secure the transfer set.

MOTOR SKILL—COGNITIVE-LESSON PLAN

SUBJECT: Ending the Therapy using the EZ-Aide Assist Device.

OBJECTIVE: The learner will be able to end the therapy using the EZ-Aide assist device.

MEDIA: EZ-Aide, lap pad, mask, practice apron with transfer set, clamp, Minicap, Home Choice, cassette, solution bags (saline bag for use with practice apron), drain line or bag. The cycler should be set up with display reading ‘Disconnect Yourself’.

REQUISITE KNOWLEDGE: Maintaining Asepsis, Transfer Set/Clamps Unit, Home Choice/Disposable Components, Gathering Supplies, Prepare Self.

HOW WILL I EVALUATE WHETHER LEARNING HAS OCCURRED? The learner will repeat the steps for ending the Home Choice therapy using the EZ-Aide assist device.

GETTING THE

LEARNER READY: At the end of this lesson you will know the steps for ending the Home Choice therapy using the EZ-Aide assist device. I will show you how to use the EZ-Aide to end the therapy. You will pay close attention to what I am doing and explaining. After you watch me several times, I will ask you to repeat the steps back to me. When you can repeat the critical steps, we will know that you are ready to practice.”

LEARNER ACTIVITIES TEACHER ACTIVITIES NOTES

1. Pay attention and watch closely. “Memorize” pictures of steps. 1. Demonstrate the procedure using the practice apron as it would be normally performed.

2. Determine the critical steps/nuances 2. Repeat demonstration explaining each step in detail. Talk through what your hands are doing. 2. Use detailed Motor Skill Analysis.

3. Repetition. 3. Third demonstration point out the critical steps. Use the labels from the condensed analysis.

4. Repeat from memory the critical steps of the procedure. 4 Repeat until the learner is able to repeat the steps and the key words without error.

MOTOR SKILL—PRACTICE-LESSON PLAN

SUBJECT: Ending the Therapy using the EZ-Aide Assist Device.

OBJECTIVE: The learner will be able to end the therapy using the EZ-Aide assist device.

MEDIA: Same as for the Cognitive Lesson Plan for this Motor Skill

REQUISITE KNOWLEDGE: Cognitive Lesson for this Motor Skill

HOW WILL I EVALUATE WHETHER LEARNING HAS OCCURRED? The learner will safely end the Home Choice therapy using the EZ-Aide.

GETTING THE LEARNER READY: “Now it is your turn to practice ending the therapy on the Home Choice using the EZ-Aide assist device. Practice until you feel you can do it without thinking. I will give you feedback about how you are doing. It doesn't matter if you make some mistakes. I will help correct them as you go along. You can practice as long as you need to. When you think you know how to do the procedure, I will ask you to do it on your own without any help from me.”

LEARNER ACTIVITIES TEACHER ACTIVITIES NOTES

1. Hands on practice. 1. “Go ahead. It is your turn to practice.”

2. Continue to practice, reducing errors to a minimum 2. Provide immediate, accurate feedback focused on what is correct. Correct any errors by stating what the correct steps are. 2. Should be a constant commentary about the performance indicating those things that are done correctly and correcting errors by stating what the correct step is.

3. Begin to monitor self, detecting errors and correcting them.

4. Repeat often enough for steps to become smooth error free and automatic. 4. Test for automatic stage by asking the learner to perform the procedure while conversing with them 4. Topic should be unrelated to the procedure.

MOTOR SKILL ANALYSIS—DETAILED

SUBJECT: Ending the Therapy using the EZ-Aide Assist Device.

Steps to Take Tricks of the Trade

1. Verify that the informational display reads “End of Therapy”.

2. Make sure you have mask, hand washing material, and new Minicap within your reach.

3. Record treatment information.

4. Press the green GO button one time. Display should read “Close Clamps”.

5. Close your transfer set.

6. Close the clamp on the patient line.

7. Close the clamps on the heater line, supply lines, and drain bag/line.

8. Press the green GO button one time. Display should read “Disconnect Yourself”.

9. Put on mask and wash hands.

10. Place L thumb and forefinger on the patient line and the R thumb and forefinger on the light blue finger grip area and wrap the remaining fingers around the transfer set.

11. With the transfer set pointing down slide the patient line into and all the way to the rear of the patient connector slot.

12. Pull down on the patient line until the circular flange sits on the grooves of the slot.

13. Pull the patient line toward you sliding the circular flange along the groove until it cannot go any further.

14. Remove your hands.

15. Open the arm by pinching the two tabs of the arm together. Move the arm to the right

16. Fold back the flaps of the Minicap package.

17. With the writing side down, place the bottom flap in-between the arm and the base at the notch.

18. Close the arm.

19. Check to make sure the Minicap package is secured.

20. With the thumb and forefinger of the right hand, grasp the top flap of the Minicap package and peel to the right opening the package slowly.

21. Using the right thumb and forefinger pick up the Minicap by the smooth sides just below the opening so the opening is facing you. 21. Caution the learner to keep their fingers on the outside of the Minicap.

22. Slide the Minicap into the right front well with the Minicap grooves at 9:00 and 3:00.

23. Check the Minicap to make sure the betadine sponge is in place.

24. With the thumb and forefinger of the left hand, grasp the patient line.

25. With the thumb and forefinger of the right hand, grasp the light blue finger grip area and wrap the remaining fingers around the transfer set.

26. Twist the transfer set to the left unscrewing it from the patient connector.

27. Remove the transfer set from the patient connector.

28. Place the dark blue tip of the transfer set into the Minicap.

29. Twist the transfer set to the right screwing the Minicap on until is stops.

30. Remove the transfer set from the EZ-Aide well.

31. Secure the transfer set to the abdomen as instructed.

32. Press the green “GO” button once. Verify the informational display ready “Turn Me Off”. Reach to the back right of the machine and turn machine off.

33. Lift the handle of the Home Choice machine. Open the door. Remove the cassette from the machine. Closed the door. Push the handle down. Discard all of the tubing. 33. Previously learned.

34. If using drain bag, dispose of effluent. 34. Refer to Disposal of Effluent Lesson Plan.

MOTOR SKILL ANALYSIS—CONDENSED

SUBJECT: Ending the therapy using the EZ-Aide Assist Device.

Brief Description of Logically Grouped Steps Label

1. Verify informational display reads “End of Therapy”. 1. Therapy complete.

2. Record treatment data. 2. Record.

3. Press “GO”. Display changes to “Close all Clamps”. 4. Close all clamps. Close transfer set. 3. Close clamps.

5. Press “GO”. Display changes to “Disconnect Yourself”. Put on Mask and wash hands. 4. Mask and wash hands.

6. Put the patient connector in the EZ-Aide patient connector slot. 5. Insert connection 0into EZ-Aide.

7. Open the Minicap and put the Minicap in the well. 6. Prepare Minicap.

8. Unscrew the transfer set, screw on the Minicap. 7. Disconnect.

9. Turn machine off, remove all tubing and bags from machine. Close door. Discard effluent. 8. Turn off and discard disposables.

MOTOR SKILL—COGNITIVE-LESSON PLAN

SUBJECT: Ending the Therapy.

OBJECTIVE: The learner will be able to repeat the critical steps in disconnecting from the Home Choice when the APD treatment is complete.

MEDIA: Home Choice set-up connected to practice apron, informational display reading “End of Therapy”, mask, cleaning wipes, minicap, lap pad, and garbage can.

REQUISITE KNOWLEDGE: Maintaining Asepsis, Components of the Home Choice/Disposables, Components of Transfer set, Opening/closing the Transfer set.

HOW WILL I EVALUATE WHETHER LEARNING HAS OCCURRED? The learner will repeat the steps for disconnecting from the Home Choice and ending therapy.

GETTING THE LEARNER READY: “At the end of this lesson you will know the steps for disconnecting from the Home Choice when the APD treatment is complete. I will show you how to disconnect from the cycler. You will pay close attention to what I am doing and explaining. After you watch me several times, I will ask you to repeat the steps back to me. When you can repeat the critical steps for ending the therapy, I will know that you are ready to practice the procedure yourself.”

LEARNER ACTIVITIES TEACHER ACTIVITIES NOTES

1. Pay attention and watch closely. “Memorize” pictures of steps. 1. Demonstrate the procedure using the practice apron as it would be normally performed. 1.Cycler is set up with display reading “End of Therapy”, and connected to the practice apron.

2. Determine the critical steps/nuances 2. Repeat demonstration explaining each step in detail. Talk through what your hands are doing. 2. Use detailed Motor Skill Analysis.

3. Repetition. 3. Third demonstration point out the critical steps. Use the labels from the condensed analysis.

4. Repeat from memory the critical steps of the procedure. 4 Repeat until the learner is able to repeat the steps and the key words without error.

MOTOR SKILL—PRACTICE-LESSON PLAN

SUBJECT: Ending the Therapy

OBJECTIVE: The learner will be able to disconnect from the Home Choice when the APD treatment is complete.

MEDIA: Same as for the Cognitive Lesson Plan for this Motor Skill

REQUISITE KNOWLEDGE: Cognitive Lesson for this Motor Skill

HOW WILL I EVALUATE WHETHER LEARNING HAS OCCURRED? The learner will safely disconnect from the Home Choice when the APD treatment is complete.

GETTING THE LEARNER READY: “Now it is your turn to practice disconnecting from the cycler. Practice until you feel you can do it without thinking. I will give you feedback about how you are doing. It doesn't matter if you make some mistakes. I will help correct them as you go along. You can practice as long as you need to. When you think you know how to do the procedure, I will ask you to do it on your own without any help from me.”

LEARNER ACTIVITIES TEACHER ACTIVITIES NOTES

1. Hands on practice. 1. “Go ahead. It is your turn to practice.” 1. Have the cycler set up and connected to practice apron for the patient to practice with.

2. Continue to practice, reducing errors to a minimum 2. Provide immediate, accurate feedback focused on what is correct. Correct any errors by stating what the correct steps are. 2. Should be a constant commentary about the performance indicating those things that are done correctly and correcting errors by stating what the correct step is.

3. Begin to monitor self, detecting errors and correcting them.

4. Repeat often enough for steps to become smooth error free and automatic. 4. Test for automatic stage by asking the learner to perform the procedure while conversing with them 4. Topic should be unrelated to the procedure.

MOTOR SKILL ANALYSIS—DETAILED

SUBJECT: Ending the Therapy

Steps to Take Tricks of the Trade

1. Verify that the informational display reads “End of Therapy”.

2. Make sure you have mask, hand washing material, and new MiniCap within your reach. 2. Should have these supplies gathered as part of Start of Therapy.

3. Record treatment information. 3. Previously learned.

4. Press the green GO button one time. Display should read “Close Clamps”.

5. Close your transfer set. 5. Previously learned.

6. Close the clamp on the patient line. 6. Previously learned.

7. Close the clamps on the heater line, supply lines, and drain bag/line. 7. Previously learned.

8. Press the green GO button one time. Display should read “Disconnect Yourself”.

9. Put on mask and wash hands 9. Previously learned.

10. Open MiniCap. 10. Previously learned.

11. Pick up the Minicap and look inside it to make sure that the sponge is wet with Betadine.

12. Replace the Minicap on the clean foil surface of the Minicap package with the open end facing away from you.

13. Grasp the transfer set between the thumb and forefinger of the left hand, using the light blue finger grip area. Hold the left hand so that the end of the transfer set is pointed down.

14. Grasp the patient line between the thumb and forefinger of the right hand by the ridges below the circular flange.

15. Holding the left hand steady, twist the patient line clockwise to remove it from the transfer set.

16. Drop the patient line from the right hand.

17. Pick up the Minicap on the finger grip area between the thumb and forefinger of the right hand.

18. Bring the Minicap up to the transfer set and screw counter-clockwise to secure. Remove your mask.

19. Secure transfer set and catheter to abdomen as instructed.

20. Press green GO button once. Verify the informational display reads “Turn me off”. Reach to the back right of the machine and turn machine off.

21. If using drain bag, disconnect drain bag from Home Choice drain line.

22. Lift the handle on the Home Choice machine. Open the door. Remove the cassette from the machine. Close the door. Push the handle down. Discard all of the tubing. 22. Previously learned.

23. If using drain bag, dispose of effluent. 23. Refer to Disposal of Effluent Lesson Plan.

MOTOR SKILL ANALYSIS-CONDENSED

SUBJECT: Ending the Therapy

Brief Description of Logically Grouped Steps Label

1. Verify display reads “End of Therapy”. 1. Therapy complete.

2. Record treatment data. 2. Record.

3. Press Go. Display changes to “Close all Clamps”. Close all clamps (including transfer set) 3. Close Clamps.

4. Press Go. Display changes to “Disconnect Yourself”. Put on Mask and Wash hands. 4. Mask and Wash Hands.

5. Open new Mini Cap. Disconnect from Home Choice patient line. Apply new minicap. Turn machine off. 5. Disconnect yourself and turn machine off.

6. Remove all tubing and bags from machine. Close door. Discard effluent. 6. Discard tubing set and effluent.

MOTOR SKILL—COGNITIVE-LESSON PLAN

SUBJECT: Ending the Therapy.

OBJECTIVE: The learner will be able to repeat the critical steps in disconnecting from the Home Choice when the APD treatment is complete.

MEDIA: Home Choice set-up connected to practice apron, informational display reading “End of Therapy”, mask, cleaning wipes, minicap, lap pad, and garbage can.

REQUISITE KNOWLEDGE: Maintaining Asepsis, Components of the Home Choice/Disposables, Components of transfer set, Opening/closing the transfer set, Components of the minicap, Opening a sterile package,

HOW WILL I EVALUATE WHETHER LEARNING HAS OCCURRED? The learner will repeat the steps for disconnecting from the Home Choice and ending therapy.

GETTING THE LEARNER READY: “At the end of this lesson you will know the steps for disconnecting from the Home Choice when the APD treatment is complete. I will show you how to disconnect from the cycler. You will pay close attention to what I am doing and explaining. After you watch me several times, I will ask you to repeat the steps back to me. When you can repeat the critical steps for ending the therapy, I will know that you are ready to practice the procedure yourself.”

LEARNER ACTIVITIES TEACHER ACTIVITIES NOTES

1. Pay attention and watch closely. “Memorize” pictures of steps. 1. Demonstrate the procedure using the practice apron as it would be normally performed. 1. Cycler is set up with display reading “End of Therapy”, and connected to the practice apron.

2. Determine the critical steps/nuances 2. Repeat demonstration explaining each step in detail. Talk through what your hands are doing. 2. Use detailed Motor Skill Analysis.

3. Repetition. 3. Third demonstration point out the critical steps. Use the labels from the condensed analysis.

4. Repeat from memory the critical steps of the procedure. 4 Repeat until the learner is able to repeat the steps and the key words without error.

MOTOR SKILL—PRACTICE-LESSON PLAN

SUBJECT: Ending the Therapy

OBJECTIVE: The learner will be able to disconnect from the Home Choice when the APD treatment is complete.

MEDIA: Same as for the Cognitive Lesson Plan for this Motor Skill

REQUISITE KNOWLEDGE: Cognitive Lesson for this Motor Skill

HOW WILL I EVALUATE WHETHER LEARNING HAS OCCURRED? The learner will safely disconnect from the Home Choice when the APD treatment is complete.

GETTING THE LEARNER READY: “Now it is your turn to practice disconnecting from the cycler. Practice until you feel you can do it without thinking. I will give you feedback about how you are doing. It doesn't matter if you make some mistakes. I will help correct them as you go along. You can practice as long as you need to. When you think you know how to do the procedure, I will ask you to do it on your own without any help from me.”

LEARNER ACTIVITIES TEACHER ACTIVITIES NOTES

1. Hands on practice. 1. “Go ahead. It is your turn to practice.” 1. Have the cycler set up and connected to practice apron for the patient to practice with.

2. Continue to practice, reducing errors to a minimum 2. Provide immediate, accurate feedback focused on what is correct. Correct any errors by stating what the correct steps are. 2. Should be a constant commentary about the performance indicating those things that are done correctly and correcting errors by stating what the correct step is.

3. Begin to monitor self, detecting errors and correcting them.

4. Repeat often enough for steps to become smooth error free and automatic. 4. Test for automatic stage by asking the learner to perform the procedure while conversing with them 4. Topic should be unrelated to the procedure.

MOTOR SKILL ANALYSIS—DETAILED

SUBJECT: Ending the Therapy

Steps to Take Tricks of the Trade

1. Verify that the informational display reads “End of Therapy”.

2. Make sure you have mask, hand washing material, and new MiniCap within your reach. 2. Should have these supplies gathered as part of Start of Therapy.

3. Record treatment information. 3. Previously learned.

4. Press the green GO button one time. Display should read “Close Clamps”.

5. Close your transfer set. 5. Previously learned.

6. Close the clamp on the patient line. 6. Previously learned.

7. Close the clamps on the heater line, supply lines, and drain bag/line. 7. Previously learned.

8. Press the green GO button one time. Display should read “Disconnect Yourself”.

9. Put on mask and wash hands 9. Previously learned.

10. Open MiniCap. 10. Previously learned.

11. Pick up the Minicap and look inside it to make sure that the sponge is wet with Betadine.

12. Replace the Minicap on the clean foil surface of the Minicap package with the open end facing away from you.

13. Grasp the transfer set between the thumb and forefinger of the left hand, using the light blue finger grip area. Hold the left hand so that the end of the transfer set is pointed down.

14. Grasp the patient line between the thumb and forefinger of the right hand by the ridges below the circular flange.

15. Holding the left hand steady, twist the patient line clockwise to remove it from the transfer set.

16. Drop the patient line from the right hand.

17. Pick up the Minicap on the finger grip area between the thumb and forefinger of the right hand.

18. Bring the Minicap up to the transfer set and screw counter-clockwise to secure. Remove your mask.

19. Secure transfer set and catheter to abdomen as instructed.

20. Press green GO button once. Verify the informational display reads “Turn me off”. Reach to the back right of the machine and turn machine off.

21. If using drain bag, disconnect drain bag from Home Choice drain line.

22. Lift the handle on the Home Choice machine. Open the door. Remove the cassette from the machine. Close the door. Push the handle down. Discard all of the tubing. 22. Previously learned.

23. If using drain bag, dispose of effluent. 23. Refer to Disposal of Effluent Lesson Plan.

MOTOR SKILL ANALYSIS—CONDENSED

SUBJECT: Ending the Therapy

Brief Description of Logically Grouped Steps Label

1. Verify display reads “End of Therapy”. 1. Therapy complete.

2. Record treatment data. 2. Record.

3. Press Go. Display changes to “Close all Clamps”. Close all clamps (including transfer set) 3. Close Clamps.

4. Press Go. Display changes to “Disconnect Yourself”. Put on Mask and Wash hands. 4. Mask and Wash Hands.

5. Open new Mini Cap. Disconnect from Home Choice patient line. Apply new minicap. Turn machine off. 5. Disconnect yourself and turn machine off.

6. Remove all tubing and bags from machine. Close door. Discard effluent. 6. Discard tubing set and effluent.

MEMORY/HABIT LEARNING LESSON PLAN

SUBJECT: Home Choice Record Keeping

OBJECTIVE: The learner will be able to retrieve and record information at end of therapy.

KIND OF LEARNING: Memory/Habit. This is a simple lesson plan and is complete by itself.

MEDIA: Home Choice cycler connected to practice apron with Informational Display reading “END OF THERAPY”, CCPD flow sheet, and pen.

REQUISITE KNOWLEDGE: Components of Home Choice.

HOW WILL I EVALUATE WHETHER LEARNING HAS OCCURRED? The learner accurately retrieves and records information from Home Choice at end of therapy.

GETTING THE LEARNER READY: “Now you are going to learn to retrieve vital information from the Home Choice when your therapy is complete, and record on your CCPD flow sheet. I will know you have learned this when you can retrieve the information and record it without error”.

LEARNER ACTIVITY TEACHER ACTIVITY NOTES

1. Pay attention. Repeat items to be memorized. 1. Present the information to be memorized: Initial Drain Total UF Average Dwell Time 1. Learner to form own associations.

2. Pay attention. 2. Show the learner how to press the down arrow to retrieve information. Show where to record information on the CCPD flow sheet.

3. Practice/Test. Learner will retrieve information from Home choice cycler and record on the CCPD flow sheet. 3. Provide feedback to learner.

MEMORY/HABIT LEARNING LESSON PLAN

SUBJECT: Disposal of Effluent

OBJECTIVE: The learner will be able to safely and properly dispose of the effluent following the APD treatment using Home Choice.

KIND OF LEARNING: Memory/Habit. This is a simple lesson plan and is complete by itself without a memory learning analysis.

MEDIA: Video-“Baxter Renal Home Patient Waste Disposal Guidelines”. Home Choice drain bag containing water/effluent.

REQUISITE KNOWLEDGE: Components of Home Choice/Disposables.

HOW WILL I EVALUATE WHETHER LEARNING HAS OCCURRED? The learner will demonstrate safe and proper disposal of the effluent in the clinic and verbalize disposal of effluent in the home.

GETTING THE LEARNER READY: Now it is time to dispose of the drained fluid. I will show you how to do this in the clinic. You will also see a video tape about how you will do this at home. You will watch very carefully at the key steps. I will review with you the components of the drain bag. You will need to know when to open the large clamp on the drainage tube to empty the bag. Then I will have you practice emptying the drain bag and tell me how you will do this at home.

LEARNER ACTIVITY TEACHER ACTIVITY NOTES

1. Repeat information several times. 1. Present information to be memorized. Tell the learner to ask questions. 1. Point out large clamp on drainage tube and small clamp on spike.

2. Form own associations. 2. Present videotape. 2. Time is 8:55.

3. Practice/Test. Learner to demonstrate effluent disposal in clinic and verbalize effluent disposal at home. 3. Question and provide feedback

JUDGMENT/DECISION LEARNING LESSON PLAN

SUBJECT: Home Choice Judgments and Decisions

OBJECTIVE: The learner will be able to take the correct action when presented with a scenario.

MEDIA: Home Choice, cassette, drain option, solution bags, minicap, clamp, CCPD flow sheet, lap pad, CXD, mask, paper towels, hand wipes, liquid anti-bacterial soap,

REQUISITE KNOWLEDGE: Asepsis, All lessons pertaining to Home Choice

HOW WILL I EVALUATE WHETHER LEARNING HAS OCCURRED? The learner will take the correct action when presented with a scenario.

GETTING THE LEARNER READY: “Now that you have memorized the decision points in the Home choice procedure, we will focus on what to look for at each one. I will tell you what to look for at each point and how to decide if you can continue with the procedure. Pay attention and listen carefully. As we finish each step, I will give you some scenarios and I want you to guess what the next step is to take. Don't worry about making mistakes, I will help you as you go along.”

LEARNER ACTIVITY TEACHER ACTIVITY NOTES

1. Pay attention and recall concepts. 1. Demonstrate the first phase of the home choice procedure, pointing out what the learner should be looking for. (Judgments) 1. Present one phase of the Home Choice procedure at a time. This lesson applies to each of the lessons that follow.

2. Learner repeats the key judgments of the phase. 2. Ask the learner to repeat the key judgments.

3. Examine the scenarios and guess the correct action. 3. Present scenarios and ask the learner to guess at the correct action to take. 3. Present one or more scenarios, problematic and non-problematic for each key judgment and each possible action the learner could take.

4. Process the feedback from the teacher and continue to guess at scenarios. 4. Continue to present until the learner is guessing correctly. 4. When the learner is guessing correctly, move on to the next phase of the procedure.

JUDGMENT/DECISION LEARNING ANALYSIS

SUBJECT: Determine if preparation is complete before Home Choice set-up is begun

LIST OF PRINCIPLES USED TO MAKE THE JUDGMENT/DECISION:

What the Learner should be looking for? (Judgments) What choices(s)/possible action steps should be taken. (Decisions) (some judgments will have several action steps)

Notes

1. Gathering supplies has been completed. 2. Inspection of supplies has been completed. 3. Cleaning the work surface has been completed. 4. Home Choice is placed properly. 5. Home Choice plugged into appropriate outlet. 6. Exchange area is acceptable. Doors and windows are closed, fans are off. No pets. 1. Gather supplies. 2. Clean the work surface. 3. Close doors, windows. Shut off fans. Remove pets. 4. Machine plugged into 3-prong outlet5. Machine placed at bed level. 6. Inspect all supplies—discard unusable disposables. Possible Scenarios: 1. Learner does not have all supplies ready. 2. Exchange area unacceptable. 3. Home choice placed on high dresser. 4. Inspection of cassette reveals cap missing off spike.

JUDGMENT/DECISION LEARNING ANALYSIS

SUBJECT: Determine if set has been loaded properly.

LIST OF PRINCIPLES USED TO MAKE THE JUDGMENT/DECISION:

If the set is not loaded properly, the machine will not function properly.

What the learner should be looking for? (Judgments) What choice(s)/possible action steps should be taken? (Decisions) (some judgments will have several action steps)

Notes

1. Cassette is installed securely in the door. 2. Organizer hanging appropriately on front of machine. 3. Drain line attached correctly, and secured into toilet, OR drain bag attached correctly, and placed on floor next to machine. 4. Large clamp on drain bag clamped. 5. Clamps on solution bags and effluent sample line are closed. 6. Caps are present on all spikes and patient line. 7. After machine has been turned on and GO button is pressed, informational display reads “Load the Set”. 1. Use a new set if set does not pass inspection. 2. If informational display reads “Load a New Set”—Try to re-install same set If prompted a second time, install a new set. 3. Close clamps solution line patient line effluent sample line large clamp on drain bag Possible Scenarios: 1. Informational display reads “Load a New Set”. 2. Home Choice set-up with large clamp open on drain bag.

JUDGMENT/DECISION LEARNING ANALYSIS

SUBJECT: Determine if solution bags are spiked properly.

LIST OF PRINCIPLES USED TO MAKE THE JUDGMENT/DECISION:

If asepsis is not maintained, contamination may result.

If contamination occurs, peritonitis may result.

If lines remain clamped after spiking, priming cannot take place.

If bags are not spiked all the way, contamination may occur, and priming may not occur.

What the learner should be looking for? (Judgments) What choice(s)/possible action steps should be taken? (Decisions) (some judgments will have several action steps)

Notes

1. Masking and hand washing has been completed before spiking bags. 2. Spikes and solution bag outlet ports remain sterile throughout procedure. 3. Appropriate spike is used in each bag Red line to heater bag. Blue line to final fill bag. 4. Heater bag placed appropriately on heater cradle. 5. Other bags placed appropriately. 6. Lines free of kinks. 7. Clamps are removed from: outlet ports solution lines patient line 1. If contamination of spike occurs, load a new set2. If contamination of outlet port occurs, choose new solution bag. 3. Push the spike all the way into the solution bag. Possible Scenarios: 1. Open spike touches hand during spiking procedure. 2.

JUDGMENT/DECISON LEARNING ANALYSIS

SUBJECT: Determine if priming has been successfully completed.

LIST OF PRINCIPLES USED TO MAKE THE JUDGMENT/DECISION:

If priming is not complete, air infusion may result.

What the learner should be looking for? judgments) What choice(s)/possible action steps should be taken? (Decisions) (some judgments will have several action steps)

Notes to the Trainer

1. When priming is complete informational display will read “Connect Yourself”. 2. Visual inspection of solution lines and patient line to verify that air has been flushed out. 1. If air remains in the lines after priming is complete—re-prime the lines. Possible Scenarios: 1. Home Choice set-up with air in lines.

JUDGMENT/DECISION LEARNING ANALYSIS

SUBJECT: Determine that Connect to the Home Choice has been completed aseptically and therapy has been initiated.

LIST OF PRINCIPLES USED TO MAKE THE JUDGMENT/DECISION:

If asepsis is not maintained, contamination may result.

If contamination occurs, peritonitis may result.

What the Learner should be looking for? (Judgment) What choice(s)/possible action steps should be taken? (Decisions) (some judgments will have several action steps)

Notes to the Trainer

1. Prepare self has been completed before connecting self. 2. Minicap is intact on transfer set before connecting. 3. Patient line is secured to abdomen before retiring. 4.

Connection completed aseptically. 5. After connection is made and GO button is pressed, informational display reads “Initial drain”. 6. Effluent is draining. 1.

For contamination of patient line, begin entire set-up over. 2. For contamination of transfer set, apply new minicap and call unit for instructions.

Possible Scenarios: 1. Tip of transfer set touches lap pad during connection. 2.

Transfer set is found without minicap before connection.

JUDGMENT/DECISION LEARNING ANALYSIS

SUBJECT: Determine if disconnecting from the Home Choice was completed aseptically at the end of therapy.

LIST OF PRINCIPLES USED TO MAKE THE JUDGMENT/DECISION:

If asepsis is not maintained, contamination may occur.

If contamination occurs, peritonitis may result.

What the learner should be looking for? (Judgments) What choice(s)/possible action steps should be taken? (Decisions) (some judgments will have several action steps)

Notes to the Trainer

1. The informational display reads “End of Therapy.” 2. Prepare self has been completed before starting. 3. The minicap remains sterile when the connection is made. 4.

Check for a betadine soaked sponge inside the minicap. 5. The dark blue tip of the transfer set remains sterile when the connection is made. 1. Complete Prepare self. 2. If the minicap is contaminated in any way discard and use a new minicap. 3. If there is no betadine soaked sponge in the minicap discard and get a new one. 4. If the dark blue tip of the transfer set is contaminated place a new minicap on and call the unit. Possible Scenarios: 1. Minicap drops on the floor. 2. Patient touches the inside of the minicap. 3. Transfer set drops on to the lap pad. 4. Patient forgets to mask and “wash” hands. 5. Patient connected to Home Choice without mask and hand wipes accessible.

JUDGMENT/DECISION LEARNING ANALYSIS

SUBJECT: Record Keeping -determine if information retrieved is satisfactory.

LIST OF PRINCIPLES USED TO MAKE THE JUDGMENT/DECISION:

If total UF is inadequate, fluid overload may result.

If total UF is too much, dehydration may result.

If the average dwell time is decreasing, this may indicate a catheter malfunction.

What the Learner should be looking for (Judgments)What choice(s)/possible action steps should be taken. (Decisions) (some judgments will have several action steps)

Notes

1. Total UF is OK. 2. Dwell times are consistent. 1. Call unit as directed. 2. Adjust dextrose solutions as directed.Possible scenarios. 1. Informational display reads “Negative UF”. 2. Average dwell times show a decreasing trend.

PRINCIPLE LEARNING LESSON PLAN

SUBJECT: Incomplete Prime

OBJECTIVE: Learner will be able to recognize situations that may cause incomplete prime and realize this may cause air infusion.

MEDIA: Apron, Home Choice—set up ready to prime—with patient line incorrectly positioned.

REQUISITE KNOWLEDGE: Home Choice Prepare HC Set Up, Turn on Load Cassette, Spiking, Priming Cassette, HC JD Memory Lesson, Air Infusion Problem Solving Lesson.

HOW WILL I EVALUATE WHETHER LEARNING HAS OCCURRED? Learner states the principles “If the Home Choice patient line is not correctly positioned, then it may not prime completely”, and “If the Home Choice patient line is not completely primed, an air infusion may occur.”

GETTING THE LEARNER READY: “You have learned how to prime and what causes air infusion. Let's talk now about some reasons this may occur. I will present situations to you and ask you to guess whether or not they may cause incomplete prime. Don't be afraid to guess wrong, that is how you learn. When you are guessing correctly I will ask you why and if you answer correctly, then we will know you understand what causes this situation.

LEARNER ACTIVITY TEACHER ACTIVITY NOTES

1. Pay attention to concepts. 1. Review concepts and state principles.

2. Guess. 2. Teacher presents scenarios and asks learner to guess. Give feedback re: accuracy of description.

3. Continue guessing as scenarios that are examples and non-examples are presented.

3. Continue to present examples and non-examples until learner is guessing correctly most of the time.

4. Restate the principles linking the concepts. 4. Have learner restate the principle in their own words.

PRINCIPLE LEARNING ANALYSIS

SUBJECT: Incomplete Prime

List of Concepts Linked to Form Principle

1. If the Home Choice patient line is not correctly positioned, then it may not prime completely. 2. If the Home Choice patient line is not completely primed, an air infusion may occur.

Suggested Scenarios

1. Unprimed Home Choice Patient Line positioned eight inches above the organizer. Prime and demonstrate air bubble. 2. Home Choice Patient Line with obvious air bubble in end.

PROBLEM SOLVING LESSON PLAN

SUBJECT: Incomplete Prime

OBJECTIVE: Learner will be able to identify situations leading to incomplete prime/air infusion and take the appropriate action steps.

MEDIA: See Incomplete Prime Principle Lesson

REQUISITE KNOWLEDGE: Incomplete Prime Decision/Decision Lesson

HOW WILL I EVALUATE WHETHER LEARNING HAS OCCURRED? When presented with scenarios, learner will identify situations leading to incomplete prime/air infusion and take the appropriate action steps.

GETTING THE LEARNER READY: “You've learned about incomplete prime/air infusion and what to do if you have one. Now I will give you problem examples, ask you to tell me what you see, what you know about the situation and what you would do if this happened to you. I will help you along in working through the situation, so don't be afraid. When you can take the correct action, then we will know you can solve this problem at home.”

LEARNER ACTIVITY TEACHER ACTIVITY NOTES

1. Pay attention and recall the concepts. 1. Review associated concepts.

2. Pay attention. 2. State the principles.

3. Solve problems and take correct actions. 3. Present scenario(s) and ask learner to identify the and solve the problem. After each scenario, the teacher asks the learner to state the possible problem and describe the appropriate actions to take. 3. Teacher may need to prompt learner to solve the problem i.e. “What is happening here?”, “What do you know about this?”, and “What do you think you should do?”. If the learner is having difficulty identifying the problem then go back and review associated concepts.

Problem Solutions to Include Unit Specific Standing Orders.

4. Process feedback. 4. Continue feedback. 4. Continue presenting scenarios until learner is developing correct solutions and taking correct actions.

PROBLEM SOLVING LEARNING ANALYSIS

SUBJECT: Incomplete Prime

PROBLEM DESCRIPTION: Incomplete Prime.

LIST OF PRINCIPLES USED TO SOLVE THE PROBLEM:

1. If the Home Choice patient line is not correctly positioned, then it may not prime completely.

2. If the Home Choice patient line is not completely primed, an air infusion may occur.

Problem Scenario Problem Solution

1. Home Choice Patient Line, ready to prime (display reads CONNECT BAGS, bags spiked);Patient Line position six inches above level of organizer. 1. Learner repositions Patient Line in organizer; presses GO.

2. Home Choice Patient Line with obvious air bubble in end, line positioned eight inches above level of organizer. Display reads CONNECT YOURSELF. 1. Learner repositions Patient Line in organizer, presses Stop, arrows down until display reads REPRIME LINE, presses ENTER, observes for complete priming of Patient Line.

JUDGEMENT/DECISION LEARNING LESSON PLAN

SUBJECT: Incomplete Prime

OBJECTIVE: The learner will be able to identify situations that might lead to incomplete prime/air infusion and state the appropriate action.

MEDIA: See Incomplete Prime Principle Lesson.

REQUISITE KNOWLEDGE: Incomplete Prime Principle Lesson

HOW WILL I EVALUATE WHETHER LEARNING HAS OCCURRED? When presented with a scenario involving incomplete prime/ air infusion, the learner will state the correct action.

GETTING THE LEARNER READY: “Now that you understand what causes incomplete prime, it is time to learn what you can do if you accidentally do this at home. I will present situations to you and suggest some actions for you take if these happen to you. You just pay attention and try to memorize the correct actions. We will know that you have learned what to do when you can repeat to me what you should do if you have an air infusion.”

LEARNER ACTIVITY TEACHER ACTIVITY NOTES

1. Pay attention and recall the concepts. 1. Review associated concepts.

2. Pay attention. 2. State the principles. 2. See J/D Analysis

3. Pay attention. 3. Present what the learner should be looking for and possible action steps that should be taken. 3. The purpose of this lesson is to get the learner to memorize where/when judgments should be made and the correct actions that should be taken. Present verbally a scenario where shoulder pain is present without air infusion and scenarios using the media where an air infusion has occurred.

4. Repeat the judgment and decision. 4. Ask the learner to repeat the action steps.

5. Process feedback. 5. Provide feedback. 5. Continue until the learner has memorized.

JUDGEMENT/DECISION LEARNING ANALYSIS

SUBJECT: Incomplete Prime

LIST OF PRINCIPLES USED TO MAKE THE JUDGEMENT/DECISION:

1. If the Home Choice patient line is not correctly positioned, then it may not prime completely.

2. If the Home Choice patient line is not completely primed, an air infusion may occur.

What the Learner should be looking for? (Judgments) What choice(s)/possible action steps should be taken? (Decisions) (some judgments will have several action steps)

1. Home Choice Patient Line positioned above level of organizer. 1. Reposition line before priming.

2. Home Choice Patient Line with primed line and obvious air bubble. Display reads CONNECT YOURSELF. 2. If Home Choice Patient Line positioned above level of organizer, place properly. Reprime line: Press Stop, press down until REPRIME LINE, Press Enter.

PROBLEM SOLVING LESSON PLAN

SUBJECT: Incomplete Prime

OBJECTIVE: Learner will be able to identify situations leading to incomplete prime/air infusion and take the appropriate action steps.

MEDIA: See Incomplete Prime Principle Lesson

REQUISITE KNOWLEDGE: Incomplete Prime Decision/Decision Lesson

HOW WILL I EVALUATE WHETHER LEARNING HAS OCCURRED? When presented with scenarios, learner will identify situations leading to incomplete prime/air infusion and take the appropriate action steps.

GETTING THE LEARNER READY: “You've learned about incomplete prime/air infusion and what to do if you have one. Now I will give you problem examples, ask you to tell me what you see, what you know about the situation and what you would do if this happened to you. I will help you along in working through the situation, so don't be afraid. When you can take the correct action, then we will know you can solve this problem at home.”

LEARNER ACTIVITY TEACHER ACTIVITY NOTES

1. Pay attention and recall the concepts. 1. Review associated concepts.

2. Pay attention. 2. State the principles.

3. Solve problems and take correct actions. 3. Present scenario(s) and ask learner to identify the and solve the problem. After each scenario, the teacher asks the learner to state the possible problem and describe the appropriate actions to take. 3. Teacher may need to prompt learner to solve the problem i.e. “What is happening here?”, “What do you know about this?”, and “What do you think you should do?”. If the learner is having difficulty identifying the problem then go back and review associated concepts.

Problem Solutions to Include Unit Specific Standing Orders.

4. Process feedback. 4. Continue feedback. 4. Continue presenting scenarios until learner is developing correct solutions and taking correct actions.

PROBLEM SOLVING LEARNING ANALYSIS

SUBJECT: Incomplete Prime

PROBLEM DESCRIPTION: Incomplete Prime.

LIST OF PRINCIPLES USED TO SOLVE THE PROBLEM:

1. If the Home Choice patient line is not correctly positioned, then it may not prime completely.

2. If the Home Choice patient line is not completely primed, an air infusion may occur.

Problem Scenario Problem Solution

1. Home Choice Patient Line, ready to prime (display reads CONNECT BAGS, bags spiked);Patient Line position six inches above level of organizer. 1. Learner repositions Patient Line in organizer; presses GO.

2. Home Choice Patient Line with obvious air bubble in end, line positioned eight inches above level of organizer. Display reads CONNECT YOURSELF. 1. Learner repositions Patient Line in organizer, presses Stop, arrows down till display reads REPRIME LINE, presses ENTER, observes for complete priming of Patient Line.

CONCEPT LEARNING LESSON PLAN

SUBJECT: Home Choice Alarms

OBJECTIVE: The learner will identify Auto Restart, Manual Restart, and System Error Alarms.

MEDIA: Examples and non-examples (HC 12; FIG. 8L). See Concept Analysis.

REQUISITE KNOWLEDGE: Home Choice Set Up Procedures

HOW WILL I EVALUATE WHETHER LEARNING HAS OCCURRED? The learner will identify Auto Restart, Manual Restart, and System Error Alarm situations.

GETTING THE LEARNER READY: “At the end of this lesson you will be able to identify different alarm situations. I will create problem situations with the Home Choice setup and treatment that cause alarms. I will ask you to guess whether the alarm is a Manual Restart, Auto Restart or System Error. I will tell you if you are right or wrong and why. It is OK if you make mistakes, that is how you learn. We will keep doing this until you are guessing correctly all of the time. Then we will know you got it.”

LEARNER ACTIVITY TEACHER ACTIVITY NOTES

1. Pay attention to definition. 1. Give definition of concept. 1. May delay giving definition of concept to end of lesson.

2. Guess if it is example or non-example. 2. Present examples and non-examples of items to illustrate concept. Give learner feedback about accuracy of guesses. 2. Usually start with example/non-example pairs, then as learner is guessing correctly, present single examples and non-examples. Final examples and non-examples should be very close so learner must make fine discriminations.

3. Continue guessing as examples and non-examples are presented. 3. Continue to present examples and non-examples until learner is guessing correctly all of the time.

4. Help teacher formulate definition of concept. 4. Have learner formulate definition of concept with you. 4. If definition has been presented at start of lesson, have learner use own words to formulate definition.

CONCEPT LEARNING ANALYSIS

SUBJECT: Home Choice Alarms

Definition(Critical Characteristics)

1. Home Choice system finds a problem with the therapy, sounds an alarm, stops moving solution, and displays the type of alarm. 2. Auto Restart—3 beeps or 6 beeps, do not need to press any buttons. 3. Manual Restart—continuous beeping, must press Stop. 4. System Error—continuous beeping, display System Error: nnnn, must press Stop. Suggested Example/Non-Example Pairs(verbal descriptions, suggested pictures/video-clips, scenarios)

1. The Non-Examples would be any non-alarm condition. 2. While learner connected to Home Choice and in a drain phase, close patient line clamp. 3. Do not correct the situation in 2. Allow the 6 beeps to occur. 4. Do not correct the situation in 3. Allow the Auto Restart alarm to become a Manual Restart. 5. A picture of a display showing a System Error Alarm (HC 12). 6. During a set up leave the heater line clamped. 7. Bypass a fill phase that has just started. 8. Repeat situation 2., but open the patient line clamp after the 3 beeps. 9.Repeat situation 3., but open the patient line clamp after the 6 beeps.

PRINCIPLE LEARNING LESSON PLAN

SUBJECT: Home Choice Alarms

OBJECTIVE: Learner will recognize situations that may lead to Home Choice Alarms.

MEDIA: Home Choice, Home Choice Disposables, Pictures of System Error Display (HC 12).

REQUISITE KNOWLEDGE: Home Choice Setup Procedures, Home Choice Alarm Concept

HOW WILL I EVALUATE WHETHER LEARNING HAS OCCURRED? Learner states the principles: “If any line is closed due to kink, closed clamp or an empty bag is present then an Auto Restart Alarm—“CHECK DRAIN LINE”, “CHECK HEATER LINE”, etc.,—will occur”, “If one or more of the lines are closed or the solution bags are empty, then a Manual Restart Alarm—“CHECK LINES AND BAGS”—will occur”, “If you program a value that is unreasonable, a Manual Restart Alarm—“CHECK THERAPY TIME”, “CHECK TOTAL VOLUME”, etc.,—will occur”, NOTE: Do not use this principle if learner not taught how to program Home Choice, “If you try to bypass an alarm or phase and you have not completed the phase, then a Manual Restart Alarm—“DRAIN NOT FINISHED”, “FILL NOT FINISHED”, etc.,—will occur”, NOTE: Do not use this scenario if learner not taught how to bypass, “If the disposable cassette fails testing during setup, then a Manual Restart Alarm—“LOAD A NEW SET”—will occur”, “If you do not drain enough volume, then an Auto Restart Alarm—“LOW DRAIN VOLUME”—will occur”, “If fluid is moving too slow through the system, then an Auto Restart Alarm—“SLOW FLOW HEATER”, “SLOW FLOW PATIENT”, etc.,—will occur”, “If the machine is tilted, then an Auto Restart Alarm—“MACHINE TILTED”—will occur”, “If you retain more than 50% of your fill over the course of your treatment, then a Manual Restart Alarm—“CAUTION: NEGATIVE UF”—will occur”, “If your position is more than 1 foot above the Home Choice Machine, then an Auto Restart Alarm—“CHECK YOUR POSITION”—will occur”, “If the system detects an error in the way the cassette was loaded or a problem with the system, then a Manual Restart Alarm—“RELOAD SET”—will occur”, “If a problem occurs inside the Home Choice machine, then a System Error Alarm will occur”.

GETTING THE LEARNER READY: “You have learned the characteristics of the Home Choice alarms. Let's talk now about some causes of these alarms. I will present situations to you and ask you to guess whether or not they may cause an alarm. Don't be afraid to guess wrong, that is how you learn. When you are guessing correctly I will ask you why and if you answer correctly, then we will know you understand what causes Home Choice alarms.

LEARNER ACTIVITY TEACHER ACTIVITY NOTES

1. Pay attention to concepts. 1. Review concepts and state principles.

2. Guess. 2. Teacher presents scenarios and asks patient to guess. Give feedback re accuracy of description.

3. Continue guessing as scenarios that are examples and nonexamples are presented. 3. Continue to present examples and non examples until learner is guessing correctly most of the time.

4. Restate the principles linking the concepts. 4. Have learners restate the principle in their own words.

PRINCIPLE LEARNING ANALYSIS

SUBJECT: Home Choice Alarms

List of Concepts Linked to Form Principle

1. If any line is closed due to kink, closed clamp or an empty bag is present then an Auto Restart Alarm—“CHECK DRAIN LINE”, “CHECK HEATER LINE”, etc.,—will occur. 2. If one or more of the lines are closed or the solution bags are empty, then a Manual Restart Alarm—“CHECK LINES AND BAGS”—will occur. 3. If you program a value that is unreasonable, a Manual Restart Alarm—“CHECK THERAPY TIME”, “CHECK TOTAL VOLUME”, etc.,—will occur. NOTE: Do not use this principle if learner not taught how to program Home Choice. 4. If you try to bypass an alarm or phase and you have not completed the phase, then a Manual Restart Alarm—“DRAIN NOT FINISHED”, “FILL NOT FINISHED”, etc.,—will occur. NOTE: Do not use this scenario if learner not taught how to bypass. 5. If the disposable cassette fails testing during setup, then a Manual Restart Alarm—“LOAD A NEW SET”—will occur. 6. If you do not drain enough volume, then an Auto Restart Alarm—“LOW DRAIN VOLUME”—will occur. 7. If fluid is moving too slow through the system, then an Auto Restart Alarm—“SLOW FLOW HEATER”, “SLOW FLOW PATIENT”, etc.,—will occur. 8. If the machine is tilted, then an Auto Restart Alarm—“MACHINE TILTED”—will occur. 9. If you retain more than 50% of your fill over the course of your treatment, then a Manual Restart Alarm—“CAUTION: NEGATIVE UF”—will occur. 10. If your position is more than 1 foot above the Home Choice Machine, then an Auto Restart Alarm—“CHECK YOUR POSITION”—will occur. 11. If the system detects an error in the way the cassette was loaded or a problem with the system, then a Manual Restart Alarm—“RELOAD SET”—will occur. 12. If a problem occurs inside the Home Choice machine, then a System Error Alarm will occur.

Suggested Scenarios

1. While learner connected to Home Choice and in a drain phase, close patient line clamp. Alarm beeps 3 times, display reads “CHECK DRAIN LINE”. 2. During a set up leave the heater line clamped. Alarm beeps 3 times, display reads “CHECK HEATER LINE”. 3. During a set up leave the heater line and the drain line clamped. Alarm beeps continuously, display reads “CHECK LINES AND BAGS”. 4. Program the following: Total Volume: 10,000, Therapy Time: 00:10, Fill Vol: 2000 ml, Last Fill Vol: 0 ml. Press Stop. Alarm beeps continuously, display reads “CHECK THERAPY TIME”. NOTE: Do not use this scenario if learner not taught how to program Home Choice. 5. While learner connected to Home Choice and in a fill phase, attempt to bypass the fill. Alarm beeps continuously, display reads “FILL NOT FINISHED”. NOTE: Do not use this scenario if learner not taught how to bypass. 6. Tell the learner that they are setting up the cycler. Show the learner a picture of a display that reads “LOAD A NEW SET”. Tell the learner that the alarm is beeping continuously. 7. Tell the learner that they are on the Home Choice, in drain and an alarm beeps 3 times, display reads “LOW DRAIN VOLUME”. 8. While learner connected to Home Choice and in a fill phase, partially kink the heater line. Alarm beeps 3 times, display reads “SLOW FLOW HEATER”. 9. Prop one end of the Home Choice up on a book. Alarm beeps 3 times, display reads “MACHINE TILTED”. 10. Tell the learner that they are on the Home Choice, at the end of a drain and the alarm beeps continuously, display reads “CAUTION: NEGATIVE UF”. 11. . While learner connected to Home Choice and in a fill phase, have them stand up. Alarm beeps 3 times, display reads “CHECK YOUR POSITION”. 12. Tell the learner that they are setting up the Home Choice. Tell the learner the display reads “RELOAD SET”. Tell the learner that the alarm is beeping continuously. 13. Show the learner a picture of a display that reads “SYSTEM ERROR: nnnn”.(HC 12) Tell them that the alarm is beeping continuously. JUDGEMENT/DECISION LEARNING LESSON PLAN

SUBJECT: Home Choice Alarms

OBJECTIVE: Learner will recognize situations that may lead to Home Choice Alarms and state the appropriate actions to take to correct the alarm condition.

MEDIA: See Home Choice Alarms Principle Lesson

REQUISITE KNOWLEDGE: Home Choice Alarms Principle Lesson, Fibrin Problem Solving Lesson, Constipation Problem Solving Lesson.

HOW WILL I EVALUATE WHETHER LEARNING HAS OCCURRED? When presented with a scenario involving situations that may lead to Home Choice Alarms, the learner will state the correct actions to take to correct the alarm condition.

GETTING THE LEARNER READY: “Now that you understand what causes Home Choice Alarms, it is time to learn what you can do if this happens to you at home. I will present situations to you and suggest some actions for you take if these happen to you. You just pay attention and try to memorize the correct actions. We will know that you have learned what to do when you can repeat to me what you should do if you have an alarm on the Home Choice.”

LEARNER ACTIVITY TEACHER ACTIVITY NOTES

1. Pay attention and recall the concepts. 1. Review associated concepts.

2. Pay attention. 2. State the principles. 2. See J/D Analysis

3. Pay attention. 3. Present what the learner should be looking for and possible action steps that should be taken. 3. The purpose of this lesson is to get the learner to memorize where/when judgments should be made and the correct actions that should be taken.

4. Repeat the judgment and decision. 4. Ask the learner to repeat the action steps.

5. Process feedback. 5. Provide feedback. 5. Continue until the learner has memorized.

JUDGEMENT/DECISION LEARNING ANALYSIS

SUBJECT: Home Choice Alarms

LIST OF PRINCIPLES USED TO MAKE THE JUDGEMENT/DECISION:

1. If any line is closed due to kink, closed clamp or an empty bag is present then an Auto Restart Alarm—“CHECK DRAIN LINE”, “CHECK HEATER LINE”, etc.,—will occur.

2. If one or more of the lines are closed or the solution bags are empty, then a Manual Restart Alarm—“CHECK LINES AND BAGS”—will occur.

3. If you program a value that is unreasonable, a Manual Restart Alarm—“CHECK THERAPY TIME”, “CHECK TOTAL VOLUME”, etc.,—will occur. NOTE: Do not use this principle if learner not taught how to program Home Choice.

4. If you try to bypass an alarm or phase and you have not completed the phase, then a Manual Restart Alarm—“DRAIN NOT FINISHED”, “FILL NOT FINISHED”, etc.,—will occur. NOTE: Do not use this scenario if learner not taught how to bypass.

5. If the disposable cassette fails testing during setup, then a Manual Restart Alarm—“LOAD A NEW SET”—will occur.

6. If you do not drain enough volume, then an Auto Restart Alarm—“LOW DRAIN VOLUME”—will occur.

7. If fluid is moving too slow through the system, then an Auto Restart Alarm—“SLOW FLOW HEATER”, “SLOW FLOW PATIENT”, etc.,—will occur.

8. If the machine is tilted, then an Auto Restart Alarm—“MACHINE TILTED”—will occur.

9. If you retain more than 50% of your fill over the course of your treatment, then a Manual Restart Alarm—“CAUTION: NEGATIVE UF”—will occur.

10. If your position is more than 1 foot above the Home Choice Machine, then an Auto Restart Alarm—“CHECK YOUR POSITION”—will occur.

11. If the system detects an error in the way the cassette was loaded or a problem with the system, then a Manual Restart Alarm—“RELOAD SET”—will occur.

12. If a problem occurs inside the Home Choice machine, then a “SYSTEM ERROR”Alarm will occur.

What the Learner should be looking for? (Judgments) What choice(s)/possible action steps should be taken? (Decisions) (some judgments will have several action steps)

1. “CHECK DRAIN LINE”, “CHECK HEATER LINE”, “CHECK FINAL LINE”, “CHECK PATIENT LINE”, or “CHECK SUPPLY LINE alarm situation. 1. Check the appropriate line for kinks, closed clamps, fibrin blockage. Correct the problem. If the alarm becomes a Manual Restart Alarm, then press Stop, check the appropriate line again for kinks, closed clamps, fibrin blockage. Correct the problem. Press Go to continue the treatment. If the alarm is “CHECK HEATER LINE”, “CHECK FINAL LINE”, OR “CHECK SUPPLY LINE”, check for empty bags also. If bags are empty, call clinic or 800 number for advice.

2. “CHECK LINES AND BAGS” alarm situation. 2. Press Stop. Check all the lines and bags for kinks, closed clamps, fibrin blockage. Correct the problem. Check for empty bags. If bags are empty, call clinic or 800 number for advice. Press Go to continue the setup.

3. “CHECK THERAPY TIME”, “CHECK TOTAL VOLUME”, etc.,—alarm situation. NOTE: Do not use this judgment/decision if learner not taught how to program Home Choice. 3. Press Stop. Display automatically returns to the parameter and flashes the value you need to change. Change the value or other values. Press Stop to exit CHANGE PROGRAM.

4. “DRAIN NOT FINISHED”, “FILL NOT FINISHED”, etc.,—alarm situation. NOTE: Do not use this scenario if learner not taught how to bypass. 4. Press Stop. Check with your clinic to learn about when it is safe to bypass. If the learner chooses to bypass, press the down arrow until the display reads “BYPASS”. Press enter to choose bypass.

5. “LOAD A NEW SET” alarm situation. 5. Press Stop. Close all clamps. Open door. Remove and discard the disposable set , bags and cassette. Get a new disposable set, solution bags and start over again with setup. Press Go and follow the setup instructions in the display.

6. “LOW DRAIN VOLUME” alarm situation. 6. Change your position to try to drain more volume. Check the catheter, transfer set, and drain line for kinks, closed clamp, Open any clamps, unkink the tubing, Look for fibrin blockage in the tubing. If present milk the tubing at the level of the blockage. Assess bowel patterns, enema if constipated. If the alarm becomes a Manual Restart Alarm, press Stop, change your position again or lower the machine by 6 inches. Press Go to continue the drain. NOTE: If learner has been taught to bypass may add the step of pressing the down arrow until display reads “DRAIN VOL: nnnML” and assessing whether or not to bypass this alarm.

7. “SLOW FLOW HEATER”, “SLOW FLOW PATIENT”, etc.,—alarm situation. 7. Check the appropriate line for kinks, closed clamps, fibrin blockage. Correct the problem. If the alarm becomes a Manual Restart Alarm, press Stop, check the appropriate line again for kinks, closed clamps, fibrin blockage. Correct the problem. Press Go to continue the treatment.

8. “MACHINE TILTED” alarm situation. 8. Place Home Choice on flat, even surface. If the alarm becomes a Manual Restart Alarm or if this alarm occurs at “PRESS GO TO START”, then press Stop, place the machine on a flat, even surface, and press Go to resume.

9. “CAUTION: NEGATIVE UF” alarm situation. 9. Press Stop. Change your position to try to drain more volume. Check the catheter, transfer set, and drain line for kinks, closed clamp, Open any clamps, unkink the tubing, Look for fibrin blockage in the tubing. If present milk the tubing at the level of the blockage. Assess bowel patterns, enema if constipated. Press Go to return to drain. NOTE: If learner has been taught to bypass may add the step of pressing the down arrow until display reads “TOTAL UF: nnnML” and assessing whether or not to bypass this alarm. This alarm can only be bypassed twice.

10. “CHECK YOUR POSITION” alarm situation. 10. Position yourself or the machine where your abdomen is no more than 1 foot above the heater cradle. If the alarm becomes a Manual Restart Alarm, press Stop, position yourself or the machine where your abdomen is no more than 1 foot above the heater cradle, press go to resume the treatment.

11. “RELOAD SET” alarm situation. 11. Press Stop. Close all clamps. Open the door. Remove the cassette, reload the cassette. Hold tubing where it exits the well and push back while you close the door. Open the clamps. Press Go. When the display reads “CONNECT BAGS” press Go. Priming will begin.

12. “SYSTEM ERROR” alarm situation. 12. Press Stop. Write down the system error number and the phase that appears in the display. Call the Baxter 800 phone number on the machine.

MEMORY LEARNING LESSON PLAN SUBJECT: UHome ChoiceltraBag Judgment Decision Points

OBJECTIVE: Learner will be able to recall the decision points of the Home Choice Treatment.UltraBag Exchange.

MEDIA: Card with the mnemonic printed on it.

REQUISITE KNOWLEDGE: Maintaining Asepsis Unit, Transfer Set/Clamps, Prepare HC Set Up, Turn On Load Cassette, Spiking Solution Bags, Priming CassetteGathering Supplies, Prepare Self, Prepare Connect to Home Choice Cycler, Ending HC Therapy. the UltraBag, Connect to the UltraBag, Drain/Flush/Fill, Disconnect, Weighing the Bag.

HOW WILL I EVALUATE WHETHER LEARNING HAS OCCURRED? The learner will be able to repeat the decision points of the UltraBag exchange Home Choice Treatment.

GETTING THE LEARNER READY: “At the end of this lesson you will know the decision points of the exchange Home Choice Treatment. These are the points at which you will need to decide if your exchange treatment is going okay or if there is a problem. I will show you where the decision points are. I want you to pay attention and try to remember them. I will give you a little memory trick to help you . Repeat the list in your mind and use the memory trick to help you. When you think you know what the decision points are I will ask you to repeat them to me.”

LEARNER ACTIVITY TEACHER ACTIVITY NOTES

1. Pay attention. 1. Present the information to be memorized. Tell the learner to ask questions or “say after me”. 1. a. Problem Solving Lessons for Connect and Disconnect are in Contamination in Troubleshooting Unit. 1. b. Problem Solving Lessons for Prime and Alarms are in Home Choice Unit.

2. Form own associations. 2. Present mnemonics—may ask learner patient to form own association. 2. Help them use the mnemonic: “Some Parades Cause Awful Detours.”CD's For Father's Day”

3. Practice/Test. 3. Question and provide feedback.

MEMORY LEARNING ANALYSIS

SUBJECT: UltraBag Home Choice Judgment/Decision Points

List of information to be memorized Mnemonic(s) or other helpful memory aids or memorization strategies.

1. Spikel. Connect Some“CD's For Father's Day”

2. Prime2. Drain Parades

3. Connect3. Flush Cause

4. Alarms Awful

5. Disconnect4. Fill Detours

PROBLEM SOLVING LEARNING LESSON PLAN

SUBJECT: Home Choice Alarms

OBJECTIVE: Learner will take appropriate actions when faced with Home Choice alarm conditions.

MEDIA: See Home Choice Alarm Principle Lesson

REQUISITE KNOWLEDGE: Home Choice Alarms Judgment Decision Lesson.

HOW WILL I EVALUATE WHETHER LEARNING HAS OCCURRED? When presented with scenarios, learner will identify Home Choice Alarm conditions and takes the appropriate action steps.

GETTING THE LEARNER READY: ““You've learned about Home Choice alarms and what to do if you have one. Now I will give you problem examples, ask you to tell me what you see, what you know about the situation and what you would do if this happened to you. I will help you along in working through the situation, so don't be afraid. When you can take the correct action, then we will know you can trouble shoot the Home Choice alarms at home.”

LEARNER ACTIVITY TEACHER ACTIVITY NOTES

1. Pay attention and recall concepts. 1. Review associated concepts. 1.

2. Pay attention. 2. State the principles (rules) 2.

3. Solve Problems and take correct actions. 3. Present problem scenarios and ask learner to solve. 3. The teacher needs to coach the learner to go through the 3 stages of the problem solving process, giving the learner more coaching at early attempts to problem solve, gradually decreasing the coaching as the learner begins to problem solve effectively. Questions such as “What do you see in this picture?”, “What do you know about. . . ?”, “Do you think that will work to solve the problem?” are examples of coaching in each stage of the problem solving process. You are guiding the learners thinking in the correct direction. In order to learn problem solving effectively the learner must see as many varied problems as possible.

4. Process feedback 4. Give Feedback 4. Continue presenting scenarios until learner is developing correct solutions and taking correct actions.

PROBLEM SOLVING ANALYSIS

SUBJECT: Home Choice Alarms

PROBLEM DESCRIPTION: Home Choice alarm conditions.

LIST OF PRINCIPLES USED TO SOLVE THE PROBLEM:

If any line is closed due to kink, closed clamp or an empty bag is present then an Auto Restart Alarm—“CHECK DRAIN LINE”, “CHECK HEATER LINE”, etc.,—will occur.

If one or more of the lines are closed or the solution bags are empty, then a Manual Restart Alarm—“CHECK LINES AND BAGS”—will occur.

If you program a value that is unreasonable, a Manual Restart Alarm—“CHECK THERAPY TIME”, “CHECK TOTAL VOLUME”, etc.,—will occur. NOTE: Do not use this principle if learner not taught how to program Home Choice.

If you try to bypass an alarm or phase and you have not completed the phase, then a Manual Restart Alarm—“DRAIN NOT FINISHED”, “FILL NOT FINISHED”, etc.,—will occur. NOTE: Do not use this scenario if learner not taught how to bypass.

If the disposable cassette fails testing during setup, then a Manual Restart Alarm—“LOAD A NEW SET”—will occur.

If you do not drain enough volume, then an Auto Restart Alarm—“LOW DRAIN VOLUME”—will occur.

If fluid is moving too slow through the system, then an Auto Restart Alarm—“SLOW FLOW HEATER”, “SLOW FLOW PATIENT”, etc.,—will occur.

If the machine is tilted, then an Auto Restart Alarm—“MACHINE TILTED”—will occur.

If you retain more than 50% of your fill over the course of your treatment, then a Manual Restart Alarm—“CAUTION: NEGATIVE UF”—will occur.

If your position is more than 1 foot above the Home Choice Machine, then an Auto Restart Alarm—“CHECK YOUR POSITION”—will occur.

If the system detects an error in the way the cassette was loaded or a problem with the system, then a Manual Restart Alarm—“RELOAD SET”—will occur.

If a problem occurs inside the Home Choice machine, then a System Error Alarm will occur.

Problem Scenario (Include Suggestions for Simulating Scenario, i.e. Demo, Created Situations, Verbalized Descriptions) Problem Solution

1. While learner connected to Home Choice and in a drain phase, close patient line clamp. Alarm beeps 3 times, display reads “CHECK DRAIN LINE”. 1a. Check the drain line for kinks, closed clamps, fibrin blockage. Correct the problem. 1b. If the alarm becomes a Manual Restart Alarm, then press Stop, check the drain line again for kinks, closed clamps, fibrin blockage. Correct the problem. Press Go to continue the treatment.

2. During a set up leave the heater line clamped. Alarm beeps 3 times, display reads “CHECK HEATER LINE”. 2a. Check the heater line for kinks, closed clamps, fibrin blockage. Check for an empty heater bag. Correct the problem. 2b. If the alarm becomes a Manual Restart Alarm, then press Stop, check the heater line again for kinks, closed clamps, fibrin blockage. Correct the problem. Press Go to continue the setup.

3. During a set up leave the heater line and the drain line clamped. Alarm beeps continuously, display reads “CHECK LINES AND BAGS”. 3. Press Stop. Check all the lines and bags for kinks, closed clamps, fibrin blockage. Check for empty bags. Correct the problem. Press Go to continue the setup.

4. Program the following: Total Volume: 10,000, Therapy Time: 00:10, Fill Vol: 2000 ml, Last Fill Vol: Oml. Press Stop. Alarm beeps continuously, display reads “CHECK THERAPY TIME”. NOTE: Do not use this scenario if learner not taught how to program Home Choice. 4. Press Stop. Display flashes the Therapy Time. Change the Therapy Time to 10:00. Press Stop.

5. While learner connected to Home Choice and in a fill phase, attempt to bypass the fill. Alarm beeps continuously, display reads “FILL NOT FINISHED”. NOTE: Do not use this scenario if learner not taught how to bypass. 5a. Press Stop. If you are sure that you want to bypass, then press the down arrow until display reads “BYPASS”. Press enter to choose bypass. 5b. If you do not want to bypass press Go to continue the fill.

6. Tell the learner that they are setting up the cycler. Show the learner a picture of a display that reads “LOAD A NEW SET”. Tell the learner that the alarm is beeping continuously. 6. Press Stop. Close all clamps. Open door and remove the cassette. Throw away the cassette and all other lines and bags. Get a new cassette and new bags. Load the cassette. Press Go to continue setup.

7. Tell the learner that they are on the Home Choice, in drain and an alarm beeps 3 times, display reads “LOW DRAIN VOLUME”. 7a. Change your position to try to drain more volume. Check the catheter, transfer set , and drain line for kinks, closed clamp, Open any clamps, unkink the tubing, Look for fibrin blockage in the tubing. If present milk the tubing at the level of the blockage. Assess bowel patterns, enema if constipated. 7b. If the alarm becomes a Manual Restart Alarm, press Stop, change your position again or lower the machine by 6 inches. Press Go to continue the drain. NOTE: If learner has been taught to bypass may add the step of pressing the down arrow until display reads “DRAIN VOL: nnnML” and assessing whether or not to bypass this alarm.

8. While patient connected to Home Choice and in a fill phase, partially kink the heater line. Alarm beeps 3 times, display reads “SLOW FLOW HEATER”. 8a. Check the heater line for kinks, closed clamps, fibrin blockage. Correct the problem. 8b. If the alarm becomes a Manual Restart Alarm, press Stop, check the heater line again for kinks, closed clamps, fibrin blockage. Correct the problem. Press Go to continue the fill.

9. Prop one end of the Home Choice up on a book. Alarm beeps 3 times, display reads “MACHINE TILTED”. 9a. Remove book and place Home Choice on flat, even surface. 9b. If the alarm becomes a Manual Restart Alarm or if this alarm occurs at “PRESS GO TO START”, then press Stop, place the machine on a flat, even surface, and press Go to resume.

10. Tell the learner that they are on the Home Choice, at the end of a drain and the alarm beeps continuously, display reads “CAUTION: NEGATIVE UF”. 10. Press Stop. Change your position to try to drain more volume. Check the catheter, transfer set, and drain line for kinks, closed clamp, Open any clamps, unkink the tubing, Look for fibrin blockage in the tubing. If present milk the tubing at the level of the blockage. Assess bowel patterns, enema if constipated. Press Go to return to drain. NOTE: If learner has been taught to bypass may add the step of pressing the down arrow until display reads “TOTAL UF: nnnML” and assessing whether or not to bypass this alarm. This alarm can only be bypassed twice

11. While patient connected to Home Choice and in a fill phase, have them stand up. Alarm beeps 3 times, display reads “CHECK YOUR POSITION”. 11a. Position yourself or the machine where your abdomen is no more than 1 foot above the heater cradle. 11b. If the alarm becomes a Manual Restart Alarm, press Stop, position yourself or the machine where your abdomen is no more than 1 foot above the heater cradle, press go to resume the treatment.

12. Tell the learner that they are setting up the Home Choice and the display reads “RELOAD SET”. Tell the learner that the alarm is beeping continuously. 12. Press Stop. Close all clamps. Open the door. Remove the cassette, reload the cassette. Hold tubing where it exits the well and push back while you close the door. Open the clamps. Press Go. When the display reads “CONNECT BAGS” press Go. Priming will begin.

13. Show the learner a picture of a display that reads “SYSTEM ERROR: nnnn”. Tell them that the alarm is beeping continuously. 13. Press Stop. Write down the system error number and the phase that appears in the display. Call the Baxter 800 phone number on the machine.

MOTOR SKILL—COGNITIVE—LESSON PLAN

SUBJECT: Home Choice “Putting It All Together”

OBJECTIVE: The learner will be able to repeat the critical steps for the Home Choice Set-Up, Treatment Initiation and Termination procedures safely.

MEDIA: Mask, Minicap, Hand Wipes, Sink, Paper Towels, Antibacterial Pump Soap, Patient's Transfer Set, Home Choice Cassette, Drain Option, PD Solution Bags, CAPD/CCPD Flow Sheets, Waste Receptacle, Clamp, CXD

REQUISITE KNOWLEDGE: Entire Home Choice Unit

HOW WILL I EVALUATE WHETHER LEARNING HAS OCCURRED? The learner will repeat the critical steps for Home Choice Set-Up, Initiation and Termination procedures.

GETTING THE LEARNER READY: “This lesson will focus on putting all of the Home Choice procedures together. I will demonstrate the set-up, initiation and termination from start to finish. Pay attention to what I am doing. When I am finished I will ask you to repeat the steps of the procedures. When you can repeat the steps without error it will be your turn to practice.”

LEARNER ACTIVITY TEACHER ACTIVITY NOTES

1. Pay Attention. “Memorize” pictures of steps. 1.First Demonstration. 1. May use patient's own transfer set for demonstration.

2. Determine “critical” steps/nuances/etc. 2. Second Demonstration—Point out critical steps, nuances (talk through what your hands are doing). 2. Use condensed Motor Skill Analysis.

3. Repetition. 3. Third Demonstration—Shorten description—use labels from condensed analysis.

4. Repeat labels from memory. 4. Give Feedback. 4. If learner unable to repeat steps perform demonstration similar to demonstration #3.

MOTOR SKILL—PRACTICE—LESSON PLAN

SUBJECT: Home Choice “Putting It All Together”

OBJECTIVE: The learner will be able to complete Home Choice Set-Up, Treatment Initiation and Termination procedures safely.

MEDIA: Same as for Cognitive Lesson Plan for this motor skill.

REQUISITE KNOWLEDGE: Cognitive lesson for this motor skill

HOW WILL I EVALUATE WHETHER LEARNING HAS OCCURRED? The learner will successfully complete Home Choice Set-Up, with treatment initiation and termination procedures.

GETTING THE LEARNER READY: “Now that you know the steps for setting up the Home Choice and the initiation and termination procedures, it is time to practice. Don't Worry if you make a mistake I will help you as you go along. We will know you have learned this when you can do all the procedures smoothly and without help from me.”

LEARNER ACTIVITY TEACHER ACTIVITY NOTES

1. Using the supplies provided Set-up the Home Choice, and initiate and terminate a treatment. 1. “Go ahead. It is your turn to practice.” 1. Have adequate supplies for multiple practices.

2. Continue to practice reducing errors to a minimum. 2. Give feedback about what is being done correctly, stating the correct steps if needed. 1. Constant commentary indicating those things that are done correctly and correcting errors by stating what should be done.

3. Begin to monitor self, detecting errors and correcting them. 3. Continue feedback.

4. Repeat often enough for steps to become smooth, error free and automatic. 4. Test for the automatic stage by asking the learner to perform the procedure while conversing with them. 4. Topics should be unrelated to the procedure.

MOTOR SKILL ANALYSIS—DETAILED

SUBJECT: “Putting It All Together”

The detailed analysis includes all previous Home Choice Motor Skill Analyses

MOTOR SKILL ANALYSIS—CONDENSED

SUBJECT: “Putting It All Together”

Brief Description of Logically Grouped Steps Label

1. Clean the work surface. 1. Clean the work surface.

2. Brief handwashing. 2. Life lesson.

3. Gather and inspect supplies. 3. Gather and inspect supplies.

4. Open and inspect solution bags. 4. Open and inspect supplies.

5. Turn machine on and load cassette. 5. Turn machine on and load cassette.

6. Prepare self. (if planning to connect immediately) 6. Prepare self.

7. Mask and wash hands. 7. Mask and wash.

8. Connect solution bags. 8. Connect bags.

9. Prime cassette. 9. Prime cassette. (prepare self, mask, and wash hands at this point if cycler was set up earlier)

10. Connect to Home Choice. 10. Initiate treatment.

11. Disconnect from Home Choice. 11. Terminate treatment.

12. Record Initial drain, Ultrafiltration and Dwell time. 12. Record.

13. Dispose of the effluent. 13. Dispose.

14. Wash hands. 14. Wash hands.

MOTOR SKILL—COGNITIVE—LESSON PLAN

SUBJECT: Disconnecting During Therapy (Hi-Dose)

OBJECTIVE: The learner will be able to repeat the critical steps to disconnect from the Home Choice after a Hi-Dose exchange.

MEDIA: Home Choice set up connected to practice apron, informational display reading “Day Dwell______of______”, cleaning wipes, 2 minicaps (1 minicap and 1 flexicap).

REQUISITE KNOWLEDGE: Asepsis, Components of Home Choice, Components of transfer set, Components of minicap, Opening a sterile package and Opening and closing the transfer set.

HOW WILL I EVALUATE WHETHER LEARNING HAS OCCURRED? The learner will repeat the steps for disconnecting during Hi Dose.

GETTING PATIENT READY TO LEARN: “At the end of this lesson you will know the steps for disconnecting from the Home choice following a Hi-Dose exchange. I will show you how to do this. I will first demonstrate the procedure as you would usually do it. Then I will demonstrate the procedure, explaining what I am doing at each point of the procedure. I want you to pay close attention to what I am doing. After you watch me do the procedure several times, I will ask you to tell me the steps in the procedure. When you can repeat the steps of the procedure without error I will know that you are ready to practice the procedure yourself.”

LEARNER ACTIVITY TEACHER ACTIVITY NOTES

1. Pay attention and watch closely. 1. Demonstrate the procedure as it would normally be performed.

2. Memorize the steps. 2. Repeat demonstration explaining in detail each step. 2. Use detailed Motor Skill Analysis

3. Determine what are the critical steps in the procedure. 3. Repeat demonstration, pointing out the critical steps of the procedure.

4. Repeat back the critical steps in the procedure. 4. Ask the patient to tell you the critical steps of the procedure. Repeat the procedure and provide feedback to the patient until he is able to repeat the steps without error.

MOTOR SKILL—PRACTICE—LESSON PLAN

SUBJECT: Disconnecting During Therapy (Hi-Dose)

OBJECTIVE: The learner will be able to disconnect from the Home Choice following a Hi-Dose exchange.

MEDIA: Same as for Cognitive Lesson for this Motor Skill.

REQUISITE KNOWLEDGE: Cognitive Lesson for this Motor Skill.

HOW WILL I EVALUATE WHETHER LEARNING HAS OCCURRED? The learner will disconnect from the Home Choice after performing a Hi-Dose exchange.

GETTING PATIENT READY TO LEARN: “Now that you are know the steps of the procedure to me it is time for you to practice it. I would like you to practice disconnecting from the machine during Hi-Dose therapy until you can do it without thinking. I will give you feedback about how you are doing as you practice. Don't worry about making mistakes, I will correct you as you go along. You may practice as long as you need to. When you feel you know the procedure, I will ask you to do the procedure on your own without any help from me.

LEARNER ACTIVITY TEACHER ACTIVITY NOTES

1. Practice the previously learned steps of disconnecting from the machine during therapy. 1. Tell the learner to go ahead, it is their turn to practice.

2. Continue practicing until the skill is automatic. 2. Provide continuous feedback to learner, correcting errors as necessary, and reinforcing job well done.

3. Perform skill without any coaching from teacher. 3. Watch learner perform skill to ascertain that skill is error free.

4. Perform skill while engaged in unrelated conversation with teacher. 3. Engage learner in unrelated conversation while watching them perform skill, to ascertain that skill is at automatic stage.

MOTOR SKILL ANALYSIS—DETAILED

SUBJECT: Disconnecting During Therapy (Hi-Dose)

Steps to Take Tricks of the Trade

1. Verify the machine informational display reads “Day Dwell______of ______”.

2. Close the white twist clamp on the transfer set. 2. Previously learned.

3. Close the white clamp on the Home Choice patient line by pinching it between the thumb and forefinger. 3. Previously learned.

4. Mask. 4. Previously learned.

5. Clean hands with cleaning wipes.

6. Open 2 minicaps. 6. Previously learned. Optional alternative can use the flexicap in place of minicap on the patient line.

7. Disconnect patient line from the transfer set . 7. Previously learned.

8. Place the patient line back in the organizer. 8. Be careful to protect both exposed ends.

9. Place a minicap on the transfer set and place transfer set on lap pad. 9. Previously learned.

10. Using the thumb and forefinger of your left hand, grasp the patient line on the ridges below the circular flange. Remove the patient line from the organizer. 10. Previously learned.

11. Place the second minicap over the exposed end of the patient line and gently push it into place to secure. 11. If using flexicap, place it over the exposed end of the patient line and twist counterclockwise into place.

12. Leave the machine on, and walk away.

MOTOR SKILL ANALYSIS—CONDENSED

SUBJECT: Disconnecting During Therapy (Hi-Dose)

Brief Description of Logically Grouped Steps Label

1. Verify display reads “Day Dwell______of______”. 1. Check Home Choice display.

2. Close transfer set and Home Choice patient line. 2. Close clamps.

3. Prepare self. Mask and wash hands. 3. Prepare.

4. Open two minicaps (1 minicap/1 flexicap). 4. Prepare minicaps/flexicap.

5. Disconnect patient line from transfer set and place in organizer. 5. Disconnect.

6. Place a minicap on transfer set and another on patient line. (Minicap and flexicap). 6. Cap off.

7. Replace patient line in organizer. Walk away. 7. Complete.

MOTOR SKILL—COGNITIVE—LESSON PLAN

SUBJECT: Disconnecting During Therapy (Hi-Dose)

OBJECTIVE: The learner will be able to repeat the critical steps to disconnect from the Home Choice after a Hi-Dose exchange.

MEDIA: Home Choice set up connected to practice apron, informational display reading “Day Dwell______of______”, cleaning wipes, 2 minicaps (1 minicap and 1 flexicap).

REQUISITE KNOWLEDGE: Maintaining Asepsis, Components of Home Choice, Transfer Set/Clamps

HOW WILL I EVALUATE WHETHER LEARNING HAS OCCURRED? The learner will repeat the steps for disconnecting during Hi Dose.

GETTING PATIENT READY TO LEARN: “At the end of this lesson you will know the steps for disconnecting from the Home choice following a Hi-Dose exchange. I will show you how to do this. I will first demonstrate the procedure as you would usually do it. Then I will demonstrate the procedure, explaining what I am doing at each point of the procedure. I want you to pay close attention to what I am doing. After you watch me do the procedure several times, I will ask you to tell me the steps in the procedure. When you can repeat the steps of the procedure without error I will know that you are ready to practice the procedure yourself.”

LEARNER ACTIVITY TEACHER ACTIVITY NOTES

1. Pay attention and watch closely. 1. Demonstrate the procedure as it would normally be performed.

2. Memorize the steps. 2. Repeat demonstration explaining in detail each step. 2. Use detailed Motor Skill Analysis

3. Determine what are the critical steps in the procedure. 3. Repeat demonstration, pointing out the critical steps of the procedure.

4. Repeat back the critical steps in the procedure. 4. Ask the patient to tell you the critical steps of the procedure. Repeat the procedure and provide feedback to the patient until he is able to repeat the steps without error.

MOTOR SKILL—PRACTICE—LESSON PLAN

SUBJECT: Disconnecting During Therapy (Hi-Dose)

OBJECTIVE: The learner will be able to disconnect from the Home Choice following a Hi-Dose exchange.

MEDIA: Same as for Cognitive Lesson for this Motor Skill.

REQUISITE KNOWLEDGE: Cognitive Lesson for this Motor Skill.

HOW WILL I EVALUATE WHETHER LEARNING HAS OCCURRED? The learner will disconnect from the Home Choice after performing a Hi-Dose exchange.

GETTING PATIENT READY TO LEARN: “Now that you are know the steps of the procedure to me it is time for you to practice it. I would like you to practice disconnecting from the machine during Hi-Dose therapy until you can do it without thinking. I will give you feedback about how you are doing as you practice. Don't worry about making mistakes, I will correct you as you go along. You may practice as long as you need to. When you feel you know the procedure, I will ask you to do the procedure on your own without any help from me.

LEARNER ACTIVITY TEACHER ACTIVITY NOTES

1. Practice the previously learned steps of disconnecting from the machine during therapy. 1. Tell the learner to go ahead, it is their turn to practice.

2. Continue practicing until the skill is automatic. 2. Provide continuous feedback to learner, correcting errors as necessary, and reinforcing job well done.

3. Perform skill without any coaching from teacher. 3. Watch learner perform skill to ascertain that skill is error free.

4. Perform skill while engaged in unrelated conversation with teacher. 3. Engage learner in unrelated conversation while watching them perform skill, to ascertain that skill is at automatic stage.

MOTOR SKILL ANALYSIS—DETAILED

SUBJECT: Disconnecting During Therapy (Hi-Dose)

Steps to Take Tricks of the Trade

1. Verify the machine informational display reads “Day Dwell______of ______”.

2. Close the white twist clamp on the transfer set. 2. Previously learned.

3. Close the white clamp on the Home Choice patient line by pinching it between the thumb and forefinger. 3. Previously learned.

4. Mask. 4. Previously learned.

5. Clean hands with cleaning wipes.

6. Open 2 minicaps. 6. Previously learned. Optional alternative can use the flexicap in place of minicap on the patient line.

7. Disconnect patient line from the transfer set . 7. Previously learned.

8. Place the patient line back in the organizer. 8. Be careful to protect both exposed ends.

9. Place a minicap on the transfer set and place transfer set on lap pad. 9. Previously learned.

10. Using the thumb and forefinger of your left hand, grasp the patient line on the ridges below the circular flange. Remove the patient line from the organizer. 10. Previously learned. .

11. Place the second minicap over the exposed end of the patient line and gently push it into place to secure. 11. If using flexicap, place it over the exposed end of the patient line and twist counterclockwise into place.

12. Leave the machine on, and walk away.

MOTOR SKILL ANALYSIS—CONDENSED

SUBJECT: Disconnecting During Therapy (Hi-Dose)

Brief Description of Logically Grouped Steps Label

1. Verify display reads “Day Dwell______of______”. 1. Check Home Choice display.

2. Close transfer set and Home Choice patient line. 2. Close clamps.

3. Prepare self. Mask and wash hands. 3. Prepare.

4. Open two minicaps (1 minicap/1 flexicap). 4. Prepare minicaps/flexicap.

5. Disconnect patient line from transfer set and place in organizer. 5. Disconnect.

6. Place a minicap on transfer set and another on patient line. (Minicap and flexicap). 6. Cap off.

7. Replace patient line in organizer. Walk away. 7. Complete.

MOTOR SKILL—COGNITIVE—LESSON PLAN

SUBJECT: Reconnecting During Therapy (Hi-Dose)

OBJECTIVE: The learner will be able to repeat the critical steps to reconnect to the Home Choice after a day dwell on Hi-Dose therapy.

MEDIA: Home Choice set up with minicap/flexicap on patient line, practice apron, informational display reading “Day Dwell______of______”.

REQUISITE KNOWLEDGE: Asepsis, Components of Home Choice, Components of transfer set, Components of minicap, Opening a sterile package, and Opening and closing the transfer set.

HOW WILL I EVALUATE WHETHER LEARNING HAS OCCURRED? The learner will repeat the steps for reconnecting to the Home Choice following a day dwell on Hi-Dose therapy.

GETTING PATIENT READY TO LEARN: “At the end of this lesson you will know the steps for reconnecting to he Home Choice following a day dwell on Hi-Dose. I will show you how to do this. I will first demonstrate the procedure as you would usually do it. Then I will demonstrate the procedure, explaining what I am doing at each point of the procedure. I want you to pay close attention to what I am doing. After you watch me do the procedure several times, I will ask you to tell me the steps in the procedure. When you can repeat the steps of the procedure without error I will know that you are ready to practice the procedure yourself.”

LEARNER ACTIVITY TEACHER ACTIVITY NOTES

1. Pay attention and watch closely. 1. Demonstrate the procedure as it would normally be performed.

2. Memorize the steps. 2. Repeat demonstration explaining in detail each step. 2. Use detailed Motor Skill Analysis.

3. Determine what are the critical steps in the procedure. 3. Repeat demonstration, pointing out the critical steps of the procedure.

4. Repeat back the critical steps in the procedure. 4. Ask the patient to tell you the critical steps of the procedure. Repeat the procedure and provide feedback to the patient until he is able to repeat the steps without error.

MOTOR SKILL—PRACTICE—LESSON PLAN

SUBJECT: Reconnecting During Therapy (Hi-Dose)

OBJECTIVE: The learner will be able to reconnect to the Home Choice following a day dwell on Hi-Dose therapy.

MEDIA: Same as for Cognitive Lesson for this Motor Skill.

REQUISITE KNOWLEDGE: Cognitive Lesson Plan for this Motor Skill.

HOW WILL I EVALUATE WHETHER LEARNING HAS OCCURRED? The learner will reconnect to the Home Choice following a day dwell on Hi-dose therapy.

GETTING PATIENT READY TO LEARN: “Now that you are know the steps of the procedure to me it is time for you to practice it. I would like you to practice reconnecting to the machine following a day dwell on Hi-dose therapy until you can do it without thinking. I will give you feedback about how you are doing as you practice. Don't worry about making mistakes, I will correct you as you go along. You may practice as long as you need to. When you feel you know the procedure, I will ask you to do the procedure on your own without any help from me.

LEARNER ACTIVITY TEACHER ACTIVITY NOTES

1. Practice the previously learned steps of disconnecting from the machine during therapy. 1. Tell the learner to go ahead, it is their turn to practice.

2. Continue practicing until the skill is automatic. 2. Provide continuous feedback to learner, correcting errors as necessary, and reinforcing job well done.

3. Perform skill without any coaching from teacher. 3. Watch learner perform skill to ascertain that skill is error free.

4. Perform skill while engaged in unrelated conversation with teacher. 3. Engage learner in unrelated conversation while watching them perform skill, to ascertain that skill is at automatic stage.

MOTOR SKILL ANALYSIS—DETAILED

SUBJECT: Reconnecting During Therapy (Hi-Dose)

Steps to Take Tricks of the Trade

1. Verify informational display reads“ Day Dwell______of______”. 1. Previously learned.

2. Expose the transfer set. 2. Previously learned.

3. Mask and wash hands. 3. Previously learned.

4. For original connection follow steps 7-12.

5. For 2-handed connection follow steps 13-18.

6. For 2-finger connection follow steps 19-24.

For Original Connection:

7. Remove the patient line from the organizer with your left hand. 8. Previously learned.

8. Wiggle and pull the minicap off the patient line using the thumb and forefinger of the right hand. If using a flexicap, twist in a clockwise direction to remove. Drop the minicap/flexicap at your right side.

9. Replace patient line in the organizer. 9. Previously learned.

10. Grasp the light blue finger grip area of your transfer set with the thumb and forefinger of your left hand, and remove the minicap from transfer set with the thumb and forefinger of your right hand. Drop the minicap to your right side. 10. Previously learned.

11. Take the patient line out of the organizer and connect to transfer set. 11. Previously learned.

12. Follow steps 25-29.

For 2-handed Connection:

13. Remove the patient line from the organizer with the right hand. 13. Previously learned.

14. Wiggle and pull the minicap from the patient line using the thumb and forefinger of the left hand. If using the flexicap, twist in a clockwise direction to remove. Drop the minicap/flexicap at your left side.

15. Grasp light blue finger grip area of your transfer set with your left thumb and forefinger. 15. Previously learned.

16. While continuing to hold the patient line in your right hand, remove the minicap from the transfer set with the thumb and forefinger of your right hand and drop to your right side. 16. Previously learned.

17. Connect the patient line to the transfer set. 17. Previously learned.

18. Follow steps 25-29.

For 2-finger Hold:

19. With the right palm facing the floor, slide your forefinger and middle finger just under the ridges of the flange on the patient line. Grasp the line with those fingers, and remove the line from the organizer. 19. Previously learned.

20. Wiggle and pull the minicap off the patient line with the thumb and forefinger of your left hand. If using the flexicap, twist to remove. Drop the minicap/flexicap at your left side. Continue to hold the patient line between your fingers.

21. Grasp light blue finger grip area of your transfer set with your left thumb and forefinger, keeping the tip pointed in a downward direction. 21. Previously learned.

22. Remove the minicap from your transfer set with the thumb and forefinger of your right hand. Drop the minicap to your right side. 22. Previously learned.

23. Connect the patient line to the transfer set. 23. Previously learned.

24. Follow Steps 25-29.

25. Open the transfer set. 25. Previously learned.

26. Open the clamp on the patient line. 26. Previously learned.

27. Press the down arrow twice on the Home Choice The informational display will read “Press GO to Continue”. 27. Previously learned.

28. Press the GO button to resume therapy. 27. The Home Choice will go into a drain cycle and the informational display will read “Day Drain______of______”.

29. Tape the transfer set to your abdomen. Remove face mask. 29. Secure the transfer set in some way to prevent pulling during sleep.

MOTOR SKILL ANALYSIS—CONDENSED

SUBJECT: Reconnecting During Therapy (Hi-Dose)

Brief Description of Logically Grouped Steps Label

1. Verify display reads “Day Dwell______of______”. 1. Check Home Choice.

2. Expose transfer set, mask, wash hands. 2. Prepare self.

3. Remove caps from patient line and transfer set. 3. Remove caps.

4. Connect patient line to transfer set. 4. Connect.

5. Open clamps on patient line and transfer set. 5. Open clamps.

6. Press down arrow twice, then press “GO”. 6. Resume Therapy.

MOTOR SKILL—COGNITIVE—LESSON PLAN

SUBJECT: Reconnecting During Therapy (Hi-Dose)

OBJECTIVE: The learner will be able to repeat the critical steps to reconnect to the Home Choice after a day dwell on Hi-Dose therapy.

MEDIA: Home Choice set up with minicap/flexicap on patient line, practice apron, informational display reading “Day Dwell______of______”.

REQUISITE KNOWLEDGE: Maintaining Asepsis, Components of Home Choice, Transfer Set/Clamps.

HOW WILL I EVALUATE WHETHER LEARNING HAS OCCURRED? The learner will repeat the steps for reconnecting to the Home Choice following a day dwell on Hi-Dose therapy.

GETTING PATIENT READY TO LEARN: “At the end of this lesson you will know the steps for reconnecting to he Home Choice following a day dwell on Hi-Dose. I will show you how to do this. I will first demonstrate the procedure as you would usually do it. Then I will demonstrate the procedure, explaining what I am doing at each point of the procedure. I want you to pay close attention to what I am doing. After you watch me do the procedure several times, I will ask you to tell me the steps in the procedure. When you can repeat the steps of the procedure without error I will know that you are ready to practice the procedure yourself.”

LEARNER ACTIVITY TEACHER ACTIVITY NOTES

1. Pay attention and watch closely. 1. Demonstrate the procedure as it would normally be performed.

2. Memorize the steps. 2. Repeat demonstration explaining in detail each step. 2. Use detailed Motor Skill Analysis.

3. Determine what are the critical steps in the procedure. 3. Repeat demonstration, pointing out the critical steps of the procedure.

4. Repeat back the critical steps in the procedure. 4. Ask the patient to tell you the critical steps of the procedure. Repeat the procedure and provide feedback to the patient until he is able to repeat the steps without error.

MOTOR SKILL—PRACTICE—LESSON PLAN

SUBJECT: Reconnecting During Therapy (Hi-Dose)

OBJECTIVE: The learner will be able to reconnect to the Home Choice following a day dwell on Hi-Dose therapy.

MEDIA: Same as for Cognitive Lesson for this Motor Skill.

REQUISITE KNOWLEDGE: Cognitive Lesson Plan for this Motor Skill.

HOW WILL I EVALUATE WHETHER LEARNING HAS OCCURRED? The learner will reconnect to the Home Choice following a day dwell on Hi-dose therapy.

GETTING PATIENT READY TO LEARN: “Now that you are know the steps of the procedure to me it is time for you to practice it. I would like you to practice reconnecting to the machine following a day dwell on Hi-dose therapy until you can do it without thinking. I will give you feedback about how you are doing as you practice. Don't worry about making mistakes, I will correct you as you go along. You may practice as long as you need to. When you feel you know the procedure, I will ask you to do the procedure on your own without any help from me.

LEARNER ACTIVITY TEACHER ACTIVITY NOTES

1. Practice the previously learned steps of disconnecting from the machine during therapy. 1. Tell the learner to go ahead, it is their turn to practice.

2. Continue practicing until the skill is automatic. 2. Provide continuous feedback to learner, correcting errors as necessary, and reinforcing job well done.

3. Perform skill without any coaching from teacher. 3. Watch learner perform skill to ascertain that skill is error free.

4. Perform skill while engaged in unrelated conversation with teacher. 3. Engage learner in unrelated conversation while watching them perform skill, to ascertain that skill is at automatic stage.

MOTOR SKILL ANALYSIS—DETAILED

SUBJECT: Reconnecting During Therapy (Hi-Dose)

Steps to Take Tricks of the Trade

1. Verify informational display reads” Day Dwell______of______”. 1. Previously learned.

2. Expose the transfer set. 2. Previously learned.

3. Mask and wash hands. 3. Previously learned.

4. For original connection follow steps 7-12.

5. For 2-handed connection follow steps 13-18.

6. For 2-finger connection follow steps 19-24.

For Original Connection:

7. Remove the patient line from the organizer with your left hand. 8. Previously learned.

8. Wiggle and pull the minicap off the patient line using the thumb and forefinger of the right hand. If using a flexicap, twist in a clockwise direction to remove. Drop the minicap/flexicap at your right side.

9. Replace patient line in the organizer. 9. Previously learned.

10. Grasp the light blue finger grip area of your transfer set with the thumb and forefinger of your left hand, and remove the minicap from transfer set with the thumb and forefinger of your right hand. Drop the minicap to your right side. 10. Previously learned.

11. Take the patient line out of the organizer and connect to transfer set. 11. Previously learned.

12. Follow steps 25-29.

For 2-handed Connection:

13. Remove the patient line from the organizer with the right hand. 13. Previously learned.

14. Wiggle and pull the minicap from the patient line using the thumb and forefinger of the left hand. If using the flexicap, twist in a clockwise direction to remove. Drop the minicap/flexicap at your left side.

15. Grasp light blue finger grip area of your transfer set with your left thumb and forefinger. 15. Previously learned.

16. While continuing to hold the patient line in your right hand, remove the minicap from the transfer set with the thumb and forefinger of your right hand and drop to your right side. 16. Previously learned.

17. Connect the patient line to the transfer set. 17. Previously learned.

18. Follow steps 25-29.

For 2-finger Hold:

19. With the right palm facing the floor, slide your forefinger and middle finger just under the ridges of the flange on the patient line. Grasp the line with those fingers, and remove the line from the organizer. 19. Previously learned.

20. Wiggle and pull the minicap off the patient line with the thumb and forefinger of your left hand. If using the flexicap, twist to remove. Drop the minicap/flexicap at your left side. Continue to hold the patient line between your fingers.

21. Grasp light blue finger grip area of your transfer set with your left thumb and forefinger, keeping the tip pointed in a downward direction. 21. Previously learned.

22. Remove the minicap from your transfer set with the thumb and forefinger of your right hand. Drop the minicap to your right side. 22. Previously learned.

23. Connect the patient line to the transfer set. 23. Previously learned.

24. Follow Steps 25-29.

25. Open the transfer set. 25. Previously learned.

26. Open the clamp on the patient line. 26. Previously learned.

27. Press the down arrow twice on the Home Choice The informational display will read “Press GO to Continue”. 27. Previously learned.

28. Press the GO button to resume therapy. 27. The Home Choice will go into a drain cycle and the informational display will read “Day Drain______of______”.

29. Tape the transfer set to your abdomen. Remove face mask. 29. Secure the transfer set in some way to prevent pulling during sleep.

MOTOR SKILL ANALYSIS—CONDENSED

SUBJECT: Reconnecting During Therapy (Hi-Dose) Brief Description of Logically Grouped Steps Label

1. Verify display reads “Day Dwell______of______”. 1. Check Home Choice.

2. Expose transfer set, mask, wash hands. 2. Prepare self.

3. Remove caps from patient line and transfer set. 3. Remove caps.

4. Connect patient line to transfer set. 4. Connect.

5. Open clamps on patient line and transfer set. 5. Open clamps.

6. Press down arrow twice, then press “GO”. 6. Resume Therapy.

MOTOR SKILL—COGNITIVE—LESSON PLAN

SUBJECT: Collecting an Effluent Specimen from Home Choice Using Aseptic Technique

OBJECTIVE: The learner will name the steps to collect an effluent specimen from Home Choice using aseptic technique.

MEDIA: Home Choice Cycler, Set up with fluid and cassette to full dummy tummy, effluent sample bag, mask, handwashing equipment.

REQUISITE KNOWLEDGE: Home Choice Unit, Maintaining Asepsis Unit, Peritonitis Concept.

HOW WILL I EVALUATE WHETHER LEARNING HAS OCCURRED? The learner will name the steps for collecting an effluent specimen from Home Choice using aseptic technique.

GETTING THE LEARNER READY: “If you ever get peritonitis, you will need to know how to collect a sterile effluent specimen. I will show you the steps for collecting a sterile specimen, and tell you everything that I am doing. Watch carefully and listen to how I describe each step. When you can name the steps for collecting this specimen, it will be your turn to practice”.

LEARNER ACTIVITY TEACHER ACTIVITY NOTES

1. Pay Attention. “Memorize” pictures of steps. 1. First Demonstration—silently.

2. Determine “critical” steps/nuances/etc. 2. Second Demonstration—Detailed description of steps. 2. Use detailed Motor Skill Analysis

3. Repetition. 3. Third Demonstration—Shorten description—use labels from condensed analysis.

4. Repeat labels from memory. 4. Give Feedback.

MOTOR SKILL—PRACTICE—LESSON PLAN

SUBJECT: Collecting an Effluent Specimen from Home Choice Using Aseptic Technique

OBJECTIVE: The learner will be able to demonstrate collection of an effluent specimen from Home Choice using aseptic technique.

MEDIA: Same as for Cognitive Lesson for this Motor Skill.

REQUISITE KNOWLEDGE: Cognitive Lesson for this Motor Skill

HOW WILL I EVALUATE WHETHER LEARNING HAS OCCURRED? The learner will effectively demonstrate collecting an effluent specimen using aseptic technique.

GETTING THE LEARNER READY: “Now that you can name the steps, it is your turn to practice. I will watch as you practice collecting the specimen. You will practice till you are comfortable doing this. When you can do it without hesitation, then we will know you have learned it”.

LEARNER ACTIVITY TEACHER ACTIVITY NOTES

1. Hands on practice. 1. Tell learner to go ahead and practice. 1. Tailor handwashing practice to patient/caregiver status. Practice both from drain and with initiation of manual drain.

2. Reduce errors to a minimum. 2. Provide immediate, accurate feedback focused on what is correct. Correct errors. Continue feedback. Repeat often enough until steps become smooth and without error. Test for automatic stage.

MOTOR SKILL ANALYSIS—DETAILED

SUBJECT: Collecting an Effluent Specimen from Home Choice Using Aseptic Technique

Steps to Take Tricks of the Trade

1. Determine if in drain phase. Push stop button on Home Choice Cycler. 1. If patient is not in drain phase, may need to initiate manual drain.

2. Mask and wash hands. 2. Previously learned motor skill. If caregiver performing, may perform full three minute wash. If connected patient performing, should use wipes.

3. Place effluent sample bag on work surface, writing side down, flaps pointing to right. Place hand on the bottom paper flap of the effluent sample bag pressing it to table. Grasp top clear flap between thumb and fingers and completely peel package back until flaps are positioned at 180o angle. 3. Effluent sample bag rests on the bottom paper flap.

4. Close white pinch clamp on effluent sample bag by pinching it shut with thumb and forefinger of right hand. 4. Previously learned motor skill.

5. Locate sample site on drain line of Home Choice Cassette. Place thumb and forefinger of right hand on sides of blue finger area. Put left index finger through the pull ring on the clear top and pull top off. Place clear top on the paper open wrapper of the effluent sample bag package.

6. With right thumb and forefinger, pick up white finger area of effluent sample bag. Put left index finger through the pull ring on the blue top and pull top off. Place blue top on the paper open wrapper of the effluent sample bag package.

7. Pick up sample site blue finger area with left thumb and forefinger. Connect white effluent sample bag with blue sample site and turn in a clockwise position until tight.

8. Press top of white pinch clamp on sample site until it opens. Press top of white pinch clamp on effluent sample site until it opens.

9. Press GO button on Home Choice; allowing sample bag to fill with effluent.

10. When effluent sample bag full, again press white pinch clamps on both sample site and effluent sample bag to close. 10. It is not necessary to stop Home Choice drain at this time.

11. Again, grasp white finger area of effluent sample bag with right thumb and forefinger, and blue finger area of sample site with left thumb and forefinger. Disconnect by twisting in a counterclockwise motion.

12. Release sample site. With left thumb and forefinger, pick up pull ring of blue effluent sample bag cap. Place cap over white end of effluent sample bag tubing, and press until secure. Place on wrapper.

13. With left thumb and forefinger, grasp blue finger area of sample site. With right thumb and forefinger, pick up pull ring of clear pull cap. Place cap over blue end of sample site tubing, and press until secure. Release.

MOTOR SKILL ANALYSIS—CONDENSED

SUBJECT: Collecting an Effluent Specimen from Home Choice Using Aseptic Technique

Brief Description of Logically Grouped Steps Label

1. Press STOP; mask and wash hands. 1. Stop, mask and wash.

2. Open effluent sample bag, close clamp. 2. Prepare effluent sample bag.

3. Remove cap from sample site; remove cap from effluent sample bag. 3. Uncap.

4. Connect effluent sample bag to sample site. 4. Connect.

5. Unclamp effluent sample bag and sample site. Press GO to fill. 5. Unclamp and fill.

6. Clamp effluent sample bag and sample site. 6. Clamp.

7. Disconnect effluent sample bag and recap. Recap sample site. 7. Disconnect and recap.

A chapter/module on Managing Medications may also be taught. These lesson plans will outline teaching the patient/learner about their medications. The medications in the unit were selected as those most likely to be identified with a peritoneal dialysis patient. Only teach the learner about the medications they are currently taking or you predict they would start within the training period. The learning involves memory and the memorization strategy will be a medication puzzle. Each piece of the puzzle will represent a different aspect of the medication; name, purpose, how to take the drug, and special considerations. Each medication is independently its own lesson plan—teach them in the order you choose.

MEMORY LEARNING LESSON PLAN

SUBJECT: Medications—See individual analyses for specific drug information.

UNIT: Managing Medications

OBJECTIVE: The learner will be able to identify the name of the medication, purpose of taking the medication, how to take the medication and special considerations related to the medication.

MEDIA: Medication puzzles.

REQUISITE KNOWLEDGE: Normal kidney function.

HOW WILL I EVALUATE WHETHER LEARNING HAS OCCURRED? The learner will name the characteristics of individual medications as listed in the analysis.

GETTING THE LEARNER READY: See Memory Analysis for each medication.

LEARNER ACTIVITY TEACHER ACTIVITY NOTES

1. Repeat information several times. 1. Present information to be memorized introducing one piece of the puzzle at a time. Tell the learner to ask questions as they arise. Information to be taught includes the common names of the medication, purpose of taking the medication, how to take the drug, special considerations, and the role in the body. 1. Teach only the medications that the learner is currently taking or anticipates starting within the training period. Puzzles should be presented in groups of three. In the case of OTC medications, the patient should be instructed to notify the PD nurse prior to taking the medication. It is the responsibility of the nurse to ask the program physicians to identify the OTC medications that are considered safe for the patient to use.

2. Form own associations. 2. Have patient review the puzzle pieces once they are all presented.

3. Test. 3. Remove pieces and ask patient what they know about the medication.

4. Put together puzzles as a final test. 4. When all medications have been taught, mix up the puzzle pieces for the medications the patient is taking and ask them to assemble the puzzles. Review information and have learner reassemble puzzles if necessary. 4. Use three puzzles at a time.

MEMORY LEARNING ANALYSIS

SUBJECT: Anti-Hypertensive Agents

GETTING THE LEARNER READY: “Now you are going to learn about anti-hypertensive agents. I will tell you common names of anti-hypertensive agents, the purpose of taking the medication, how to take it, and any special considerations about the medication. I will show you a puzzle with this information on it. I want you to pay attention to what I say and to study the puzzle. When you think you know the information about anti-hypertensive agents, I will ask you to list the information from memory.”

List of Information to be Memorized Mnemonic(s) or Other Helpful Memory Aids or Memorization Strategies

1. Common names: List learner's anti-hypertensives. 1. Medication puzzle has this information. For anti-hypertensives, write the learner's medications on a post it and place on puzzle piece or use dry erase or washable marker and write on puzzle piece.

2. Regulation of blood pressure.

3. Daily as prescribed by the physician.

4. Medications may change after starting peritoneal dialysis. a. Do not stop taking any anti-hypertensive medication without consulting your nurse or physician. b. Monitor and document blood pressure on your CAPD/CCPD flow sheet. Report abnormal readings.

5. Work to decrease the blood pressure.

MEMORY LEARNING ANALYSIS

SUBJECT: Diuretics

UNIT: Managing Medications

OBJECTIVE: The learner will be able to identify the name of the medication, purpose of taking the medication, how to take the medication and special considerations related to the medication.

GETTING THE LEARNER READY: “Now you are going to learn about diuretics. I will tell you common names of diuretics, the purpose of taking the medication, how to take it, and any special considerations about the medication. I will show you a puzzle with this information on it. I want you to pay attention to what I say and to study the puzzle. When you think you know the information about diuretics, I will ask you to list the information from memory.”

List of Information to be Memorized Mnemonic(s) or Other Helpful Memory Aids or Memorization Strategies

1. Common names: Bumex. Lasix, Diuril, Zaroxylan, Edecrin. 1. Medication puzzle has this information.

2. Increase urine output. 2. Emphasize that increases fluid (water) removal only, not toxins.

3. Daily in the morning as prescribed by physician.

4. May affect your potassium. Hypotension may result.

5. Increase urine output to help remove excess fluid.

MEMORY LEARNING ANALYSIS

SUBJECT: Epogen

UNIT: Managing Medications

OBJECTIVE: The learner will be able to identify the name of the medication, purpose of taking the medication, how to take the medication and special considerations related to the medication.

GETTING THE LEARNER READY: “Now you are going to learn about Epogen. I will tell you common names of the medication, the purpose of taking the medication, how to take it, and any special considerations about the medication. I will show you a puzzle with this information on it. I want you to pay attention to what I say and to study the puzzle. When you think you know the information about Epogen, I will ask you to list the information from memory.”

List of Information to be Memorized Mnemonic(s) or Other Helpful Memory Aids or Memorization Strategies

1. Common names: Epogen, Procrit. 1. Medication puzzle has this information.

2. Stimulate bone marrow to make red blood cells. 2. The “Born On Date” for RBCs.

3. Subcutaneous injection.

4. Very expensive medication. a. Needs refrigeration. b. Comes in single and multi dose vials of varying strengths. c. Multi-dose vials expire 21 days from the time first entered. Label with date first entered. d. Single dose is the entire bottle. e. Needs to be documented on the CAPD/CCPD flow sheet. f. Side effects may include hypertension and seizures.

5. Synthetic hormone which replaces erythropoietin that healthy kidneys make.

MEMORY LEARING LESSON PLAN

SUBJECT: Heparin

UNIT: Managing Medications

OBJECTIVE: The learner will be able to identify the name of the medication, purpose of taking the medication, when to take the medication and special considerations related to the medication.

MEDIA: Card with list of information to be memorized.

REQUISTE KNOWLEDGE: Semipermeable membrane, Fibrin, Peritonitis, Bloody Bag.

HOW WILL I EVALUATE WHETHER LEARNING HAS OCCURRED? The learner will identify the name of the medication, purpose of taking the medication, when to take the medication and special considerations related to the medication.

GETTING THE LEARNER READY: “At the end of this lesson you will be able to tell me about a medication called heparin. I will give you some important information about the medicine and show you a card with it listed on. Pay close attention to what I am saying and try to remember them. Repeat the list in your mind and use the card to help you. When you think you know it I will ask you to repeat it to me. We will know you have learned this when you can repeat the information without any help from me.”

LEARNER ACTIVITIES TEACHER ACTIVITIES NOTES

1. Repeat the information several times. 1. Present the information to be memorized. Tell the learner to ask questions or “say after me” 1. Dosing instructions per facility guidelines.

2. Form own associations 2. Present card with information listed.

3. Test 3. Ask learner to repeat the information.

MEMORY LEARNING ANALYSIS

SUBJECT: Heparin

UNIT: Managing Medications

List of Information to be Memorized Mnemonic(s) or Other Helpful Memory Aids or Memorization Strategies.

1. Heparin is a medication that prevents your body from making fibrin.

2. Heparin is normally used as a blood thinner but when added to your dialysis bags it does not enter your blood stream. It does not cross the peritoneal membrane

3. Heparin is added to your dialysate bags whenever you see fibrin.

4. Heparin is added to your dialysate bags whenever you have peritonitis.

5. Heparin can be added to your dialysate bags when you are draining slowly to improve drain time.

6. You may be instructed to add heparin to your dialysis bags if you have bloody effluent.

6. The correct dose of heparin to use is:______ Dose per Clinic specific guidelines.

MEMORY LEARNING ANALYSIS

SUBJECT: Antibiotics—IP

UNIT: Managing Medications

OBJECTIVE: The learner will be able to identify the name of the medication, purpose of taking the medication, how to take the medication and special considerations related to the medication.

GETTING THE LEARNER READY: “Now you are going to learn about IP antibiotics. I will tell you the common names of IP antibiotics, the purpose of taking the medication, how to take it, and any special considerations about the medication. I will show you a puzzle with this information on it. I want you to pay attention to what I say and to study the puzzle. When you think you know the information about IP antibiotics, I will ask you to list the information from memory.”

List of Information to be Memorized Mnemonic(s) or Other Helpful Memory Aids or Memorization Strategies

1. Common names: Ancef, Gentamicin, Tobramycin, Vancomycin. 1. Medication puzzle has this information.

2. Fight infections.

3. Daily as prescribed by physician. May be single daily dose or continuous dose with each bag. Single daily dose must dwell for at least 6 hours.

4. Pre-drawn antibiotics must be refrigerated. Course of antibiotics MUST be completed. Up to 21 days. Eat yogurt with active cultures daily while on antibiotics. 4. Eating yogurt will help to maintain normal intestinal flora while on antibiotic therapy. Remind the patient to look for yogurt with ACTIVE cultures.

5. Kills bacteria that cause infection.

MEMORY LEARNING ANALYSIS

SUBJECT: Laxatives

UNIT: Managing Medications

OBJECTIVE: The learner will be able to identify the name of the medication, purpose of taking the medication, how to take the medication and special considerations related to the medication.

GETTING THE LEARNER READY: “Now you are going to learn about laxatives. I will tell you the common names of laxatives, the purpose of taking the medication, how to take it, and any special considerations about the medication. I will show you a puzzle with this information on it. I want you to pay attention to what I say and to study the puzzle. When you think you know the information about laxatives, I will ask you to list the information from memory.”

List of Information to be Memorized Mnemonic(s) or Other Helpful Memory Aids or Memorization Strategies

1. Common names: Sorbitol, Dulcolax. 1. Medication puzzle has this information.

2. Stimulate normal bowel movement.

3. For constipation as prescribed by physician.

4a. May cause intestinal cramping and diarrhea. b. Not to be taken every day. c. Take only laxatives prescribed by the physician. 4. Some OTC laxatives are not recommended because they may contain unwanted ingredients or have unwanted actions. Some examples are: Correctol, Exlax, Milk of Magnesia, Fleets enemas.

5. Stimulates peristalsis.

MEMORY LEARNING ANALYSIS

SUBJECT: Antibiotics—Oral

UNIT: Managing Medications

OBJECTIVE: The learner will be able to identify the name of the medication, purpose of taking the medication, how to take the medication and special considerations related to the medication.

GETTING THE LEARNER READY: “Now you are going to learn about antibiotics. I will tell you the common names of antibiotics, the purpose of taking the medication, how to take it, and any special considerations about the medication. I will show you a puzzle with this information on it. I want you to pay attention to what I say and to study the puzzle. When you think you know the information about antibiotics, I will ask you to list the information from memory.”

List of Information to be Memorized Mnemonic(s) or Other Helpful Memory Aids or Memorization Strategies

1. Common names: Cipro, Keflex, Rifampin, Amoxacillin, Ceclor, Biaxin, Augmentin, Zithromax. 1. Medication puzzle has this information.

2. Fight infections.

3a. Daily as prescribed by physician. b. Follow administration instructions on the medication bottle.

4a. Important to complete the entire course. b. Dose may be adjusted if antibiotic prescribed by a physician other than the nephrologist. c. Notify PD nurse of any antibiotics prescribed by physicians other than the nephrologist. d. Notify PD nurse prior to procedures such as dental cleaning, colonoscopy, etc. as prophylaxis treatment may be required. e. Eat yogurt with active cultures daily while on antibiotic therapy. 4. Eating yogurt may help to maintain normal intestinal flora while taking antibiotics. Remind the patient to check the yogurt carton for ACTIVE cultures.

5. Kills bacteria that cause infection.

MEMORY LEARNING ANALYSIS

SUBJECT: Oral Diabetes Agents

UNIT: Managing Medications

OBJECTIVE: The learner will be able to identify the name of the medication, purpose of taking the medication, how to take the medication and special considerations related to the medication.

GETTING THE LEARNER READY: “Now you are going to learn about oral diabetic agents. I will tell you common names of oral agents, the purpose of taking the medication, how to take it, and any special considerations about the medication. I will show you a puzzle with this information on it. I want you to pay attention to what I say and to study the puzzle. When you think you know the information about oral agents, I will ask you to list the information from memory.”

List of Information to be Memorized Mnemonic(s) or Other Helpful Memory Aids or Memorization Strategies

1. Common names: Glucotrol, Glucotrol XL, Diabeta, Diabionese, Micronase, Glyburide. 1. Medication puzzle has this information.

2. Regulation of blood glucose.

3. Daily as prescribed by the physician.

4a. Monitor blood glucose as ordered by the physician. b. Oral agents may change to subcutaneous insulin with peritoneal dialysis.

5. Help with your body's production and utilization of insulin.

MEMORY LEARNING ANALYSIS

SUBJECT: Oral Iron

UNIT: Managing Medications

OBJECTIVE: The learner will be able to identify the name of the medication, purpose of taking the medication, how to take the medication and special considerations related to the medication.

GETTING THE LEARNER READY: “Now you are going to learn about oral iron. I will tell you common names of oral iron, the purpose of taking the medication, how to take it, and any special considerations about the medication. I will show you a puzzle with this information on it. I want you to pay attention to what I say and to study the puzzle. When you think you know the information about oral iron, I will ask you to list the information from memory.”

List of Information to be Memorized Mnemonic(s) or Other Helpful Memory Aids or Memorization Strategies

1. Common names: Niferex 150, Niferex Forte, Chromagen, Chromagen Forte, Ferrous Sulfate. 1. Medication puzzle has this information.

2. Increase iron stores needed for formation of new red blood cells.

3a. Take on an empty stomach with a good source of Vitamin C (orange or grapefruit juice). b. May divide doses.

4a. Do not take with phosphorus binders. b. Make cause stomach upset and constipation.

5. Iron is a mineral, stored in the liver, necessary for the formation of healthy red blood cells.

MEMORY LEARNING ANALYSIS

SUBJECT: Phosphate Binders

UNIT: Managing Medications

OBJECTIVE: The learner will be able to identify the name of the medication, purpose of taking the medication, how to take the medication and special considerations related to the medication.

GETTING THE LEARNER READY: “Now you will learn about phosphorus binders. Phosphorus is a mineral that is essential for healthy bones. You get it in the food you eat and it gets to your bones by way of your blood stream. If you eat foods high in phosphorus, the phosphorus you don't need is normally removed by healthy kidneys. This function of kidneys is not replaced by peritoneal dialysis. I will tell you the names of common phosphorus binders, the reasons for taking the binders, how to take them and special considerations about the binders and show you puzzle pieces with this information. Pay attention as I present this information and study the puzzle pieces. When you think you know the information on the puzzle pieces, I will ask you to tell it to me from memory.”

List of Information to be Memorized Mnemonic(s) or Other Helpful Memory Aids or Memorization Strategies

1. Common names: Phoslo, Renagel, Tums, Calcium Carbonate, CalciChew

2. Bind phosphorus, which is normally removed by healthy kidneys, preventing high phosphorus levels in the blood.

3. Take with food.

4a. May cause constipation. b. Avoid taking with Iron.

MEMORY LEARNING ANALYSIS

SUBJECT: Insulin—SQ Self-Injection

UNIT: Managing Medications

OBJECTIVE: The learner will be able to identify the name of the medication, purpose of taking the medication, how to take the medication and special considerations related to the medication.

GETTING THE LEARNER READY: “Now you are going to learn about subcutaneous insulin. I will tell you common names of subcutaneous insulin, the purpose of taking the medication, how to take it, and any special considerations about the medication. I will show you a puzzle with this information on it. I want you to pay attention to what I say and to study the puzzle. When you think you know the information about subcutaneous insulin, I will ask you to list the information from memory.”

List of Information to be Memorized Mnemonic(s) or Other Helpful Memory Aids or Memorization Strategies

1. Common names: Regular, Humulin, Novolin, 70/30, 50/50, NPH. 1. Medication puzzle has this information.

2. Regulation of blood glucose.

3. Subcutaneous as directed by your physician.

4a. Monitor blood glucose prior to dosing. b. Document blood glucose and insulin dose on flow sheet. c. Hypoglycemia or hyperglycemia may result. d. Refrigerate insulin, use within 30 days. e. Label vial with date first entered. 4. Stress importance of monitoring, documenting and reporting results abnormal for the patient.

5. Insulin is a hormone that enables glucose to enter the cells to be used for energy. Insulin injections are synthetic hormones.

MEMORY LEARNING ANALYSIS

SUBJECT: Vitamin D analogs

UNIT: Managing Medications

OBJECTIVE: The learner will be able to identify the name of the medication, purpose of taking the medication, how to take the medication and special considerations related to the medication.

GETTING THE LEARNER READY: “Now you are going to learn about Rocaltrol. There is only one form of the medication. I will tell you the purpose of taking the medication, how to take it, and any special considerations about the medication. I will show you a puzzle with this information on it. I want you to pay attention to what I say and to study the puzzle. When you think you know the information about Rocaltrol, I will ask you to list the information from memory.”

List of Information to be Memorized Mnemonic(s) or Other Helpful Memory Aids or Memorization Strategies

1. Common names: Rocaltrol, Calcitriol 1. Medication puzzle has this information.

2. Enhances absorption of calcium from the intestine.

3. Take any time of day, entire dose at one time.

4. Expensive medication.

5. Healthy kidney normally converts Vitamin D to active form. This active form of Vitamin D, only found in prescription drug, replaces the converted form.

MEMORY LEARNING ANALYSIS

SUBJECT: Renal Vitamins

UNIT: Managing Medications

OBJECTIVE: The learner will be able to identify the name of the medication, purpose of taking the medication, how to take the medication and special considerations related to the medication.

GETTING THE LEARNER READY: “Now you are going to learn about renal vitamins. I will tell you the common names of renal vitamins, the purpose of taking the medication, how to take it, and any special considerations about the medication. I will show you a puzzle with this information on it. I want you to pay attention to what I say and to study the puzzle. When you think you know the information about renal vitamins, I will ask you to list the information from memory.”

List of Information to be Memorized Mnemonic(s) or Other Helpful Memory Aids or Memorization Strategies

1. Common names: Nephrovite Rx, NephroCaps, NephronFA, Berocca. 1. Medication puzzle has this information.

2. Replace water soluble vitamins that can be lost through dialysis.

3. Daily as prescribed by physician.

4. These are prescription vitamins that are not similar to over-the-counter brands.

5. Vitamins are required for many normal body functions to occur.

A further unit/module/chapter may be taught on SQ and IP Medication Administration. This unit will teach the learner how to self administer subcutaneous and intraperitoneal medications at home. The learning involved is primarily memory and motor skill. As with previous units, the learner will first learn about the supplies needed, i.e.: safety of medications and syringes. Requisite knowledge includes the Maintaining Asepsis and Managing Medication Units (specifically the Epogen, Heparin, IP Insulin, SQ Insulin and IP Anti biotic memory lessons). Then the learner will learn about SQ and IP medication administration. All of these lessons are optional. Use only the lessons you need for each learner—of course, with their requisite knowledge.

Media: Please be very careful to label your usable/unusable medications for training only. Keep the training material separate from any medication used on patients in a secured place. To reduce the amount of solution bags used during patient training, you may wish to use the old ‘practice’ UltraBags during the IP segment. For practice SQ injections, a pillow or soft foam pad may be used; or, foam balls/kidneys that patients use to pump during venipuncture.

Here is a Suggested Outline Based on Requisite Knowledge:

Checking Medications—M, P, J/D, PS

Components of a Syringe—M

Syringe Markings—M

Gathering Supplies for SQ Medication Administration—M

Drawing Up SQ Medication for Self-Injection—MS

SQ Self-Injection—MS

Gathering Supplies for Reconstituting Medications—M

Reconstituting Medications—MS

Gathering Supplies for IP Medication Administration—M

Drawing Up Medication for IP Administration—MS

Adding IP Medication to the Solution Bag—MS

MEMORY LEARNING LESSON PLAN

SUBJECT: Checking Medication

UNIT: SQ/IP Medication Administration

OBJECTIVE: The learner will be able to name from memory the items to be checked on a medication vial.

MEDIA: Card with the critical features of medication checks.

REQUISTE KNOWLEDGE: Maintaining Asepsis Unit, Managing Medications (Insulin, Epogen, prn).

HOW WILL I EVALUATE WHETHER LEARNING HAS OCCURRED? The learner will name from memory the items to be checked on a medication vial.

GETTING THE LEARNER READY: “At the end of this lesson you will know the four things that you need to check on a bottle of medication. I'm going tell you what they are and show you where they are located on the bottle. Listen carefully to the items that need to be checked. I will ask you to repeat them back to me. We will know you have learned this when you can repeat them without any help from me.”

LEARNER ACTIVITIES TEACHER ACTIVITIES NOTES

1. Repeat the information several times. 1. Present information to be memorized. Tell the learner to ask questions or “say after me”.

2. Form own associations. Using the card learn where to look for critical features. 2. Show the card and show several bottles describing where to find the critical features. 2. Samples of IV antibiotics, Insulin, different dosages of Epogen.

3. Practice/Test. 3. Question and provide feedback.

MEMORY LEARNING ANALYSIS

SUBJECT: Checking Medication

UNIT: SQ/IP Medication Administration

List of Information to be Memorized Mnemonic(s) or Other Helpful Memory Aids or Memorization Strategies.

1. Name. 1. Card with items listed on it.

2. Strength of dose.

3. Expiration Date.

4. Appearance.

PRINCIPLE LEARNING LESSON PLAN

SUBJECT: Checking Medications

UNIT: SQ/IP Meds

OBJECTIVE: Learner will be able to recognize when medications are safe and unsafe to use.

MEDIA: Box Labeled, “Return to Clinic” A supply of usable/unusable Epogen, heparin, and regular insulin bottles. Need to include: expired vials, cloudy vial, vial that has been tampered with, opened and dated vials. BOTTLES SHOULD BE LABELED “FOR TRAINING” with water or cloudy solution in them.

REQUISITE KNOWLEDGE: Checking Medications Memory Lesson

HOW WILL I EVALUATE WHETHER LEARNING HAS OCCURRED? Learner states the principles

1. If incorrect medications are given, harm may result.

2. If an incorrect medication dosage is given, harm may result.

3. If the incorrect strength of medication is given, harm may result.

4. If an unsterile medication is used, harm may result.

5. If a vial has been opened, it should be used within 30 days.

6. If EPO vials are open, they should be used within 21 days.

GETTING THE LEARNER READY: “You have learned how to check medications. Let's talk now about some unsafe medication situations and what you should know if you have one. I will present medications to you and ask you to guess whether they are safe to use. Don't be afraid to guess wrong, that is how you learn. When you are guessing correctly I will ask you why and if you answer correctly, then we will know you understand what causes this condition and if it is normal.”

LEARNER ACTIVITY TEACHER ACTIVITY NOTES

1. Pay attention to concepts. 1. Review concepts and state principles.

2. Guess. 2. Teacher presents scenarios and asks learner to guess. Give feedback re: accuracy of description. 2. Use medications the learner is likely to use at home.

3. Continue guessing as scenarios that are examples and non-examples are presented. 3. Continue to present examples and non-examples until learner is guessing correctly most of the time.

4. Restate the principles linking the concepts. 4. Have learner restate the principle in their own words.

PRINCIPLE LEARNING ANALYSIS

SUBJECT: Checking Medications

List of Concepts Linked to Form Principle

1. If incorrect medications are given, harm may result. 2. If an incorrect medication dosage is given, harm may result. 3. If the incorrect strength of medication is given, harm may result. 4. If an unsterile medication is used, harm may result. 5. If a vial has been opened, it should be used within 30 days. 6. If EPO vials are open, they should be used within 21 days.

Suggested Scenarios

Box Labeled, “Return to Clinic” A supply of usable/unusable Epogen, heparin, and regular insulin bottles. Need to include: expired vials, cloudy vial, vial that has been tampered with, opened and dated vials. BOTTLES SHOULD BE LABELED “FOR TRAINING” with water or cloudy solution in them. Present bottles one at a time to learner. Ask learner to state if each vial is safe or unsafe to use.

JUDGMENT/DECISION LEARNING LESSON PLAN

SUBJECT: Checking Medications

UNIT: SQ/IP Medication Administration

OBJECTIVE: The learner will be able to identify medications that are safe and unsafe to use, and state actions to take.

MEDIA: See Checking Medications Principle Lesson.

REQUISITE KNOWLEDGE: Checking Medications Principle Lesson.

HOW WILL I EVALUATE WHETHER LEARNING HAS OCCURRED? The learner will identify and select the correct vial of medication when given a scenario by the teacher and state the correct action to take

GETTING THE LEARNER READY: “We have talked about how to know if a medication is safe or unsafe to use. Now I am going to tell you what to do when you find a med is unsafe.

Pay attention and memorize the steps. I will ask you to repeat them back. When you can tell me what you would do with a medication, we will know you have learned this.”

LEARNER ACTIVITIES TEACHER ACTIVITIES NOTES

1. Pay attention and recall the concepts. 1. Review the associated concepts. 1. Sterile/Unsterile

2. Pay attention. 2. State the principles. 2. See analysis.

3. Pay attention. 3. Present what the learner should be looking for and possible action steps that should be taken.

4. Repeat the judgment and decision. 4. Ask the learner to repeat the action steps.

5. Process feedback. 5. Provide feedback. 5. Continue until the learner has memorized.

JUDGMENT/DECISION LEARNING ANALYSIS

SUBJECT: Checking Medications

List of Principles Used to Make the Judgment/Decision:

1. If incorrect medications are given, harm may result.

2. If an incorrect medication dosage is given, harm may result.

3 . If the incorrect strength of medication is given, harm may result.

4. If an unsterile medication is used, harm may result.

5. If a vial has been opened, it should be used within 30 days.

6. If EPO vials are open, they should be used within 21 days

What the Learner should be looking for? (Judgments) What choice(s)/possible action steps should be taken? (Decisions) (some judgments will have several action steps)

1. Correct Medication. 1. If incorrect return the medication to supply shelf and choose the correct medication.

2. Correct strength. 2. If incorrect return the medication to the supply shelf and choose the correct strength.

3. Expiration Date. 3. If expired place vial in box labeled “Return to Clinic”.

4. Appearance. 1. If solution is cloudy place vial in box labeled “Return to Clinic”. 2. If bottle has been tampered with place in box labeled “Return to Clinic”.

PROBLEM SOLVING LESSON PLAN

SUBJECT: Checking Medications

UNIT: SQ/IP Medications

OBJECTIVE: Learner will be able to identify medications that are safe and unsafe and take the appropriate action steps.

MEDIA: See Checking Medications Principle Lesson

REQUISITE KNOWLEDGE: Checking Medications Decision/Decision Lesson

HOW WILL I EVALUATE WHETHER LEARNING HAS OCCURRED? Learner will identify medications that are safe and unsafe and demonstrate the appropriate actions to take.

GETTING THE LEARNER READY: “You've learned about checking medications and what to do if you have a medication that is unusable. Now I will give you problem examples, ask you to tell me what you see, what you know about the situation and what you would do if this happened to you. I will help you along in working through the situation, so don't be afraid. When you can take the correct action, then we will know you can solve this problem at home.”

LEARNER ACTIVITY TEACHER ACTIVITY NOTES

1. Pay attention and recall the concepts. 1. Review associated concepts.

2. Pay attention. 2. State the principles.

3. Solve problems and take correct actions. 3. Present scenario(s) and ask learner to identify the and solve the problem. After each scenario, the teacher asks the learner to state the possible problem and describe the appropriate actions to take. 3. Teacher may need to prompt learner to solve the problem i.e. “What is happening here?”, “What do you know about this?”, and “What do you think you should do?“. If the learner is having difficulty identifying the problem then go back and review associated concepts.

Problem Solutions to Include Unit Specific Standing Orders.

4. Process feedback. 4. Continue feedback. 4. Continue presenting scenarios until learner is developing correct solutions and taking correct actions.

PROBLEM SOLVING LEARNING ANALYSIS

SUBJECT: Checking Medications

PROBLEM DESCRIPTION: Unsafe Medications

List of Principles Used to Solve the Problem:

1. If incorrect medications are given, harm may result.

2. If an incorrect medication dosage is given, harm may result.

3. If the incorrect strength of medication is given, harm may result.

4. If an unsterile medication is used, harm may result.

5. If a vial has been opened, it should be used within 30 days.

6. If EPO vials are open, they should be used within 21 days.

Problem Scenario Problem Solution

1.Give learner a variety of vials of medication that are safe and unsafe to use. Use medications they are currently using. 1. For each vial, learner will: state whether vial is usable or unusable. discard vial if appropriate. place vial in Return to Clinic box if appropriate.

MEMORY LEARNING LESSON PLAN WITH SIMPLE MOTOR SKILL

SUBJECT: Components of a Syringe

UNIT: SQ/IP Medication Administration

OBJECTIVE: The learner will be able to name the components of a syringe and move the plunger of the syringe up and down easily.

MEDIA: Picture of syringe (MA 7); syringe.

REQUISITE KNOWLEDGE: None

HOW WILL I EVALUATE WHETHER LEARNING HAS OCCURRED? The learner will correctly name the parts of a syringe and the learner can move the plunger up and down easily.

GETTING THE LEARNER READY: “Now you are going to learn the components of a syringe. I will show you a syringe, tell you what the components are, and give you a memory trick to help you. Look carefully at the syringe, repeat the components in your mind, and use the memory trick to help you. When you feel you know the parts of the syringe, I will give you a syringe and ask you to tell me the parts. We will know you know the components of a syringe when you can correctly tell me the names of the components. I will also show you how to move the plunger of the syringe and let you practice until you can move it without difficulty.”

LEARNER ACTIVITY TEACHER ACTIVITY NOTES

1. Repeat information several times. 1. Show the learner the picture of the syringe, tell them each component as you show them. 1. Learner may need glasses to complete lesson.

2. Repeat the mnemonic “Calico cats never purr for blonde handlers.” or form own association to remember components. 2. Present the mnemonic and ask the learner to repeat it to you. Alternately, ask questions to help learner form own associations. 2. Cap Calico Calibrations Cats Needle Never Plunger Purr Flange For Barrel Blonde Hub Handlers

3. State name of syringe components. 3. Give learner a syringe and ask the learner to name the components.

4. Practice moving the plunger up and down until learner can do it without hesitation or difficulty. 4. Show learner how to move the plunger of the syringe up and down.

MEMORY LEARNING ANALYSIS

SUBJECT: Components of a Syringe

List of Information to be Memorized Mnemonic(s) or Other Helpful Memory Aids or Memorization Strategies

CapCalibrationsNeedlePlungerFlangeBarrelHub

CalicoCatsNeverPurrForBlondeHandlers

MEMORY LEARNING LESSON PLAN

SUBJECT: Syringe Markings

UNIT: SQ/IP Medication Administration

OBJECTIVE: The learner will be able to describe the markings on the barrel of the syringe and when shown examples of filled syringes, state the amount of fluid contained in the syringe.

MEDIA: Syringes in sizes the learner is likely to encounter, liquid measuring cup with markings, assorted sizes of syringes filled with varying amounts of fluid.

REQUISITE KNOWLEDGE: Components of a Syringe

HOW WILL I EVALUATE WHETHER LEARNING HAS OCCURRED? The learner will describe the markings on the barrel of the syringe and correctly state amount of fluid contained in syringes when presented with syringes filled with varying amounts of fluid.

GETTING THE LEARNER READY: “Now you are going to learn what the markings on the syringes mean and how to determine the amount of fluid in a syringe. You will need to pay attention while I explain the markings to you, compare them to the markings you find on the liquid measuring cup, then show you examples of different size syringes filled with different amounts of fluid. I will ask you to tell me how much fluid is in each of the syringes. We will know that you understand syringe markings when you are able to tell me all of the time how much fluid is in the syringes I show you.”

LEARNER ACTIVITY TEACHER ACTIVITY NOTES

1. Pay attention. 1. Explain the markings of the syringe and how they relate to measurement of fluid. Compare to liquid measuring cup to help learner's understanding. 1. The learner may need to wear glasses to complete this lesson. Use several different sizes of syringes to illustrate that size of the syringe affects the meaning of the markings. Use everyday example of a container that has markings to indicate measure of volume.

2. Examine samples of fluid-filled syringes. Guess the volume of fluid contained in each. 2. Show examples of syringes filled with fluid. Ask learner to guess the amount of fluid contained in the syringe. 2. Present syringes in sizes that the learner will be most likely to encounter as they do the treatment. Include syringes that the learner will likely not use as part of the treatment.

3. Continue to examine syringes until guessing volume correctly. 3. Present examples until learner is correctly guessing the volume all of the time. 3. If brand of syringes used in program changes, may want to expose learner to all brands that may be used.

4. Explain syringe markings to teacher. 4. Ask learner to explain the syringe markings in their own words.

MEMORY LEARNING ANALYSIS

SUBJECT: Syringe Markings

List of Information to be Memorized Mnemonic(s) or Other Helpful Memory Aids or Memorization Strategies

1. Syringe markings measure fluid. 1. Compare syringe to measuring cup.

2. Syringes come in different sizes. 2. Show 10 cc, 3 cc, 1 cc syringes.

MEMORY LEARNING LESSON PLAN

SUBJECT: Gathering Supplies for SQ Medication Administration

UNIT: SQ/IP Medication Administration

OBJECTIVE: Learner will be able to gather the correct supplies to perform a self-injection of medication.

MEDIA: Laminated card with mnemonic; syringe, medication, alcohol pads, sharps container and CAPD/CCPD flow sheets.

REQUISITE KNOWLEDGE: Maintaining Asepsis Unit, Managing Medications (Epogen, Insulin, pm), Checking Medications, Components of a Syringe, Syringe Markings.

HOW WILL I EVALUATE WHETHER LEARNING HAS OCCURRED? The learner will be able to choose the correct supplies from a large group of similar items.

GETTING THE LEARNER READY: “Now you are going to memorize a list of supplies you will need to do a self-injection. I'll show you the supplies needed, tell you what they are and give you a little memory trick to help you. Look carefully at the supplies, repeat the list in your mind, and use the memory trick to help you. When you feel you know which supplies you need, I'll ask you to get them from the supply cabinet (shelf).”

LEARNER ACTIVITY TEACHER ACTIVITY NOTES

1. Repeat information several times. 1. Present information to be memorized. Tell the learner to ask questions or “say after me”.

2. May form own associations or use the memory trick. 2. Present mnemonics—may ask patient questions to form own association. 3. Caution Safe Syringes Are Mandatory

3. List supplies from memory. 3.Ask the learner to list the supplies.

4. Practice/Test. 4.Question and provide feedback.

MEMORY LEARNING ANALYSIS

SUBJECT: Gathering Supplies for SQ Medication Administration

List of Information to be Memorized Mnemonic(s) or Other Helpful Memory Aids or Memorization Strategies

1. CAPD/CCPD flow sheets. 1. Caution.

2. Sharp container. 2. Safe.

3. Syringes. 3. Syringes.

4. Alcohol pad. 4. Are.

5. Medication. 5. Mandatory.

MOTOR SKILL—COGNITIVE—LESSON PLAN

SUBJECT: Drawing Up SQ Medication for Self-Injection

UNIT: SQ/IP Medication Administration

OBJECTIVE: The learner will be able to repeat the critical steps required for drawing up SQ medications for self-injection.

MEDIA: Medication, 2 alcohol pads, gauze, syringe, and CAPD/CCPD flow sheet.

REQUISITE KNOWLEDGE: Maintaining Asepsis Unit, Managing Medications (Epogen, Insulin, pm), Checking Medications, Components of a Syringe, Syringe Markings, Gathering Supplies for SQ Self Injection.

HOW WILL I EVALUATE WHETHER LEARNING HAS OCCURRED? Learner will repeat the critical steps for drawing medication for self-injection.

GETTING THE LEARNER READY: “At the end of this lesson you will know the steps for drawing medication. I will show you how to draw up medication. I will first demonstrate the procedure as you will usually do it. Then I will demonstrate the procedure explaining what I am doing at each point. I want you to pay close attention to what I am doing. After you watch me do the procedure several times, I will ask you to tell me the steps in the procedure. When you repeat the steps of the procedure to me without error, I will know you are ready to practice the procedure yourself”.

LEARNER ACTIVITY TEACHER ACTIVITY NOTES

1. Pay Attention. “Memorize” Pictures of steps. 1. First Demonstration. 1. This lesson may be tailored for the caregiver.

2. Determine “critical steps/nuances/etc. 2. Second Demonstration—Point out critical steps, nuances, talk through what your hands are doing using detailed analysis.

3. Repetition. 3. Third Demonstration—shorten description—use labels from condensed analysis.

4. Repeat labels from memory. 4. Give Feedback. If learner is unable to repeat the critical steps it may be necessary to perform another demonstration similar to #3.

MOTOR SKILL—PRACTICE—LESSON PLAN

SUBJECT: Drawing Up SQ Medication for Self-Injection

UNIT: SQ/IP Medication Administration

OBJECTIVE: The learner will be able to draw up SQ medications following aseptic technique.

MEDIA: Same as Cognitive Lesson Plan

REQUISITE KNOWLEDGE: Cognitive Lesson Plan for this Motor Skill

HOW WILL I EVALUATE WHETHER LEARNING HAS OCCURRED? The learner will aseptically draw up SQ medication for self-injection.

GETTING THE LEARNER READY: “Now that you are able to repeat the steps of the procedure to me it is time for you to practice. I would like you to practice the procedure until you feel you can do it without thinking. I will give you feedback about how you are doing as you practice. Don't worry about making mistakes, I will correct you as you go along. You may practice as long as you need. When you feel you know the procedure, I will ask you to do the procedure on your own without any help from me.”

LEARNER ACTIVITY TEACHER ACTIVITY NOTES

1. Hands on practice. 1. Tell learner to go ahead and practice. 1. Have adequate supplies for multiple practices.

2. Reduce errors to a minimum. 2. Provide immediate, accurate feedback focused on what is correct.

3. Correct errors. 3. Continue feedback.

4. Repeat often enough until steps become smooth and without error. 4. Test for automatic stage.

MOTOR SKILL ANALYSIS—DETAILED

SUBJECT: Drawing Up SQ Medications for Self-Injection

Steps to Take Tricks of the Trade

1. Wash Hands. 1. Previously learned.

2. Check medication. 2. Previously learned J/D.

3. Open the syringe packet. 3. Previously learned Motor Skill.

4. Pick up the medication vial by wrapping forefinger, middle, ring and little fingers of your right hand around the vial . Using the thumb of the same hand push up on the edge of the plastic cap until it pops off and exposes the top rubber port. Place the vial upright on the clean working surface. Pick up one alcohol pad and tear open the package across the top. Place the pad on the medication vial. Wipe top of vial in a circular motion. Open second alcohol pad and place on sterile syringe package. 4. If medication vial top already removed, omit this step.

5. Pick up the syringe with the right hand by using your thumb on one side and grasp your fingers around the barrel of the syringe. Hold the syringe in a horizontal position. Check to ensure the needle is attached by firmly holding onto the needle cap with the thumb and forefinger of your left hand, at the same time turn the syringe clockwise with the right hand.

6. To remove protective needle cap, pull the needle cap off, away from the syringe. Set the needle cover aside.

7. Remove the alcohol pad from the medication vial and discard.

8. Using your left thumb and forefinger, stabilize the vial of medication. the vial of medication. Rotate the syringe in your right hand so you are holding the barrel of the syringe like a pencil. Insert the needle downward into the rubber port of the vial. Remove your left hand from the vial. Rotate it so the palm faces up. Grasp the vial between the left thumb and forefinger and hold firmly. Pick up the vial and syringe as a unit and invert it. If necessary use your right hand and adjust the syringe to make sure the needle tip is below the level of medication in the vial. 8. Be sure the needle is in the medication and not above in an air space.

9. Wrap little finger and ring finger of left hand around barrel of syringe. Stabilize the syringe against the palm below thumb. Move right hand thumb and first two fingers to end of the plunger. Pull the plunger back to draw up the prescribed dose of medication.

10. Tap the barrel of the syringe with the right forefinger to force any air in the syringe to rise toward the hub. 10. Be sure all the air has been removed from the syringe.

11. With thumb and first two fingers of right hand on end of plunger, push any air into the vial by pushing up gently on the plunger.

12. If necessary repeat steps 9 through 11 to ensure prescribed dose of medication has been drawn into syringe.

13. Holding syringe barrel between right thumb and forefinger; release left little and ring finger from syringe. Continue to hold medication vial with left thumb and first two fingers. Remove needle from vial by pulling the barrel of the syringe straight out of the vial opening. Place the vial on the work surface.

14. Immediate administration of medication is preferred, however if recapping the needle is necessary, slide the needle into the opening of the cap until the needle cap is nearly on the needle. 14. Recapping with one hand technique reduces chances of contamination of the needle and accidental puncture wounds. 1 4a. It is preferred that when medications are drawn up, they are immediately administered.

15. Bring the syringe and needle to a vertical position using the right hand.

16. Secure the cap on the needle by pushing down firmly with the left hand until you hear a click. 16. Cap is on securely when the cap clicks in place.

MOTOR SKILL ANALYSIS—CONDENSED

SUBJECT: Drawing Up SQ Medications for Self-Injection

Brief Description of Logically Grouped Steps Label

1. Gather supplies. Wash hands. Check medication. Open and apply alcohol pads. 1. Get Ready.

2. Secure needle onto hub. Remove needle cap. 2. Prepare syringe.

3. Insert into vial. Draw up medication. 3. Draw up medication.

4. Tap out air bubbles. Remove syringe from vial. Recap if necessary. 4. Check syringe for air and remove.

MOTOR SKILL—COGNITIVE—LESSON PLAN

SUBJECT: SQ Self-Injection

UNIT: SQ/IP Medication Administration

OBJECTIVE: The learner will be able to repeat the critical steps required for a SQ self-injection.

MEDIA: Medication, alcohol prep pads, syringe, sharps container, flat throw pillow, CAPD/CCPD flow sheet.

REQUISITE KNOWLEDGE: Maintaining Asepsis Unit, Managing Medications (Epogen, Insulin, prn), Checking Medication, Components of a Syringe, Syringe Markings, Drawing up SQ Medications for Self Injection.

HOW WILL I EVALUATE WHETHER LEARNING HAS OCCURRED? Learner will repeat the critical steps for a SQ self-injection.

GETTING THE LEARNER READY: “At the end of this lesson you will know the steps for giving yourself a SQ self-injection. I will show you how to give yourself an injection. I will first demonstrate the procedure as you would usually do it. Then I will demonstrate the procedure explaining what I am doing at each point of the procedure. I want you to pay close attention to what I am doing. After you watch me do the procedure several times, I will ask you to tell me the steps in the procedure. When you can repeat the steps of the procedure to me without error, I will know you are ready to practice the procedure yourself.”

LEARNER ACTIVITY TEACHER ACTIVITY NOTES

1. Pay attention. “Memorize” pictures of steps. 1. First Demonstration. 1. Use a flat throw pillow for practice injections.

2. Determine “critical” steps. 2. Second Demonstration—Point out critical steps, talk through what your hands are doing using the detailed analysis.

3. Repetition. 3. Third Demonstration—Shorten description—use labels from condensed version.

4. Repeat labels from memory. 4. Give feedback. If learner is unable to repeat steps, perform demonstration #3 again.

MOTOR SKILL—PRACTICE—LESSON PLAN

SUBJECT: SQ Self-Injection

UNIT: SQ/IP Medication Administration

OBJECTIVE: The learner will be able to perform a safe SQ self-injection.

MEDIA: Same as Cognitive Lesson Plan

REQUISITE KNOWLEDGE: Cognitive Lesson Plan for this Motor Skill.

HOW WILL I EVALUATE WHETHER LEARNING HAS OCCURRED? The learner will perform a safe SQ self-injection.

GETTING THE LEARNER READY: “Now that you are able to repeat the steps of the procedure to me it is time for you to practice. I would like you to practice the procedure until you feel you can do it without thinking. I will give you feedback about how you are doing as you practice. Don't worry about making mistakes, I will correct you as you go along. You may practice as long as you need. When you feel you know the procedure, I will ask you to do the procedure on your own without any help from me.”

LEARNER ACTIVITY TEACHER ACTIVITY NOTES

1. Hands on practice. 1. Tell the learner to “Go ahead, it is your turn to practice.” 1. Have adequate supplies for multiple practices.

2. Reduce errors to a minimum. 2. Provide immediate, accurate feedback focused on what is correct.

3. Correct errors. 3. Continue feedback.

4. Repeat often enough for steps to become smooth and without error. 4. Test for automatic stage.

MOTOR SKILLS ANALYSIS—DETAILED

SUBJECT: SQ Self-Injection

Steps to Take Tricks of the Trade

1. Draw up medication. 1. Previously learned motor skill—if left uncapped, syringe is in right hand at this point.

2. *If needle recapped, pick up the syringe with the right hand by using your thumb on one side and grasp your fingers around the barrel of the syringe. Hold the syringe in a horizontal position, needle pointing up. To remove the protective needle cap, pull the needle cap off, away from the syringe. Set the needle cover aside 2.

3. Rotate the syringe in your right hand so you are holding the barrel of the syringe like a pencil. Needle should be pointing in desired direction of injection.

4. Using left forefinger and thumb, pick up alcohol prep pad and clean off selection site by wiping a in a circular motion until cleaned area of 1 inch in diameter. 3a. If delay has occurred between drawing and injecting medication, open a new alcohol prep pad. 3b. J/D site selection.

5. Remove alcohol prep pad from skin site and place on opened syringe wrapper. 4.

6. With thumb and forefinger of left hand pinch skin area around cleaned site up to 2 inches wide. 5. Avoid contamination. Width may vary from patient to patient.

7. Continuing to hold the syringe in the right hand in a pencil grip, insert needle into the site at a 45 degree angle to the skin. 6. Bevel should be upwards.

8. Release left hand. 7.

9. Stabilize syringe at hub with left thumb and forefinger. 8.

10. Move right thumb and forefinger back to plunger and pull back plunger until you visualize air in the syringe. 9. If blood enters the syringe, discard syringe and draw up new medication. 11. With thumb of right hand, press in plunger slowly until all medication has been injected and plunger stops. 10.

12. Grasp the barrel of the syringe between thumb and forefinger of right hand. 11.

13. With thumb and first two fingers of left hand pick up alcohol prep pad, withdraw needle from skin and when removing needle, immediately place alcohol prep pad over the injection site. 12.

14. With the first two fingers of the left hand press the alcohol prep pad firmly over the injection site and massage in a circular motion. 13. Decreases discomfort.

15. Discard syringe in sharps container. 14.

16. Document injection on CAPD/CCPD flow sheet. 15.

MOTOR SKILLS ANALYSIS—CONDENSED

SUBJECT: SQ Self-Injection

Brief Description of Logically Grouped Steps Label

1. Draw up medication. 1. Prepare medication.

2. Prepare site. Insert needle. Inject medication. Remove needle. 2. Administer medication.

3. Dispose of needle.Document injection. 3. Finish.

MEMORY LEARNING LESSON PLAN

SUBJECT: Gathering Supplies for IP Medication Administration

UNIT: SQ/IP Medication Administration

OBJECTIVE: Learner will be able to gather the correct supplies for IP medication administration.

MEDIA: Laminated card with mnemonic: mask, medication, solution bag, syringe with 1″ needle, betadine prep pad, 2×2 sterile gauze, tape, sharps container.

REQUISITE KNOWLEDGE: Maintaining Asepsis Unit, Managing Medications (IP Antibiotics, IP Heparin, IP Reg. Insulin), Checking Medications, Components of a Syringe, Syringe Markings.

HOW WILL I EVALUATE WHETHER LEARNING HAS OCCURRED? The learner will choose the correct supplies for IP medication administration.

GETTING THE LEARNER READY: “Now you are going to memorize a list of supplies you will need to inject medication safely into the solution bag. I'll show you the supplies needed, tell you what they are and give you a little memory trick to help you. Look carefully at the supplies, repeat the list in your mind, and use the memory trick to help you. When you feel you know which supplies you need, I'll ask you to get them from the supply cabinet (shelf).”

LEARNER ACTIVITY TEACHER ACTIVITY NOTES

1. Repeat information several times. 1. Present information to be memorized. 1. May choose to place supplies on table.

2. Form own associations. 2. Present mnemonic—may ask learner questions to form own associations.

3. Practice/Test. Have learner choose supplies from shelf. 3. Question and provide feedback. 3. Include on the supply shelf supplies that are not needed for this lesson.

MEMORY LEARNING ANALYSIS

SUBJECT: Gathering Supplies for IP Medication Administration

List of Information to be Memorized Mnemonic(s) or Other Helpful Memory Aids or Memorization Strategies

Bag Big

Betadine Blue

Mask M

&

Medication M

Syringe S

Tape Taste

Sharps container So

Gauze Good

MOTOR SKILL—COGNITIVE—LESSON PLAN

SUBJECT: Drawing up Medication for IP Administration

UNIT: SQ/IP Medication Administration

OBJECTIVE: The learner will be able to repeat the critical steps required for drawing up medications for IP administration.

MEDIA: Mask, medication, betadine prep pad, gauze, syringe, solution bag, sharps container, clamp, tape, supplies for cleaning work surface, and warming bags.

REQUISITE KNOWLEDGE: Maintaining Asepsis Unit, Managing Medications (IP antibiotics, IP heparin, IP Reg. Insulin), Checking Medications, Components of a Syringe, Syringe Markings, Gathering Supplies for IP Injection, Prepare UltraBag or Prepare Home Choice Set Up. (optional: Reconstituting Medications for IP Administration).

HOW WILL I EVALUATE WHETHER LEARNING HAS OCCURRED? Learner will repeat the critical steps for drawing medication for IP injection.

GETTING THE LEARNER READY: “At the end of this lesson you will know the steps for drawing up IP medication. I will show you how to draw up medication. I will first demonstrate the procedure as you will usually do it. Then I will demonstrate the procedure explaining what I am doing at each point. I want you to pay close attention to what I am doing. After you watch me do the procedure several times, I will ask you to tell me the steps in the procedure. When you repeat the steps of the procedure to me without error, I will know you are ready to practice the procedure yourself.”

LEARNER ACTIVITY TEACHER ACTIVITY NOTES

1. Pay Attention. “Memorize” pictures of steps. 1. First Demonstration.

2.Determine “critical” steps/nuances/etc. 2. Second Demonstration—Point out critical steps, nuances, talk through what your hands are doing using the detailed analysis.

3. Repetition. 3. Third Demonstration—Shorten description—use labels from condensed analysis.

4. Repeat labels from memory. 4. Give Feedback. If the learner is unable to repeat the critical steps it may be necessary to perform demonstration #3 again.

MOTOR SKILL—PRACTICE—LESSON PLAN

SUBJECT: Drawing Up Medications for IP Administration

UNIT: SQ/IP Medication Administration

OBJECTIVE: The learner will be able to draw up medication for IP administration following aseptic technique.

MEDIA: Same as for Cognitive Lesson Plan

REQUISITE KNOWLEDGE: Cognitive Lesson Plan for this Motor Skill

HOW WILL I EVALUATE WHETHER LEARNING HAS OCCURRED? The learner will aseptically draw up medication for IP administration.

GETTING THE LEARNER READY: “Now that you are able to repeat the steps of the procedure to me it is time for you to practice. I would like you to practice the procedure until you feel you can do it without thinking. I will give you feedback about how you are doing as you practice. Don't worry about making mistakes, I will correct you as you go along. You may practice as long as you need. When you feel you know the procedure, I will ask you to do the procedure on your own without help from me.”

LEARNER ACTIVITY TEACHER ACTIVITY NOTES

1. Hands on practice. 1. Tell learner to go ahead and practice. 1. Have adequate supplies for multiple practices.

2. Reduce errors to a minimum. 2. Provide immediate, accurate feedback focused on what is correct.

3. Correct errors. 3. Continue feedback.

4. Repeat often enough until steps become smooth and without error. 4. Test for automatic stage.

MOTOR SKILL ANALYSIS—DETAILED

SUBJECT: Drawing Up Medications for IP Administration

Steps to Take Tricks of the Trade

1. Gather supplies for IP medication administration. 1. Previously learned Memory.

2. Prepare the UltraBag or Prepare for Home Choice Set Up. 2. Prepare UltraBag includes masking and handwashing. Prepare for Home Choice Set Up includes masking and handwashing.

3. Tear off a 2-3” strip of tape. Fold the medication stem of the port up. Position vertically. Tape stem to bag.

4. Pick up the medication vial by wrapping forefinger, middle, ring and little fingers of your right hand around the vial . Using the thumb of the same hand, push up on the edge of the plastic cap until it pops off and exposes the top rubber port. 4a. If medication vial top already removed, omit this step. 4b. If beginning this lesson after Reconstituting Medications for IP Administration, omit this step.

5. Pick up the betadine prep pad and completely tear off one corner. Join the two corners adjacent to the tear and fold the outer wrapper in half along the diagonal. Hold the two corners together with the thumb and forefinger of your right hand keeping the third intact corner facing your palm.

6. Hold the torn corner of the betadine prep pad above the medication vial. Slide your right thumb and forefinger down to the fold. Gently milk the betadine prep pad along the fold until a drop of betadine falls onto the top rubber port of the vial. Keep milking the betadine prep pad until enough betadine has been applied to cover the entire surface of the medication vial rubber port. 6. Be sure the betadine covers the entire top of the medication vial.

7. Continue to hold the betadine prep pad in your right hand and move to the UltraBag/Solution Bag. Hold the torn corner of the betadine prep pad above the medication port rubber end. Gently milk the betadine prep pad along the fold until a drop of betadine falls onto the medication port rubber end. Keep milking the betadine prep pad until enough betadine has been applied to cover the entire surface of the rubber end. If additional betadine is needed open a second betadine prep pad as in step 5. 7. May need more betadine prep pads to ensure wetness. Be sure the betadine covers the entire top of the medication port rubber end.

8. Set a timer for 5 minutes.

9. When the timer has finished timing 5 minutes open a sterile 2×2 gauze.

10. Using thumb and forefinger of one hand pick up one comer of the gauze pad.

Using a sterile comer wick the betadine from the medication vial. Using another sterile comer wick the betadine from the UltraBag/Solution Bag medication port rubber end.

Discard the gauze.

11. Remove the outer wrapper from correct size syringe. 11a. Be sure you use a 1″ needle to puncture the bag medication port. 11b. If this lesson taught after Reconstituting Medications for IP Administration, may adapt to syringe use (i.e. using same syringe to reconstitute and draw up medication vs. one syringe to reconstitute medication, and a different syringe to draw up medication).

12. With the thumb and forefinger of your right hand, grasp the barrel of the syringe and pick up. Check to ensure the needle is attached by firmly holding the needle cap with the thumb and forefinger of your left hand and at the same time turn the syringe clockwise with the right hand.

13. Remove the needle cap and place on the working surface.

14. Using the left thumb and forefinger, stabilize the vial of medication. Rotate the syringe in your right hand so you are holding the barrel of the syringe like a pencil. Insert the needle downward into the rubber port of the vial. Remove your left hand from the vial. Rotate it so the palm faces up. Grasp the vial between the left thumb and forefinger and hold firmly. Pick up the vial and syringe as a unit and invert it. If necessary use your right hand and adjust the syringe to make sure the needle tip is below the level of medication in the vial.

15. Wrap little finger and ring finger of left hand around barrel of syringe. Stabilize the syringe against the palm below thumb. Move right hand thumb and first two fingers to end of the plunger. Pull the plunger back to draw up the prescribed dose of medication.

16. Tap the barrel of the syringe with the right forefinger to force any air in the syringe to rise toward the hub. 16. Be sure all air has been removed from the syringe.

17. With thumb and first two fingers of right hand on end of plunger, push any air into the vial by pushing up gently on the plunger.

18. If necessary, repeat steps 15-17 to ensure prescribed dose of medication has been drawn into syringe.

19. Holding syringe barrel between right thumb and forefinger; release left little and ring finger from syringe. Continue to hold medication vial with left thumb and first two fingers. Remove needle from vial by pulling the barrel of the syringe straight out of the vial opening. Place the vial on the work surface.

20. Immediate administration of medication is preferred, however, if recapping the needle is necessary, slide the needle into the opening of the cap until the needle cap is nearly on the needle. 20a. Recapping with one hand technique reduces chances of contamination of the needle and accidental puncture wounds. 20b. It is preferred that when medications are drawn up, they are immediately administered.

21. Bring the syringe and needle to a vertical position using the right hand.

22. Secure the cap on the needle by pushing down firmly with the left hand until you hear a click. 22. Cap is on securely when the cap clicks in place.

MOTOR SKILL ANALYSIS—CONDENSED

SUBJECT: Drawing Up Medications for IP Administration

Brief Description of Logically Grouped Steps Label

1. Prepare the UltraBag/Solution Bag. 1. Prepare bag.

2. Check medication. 2. Check.

3. 5 minute betadine soak. 3. Apply betadine and wait.

4. Wick off betadine using sterile 2×2. 4. Wick betadine.

5. Draw up medication into syringe. 5. Draw up medication.

MEMORY LEARNING LESSON PLAN

SUBJECT: Reconstituting medications for IP administration.

UNIT: SQ/IP Medication Administration

OBJECTIVE: Learner will be able to gather the supplies needed to reconstitute a medication for IP administration.

MEDIA: Laminated card with supplies listed. Medication vial, 10 cc vial of sterile water/normal saline, 10 cc syringe with 1” needle, mask, sharps container, 2×2 gauze, betadine prep pad

REQUISTE KNOWLEDGE: Maintaining Asepsis, Checking medications, Components of a syringe, Syringe markings.

HOW WILL I EVALUATE WHETHER LEARNING HAS OCCURRED? Learner will gather the correct supplies needed to reconstitute a medication for IP administration.

GETTING THE LEARNER READY: “Now you are going to memorize a list of supplies that you will need to reconstitute a powdered medication. I'll show you the supplies needed, tell you what they are. Look carefully at the supplies and repeat the list. When you feel you know the supplies you need, I'll ask you to get them from the supply cabinet.”

LEARNER ACTIVITIES TEACHER ACTIVITIES NOTES

1. Repeat information several times 1. Present the information to be memorized. Tell the learner to ask questions or “say after me”

2. May form own associations or use own memory trick. 2. Present information. May ask patient questions to form own associations.

3. List supplies from memory. 3. Ask the learner to list the supplies

4. Practice/Test 4. Question and provide feedback

MEMORY LEARNING ANALYSIS

SUBJECT: Reconstituting medications for IP administration.

List of Information to be Memorized Mnemonic(s) or Other Helpful Memory Aids or Memorization Strategies

1. Medication vial

2. 10 cc vial of Sterile water or Normal Saline.

3. 10 cc syringe

4. 2×2 gauze

5. Mask

6. Sharps container

7. Betadine prep pad

MOTOR SKILL—COGNITIVE—LESSON PLAN

SUBJECT: Reconstituting Medications for IP Administration

UNIT: SQ/IP Medication Administration

OBJECTIVE: Learner will be able to reconstitute a medication for IP administration.

MEDIA: Medication Vial, 2 10 cc vials of sterile water, 10 cc syringe with a 1” needle, betadine prep pad, sterile 2×2 gauze, mask, bleach solution, paper towel, sharps container, timer, baking soda, 1” tape.

REQUISTE KNOWLEDGE: Maintaining Asepsis, Managing Medications (IP Antibiotics) Checking Medications, Components of a Syringe, Syringe Markings, Gathering Supplies for Reconstituting IP Medications.

HOW WILL I EVALUATE WHETHER LEARNING HAS OCCURRED? Learner will reconstitute a medication for IP administration.

GETTING THE LEARNER READY: “At the end of this lesson you will know the steps for reconstituting a medication for IP use. I will show you how to do it. I will first demonstrate the procedure as you would usually do it. Then I will demonstrate the procedure explaining what I am doing at each point. I want you to pay close attention to what I am doing. After you watch me do the procedure several times, I will ask you to tell me the steps. When you can repeat the steps of the procedure to me without error, I will know you are ready to practice the procedure yourself.”

LEARNER ACTIVITIES TEACHER ACTIVITIES NOTES

1. Pay attention. “Memorize” pictures of steps. 1. First Demonstration. For demonstration and practice purposes using scissors remove the metal ring from a sterile water vial and replace the liquid with baking soda, then tape the rubber stopper in place. This will then serve as a “demo” medication vial.

2. Determine “critical” steps. 2. Second Demonstration—Point out critical steps, talk through what your hands are doing using the detailed analysis.

3. Repetition. 3. Third Demonstration—Shorten description—use labels from condensed analysis.

4. Repeat labels from memory. 4. Give feedback. If learner is unable to repeat steps, perform demonstration #3 again.

MOTOR SKILL—PRACTICE-LESSON PLAN

SUBJECT: Reconstituting Medications for IP Administration

UNIT: SQ/IP Medication Administration

OBJECITVE: Learner will be able to reconstitute a medication for IP administration.

MEDIA: Same as Cognitive Lesson Plan

REQUISTE KNOWLEDGE: Cognitive Lesson Plan for this Motor Skill

HOW WILL I EVALUATE WHETHER LEARNING HAS OCCURRED? Learner will reconstitute a medication for IP administration.

GETTING THE LEARNER READY: “Now that you are able to repeat the steps of the procedure to me it is time for you to practice. I would like you to practice the procedure until you feel you can do it without thinking. Don't worry if you make a mistake I will help you as you go along. You may practice as long as you need. When you feel you know the procedure, I will ask you to do it on your own without any help from me.”

LEARNER ACTIVITIES TEACHER ACTIVITIES NOTES

1. Hands on practice. 1. Tell the learner to go ahead and practice. 1. Have adequate supplies for multiple practices. For demonstration and practice purposes using scissors remove the metal ring from a sterile water vial and replace the liquid with baking soda, then tape the rubber stopper in place. This will then serve as a “demo” medication vial.

2. Reduce errors to a minimum. 2. Provide immediate, accurate feedback focused on what is correct.

3. Correct errors. 3. Continue feedback

4. Repeat often enough until steps become smooth without error.

MOTOR SKILL ANALYSIS—DETAILED

SUBJECT: Reconstituting medications for IP administration.

Steps to Take Tricks of the Trade

1. Clean the work surface. 1. Previously learned.

2. Wash hands. 2. Life lesson

3. Gather supplies. 3. Previously learned

4. Mask and wash hands. 4. Previously learned

5. Pick up the medication vial by wrapping forefinger, middle, ring and little fingers of your right hand around the vial. Using the thumb of the same hand push up on the edge of the plastic cap until it pops off and exposes the top rubber port. Place the vial upright on the clean working surface. 5. May allow learner to use one hand to grip the vial while pushing the plastic cap off with the thumb of the opposite hand.

6. Repeat step # 5 using the vial of sterile water. 6.

7. Pick up the betadine prep pad and completely tear off one corner. Join the two corners adjacent to the tear and fold the outer wrapper in half along the diagonal. Hold the two corners together with the thumb and forefinger of your right hand keeping the third intact corner facing your palm. 7.

8. Hold the tom corner of the betadine prep above the medication vial. Slide your right thumb and forefinger down to the fold. Gently milk the betadine prep along the fold until a drop of betadine falls onto the top rubber port of the vial. Keep milking the prep until enough betadine has been applied to cover the entire surface of the rubber port.

8. Be sure the betadine covers the entire rubber port of the medication vial.

9. Continue to hold the betadine prep in your right hand and move to the sterile water vial. Hold the tom corner of the betadine prep above the sterile water vial. Gently milk the betadine prep along the fold until a drop of betadine falls onto the top rubber port of the vial. Keep milking the prep until enough betadine has been applied to cover the entire surface of the rubber port. If additional betadine is needed open a second prep pad as in step # 7. 9. Be sure the betadine covers the entire rubber port of the sterile water vial. If additional betadine is needed open a second prep pad as in step # 7.

10. Set atimer for 5 minutes. 10.

11. When the timer has finished timing 5 minutes open a sterile 2×2 gauze. 11.

12. Using thumb and forefinger of one hand pick up one corner of the gauze pad. Using a sterile corner wick the betadine from the medication vial. Using another sterile corner wick the betadine from the sterile water vial. Discard the gauze. 12.

13. Remove the outer wrapper from the 10 cc syringe. 13. Previously learned.

14. With the thumb and forefinger of your right hand grasp the barrel of the syringe and pick up. Check to ensure the needle is attached by firmly holding the needle cap with the thumb and forefinger of your left hand and at the same time turn the syringe clockwise with the right hand. 14.

15. Remove the needle cap and place on the working surface. 15.

16. Using the left thumb and forefinger, stabilize the vial of sterile water. Rotate the syringe in your right hand so you are holding the barrel of the syringe like a pencil. Insert the needle downward into the rubber port of the vial. Remove your left hand from the vial. Rotate it so the palm faces up. Grasp the vial between the left thumb and forefinger and hold firmly. Pick up the vial and syringe as a unit and invert it. If necessary use your right hand and adjust the syringe to make sure the needle tip is below the level of water in the vial. 16.

17. Wrap little finger and ring finger of left hand around barrel of syringe. Stabilize the syringe against the palm below thumb. Move right hand thumb and first two fingers to end of the plunger. Pull the plunger back to draw up 10 cc of sterile water. Adjust syringe if necessary to make sure the needle tip is below the level of water in the vial. 17.

18. Tap the barrel of the syringe with the right forefinger to force any air in the syringe to rise toward the hub. Gently allow the plunger to pull any air back up into the water vial. With thumb and first two fingers of right hand on end of plunger, push any air into the vial by pushing up gently on the plunger. 18a. The vacuum will pull air/water back into the vial.18b. It may be necessary to manually push air back into vial.

19. Repeat steps 16-18 until the syringe is cleared of air and contains 10 ml of water. 19.

20. Holding syringe barrel between right thumb and forefinger; release left little and ring finger from syringe. Continue to hold vial with left thumb and first two fingers. Remove needle from vial by pulling the barrel of the syringe straight out of the vial opening. Place the vial on the work surface. 20.

21. Using your left thumb and forefinger stabilize the medication vial. Rotate the syringe in your right hand so you are holding the barrel of the syringe like a pencil. Insert the needle downward into the rubber port of the vial. 21.

22. Push the plunger down until it moves no further and inject all of the water into the medication vial. 22.

23. Remove the needle from the medication vial and dispose in the sharps container. 23. If using same syringe to draw up reconstituted medication, may leave needle in vial while doing step 24 and proceed to drawing up med after mixing; or to recap needle: slide the needle into the opening of the cap until the needle cap is nearly on the needle. Bring the syringe and needle to a vertical position using the right hand. Secure the cap on the needle by pushing down firmly with the left hand until you hear a click.

24. Gently invert the medication vial and mix until all the powder is dissolved. 24.

MOTOR SKILL ANALYSIS—CONDENSED

SUBJECT: Reconstituting Medications for IP Administration.

Brief Description of Logically Grouped Steps Label

1. Clean working surface. Wash hands and gather supplies. 1. Get ready.

2. Mask and wash hands. 2. Mask and wash hands.

3. Place betadine on the rubber ports of the medication and water vials. 3. Prep ports.

4. Wait 5 minutes. 4. Wait 5 minutes.

5. Remove the betadine. 5. Remove the betadine

6. Draw up the water. 6. Draw up the water.

7. Inject into the medication vial. 7. Inject into the medication vial.

8. Mix to dissolve. 8. Dissolve.

MOTOR SKILL—COGNITIVE-LESSON PLAN

SUBJECT: Adding IP Medication to the Solution Bag

UNIT: SQ/IP Medication Administration

OBJECTIVE: The learner will be able to repeat the critical steps required for intraperitoneal medication administration.

MEDIA: Mask, medication pre-drawn into a syringe, tape, solution bag, sharps container, CAPD/CCPD flow sheet.

REQUISITE KNOWLEDGE: Maintaining Asepsis Unit, Managing Medications (IP antibiotics, IP heparin, IP Reg. Insulin), Checking Medications, Components of a Syringe, Syringe Markings, Prepare UltraBag, Gathering Supplies for Adding IP Medication, Drawing up IP Medication (optional: Reconstituting Medications for IP Administration).

HOW WILL I EVALUATE WHETHER LEARNING HAS OCCURRED? Learner will repeat the critical steps for intraperitoneal medication administration.

GETTING THE LEARNER READY: “At the end of this lesson you will know the steps for adding medication to the solution bag. I will show you how to add the medication. I will first demonstrate the procedure as you would usually do it. Then I will demonstrate the procedure, explaining what I am doing at each point of the procedure. I want you to pay close attention to what I am doing. After you watch me do the procedure several times, I will ask you to tell me the steps in the procedure. When you can repeat the steps of the procedure to me without error, I will know that you are ready to practice the procedure yourself.”

LEARNER ACTIVITY TEACHER ACTIVITY NOTES

1. Pay attention. “Memorize” pictures of steps. 1. First Demonstration. 1. May use ‘practice’ UltraBags from the UltraBag Unit.

2. Determine “critical” steps. 2. Second Demonstration—Point out critical steps, talk through what your hands are doing using detailed analysis.

3. Repetition. 3. Third Demonstration—Shorten description—use labels from condensed analysis.

4. Repeat labels from memory. 4. Give feedback. If learner unable to repeat steps, perform demonstration #3 again.

MOTOR SKILL—PRACTICE-LESSON PLAN

SUBJECT: Adding IP Medication to the Solution Bag

UNIT: SQ/IP Medication Administration

OBJECTIVE: The learner will be able to safely administer intraperitoneal medication into the solution bag.

MEDIA: Same as Cognitive Lesson Plan.

REQUISITE KNOWLEDGE: Motor Skill—Cognitive Lesson Plan.

HOW WILL I EVALUATE WHETHER LEARNING HAS OCCURRED? Learner will be able to safely inject IP medications into the solution bag.

GETTING THE LEARNER READY: “Now that you are able to repeat the steps of the procedure to me it is time for you to practice. I would like you to practice the procedure until you feel you can do it without thinking. I will give you feedback about how you are doing as you practice. Don't worry about making mistakes, I will correct you as you go along. You may practice as long as you need. When you feel you know the procedure, I will ask you to do it on your own without any help from me.”

LEARNER ACTIVITY TEACHER ACTIVITY NOTES

1. Hands on practice. 1. Tell the learner to go ahead and practice. 1. Have adequate supplies for multiple practices. Again, may use old ‘practice’ bags from UltraBag Unit.

2. Reduce errors to a minimum. 2. Provide immediate, accurate feedback focused on what is correct.

3. Correct errors. 3. Continue feedback.

4. Repeat often enough for steps to become smooth and without error. 4. Test for automatic stage.

MOTOR SKILL ANALYSIS—DETAILED

SUBJECT: Adding IP Medication to the Solution Bag

Steps to Take Tricks of the Trade

1. Draw up medication for IP administration.1a. If needle recapped, pick up the syringe with the right hand by using your thumb on one side and grasp your fingers around the barrel of the syringe. Hold the syringe in a horizontal position, needle pointing up. To remove the protective needle cap, pull the needle cap off, away from the syringe. Set the needle cover aside. 1. Previously learned motor skill. If left uncapped, syringe is in right hand at this point.

2. Remove tape from medication port stem. Hold the medication port on the solution bag between the thumb and the first two fingers of the left hand, thumb on bottom, fingers on top.

3. Rotate the syringe in your right hand so you are holding the barrel of the syringe like a pencil. Gently guide the tip of needle through bulls eye circle of the medication port. The syringe should be in the same plane as the medication port.

4. Push the needle into the bag up to the hub.4. Keep the needle in a straight line.

5. If resistance is met, pull back the needle ⅛ inch, then re-advance slowly into the medication port, keeping the needle in a straight line inside the medication port.

6. Stabilizing the barrel of the syringe with the first two fingers, move the thumb to the plunger end, and inject the medication by pushing the plunger until it stops.

7. Carefully remove the needle from the medication port by pulling it straight out.

8. Discard the needle in the sharps container.

9. Grasp each end of the solution bag and raise and lower each end five times to well mix the medication in the solution.

10. Squeeze the medication port to mix any medication remaining at the site. Also check for any leakage of fluid. 10. If adding medication to solution bag before immediate exchange, label the solution bag with the name of medication on tape, attach to bag.

11. Document the added medication onto the CAPD/CCPD flow sheet. 11. Previously learned Motor Skill.

MOTOR SKILL ANALYSIS—CONDENSED

SUBJECT: Adding IP Medication to the Solution Bag

Brief Description of Logically Grouped Steps Label

1. Hold medication port, insert needle into bulls eye. 1. Insert needle.

2. Inject medication. 2. Inject.

3. Remove needle from medication port and discard into a sharps container. 3. Remove and discard needle.

4. Mix medication in solution bag by raising and lowering the ends, squeeze medication port. 4. Mix medication.

5. Document onto CAPD/CCPD flow sheets. 5. Document.

Another module in the PD Training program is “Managing Diet”. In this module the trainer is assisted by the dietician who together present the necessary material to the patient/learner. The lessons on “Hyperlipidemia” and Caloric Needs” are optional depending on the patient/learner's condition. The lessons on sugars and sodium, will need to be taught as requisite knowledge for the “Hyperosmolarity” lesson in the “Fluid Balance Unit.”

The lessons in this module are taught in a fashion similar to previous lessons with the trainer presenting the material and concepts, then providing examples and non-examples for review, comparison and having the learner hone perceptions and skills until the material is mastered. Then a definition of the concept presented is reviewed (if presented earlier) or presented and the patient/learner encouraged to provide his/her own definitions, making sure all critical points are covered.

Specialized media used include the set of “Food Cards” made by the Dairy Council of Wisconsin. Each food group is represented, and pictures of specific food items are on each card. On the back of the cards are the nutritional facts. These cards are used both in the lessons and when selecting foods for dietary requirements. The “Good Healthy Choices for PD” booklet helps learners choose from a list foods for each meal. Mock “Lab Report Cards” and menus from widely available restaurants have also been prepared for this unit. For the last lesson plan “Putting it all Together”, menus from area restaurants may also be used.

Following is a suggested outline based on knowledge necessary to make preferred dietary choices. Each sub-section will be discussed in turn:

Protein

Protein, High Quality/Low Quality—C

Protein Loss—M

Protein Needs—P, J/D

Sodium—C

Sugars—C

Fats—C

Calories—C

Caloric Needs—P, J/D

Hyperlipidemia—P, J/D

Calcium—M

PTH

Phosphorus—C

—Phosphorous—M

Bone Disease—C

Healthy Bones—P, J/D

Potassium—M

Effects of Potassium on the Body—M

Putting it All Together—PS

The first subsection in the Dietary module is “Protein” in which the patient learns to name the functions of protein in the body and how it is measured. Concepts to be mastered include the facts that protein builds body tissues such as muscle; maintains fluid in the appropriate spaces, helps to prevent edema.; helps to fight infections; helps to heal body tissues, such as healing wounds; protein is measured by albumin levels. Note, the trainer may here describe any other methods used such as nPNA, nPCR.

The second sub-section in the “Managing Diet” module teaches the learner will be able to differentiate between high quality protein and low quality protein. Different proteins are presented such as animal proteins (beef, chicken, other fowl, pork, eggs, dairy products) and protein supplements. As in previous lessons, the trainer presents examples/non-examples and requests the patient/learner to identify what kind of protein is represented. Suggested example/non-examples and scenarios are: pictures of scrambled egg/bowl of cereal; picture of steak/mashed potatoes; picture of fish/slice of bread; picture of pork chop/green salad; picture of chicken breast/green beans; picture of glass of milk/peanut butter sandwich; picture of wedge of cheese/multiple beans; picture of hamburger patty/baked beans; boiled egg/pita bread; picture of carton of egg substitute (Teacher must provide actual carton); Carnation instant breakfast (Teacher must provide actual carton); can of protein powder—grouping of Promod, Ensure, Sustacal (Teacher must provide actual items); jar of peanut butter; refried beans; shrimp; can of tuna; jar of nuts; macaroni and cheese; cottage cheese; pudding/gelatin; and/or tofu.

The trainer then proceeds to the next sub-section “Protein Loss” in which the objective is to have the patient/learner be able to recognize and state the conditions when protein loss may occur (note, the trainer should only present those methods of protein loss as they apply to the individual patient). The concepts to be presented and learned are:

Protein diffuses across the peritoneal membrane and is lost in the drained effluent;

the transport category, amount of dialysis, and volume of drained effluent may effect rate of loss;

During an episode of peritonitis the peritoneal membrane becomes more permeable to protein, therefore increased protein loss occurs;

Nephrotic syndrome can cause increased loss of protein in urine; and

Other significant infectious processes.

Sub-section “Protein Needs” is presented with the patient/learner first learning the relationship between protein needs and protein intake, and then to identify the relationship between protein needs and protein intake. Media may include a card with the principles on it or any other illustrative material as needed. The patient/learner will be deemed to have learned the concepts when he/she can correctly repeat the following:

1. If you are on peritoneal dialysis, then you will lose protein with drained effluent.

2. If you have an episode of peritonitis, then protein loss will increase.

3. If you eat sufficient high quality protein ______ then you will maintain protein status.

4. If protein losses increase and dietary intake increases, then protein needs may be met.

5. If protein losses increase and dietary intake does not increase, then protein needs may not be met.

6. If protein needs are not met, then susceptibility to infection is increased.

7. If protein needs are not met, then wounds may not heal.

8. If protein needs are not met, then edema may occur.

9. If protein needs are not met, then the body will break down its own tissue to meet protein needs.

The lesson then proceeds to teaching the patient/learner how to identify inadequate protein intake, recognize conditions that may require intervention and state the action to take. Examples of illustrative scenarios and solutions and examples/non-example pairs are presented which may include:

1. “You are on peritoneal dialysis.” You will need to increase your protein intake.

Your dietitian will help you determine how much to eat.

2. “Your Nutritional Report Card shows an albumin level of 3.0.(too low).”

Increase your protein intake by eating more high quality protein.

Consider small frequent high protein snacks.

our dietitian may recommend a supplement.

3. “Meat is expensive and you are on a tight budget.”

Consider lower cost sources of protein (eggs, chicken).

Contact your dietitian for help with less expensive sources of protein or other means of assistance.

4. “You have a episode of peritonitis.”

You will need to increase your protein intake.

Your dietitian can help you.

You may need a supplement.

5. “You have been on a lower protein diet (hemodialysis, pre ESRD).”

You will need to increase your protein intake now that you are on peritoneal dialysis.

6. “Your Nutritional Report Card shows an albumin of 4.1 (desired range)”.

Pat yourself on the back.

Continue the good work.

7. “Food does not taste good, and you don't want to eat meat.” 1.

Contact your dietitian, who may recommend a supplement or protein powder.

8. “Your religion calls for a vegetarian diet.”

Contact your dietitian to suggest alternative sources of protein.

1. “You have an infection of ______.

(Choose a situation applicable to this learner).

Contact your physician.

You will need more protein in your diet.

Contact your dietitian if you need help.

2. Breakfast of 2 poached eggs, English muffin, grapefruit juice.

Lunch of chicken salad on white bread, apple, and small glass of milk.

Dinner of shrimp cocktail, broiled fish, rice pilaf, green beans, sugar-free jello.

Pat yourself on the back.

Continue eating adequate amounts of protein.

11. Breakfast of cereal bar, juice, and coffee.

Lunch of bean burrito and a coke.

Dinner of chicken noodle soup, crackers, and a piece of pie.

Increase the protein in your diet.2.

Consult dietitian for suggested changes.

A further sub-section in the “Managing Diet” module is “Sodium” in which the patient is taught to recognize foods high in sodium. The trainer starts with the identification of two categories of food, processed or convenience foods, and foods cooked or prepared with table salt added. Suggested verbal descriptions, pictures, video clips, and/or scenarios of example/non-example pairs are:

1. Cup of chicken bouillon/cup of tea. (Teacher must provide actual packages).

2. Canned green beans/fresh green beans. (Verbal).

3. Bologna/chicken breast.

4. Egg/bacon.

5. Salt added to any food. (Teacher must provide actual packet).

6. Glass of tomato juice/glass of apple juice.

7. Potato chips/baked potato.

8. Three cheese pizza and a cola/plate with chicken breast, baked potato, and salad.

9. Can of regular soup/Can of low-sodium soup/Bowl of home made soup. (Teacher must provide actual cans of regular and low-sodium; homemade soup on flashcard)

10. Sausages/pork chop.

11. Ham/turkey.

12. Seasoned salt—show grouping of brands such as MSG, Accent, Natures Seasoning, Lawry's Seasoned Salt. (Teacher must provide actual packages).

13. Salt/bottles of dried herbs. (Teacher must provide actual containers).

14. Pretzels.

15. Grouping of relish, ketchup, mustard.

16. Fruit cocktail.

The goal of another sub-section of the “Managing Diet” module is learning to identify foods with high sugar content. The trainer presents a definition of different sugars (including fructose, glucose, dextrose, corn and other syrups, and other sweeteners; i.e., honey) and proceeds (as in previous modules) with presenting examples/non-examples of foods high in sugar, working with the patient/learner until he/she can correctly identify high and low sugar foods. After the presentation the trainer helps the patient/learner make a definition of sugar. Some illustrative examples in different media may include:

1. Glass of fruit punch/glass of unsweetened apple juice.

2. Can of cola soda/can of clear, diet soda (Teacher must provide the actual cans of soda).

3. Candy bar/graham cracker.

4. Jelly.

5. Sugar packet/packet of artificial sweetener.

6. Hard candy /small bunch of grapes.

7. Plain waffle/pastry.

8. Maple syrup.

9. Apple/slice of bread.

10. Fresh pear/fruit cocktail.

11. Strawberries/raisins.

12. Peaches, fresh/in light syrup.

13. Saltines.

14. 4.25% bag of PD solution, 1.5% bag of PD solution, 2.5% bag of PD solution.

15. Cookies/potato chips.

16. Honey.

Another important dietary component which PD patients must learn to manage is “Fats”. This module focuses on identifying fats (oils, margarine, butter, shortening and foods that contain significant amounts of these; nuts and nut butters; fatty meats; whole milk and milk products; and many convenience foods.) and foods with a high fat content. Presentation to the patient/learner proceeds as with previous lessons. Examples/non-examples may include:

1. French fries/plain baked potato.

2. Sausage/turkey breast.

3. Jar of mayonnaise/jar of mustard, ketchup, pickle relish.

4. Dish of nuts/bowl of pretzels.

5. Bacon/can of tuna.

6. Pork chop/chicken breast.

7. Carton of whole milk/carton of skim milk.

8. Butter/margarine.

9. Three cheese pizza/plate of spaghetti with tomato sauce and meatballs.

10. Hot dog/tuna sandwich.

11. Grilled fish fillet/fish sticks.

12. Ice cream/Popsicle.

13. Egg, cheese, and sausage biscuit.

14. Cream cheese.

15. Fried egg roll.

16. Macaroni and cheese.

17. Piece of yellow cake/granola bar.

Yet another sub-section of the “Managing Diet” module is “Calories” in which the patient/learner is taught the concept of “calories”, and how to recognize the caloric values of foods(especially high and low calorie foods) to appropriately manage their diet. Definitions are provided and example/non-example pairs are presented. At the end of the presentation the patient is asked to formulate a definition of high and low calorie foods and should be able to differentiate those foods which are high or low in calories. The patient's definition of high calorie foods should include Foods containing high sugar and/or fat content and PD solution (all dextrose concentrations). Example/non-examples from the “Fat” and “Sugar” sub-sections may be used here.

In the “Caloric Needs” subsection of the “Managing Diet” unit (presented after the patient has mastered the “Calories”, “Sugars”, “Fats” and “Protein” sub-sections) the patient/learner is taught to be able to identify the relationship between the caloric content of food and undesired weight changes. The following are important concepts for the patient/learner to learn in this module:

If you take in more calories than your body needs, then weight gain occurs.

If you take in less calories than your body needs, then weight loss occurs.

If you eat foods that contain large amounts of fat or sugar and/or use high-dextrose PD solutions, then undesired weight gain may result.

If your activity level increases over your normal level, then caloric needs may increase.

If you eat foods that meet your caloric needs, then you may avoid undesirable weight changes.

If you maintain your body weight within the desired range, then you may have fewer problems controlling blood pressure, blood glucose and blood lipid values.

Suggested scenarios, examples/non-examples and illustrative material to teach this unit may include:

“You eat 500 calories per day over your needs.”

“You eat 500 calories less per day than your needs.”

“You eat the same amount of food, but use all 4.25% Dextrose for your exchanges.”

“You eat mostly fried and fast foods.”

“You usually go to a fast food restaurant for lunch, but now you are bringing your lunch from home.”

“You have begun to take a vigorous walk with your new dog each evening.”

“You have been following the dietary recommendations and your blood sugar is down 10 points.”

“You have been eating fast food for lunch each day and you have gained body weight on your last clinic visit and your blood cholesterol is 300.”

“Your weight is now within the desired range and your blood pressure has dropped 5 points.”

Another sub-section in the “Managing Diet” module is “Hyperlipidemia”. The object of this unit is to enable the learner to be able to identify the relationship between sugar and fat intake and hyperlipidemia. Illustrative materials may include a card with principles listed, examples and non-examples in analysis. Important principles in this sub-section are

If you eat excessive sugars, then your triglyceride may exceed healthy levels.

If you eat excessive fats, then your cholesterol may exceed healthy levels.

If triglyceride and cholesterol exceed healthy levels, then you may be at increased risk for heart disease and stroke.

Prior to presenting this section, the dietician should have determined the patient/learner's desired fat and sugar intake. A suggested list of materials to use in presenting this section may include:

Lab report card with elevated cholesterol.

Lab report card with cholesterol in recommended range.

Lab report with elevated triglycerides.

Lab report with triglycerides in recommended range.

Examples of meals using food cards:

Turkey breast, pasta, broccoli, and fruit cocktail.

Ham, mashed potatoes with gravy, green beans, corn bread, cherry pie.

Hot dog, French fries, soda, cookies.

Tuna, green salad, fresh berries, apple juice.

Oatmeal, strawberries, wheat toast.

Scrambled eggs, bacon, biscuits.

Salad with bacon, cheddar cheese and regular dressing.

Salad with cottage cheese and fat free dressing.

Broccoli cheese potato.

Baked potato plain.

Breakfast sandwich with sausage, egg and cheese.

Hard boiled egg, bagel and fat free cream cheese.

Cold cereal with fresh fruit and skim milk, English muffin.

Blueberry muffin, cold cereal with teaspoon of sugar and whole milk.

Granola bar.

Candy bar.

Potato chips.

Air-popped popcorn.

After presenting the concepts of how sugar and fat intake may cause hyperlipidemia, the trainer teaches the patient/learner what to do if he/she has a problem or suspects he/she might have a problem with fats and sugars in the diet and suggests some actions to take. The following examples and scenarios and suggested actions may be used to teach the patient how to manage conditions related to hyperlipidemia.

Lab report card with elevated cholesterol

Decrease fat intake; Consult dietitian.

Lab report card with cholesterol in recommended range

Pat yourself on the back; Continue good healthy eating

Lab report with elevated triglycerides

Decrease intake of sugar; consult dietitian.

Lab report with triglycerides in recommended range

Pat yourself on the back; continue good healthy eating

Menus:

Breakfast of scrambled eggs, bacon, biscuits; lunch of hot dog, French fries, soda, cookies dinner of Ham, mashed potatoes with gravy, green beans, corn bread, cherry pie

Action: Consider decreasing fat intake; consult dietitian for suggested changes.

Breakfast of oatmeal, strawberries, wheat toast. Lunch of tuna, green salad, fresh berries, apple juice. Dinner of turkey breast, pasta, broccoli, and fruit cocktail.

Action: Pat yourself on the back; continue good healthy eating.

Breakfast of Danish pastry, hot cocoa with marshmallows, sugar-sweetened cereal. Lunch of peanut butter and jelly sandwich, cookies, a rice krispies treat, and a Coke. Dinner of ham, candied yams, Ambrosia salad (mandarin oranges, pineapple, marshmallows, coconut, and cool whip), and frosted chocolate cake. Action: Consider decreasing sugar intake; consult dietitian for suggested changes.

A further sub-section in the “Managing Diet” module is “Phosphorus Content of Foods” in which the patient/learner will learn to differentiate between foods that are higher and lower in phosphorus. The trainer will tell the patient the types of food that generally have a high phosphorus content, then use illustrative media of specific foods to reinforce the material presented by having the patient/learner identify the phosphorus content of the foods until the patient/learner can correctly identify high and low phosphorus content foods. The patient/learner should have presented a list of foods they usually eat, and these will be reviewed for phosphorus content. When the examples have been reviewed, the patient/learner should know these critical characteristics and categories of foods high in phosphorus, including protein foods, especially dairy products, nuts and seeds, beans and legumes, cola sodas, and whole grains. Examples/non-examples and illustrative materials may include

Can of white soda/can of cola soda (Teacher must provide actual soda cans).

Chicken.

Milk/packets of non-dairy creamer (Teacher must provide non-dairy creamer).

Block of cheddar cheese/cream cheese.

Can of kidney beans/fresh green beans.

Can of tuna. (picture of tuna sandwich)

Tortilla/biscuits.

Oatmeal/grits.

Yogurt/gelatin.

Can of Cream of mushroom soup/can of chicken noodle soup (Teacher must provide actual soup cans).

Can of Root Beer soda (Teacher must provide actual soda can).

Glass of milk.

Ice cream.

Carton of yogurt.

White bread.

Fruit Cocktail.

Shrimp.

Salad.

Cookies.

The “Parathyroid Hormone—PTH” sub-section continues the “Managing Diet” module. When mastered the patient/earner will be able to repeat the critical functions of PTH in the body. The trainer may discuss the functions of the parathyroid hormone (PTH), give the patient/learner a card listing these functions and work with the learner until they are memorized. Topics to be covered may include:

Parathyroid hormone—PTH—is secreted by four parathyroid glands located in your neck.

PTH helps regulate serum calcium by stimulating healthy kidneys to conserve calcium.

regulating the absorption of calcium from the gut acting on the bone to release calcium from the bones.

PTH helps regulate serum PO4 by regulating excretion in the kidney.

High levels of PO4 can lead to high levels of PTH.

Patients with kidney disease do not respond properly to elevated levels of PTH

High levels of PTH can lead to severe bone disease resulting in fractures and chronic pain syndromes.

Yet another sub-section in the “Managing Diet” module is “Bone Disease” in which the 1patient/earner become able to define bone disease and state effects of bone disease on the body. Before presenting this section, the “Normal Function,” “Uremia,” “Calcium,” and Phosphorus” units should have been learned and the patient should be able to list the critical characteristics of the definition of bone disease which include a loss of bone structure and an imbalance of calcium, phosphorus and PTH. Signs and symptoms of bone disease may include bone pain; bone fractures; pruritis; psudogout (with joint swelling); inflammation and pain; metastatic calcifications in the skin cornea, and/or digits; and muscle weakness with osteomalacia.

Some suggested example/non-examples in the format of verbal descriptions, suggested pictures/video-clips, scenarios may include:

Healthy bone structure/unhealthy bone structure (Use Abbott's “A Taste For Life” bone demonstrator.)

Picture of normal hand/picture of hand with calciphylaxis (Use Genzyme's “In Balance” educational materials.)

Verbal description of person without any fractures/person with fractured bone.

Picture of person itching arm. (UP 19)Picture of person smiling(UP 12)

Verbal description of normal joints/swelling in a joint.

Following the “Bone Disease” sub-section the trainer moves on to “Healthy Bones” from which, when mastered, the learner will be able to identify the relationship between bone disease, calcium, phosphorus, PTH, binders, and Vitamin D analogs. To be covered in this section are the following principles:

Calcium and phosphorus must be in balance to prevent bone disease.

When kidneys fail they no longer get rid of excess phosphorus, therefore the blood phosphorus level rises.

When kidneys fail they no longer convert Vitamin D to the active form, therefore absorption of calcium from the gut decreases and blood calcium levels fall.

If calcium levels fall, then PTH is secreted.

If phosphorus levels rise, then PTH is secreted.

If PTH is secreted, then calcium is pulled out of the bones to increase blood levels.

If calcium is pulled out of the bones, then the bones weaken.

If the bones weaken, then you will have signs and symptoms of bone disease.

If the bones weaken, then you will not produce enough red blood cells.

If binders, Vitamin D analogs, and calcium supplements are taken as prescribed and dietary phosphorus intake is as prescribed, then blood levels of calcium and phosphorus will be under better control and bone disease may be less severe.

Some suggested scenarios to present in teaching this module may include:

Description of person taking binders with a cup of coffee.

Description of person eating a steak and baked beans and drinking milk for dinner.

Lab report card with elevated phosphorus, decreased calcium, and elevated PTH.

Description of person who forgets to take binders with lunch but takes them in the middle of the afternoon.

Description of person who reports to the nurse that they did not have the prescription for vitamin D analogs filled because they discovered that insurance would not cover the medication and they could not afford to pay for it.

Description of person who has indigestion frequently and drinks milk to help relieve it.

Description of person itching.

Description of person with hip pain.

Description of person with hard deposits under their skin.

Description of person taking binders and vitamin D analogs as prescribed.

Description of person taking binders while eating breakfast.

Description of person eating food pattern as recommended by the dietitian.

When the patient/learner understands the concept of bone disease, the trainer continues by presenting material on how to keep bones healthy using illustrative examples/non-examples and scenarios and describing some actions that can be taken in certain situations.

Person takes binders while eating breakfast.

Pat yourself on the back; continue to take binders with meals.

Person takes binders with a cup of coffee

Take binders with food; consult dietitian to help with timing of binders.

Person eats a steak, baked beans and drinks milk for dinner.

Consider reducing the amount of phosphorus intake;

consult dietitian for changes to diet as needed; take binders as prescribed.

Lab report card with elevated phosphorus, decreased calcium, and elevated PTH

Decrease phosphorus intake; take binders as prescribed;

take vitamin D analogs as prescribed; consult dietitian.

Description of person who forgets to take binders with lunch but takes them in the middle of the afternoon.

Keep binders close to area where meals are eaten;

carry binders with you when you are eating meals away from home;

take binders at start or middle of meal.

Breakfast of poached eggs, strawberries, white toast. Lunch of tuna, green salad,

fresh berries, apple juice. Dinner of turkey breast, pasta, broccoli, and fruit

cocktail.

Pat yourself on the back; continue good healthy eating.

Breakfast of oatmeal with cream, whole wheat toast with peanut butter, and a glass of milk. Lunch of cheeseburger, French fries and a Coke. Dinner of cheese enchilada, refried beans, Spanish rice, frosted chocolate cake and a glass of milk.

Decrease phosphorus intake; consult with dietitian for dietary changes;

take binders as prescribed.

Upon filling the initial prescription for vitamin D analogs person realizes that insurance will not pay for it and/or they cannot afford to pay for it.

Tell the nurse or dietitian.

Description of person who has indigestion frequently and drinks milk to help relieve it.

Tell the nurse or dietitian.

Description of person itching.

Tell the nurse; take binders as prescribed; control phosphorus intake;

Skin care with lotion.

Description of person with hip pain.

Report the pain to the nurse.

Description of person with hard deposits under their skin.

Report to the nurse; watch calcium and phosphorus intake;

take binders as prescribed.

Person takes binders and vitamin D analogs as prescribed.

Pat yourself on the back; continue taking medications as prescribed.

Another unit in the “Managing Diet” module is “Potassium”. In this unit the patient/learner will be able to identify high and low potassium foods. The trainer discusses which foods have high and low potassium and presents illustrative examples of high/low potassium foods. Foods discussed should include “Raw, fresh, red, yellow, orange fruits and vegetables are high in potassium”; and present the general principles of “Raw vs. Cooked”, and “Fresh vs. Canned or Frozen”, (the trainer must make the learner aware exceptions to this rule). More particularly the following should be presented:

Raw, fresh, red, yellow, orange fruits and vegetables are usually high in potassium including: oranges, orange juice, grapefruit, kiwi, potatoes in any form, tomatoes, tomato juice, bananas, cantaloupes, spinach, dried beans, dried fruits (raisins), chocolate, salt substitute (provide actual packet), winter squash. Low potassium foods include all kinds of berries, grapes, apples, apple juice, pineapple, green beans, corn, zucchini squash, carrots, peppers (all kinds) mixed vegetables, cranberry juice and juice blends (except orange, cabbage, eggplant, peaches and pears.

The trainer continues with “Effects of Potassium on the Body”. The objective for this sub-section is that the learner will be able to state what potassium is, what it does in the body and the effects of low and high potassium on the body. Using various media, the trainer defines potassium and its effects on the body. Using the processes described in the previous sections, the patient/learner will review and learn the materials. In presenting the effects of potassium on the body the trainer should cover the following information:

Potassium is a nutrient that is present inside the cells.

Potassium's role in the body: is to help maintain normal water balance and aid in regulation of neuromuscular activity (muscle contraction and sending nerve impulses), especially transmitting electrical impulses in the heart.

Effects of too little potassium may include confusion, muscle weakness; and cardiac arrythmia.

Effects of too much potassium: may include muscle weakness; dysrhythmias; nausea and vomiting, and p aresthesias

The final sub-section in the “Managing Diet” module is “Putting It All Together.” The objective of this section is to enable the learner to be able to identify foods that make up appropriate meals to meet individual nutritional needs and avoid complications such as, bone disease, hyperlipidemia, and undesired weight changes. The learner will be able to identify situations that may contribute to complications and the correct actions to take. Further, tThe learner will choose meals that meet individual nutritional needs from menus, “Good Healthy Choices,” when given scenarios or when shown cards depicting food items. The learner will identify situations that may contribute to complications and describe the correct actions to take. Some suggested media to use for examples include “Good Healthy Choices for PD,” food cards, and menus from local restaurants.

A preferred suggested procedure for this sub-section is for the trainer to first give the patient/learner menus, food cards and the “Good Healthy Choices” book and ask the patient to pick a meal plan for two days that will meet his/her nutritional needs. The trainer will also give the patient/learner problem examples, and ask the patient/learner to tell the trainer what the patient/learner sees, what he/she knows about the situation and what he/she would do if the situation happened to him/her. The trainer works with the patient/learner until he/she can choose appropriate foods consistently and take the correct actions, and trainer believes the patient/learner can manage diet and medications at home.”

A preferred sequence of teaching may include:

Presenting “Good Healthy Choices” and having the patient/learner choose meals that meet his/her nutritional needs.

Then present food cards and ask patient/learner to create several days of meals that meet nutritional requirements.

When these have been done, have learner pick menus for two or three restaurants where they might typically eat lunch/dinner and choose meals that meet nutritional needs.

Note: the above sequence moves from the structured format of “Good Healthy Choices” to the food cards” which are less structured and finally to the least structured, menus from local restaurants. This progression allows the learner to have more guidance initially, then work more independently. This may facilitate learning.

Further scenarios may be presented to the patient/learner by the trainer who then asks the patient/learner to state the possible problem and describe appropriate actions to take. The trainer may need to encourage and prompt the patient/learner to solve the problem by using language similar to “What is happening here?”, “What do you know about this?”, and “What do you think you should do?”. If the learner is having difficulty identifying the problem then the trainer should go back and review associated concepts. Problems presented should include those specific to the patient/learner's condition (if necessary) as well as the examples presented below. Some examples of problems and solutions that may be used in the training include:

It's hard to remember to take your binders at lunch because you are normally away from home at that time.

Learner states will pack binders in a small container; learner consults nurse or dietitian for help.

Your friends ask you out for pizza.

Learner states that has options to eating pizza (can order salad and pasta)or scrape some of the cheese off the pizza

You go to a wedding where they serve ham, cheese potatoes, green beans, rolls with butter, cole slaw and banana pudding.

Learner chooses foods appropriate for their diet.

You are at a breakfast buffet. The choices are: Bagels, blueberry muffins, white and wheat toast, cream cheese, jelly, peanut butter, scrambled eggs, bacon, sausage, biscuits and gravy, yogurt, sugar-sweetened cereals, whole milk, low fat milk, orange and apple juice, and coffee.

Learner chooses foods appropriate for their diet.

You're hungry but the thought of eating meat makes you nauseous.

Learner states will consult with the dietitian.

You are supposed to take three Phoslo with each meal. The pills make you feel very full so you start taking only one with each meal.

Learner states will contact nurse or dietitian.

Your favorite food in the whole world contains a large amount of dairy products.

Learner states will ask dietitian how to work some of this food into the diet.

You have an episode of peritonitis.

Learner states that protein needs increase during peritonitis. Learner chooses additional sources of protein for each meal.

The doctor tells you that your potassium level is low and you should eat more potassium.

Learner states that they will ask dietitian how much additional potassium intake they are allowed and uses list of potassium foods to select foods to meet their potassium requirement.

Learner receives nutritional report card with cholesterol over 300.

Learner identifies that this level is too high, states will contact dietitian for diet modifications. Learner chooses diet for one day with foods lower in fat content. If prescribed cholesterol lowering drug, learner voices that they will take the medication as prescribed.

Learner receives nutritional report card with low serum albumin and has had a weight loss of three pounds below desired weight range. The weight loss is true body weight, not fluid.

Learner states will consult dietitian for diet modifications. Learner chooses diet for one day that has increased protein and calorie intake.

Your phosphorus on your last nutritional report card it high. You have been itching.

Learner states will take binders as prescribed, review dietary intake of phosphorus, eliminate nonessential high phosphorus foods, and consult dietitian as necessary.

A “Troubleshooting” chapter may be used which would preferably pull together many concepts begun in other units. The trainer may find it easier to teach sets of lessons as they fit with UltraBag/Home Choice and/or Fluid Balance. As this chapter is taught the learners are being prepared to function independently as troubleshooters. They must actually perform the actions in the Problem Solving Lessons as they would be wanted or expected to do them at home. So, if calling the clinic is an action step-have them pick up a disconnected telephone and dial the clinic phone number. Media may include: a Media Book, UltraBag fill line/Home Choice Cassette with air, practice aprons, transfer set, minicap, UltraBag supplies, eggs (optional) cotton balls, heparin, supplies for IP medication addition, mock flow sheets, spring scales. Verbal scenarios may be used as well. The following is a suggested outline respective of subject matter and requisite knowledge.

Air Infusion—(Concept formation, Principle, Judgment/Decision-making, Problem-Solving)

Bloody Bag—(Concept formation, Principle, Judgment/Decision-making, Problem-Solving)

Recognizing Peritonitis—(Concept formation)

Contamination—(Principle, Judgment/Decision-making, Problem-Solving)

Recognizing Peritonitis—(Principle, Judgment/Decision-making, Problem-Solving)

Inadequate Drain—(Concept formation)

Constipation—(Concept formation, Principle, Judgment/Decision-making, Problem-Solving)

Fibrin—(Concept formation, Principle, Judgment/Decision-making, Problem-Solving)

Fluid Overload—(Principle, Judgment/Decision-making, Problem-Solving)

Dehydration—(Principle, Judgment/Decision-making, Problem-Solving)

A concept plan for the Air Infusion sub-section of this Troubleshooting unit/module may include the objective of getting the learner to be able to identify shoulder pain developed from an air infusion. MEDIA may include: Giving examples and non-examples with teacher/learner dialogue. After reviewing the dialogue between the learner and the teacher, the learner will tell the teacher the characteristics of air infusion. The learner may be prepared using: “At the end of this lesson you will define an air infusion. I will tell you some characteristics, give you some examples, and then ask you to guess if this would be a symptom of air infusion. I will tell you if you are right or wrong and why. It is okay if you make a mistake, because this is how you learn. We will keep doing this until you are answering all correctly and then we will know that you understand it.” Activities may include: Trainer giving definition of air infusion (May delay giving definition of concept to end of lesson.); such as (including critical characteristics) Pain localized to the right or left shoulder occurring after an air infusion; and, or Increases with inspiration, holding breath, coughing. Trainer then may discuss examples and non-examples of items to illustrate air infusion giving learner feedback about accuracy of guesses (Usually start with example/non-example pairs, then as learner is guessing correctly, present single examples and non-examples; Final examples and non-examples should be very close so learner must make fine discriminations).

Suggested Example/Non-Example Pairs (Verbal Descriptions, Suggested Pictures/Video-clips, Scenarios) May Include:

1. Pain localized to the shoulder not associated with a change in activity level. Increases in intensity with holding breath, coughing, and inspiration.

2. Pain developing after a change in activity, i.e. after starting to exercise.

3. Pain radiating to the jaw, down the arm. Also associated with shortness of breath.

4. Pain developing after realizing the fill line was not flushed.

Continue to present and learner continues guessing as examples and non-examples are presented until learner is guessing correctly all of the time. Then, have learner formulate definition of concept of air infusion. If definition has been presented at start of lesson, have learner use own words to formulate definition.

A principle lesson plan for the Air Infusion sub-section of the Troubleshooting module will preferably give the patient/learner the ability to recognize situations that may lead to air infusion and understand that this may lead to shoulder pain. Preferred media may include an UltraBag, Apron, Home Choice—set up ready to prime—with patient line incorrectly positioned. Ultimately, the learner will learn the principles “If you do not properly flush the UltraBag fill line/Home Choice patient line, then you may get an air infusion.” The trainer will review the concepts from the previous lesson plan and state principles (“If you do not properly flush the UltraBag fill line/Home Choice patient line, then you may get an air infusion.”). The teacher then presents scenarios and asks learner to guess (demonstrating for example a scenario of going from drain to fill without flushing (or not flushing before drain); demonstrating positioning of the patient line incorrectly in the organizer so that the patient line does not prime completely; and showing air in line). The learner then continues guessing as scenarios that are examples and non-examples are presented until the learner is able to restate the principle in their own words.

A judgment/decision lesson plan for the Air Infusion sub-section will preferably give the patient/learner the ability to identify the presence of shoulder pain due to air infusion and state the appropriate action. Preferred illustrations/media may include a partially flushed UltraBag Fill Line/Home Choice Patient Line connected to apron. For UltraBag patient—new UltraBag supplies will also be needed. The trainer will review associated concepts, and state the principles. Then, the trainer will present what the learner should be looking for and possible action steps that should be taken. Note, the purpose of this lesson is to get the learner to memorize where/when judgments should be made and the correct actions that should be taken. Present verbally a scenario where shoulder pain is present without air infusion and scenarios using the media where an air infusion has occurred. Continue repeating until the learner has memorized. What the learner should be looking for (Judgments) and what choice(s)/possible action steps should be taken (Decisions) (some judgments will have several action steps) may be as follows:

1. Pain in right or left shoulder following infusion. May increase with inspiration, holding breath, or coughing should drive the decision to Initiate drain lying down with feet up, and/or to complete next UltraBag/Home Choice fill. Also, If pain continues, to call the clinic. A further scenario could be shoulder pain which increases or radiates to the jaw, and/or down the arm. The proper judgment/decision—call 911.

A problem solving lesson plan for the Air Infusion sub-section will preferably give the patient/learner the ability to identify shoulder pain from air infusion and take the appropriate action steps.

The trainer will first review associated concepts, principles, and then present scenario(s) and ask learner to identify the and solve the problem. After each scenario, the teacher asks the learner to state the possible problem and describe the appropriate actions to take. Teacher may need to prompt learner to solve the problem i.e. “What is happening here?”; “What do you know about this?”, and “What do you think you should do?”. If the learner is having difficulty identifying the problem then go back and review associated concepts. Problem solutions to include unit/clinic specific standing orders. The learner will then solve the problems and take correct actions, continuing until the learner is developing correct solutions and taking correct actions. A first Problem Scenario may proceed thusly, Show the UltraBag with the air in the lines. Present verbal scenario. “You filled using this UltraBag.” The Problem Solution the Learner will ultimately learn is to state “I have shoulder pain.” “Thus, I should initiate drain lying down with feet up, and complete next UltraBag/Home Choice fill, and if pain continues, call the clinic. The trainer may also present a second scenario where shoulder pain increases or radiates to the jaw, and or down the arm. The solution—Call 911.

Bloody Bag—Concept formation

UNIT: Troubleshooting

OBJECTIVE: The learner will be able to identify a bloody bag.

MEDIA: Pictures of examples and non examples(TS 1, 5, 6, 11, 18; FIGS. 9A, 9C, 9F and 9I)

REQUISITE KNOWLEDGE: UltraBag/Home Choice Procedure

HOW WILL I EVALUATE WHETHER LEARNING HAS OCCURRED? The learner will identify a bloody bag when presented with pictures.

GETTING THE LEARNER READY: “At the end of this lesson you will tell if a bag is bloody or not. I will tell you what a bloody bag looks like, then I will show you some pictures. I will ask you to guess if the bags in the pictures are bloody or not. When you are guessing them all correctly, we will know that you can identify a bloody bag.”

LEARNER ACTIVITY TEACHER ACTIVITY NOTES

1. Pay attention to definition.1. Give definition of bloody bag. 1. May delay giving definition of concept to end of lesson.

2. Guess if it is example or non-example. 2. Present pictures of the examples and non-examples illustrate bloody bags and ask learner to guess. Give learner feedback about accuracy of guesses. 2. Usually start with example/non-example pairs, then as learner is guessing correctly, present single examples and non-examples. Final examples and non-examples should be very close so learner must make fine discriminations.

3. Continue guessing as examples and non-examples are presented. 3. Continue to present examples and non-examples until learner is guessing correctly all of the time.

4. Help teacher formulate definition of concept. 4. Have learner formulate definition of bloody with you. 4. If definition has been presented at start of lesson, have learner use own words to formulate definition.

Definition(Critical Characteristics)

1. Pink Tinged effluent2. Bright red effluent

Suggested Example/Non-Example Pairs(Verbal Descriptions, Suggested Pictures/Video-clips, Scenarios)

1. Picture of pink tinged effluent/picture of clear effluent(TS 18/1)2. Picture of red effluent/picture of clear effluent(TS 5/1)3. Picture of pink tinged effluent/picture of cloudy effluent(TS 18/6)4. Picture of red effluent/picture of clear effluent with fibrin(TS 5/11)

Bloody Bag—Principle

OBJECTIVE: Learner will be able to recognize situations that may lead to bloody bag and understand that this is not a normal situation.

MEDIA: Pictures of Bloody Bags (TS 5, 18; FIGS. 9C and 9I), Verbal Scenarios.

REQUISITE KNOWLEDGE: Bloody Bag Concept Lesson

HOW WILL I EVALUATE WHETHER LEARNING HAS OCCURRED? Learner states the principles “If menses, straining, trauma to the abdomen happen, then bloody bag may occur.” and “If effluent is bloody, this may not be normal and may be cause for concern.”

GETTING THE LEARNER READY: “You have learned how to tell if a bag is bloody or not. Let's talk now about some causes of bloody bags and what you should know if you have one. I will present situations to you and ask you to guess whether or not they may cause a bloody bag. I will also ask you if you think this is normal. Don't be afraid to guess wrong, that is how you learn. When you are guessing correctly I will ask you why and if you answer correctly, then we will know you understand what causes this condition and if it is normal.”

LEARNER ACTIVITY TEACHER ACTIVITY NOTES

1. Pay attention to concepts. 1. Review concepts and state principles. 2. Guess. 2. Teacher presents scenarios and asks learner to guess. Give feedback re: accuracy of description. 2. After verbalizing scenarios ask the learner to guess if this would cause a bloody bag. Show pictures of bloody bags and get learner to state if this is normal.

3. Continue guessing as scenarios that are examples and non-examples are presented.

3. Continue to present examples and non-examples until learner is guessing correctly most of the time.

4. Restate the principles linking the concepts. 4. Have learner restate the principle in their own words.

List of Concepts Linked to Form Principle

1. If menses, straining, trauma to the abdomen happen, then bloody bag may occur.2. If effluent is bloody, this may not be normal and cause for concern.

Suggested Scenarios

Pictures of bloody bags(TS 5, 18)Verbal scenarios describing menses, straining and trauma to abdomen

Bloody Bag—Judgment/Decision

OBJECTIVE: The learner will be able to recognize a bloody bag and state the appropriate action to take.

MEDIA: See Principle Lesson.

REQUISITE KNOWLEDGE: Bloody Bag Principle Lesson

HOW WILL I EVALUATE WHETHER LEARNING HAS OCCURRED? When presented with a picture of a bloody bag the learner will state the appropriate action.

GETTING THE LEARNER READY: “Now that you understand what causes a bloody bag and that this is not normal, it is time to learn what you can do if you drain one at home. I will present situations to you and suggest some actions for you take if these happen to you. You just pay attention and try to memorize the correct actions. We will know that you have learned what to do when you can repeat to me what you should do if you have a bloody bag.”

LEARNER ACTIVITY TEACHER ACTIVITY NOTES

1. Pay attention and recall the concepts. 1. Review associated concepts.

2. Pay attention. 2. State the principles.

3. Pay attention. 3. Present what the learner should be looking for and possible action steps that should be taken. 3. The purpose of this lesson is to get the learner to memorize where/when judgments should be made and the correct actions that should be taken.

4. Repeat the judgment and decision. 4. Ask the learner to repeat the action steps.

5. Process feedback. 5. Provide feedback. 5. Continue until the learner has memorized.

List of Principles used to Make the Judgement/Decision:

1. If menses, straining, trauma to the abdomen happen, then bloody bag may occur.

2. If effluent is bloody, this may not be normal and may be cause for concern.

What the Learner should be looking for?(Judgments) What choice(s)/possible action steps should be taken? (Decisions) (some judgments will have several action steps)

1. Bloody Effluent 1. Complete the exchange, save the bag and call the clinic.

Bloody Bag—Problem Solving

OBJECTIVE: Learner will be able to identify a bloody bag and take the appropriate action steps.

MEDIA: See Bloody Bag Principle Lesson

REQUISITE KNOWLEDGE: Bloody Bag Decision/Decision Lesson

HOW WILL I EVALUATE WHETHER LEARNING HAS OCCURRED? Learner will identify a bloody bag and demonstrate the appropriate actions to take.

GETTING THE LEARNER READY: “You've learned about bloody bags and what to do if you drain one. Now I will give you problem examples, ask you to tell me what you see, what you know about the situation and what you would do if this happened to you. I will help you along in working through the situation, so don't be afraid. When you can take the correct action, then we will know you can solve this problem at home.”

LEARNER ACTIVITY TEACHER ACTIVITY NOTES

1. Pay attention and recall the concepts. 1. Review associated concepts.

2. Pay attention. 2. State the principles.

3. Solve problems and take correct actions. 3. Present scenario(s) and ask learner to identify the and solve the problem. After each scenario, the teacher asks the learner to state the possible problem and describe the appropriate actions to take. 3. Teacher may need to prompt learner to solve the problem i.e. “What is happening here?”, “What do you know about this?”, and “What do you think you should do?”. If the learner is having difficulty identifying the problem then go back and review associated concepts.

Problem solutions to include unit specific standing orders.

4. Process feedback. 4. Continue feedback. 4. Continue presenting scenarios until learner is developing correct solutions and taking correct actions.

PROBLEM DESCRIPTION: Bloody Bag

List of Principles used to Solve the Problem:

1. If menses, straining, trauma to the abdomen happen, then bloody bag may occur.

2. If effluent is bloody, this may not be normal and cause for concern.

Problem Scenario Problem Solution

1. At the end of an actual drain tell the learner that their effluent “looks like this” and show them a picture of a bloody bag. 1. Learner will complete the exchange, save the bag and call the clinic.

A concept learning plan in a Recognizing Peritonitis sub-section of the Troubleshooting unit will give the learner the ability to identify peritonitis. Preferred media may include pictures (TS 1-3,7,9,11,12,18; FIGS. 9A, 9B, 90D, 9E, 9F, and 9I)/verbal scenarios of examples and non-examples.

REQUISITE KNOWLEDGE: Maintaining Asepsis Unit, UltraBag/Home Choice

HOW WILL I EVALUATE WHETHER LEARNING HAS OCCURRED? When shown pictures or given verbal descriptions, the learner differentiates between examples and non-examples of peritonitis.

GETTING THE LEARNER READY: “Peritonitis is an infection in your peritoneum. It causes cloudy fluid, abdominal pain, nausea and vomiting, and sometimes fever. It is important to recognize this infection. I am going to show you pictures that may or may not represent peritonitis. I want you to look at the pictures and tell me whether or not you think this person has peritonitis. Don't worry if you make mistakes, I will help you as you go along. When you are getting them all correct, we will know you have learned it.”

LEARNER ACTIVITY TEACHER ACTIVITY NOTES

1. Pay attention to definition. 1. Give definition of peritonitis. 1. May delay giving definition of concept to end of lesson. Use critical characteristics.

2. Guess if it is example or non-example. 2. Present examples and non-examples of items to illustrate concept. Give learner feedback about accuracy of guesses. 2. Usually start with example/non-example pairs, then as learner is guessing correctly, present single examples and non-examples. Final examples and non-examples should be very close so learner must make fine discriminations.

3. Continue guessing as examples and non-examples are presented. 3. Continue to present examples and non-examples until learner is guessing correctly all of the time.

4. Help teacher formulate definition of concept. 4. Have learner formulate definition of concept with you. 4. If definition has been presented at beginning of lesson have learner use own words to formulate definition.

Definition(Critical Characteristics)

1. Cloudy effluent.2. Abdominal Pain.3. Nausea and Vomiting.4. Fever. Suggested Example/Non-Example Pairs(verbal descriptions, suggested pictures/video-clips, scenarios)

1. Picture of cloudy effluent/picture of clear effluent(TS 2/TS 1).2. Picture of cloudy effluent/picture of clear effluent with fibrin(TS 2/TS 11).3. Picture of cloudy effluent/picture of clear fluid with fibrin(TS 3/TS 12).4. Picture of bloody fluid/picture of cloudy fluid(TS 18/TS 3)5. Picture of Home Choice Drain Line with cloudy effluent(TS 7).6. Picture of Home Choice Drain Bag with cloudy effluent(TS 9). Verbal Scenarios1. Person draining cloudy effluent and holding their belly in pain/person draining clear effluent while relaxing watching TV.2. Person draining cloudy effluent while vomiting..3. Person temperature 101 F., holding their belly, drained cloudy effluent.4. Person holding their belly in pain, not connected to UltraBag.

PRINCIPLE LEARNING LESSON PLAN

SUBJECT: Recognizing Peritonitis

UNIT: Troubleshooting

OBJECTIVE: Learner will know when to check for cloudy effluent and to get treatment immediately if present.

MEDIA: Verbal Scenarios

REQUISITE KNOWLEDGE: Contamination Problem Solving Lesson

HOW WILL I EVALUATE WHETHER LEARNING HAS OCCURRED? Learner states the principle “If you have symptoms of peritonitis, then you should check for cloudy fluid.” and “If your fluid is cloudy, then you should get treatment immediately.”

GETTING THE LEARNER READY: “You have learned that peritonitis is a serious infection. Let's talk now about how to check for peritonitis and what you should do if you have it. I will present situations to you and ask you to guess whether or not you think peritonitis may be present. Don't be afraid to guess wrong, that is how you learn. When you are guessing correctly I will ask you why and if you answer correctly, then we will know you understand when to check for peritonitis and what to do if you have it.”

LEARNER ACTIVITY TEACHER ACTIVITY NOTES

1. Pay attention to concepts. 1. Review concepts and state principles. 1. Review Peritonitis concept. State principles.

2. Guess. 2. Teacher presents scenarios and asks learner to guess. Give feedback re: accuracy of description. 2. After verbalizing scenarios or demonstrating scenarios ask the learner to guess if this would cause be a reason to check for cloudy fluid Get learner to state what to do in each situation.

3. Continue guessing as scenarios that are examples and non-examples are presented. 3. Continue to present examples and non-examples until learner is guessing correctly most of the time.

4. Restate the principles linking the concepts. 4. Have learner restate the principle in their own words.

List of Concepts Linked to Form Principle

If you have symptoms of peritonitis, then you should check for cloudy fluid. If your fluid is cloudy, then you should get treatment immediately.

Suggested Scenarios

1. Patient watching TV, onset of abdominal pain.

2. Patient with thermometer registering temperature of 100 F.

3. Patient on Home Choice awakens during night holding abdomen.

4. Patient performing UltraBag exchange, observing cloudy fluid.

5. Patient at dinner table, eating; holds abdomen.

6. Patient holding emesis basin, washcloth on forehead.

7. Patient enjoying a day at the beach with his family.

JUDGEMENT/DECISION LEARNING LESSON PLAN

SUBJECT: Recognizing Peritonitis

UNIT: Troubleshooting

OBJECTIVE: Learner will be able to recognize symptoms of peritonitis, check for cloudy effluent, and state appropriate action based on findings.

MEDIA: Verbal scenarios

REQUISITE KNOWLEDGE: Recognizing Peritonitis Principle Learning Lesson

HOW WILL I EVALUATE WHETHER LEARNING HAS OCCURRED? The learner recognizes symptoms of peritonitis and states the appropriate action steps to take.

GETTING THE LEARNER READY: “Now that you understand when to check for peritonitis and the importance of prompt treatment, it is time to learn what you can do if you have symptoms to get the treatment you need immediately. I will present situations to you and suggest some actions for you take if these happen to you. You just pay attention and try to memorize the correct actions. We will know that you have learned what to do when you can repeat to me what you should do if you have peritonitis.”

LEARNER ACTIVITY TEACHER ACTIVITY NOTES

1. Pay attention and recall concepts. 1. Review associated concepts.

2. Pay attention. 2. State the principles.

3. Pay attention. 3. State what the learner should be looking for and possible action steps that should be taken. 3. The purpose of this lesson is to get the learner to memorize where/when judgments should be made and the correct actions that should be taken.

4. Repeat the Decision/Decision. 4. Ask the learner to repeat the action steps. 4. Continue presenting scenarios until learner is stating correct actions.

5. Process feedback. 5. Provide feedback. 5. Continue until the learner has memorized.

List of Principles used to Make the Decision:

If you have symptoms of peritonitis, then you should check for cloudy fluid.

If your fluid is cloudy, then you should get treatment immediately.

What should leaner be looking for?(Judgments) What Choice/Possible Action Steps Should be Taken?(some judgments may have several action steps)

1. Patient watching TV, onset of abdominal pain. 1. Perform exchange, observe for cloudy effluent.2. Cloudy effluent present—complete exchange—clamp both the fill line and drain line.3. Place a Minicap on the end of the patient connector.4. Call nurse at the clinic immediately.5. Follow unit specific instructions.

2. Patient with thermometer registering temperature of 100 F. 1. Perform exchange, observe for cloudy effluent. Effluent clear—saves fluid—calls nurse.

3. Patient on Home Choice awakens during night holding abdomen. 1. Performs manual drain, observes effluent.2. Cloudy effluent present—Collect an effluent sample—previously learned motor skill.3. Page nurse on call immediately.4. Follow unit specific instructions

4. Patient performing UltraBag exchange, observing cloudy fluid. 1. Complete the exchange.2. Clamp both the fill line and drain line.3. Place a Minicap on the end of the patient connector.4. Call nurse at the clinic immediately.5. Follow unit specific instructions.

5. Patient at dinner table, eating; holds abdomen. 1. Performs exchange, effluent clear , “must be something I ate.”

6. Patient holding emesis basin, washcloth on forehead. 1. Performs exchange, fluid cloudy—saves fluid—calls nurse. (see judgment 1)

7. Patient enjoying outing with family. 1. No action necessary.

PROBLEM SOLVING LESSON PLAN

SUBJECT: Recognizing Peritonitis

OBJECTIVE: Learner will be able to identify an episode of peritonitis and determine the action steps to take.

MEDIA: See Recognizing Peritonitis Decision/Decision Lesson

REQUISITE KNOWLEDGE: Recognizing Peritonitis Decision/Decision Lesson

HOW WILL I EVALUATE WHETHER LEARNING HAS OCCURRED? Learner will identify an episode of peritonitis and state the appropriate actions to take.

GETTING THE LEARNER READY: “You've learned about peritonitis and what to do if you have the infection. Now I will give you problem examples, ask you to tell me what you see, what you know about the situation and what you would do if this happened to you. I will help you along in working through the problem, so don't be afraid. When you can take the correct action, then we will know you can solve this problem at home.”

LEARNER ACTIVITY TEACHER ACTIVITY NOTES

1. Pay attention and recall the concepts. 1. Review associated concepts.

2. Pay attention. 2. State the principles.

3. Solve problems and take correct actions. 3. Present scenario(s) and ask learner to identify and solve the problem. Show pictures with scenarios of different peritonitis episodes. After each scenario, the teacher asks the learner to state the possible problem and describe the appropriate actions to take. 3. Teacher may need to prompt learner to solve the problem i.e. “What is happening here?”, “What do you know about this?”, and “What do you think you should do?”. If the learner is having difficulty identifying the problem then go back and review associated concepts. ** Problem solutions to include unit specific standing orders.

4. Process feedback. 4. Continue feedback. 4. Continue presenting scenarios until learner is developing correct solutions and taking correct actions.

PROBLEM DESCRIPTION: Peritonitis.

LIST OF PRINCIPLES USED TO SOLVE THE PROBLEM: If you have symptoms of peritonitis, then you should check for cloudy fluid. If your fluid is cloudy, then you should get treatment immediately.

Problem Scenario Problem Solution

1. Cloudy bag seen at the end of an UltraBag exchange (daytime). 1. Complete the exchange.2. Clamp both the fill line and drain line.3. Place a Minicap on the end of the patient connector.4. Call nurse at the clinic immediately.5. Follow unit specific instructions.

2. Cloudy bag seen at the end of an UltraBag exchange (at night or on weekend/holiday). 1. Complete the exchange.2. Clamp both the fill line and drain line.3. Place a Minicap on the end of the patient connector.4. Page the nurse on call immediately.5. Follow unit specific instructions.

3. Cloudy fluid seen during an initial drain on the Home Choice Cycler. 1. Collect an effluent sample-previously learned motor skill.2. Page nurse on call immediately.3. Follow unit specific instructions.

4. Cloudy fluid seen in drain line coming from Home Choice Cycler. 1. Collect an effluent sample—previously learned motor skill.2. Page nurse on call immediately.3. Follow unit specific instructions.

5. Collection of cloudy fluid seen at night or in the morning in the drainage set. 1. Collect an effluent sample. 2. Page nurse on call immediately.3. Follow unit specific instructions.

Inadequate Drain—concept

UNIT: Troubleshooting

OBJECTIVE: The learner will be able to recognize an inadequate drain.

MEDIA: Scenarios, pictures of examples and non-examples(TS 4,11,14-17; FIGS. 9B, 9F-9I) and CAPD/CCPD Flow Sheet.

REQUISITE KNOWLEDGE: Components of the UltraBag, UltraBag J/D Memory, Weighing/Recording.

HOW WILL I EVALUATE WHETHER LEARNING HAS OCCURRED? When given an example or scenario, the learner will identify if there is an inadequate drain.

GETTING THE LEARNER READY: “At the end of this lesson you will tell whether or not a drain is inadequate. I will give you various examples and scenarios, then ask you to guess if you think flows are adequate or inadequate will tell you if you are right or wrong and why. It is OK if you make mistakes because that is how you learn. We will keep doing this until you are guessing correctly and then we will know that you got it.”

LEARNER ACTIVITY TEACHER ACTIVITY NOTES

1. Pay attention to definition.1. Formulate definition of an inadequate drain. 1. Use simple terms that are non-medical

2. Guess if it is example or non-example. 2. Present scenarios and examples and non-examples of inadequate drains. Give learner feedback about accuracy of guesses. 2. Usually start with example/non-example pairs, then as learner is guessing correctly, present single examples and non-examples. Final examples and non-examples should be very close so learner must make fine discriminations.

3. Continue guessing as examples and non-examples are presented. 3. Continue to present examples and non-examples until learner is guessing correctly all of the time.

4. Help teacher formulate definition of an inadequate drain. 4. Have learner formulate definition of an inadequate drain.

Definition(Critical Characteristics)

1. There is little fluid drained.2. Drain volume is less than fill volume. (except after a long dwell).3. Drain volume is <¾ of fill volume. Suggested Example/Non-Example Pairs(verbal descriptions, suggested pictures/video-clips, scenarios) 1. Picture of a full drain bag/picture of a drain bag with a small amount of fluid(TS 11/14).2. Picture of an over-filled drain bag(TS 4). 3. Picture of an UltraBag fill bag showing a fill volume of 2500 ml along with a drain bag attached hanging from a spring scale with the markers measuring 1400 ml(TS 15).4. Picture of an UltraBag with fill bag showing a volume of 2500 ml along with a drain bag attached hanging from a spring scale with markers measuring 2800 ml(TS 16).5. Picture of an UltraBag with fill bag showing a fill volume of 2500 ml along with a drain bag attached hanging from a spring scale with markers measuring 2400 ml(TS 17).6. Scenario of a patient who has filled with a 2500 ml bag of solution and only drains a small amount of fluid.7.

Scenario of a patient who has filled with a 2500 ml bag of solution and drains ½ a bag of fluid.

Contamination—Principle

UNIT: Troubleshooting

OBJECTIVE: Learner will be able to recognize situations that may lead to an episode of peritonitis.

MEDIA: Transfer set connected to a catheter adapter on an apron, Minicap, Home Choice Cassette.

REQUISITE KNOWLEDGE: Maintaining Asepsis, Transfer Set/Clamps, Concept of Peritonitis, UltraBag and/or Home Choice units.

HOW WILL I EVALUATE WHETHER LEARNING HAS OCCURRED? Learner states the principle “If contamination occurs, peritonitis may result.”

GETTING THE LEARNER READY: “You have learned that peritonitis is a serious infection. Let's talk now about what causes peritonitis. I will present situations to you and ask you to guess whether or not you think they may cause peritonitis. Don't be afraid to guess wrong, that is how you learn. When you are guessing correctly I will ask you why and if you answer correctly, then we will know you understand what causes peritonitis.”

LEARNER ACTIVITY TEACHER ACTIVITY NOTES

1. Pay attention to concepts. 1. Review concepts and state principles. 1. Review contamination from Maintaining Asepsis unit. Review Peritonitis concept.

2. Guess. 2. Teacher presents scenarios and asks learner to guess. Give feedback re: accuracy of description. 2. After verbalizing scenarios or demonstrating scenarios ask the learner to guess if this would cause peritonitis. Give some examples of maintaining sterility as learner begins to guess correctly.

3. Continue guessing as scenarios that are examples and non-examples are presented. 3. Continue to present examples and non-examples until learner is guessing correctly most of the time.

4. Restate the principles linking the concepts. 4. Have learners restate the principle in their own words.

List of Concepts Linked to Form Principle

If contamination occurs, then peritonitis may result.

Suggested Scenarios

1. Hole in the Transfer Set: Verbalize description as fluid dripping from Transfer Set, wetness on clothing with Minicap intact. This may lead to peritonitis.

2. Demonstrate a Transfer Set coming apart from catheter adapter. This may lead to peritonitis.

3. Verbalize a Minicap coming off at night, Minicap came off in shower, while swimming, while exercising, or while doing anything for longer than 5 seconds. This may lead to peritonitis.

4. Demonstrate touching the blue sterile tip of the Transfer Set to skin, table, lap pad, unsterile part of patient connector end for less than 5 seconds. This may lead to peritonitis.

5. Verbalize fluid leaking from the white twist clamp area on the Transfer Set. This may lead to peritonitis.

6. Minicap drops on the floor. This may lead to peritonitis.

7. Patient touches the inside of the minicap This may lead to peritonitis.

8. Patient forgets to mask and “wash” hands. This may lead to peritonitis.

9. Inspection of cassette reveals cap missing off spike. This may lead to peritonitis.

10. Open spike touches hand during spiking procedure. This may lead to peritonitis.

11. Exchange being started with open windows/fans/pets. This may lead to peritonitis.

12. Exchange being completed on dirty work surface. This may lead to peritonitis.

Contamination—Judgment/Decision

UNIT: Troubleshooting

OBJECTIVE: Learner will be able to recognize contamination and be able to state the appropriate action to take.

MEDIA: See Contamination Principle Lesson

REQUISITE KNOWLEDGE: Contamination Principle Lesson

HOW WILL I EVALUATE WHETHER LEARNING HAS OCCURRED? The learner will recognize contamination and state the appropriate actions to take.

GETTING THE LEARNER READY: “Now that you understand that contamination can lead to peritonitis, it is time to learn what you can do if contamination does occur in order to try to prevent that serious infection. I will present contamination situations to you and suggest some actions for you take if these happen to you. You just pay attention and try to memorize the correct actions. We will know that you have learned what to do when you can repeat to me what you should do if you contaminate.”

LEARNER ACTIVITY TEACHER ACTIVITY NOTES

1. Pay attention and recall the concepts. 1. Review associated concepts.

2. Pay attention. 2. State the principles.

3. Pay attention. 3. Present what the learner should be looking for and possible action steps that should be taken. 3. The purpose of this lesson is to get the learner to memorize where/when judgments should be made and the correct actions that should be taken.

4. Repeat the judgment and decision. 4. Ask the learner to repeat the action steps.

5. Process feedback. 5. Provide feedback. 5. Continue until the learner has memorized.

LIST OF PRINCIPLES USED TO MAKE THE JUDGEMENT/DECISION: If contamination occurs, peritonitis may result.

What the Learner should be looking for?(Judgments) What choice(s)/possible action steps should be taken? (Decisions) (some judgments will have several action steps)

1. Hole in the Transfer Set: Verbalize description as fluid dripping from Transfer Set, wetness on clothing with Minicap intact. 1. Close white twist clamp.2. Close clamp around Transfer Set closer to body than the apparent leak.3. Notify nurse, go to clinic ASAP.

2. Demonstrate a Transfer Set coming apart from catheter adapter. 1. If connection loose and no fluid leaking, tighten connection.2. If connection apart, or fluid leaking, reconnect Transfer Set to adapter.2. Close clamp around catheter.3. Notify nurse, go to clinic ASAP.

3. Verbalize a Minicap coming off at night (“What would you do if you woke up in the morning and your Minicap was gone?), Minicap came off in shower, while swimming, while exercising, or while doing anything for longer than 5 seconds. 1. Ensure white twist clamp is closed on Transfer Set.2. Apply new Minicap to blue sterile tip of transfer set.3. Close clamp around Transfer Set.4. Notify nurse, go to clinic ASAP.

4. Demonstrate touching the blue sterile tip of the Transfer Set to skin, table, lap pad, unsterile part of patient connector end for less than 5 seconds. 1. Ensure white twist clamp is closed on Transfer Set.2. Place a new Minicap on the end of the blue sterile tip for 10 minutes.3. Place another new Minicap on the end of the blue sterile tip for 10 minutes or until the next exchange is due.4. Notify your clinic of contamination ASAP.

5. Verbalize fluid leaking from the white twist clamp area on the Transfer Set. 1. Ensure white twist clamp is closed on Transfer Set.2. Close clamp around Transfer Set.3. Notify nurse, go to clinic ASAP.

6. The minicap remains sterile when the connection is made. 1. If the minicap is contaminated in any way discard and use a new minicap.

7. Check for a betadine soaked sponge inside the minicap. 1. If there is no betadine soaked sponge in the minicap discard and get a new one.

8. Prepare self has been completed before starting. 1. Complete prepare self.

9. Exchange area is acceptable. Doors and windows are closed, fans are off. No pets. 1. Close doors and windows. Turn off fans. Remove pets.

10. Caps are present on all spikes and patient line on Home Choice Cassette. 1. Use a new set if set does not pass inspection.

11. Spikes and solution bag outlet ports remain sterile throughout procedure. 1. If contamination of spike occurs, load a new set.2. If contamination of outlet port occurs, choose new solution bag.3. Push the spike all the way into the solution bag.

Contamination—problem solving

OBJECTIVE: The learner will be able to identify contamination episode(s) and take the appropriate action.

MEDIA: See Contamination Principle Lesson

REQUISITE KNOWLEDGE: Contamination Decision/Decision Lesson

HOW WILL I EVALUATE WHETHER LEARNING HAS OCCURRED? The learner will identify episodes of contamination and take appropriate actions.

GETTING THE LEARNER READY: “You've learned about contamination and peritonitis and what to do if you do accidentally contaminate. Now I will give you problem examples, ask you to tell me what you see, what you know about the situation and what you would do if this happened to you. I will help you along in working through the situation, so don't be afraid. When you can take the correct action, then we will know you can solve this problem at home.”

LEARNER ACTIVITY TEACHER ACTIVITY NOTES

1. Pay attention and recall the concepts. 1. Review associated concepts. 1. Maintaining Asepsis/Peritonitis

2. Pay attention. 2. State the principles. 2. “If contamination occurs, then peritonitis may result.”

3. Solve problems and take correct actions. 3. Present scenario(s) and ask learner to identify the and solve the problem. 3. Teacher may need to prompt learner to solve the problem i.e. “What is happening here”, “What do you know about this?”, and “What do you think you should do?”. If the learner is having difficulty identifying the problem then go back and review associated concepts. ** Problem solutions to include unit specific standing orders.

4. Process feedback. 4. Continue feedback. 4. Continue presenting scenarios until learner is developing correct solutions and taking correct actions.

PROBLEM DESCRIPTION: Contamination

List of Principles used to Solve the Problem:

1. If contamination occurs, then peritonitis may result.

Problem Scenario Problem Solution

1. Hole in the Transfer Set: Verbalize description as fluid dripping from Transfer Set, wetness on clothing with Minicap intact. 1. Close white twist clamp.2. Close clamp around Transfer Set closer to body than the apparent leak.3. Notify nurse, go to clinic ASAP.

2. Demonstrate a Transfer Set coming apart from catheter adapter. 1. If connection loose, no fluid leaking, tighten connection.2. If connection apart or fluid leaking, reconnect Transfer Set to adapter.2. Close clamp around catheter.3. Notify nurse, go to clinic ASAP.

3. Verbalize a Minicap coming off at night (“What would you do if you woke up in the morning and your Minicap was gone?), Minicap came off in shower, while swimming, while exercising, or while doing anything for longer than 5 seconds. 1. Ensure white twist clamp is closed on Transfer Set.2. Apply new Minicap to blue sterile tip of transfer set.3. Close clamp around Transfer Set.4. Notify nurse, go to clinic ASAP.

4. Demonstrate touching the blue sterile tip of the Transfer Set to skin, table, lap pad, unsterile part of patient connector end for less than 5 seconds. 1. Ensure white twist clamp is closed on Transfer Set.2. Place a new Minicap on the end of the blue sterile tip for 10 minutes.3. Place another new Minicap on the end of the blue sterile tip for 10 minutes or until the next exchange is due.4. Notify your clinic of contamination ASAP.

5. Verbalize fluid leaking from the white twist clamp area on the Transfer Set. 1. Ensure white twist clamp is closed on Transfer Set.2. Close clamp around Transfer Set.3. Notify nurse, go to clinic ASAP.

6. Demonstrate dropping a Minicap on the table when opening the package. 1. Discard and get a new one.

7. Demonstrate connecting to UltraBag or Home Choice cassette without a mask. 1. Stop connection.2. Put on mask.3.Wash hands.4. Start exchange over again.

8. Demonstrate contamination of the spike by touching spike to hand while spiking. 5. Discard cassette6. Load a new cassette.7.Use new bag.

9. Show a new cassette with a cap missing. 1. Discard.

10. Scenario of starting to disconnect with dog in room. 1. Remove dog.

Constipation—Concept formation

UNIT: Troubleshooting

OBJECTIVE: The learner will be able to identify if constipation is present.

MEDIA: Give examples and non-examples of teacher-learner dialogue.

HOW WILL I EVALUATE WHETHER LEARNING HAS OCCURRED? After reviewing the dialogue between the teacher and learner, the learner will tell the teacher the characteristics of constipation.

GETTING THE LEARNER READY: “At the end of this lesson, you will define what constipation is. I will tell you some characteristics, give you some examples and then ask you to guess if this is present. I will tell you if you are right or wrong and why. It is OK if you make a mistake, because that is how you learn. We will keep doing this until you are guessing all correctly and then we will know that you got it.”

LEARNER ACTIVITY TEACHER ACTIVITY NOTES

1. Pay attention to definition. 1. Give definition of constipation. 1. Straining when moving bowels. Hard, dry stools. Infrequent bowel movements. No bowel movement in one week.

2. Guess if it is example or non-example. 2. Present examples and non-examples of characteristics of constipation. Give learner feedback about accuracy of guesses. 2. Usually start with example/non-example pairs, then as learner is guessing correctly, present single examples and non-examples. Final examples and non-examples should be very close so learner must make fine discriminations.

3. Continue guessing as examples and non-examples are presented. 3. Continue to present examples and non-examples until learner is guessing correctly all of the time.

4. Help teacher formulate definition of constipation. 4. Have learner formulate definition of constipation with you. 4. If definition has been presented at start of lesson, have learner use own words to formulate definition.

Definition(Critical Characteristics)

1. Straining when moving bowels.2. Stool is hard and dry.3. Infrequent bowel movement.4. No bowel movement.

Suggested Example/Non-Example Pairs(Verbal Descriptions, Suggested Pictures/Video-clips, Scenarios)

1. Patient tells nurse that he/she has not had a bowel movement in one week.2. Patient tells nurse that bowel movements occur several times a day.3. Patient tells nurse that he/she has daily bowel movements.4. Patient tells nurse that bowel movements consists of hard dry stools.5. Patient tells nurse bowel movements consists of liquid stools.6. Patient tells nurse that he /she has to strain when moving bowels.7. Patient tells nurse that he/she is unable to have a bowel movement.8. Patient tells nurse that he/she has daily bowel movements/patient tell nurse that he/she has only been having bowel movements every 2-3 days.

Constipation—principle

UNIT: Troubleshooting

OBJECTIVE: Learner will recognize an inadequate drain related to constipation.

MEDIA: Inadequate Drain pictures (TS 14, 15, 16)/verbal scenarios

REQUISITE KNOWLEDGE: Inadequate Drain and Constipation Concept Lessons

HOW WILL I EVALUATE WHETHER LEARNING HAS OCCURRED? Learner states the principle “If you have constipation, then you may have an inadequate drain.”

GETTING THE LEARNER READY: “You have learned about constipation and also about inadequate drains. Lets talk know about the relationship of these 2 concepts. I will present situations to you and ask you to guess whether or not they may be related. I will also ask you if you think this is normal. Don't be afraid to guess wrong, that is how you learn. When you are guessing correctly I will ask you why and if you answer correctly, then we will know you understand the relationship between constipation and inadequate drains.”

LEARNER ACTIVITY TEACHER ACTIVITY NOTES

1. Pay attention to concepts. 1. Review concepts and state principles. 1.

2. Guess. 2. Teacher presents scenarios and asks patient to guess. Give feedback re accuracy of description. 2. After verbalizing scenarios ask the learner to guess if this would cause a bloody bag. Show pictures of bloody bags and get learner to state if this is normal.

3. Continue guessing as scenarios that are examples and nonexamples are presented. 3. Continue to present examples and non examples until learner is guessing correctly most of the time.

4. Restate the principles linking the concepts. 4. Have learners restate the principle in their own words.

List of Concepts Linked to Form Principle

1. If you have constipation, then you may have an inadequate drain.

Suggested Scenarios

1. Learner tells teacher that he/she has not had a bowel movement in one week. Show picture of a drain bag with a small amount of fluid (TS 14).2. Learner tells teacher that bowel movements consist of hard dry stools. Show picture of an UltraBag fill bag showing a fill volume of 2500 ml along with a drain bag attached hanging from a spring scale with the markers measuring 1400 ml(TS 15).3. Learner tells teacher that he/she has to strain when moving bowels. Present scenario of a learner who has filled with a 2500 ml bag of solution and only drains a small amount of fluid.4.Learner tells teacher that he/she is unable to have a bowel movement. Present scenario of a learner who has filled with a 2500 ml bag of solution and drains ½ a bag of fluid5. Learner tells teacher that bowel movements consist of hard dry stools. Show Picture of an UltraBag with fill bag showing a volume of 2500 ml along with a drain bag attached hanging from a spring scale with markers measuring 2800 ml(TS 16).6. Learner tells Teacher that he/she has daily bowel movements. Show picture of an UltraBag fill bag showing a fill volume of 2500 ml along with a drain bag attached hanging from a spring scale with the markers measuring 1400 ml(TS 15).

Constipation—judgment/decision

OBJECTIVE: Learner will state if inadequate drain is related to constipation and if so, state correct action to take.

MEDIA: See Constipation Principle Learning Lesson

REQUISITE KNOWLEDGE: Constipation Principle Learning Lesson

HOW WILL I EVALUATE WHETHER LEARNING HAS OCCURRED? When presented with various scenarios, learner states if inadequate drain is related to constipation, and if so, states appropriate action to take.

GETTING THE LEARNER READY: “Now that you have learned about the relationship between inadequate drain and constipation, it is time to learn what to do if your drain is inadequate and you believe it is related to your bowels. I will show you some scenarios and suggest some actions for you to take if this happens to you. You just pay attention and try to memorize the correct actions. We will know that you have learned what to do when you can repeat to me what you should do if you do not drain enough to move on in the exchange because of constipation.”

LEARNER ACTIVITIES TEACHER ACTIVITIES NOTES

1. Pay attention. 1. Review associated concepts.

2. Pay attention. 2. State the principles.

3. Pay attention. 3. Present what the learner should be looking for and possible action steps that should be taken.

4. Repeat the judgment and decision. 4. Ask the learner to repeat the action steps.

5. Process feedback. 5. Provide feedback. 5. Continue until the learner has memorized.

LIST OF PRINCIPLES USED TO MAKE THE JUDGEMENT/DECISION:

If you have constipation, then you may have an inadequate drain.

What the Learner should be looking for?(Judgments) What choice(s)/possible action steps should be taken? (Decisions) Some judgments will have several action steps. Inadequate drain volume, drain time elapsed is 20-30 minutes, and lack of movement into the drain bag. Constipation present. Change position to encourage additional flow. If the drain bag is smaller than the fill bag check the catheter, transfer set, and drain line for kinks, closed clamp, intact frangible. Open any clamps, unkink the tubing, or bend the frangible at the break point back and forth 3-4 times to create additional space. If drain does not resume then clamp the drain line and weigh the bag. If drain volume is >¾ of the fill volume complete the exchange. If the drain volume is <¾ then continue as per facility guidelines. Take an enema as prescribed by facility. Adjust stool softeners, fluid intake, and activity as prescribed by facility. NOTE: Teacher needs to ensure learner knows how to administer an enema. If constipation and inadequate drain volume happens on two consecutive exchanges call the facility.

Constipation—problem solving

OBJECTIVE: Learner will identify inadequate drain related to constipation and take the appropriate action steps.

MEDIA: Verbal Scenarios, apron with Ultra Bag connected with small amount of fluid in drain bag, 2500 ml Ultra Bag hanging on IV pole with drain bag hanging on spring scale with approximately 1400 ml drain volume

REQUISITE KNOWLEDGE: Constipation Decision/Decision Lesson

HOW WILL I EVALUATE WHETHER LEARNING HAS OCCURRED? When presented with scenarios, learner will identify inadequate drain related to constipation and take the appropriate action steps.

GETTING THE LEARNER READY: “You've learned about inadequate drain related to constipation and what to do if this happens to you. Now I will give you problem examples, ask you to tell me what you see, what you know about the situation and what you would do if this happened to you. I will help you along in working through the situation, so don't be afraid. When you can take the correct action, then we will know you can solve this problem at home.”

LEARNER ACTIVITY TEACHER ACTIVITY NOTES

1. Pay attention and recall the concepts. 1. Review associated concepts.

2. Pay attention. 2. State the principles.

3. Solve problems and take correct actions. 3. Present scenario(s) and ask learner to identify the situation and solve the problem. After each scenario, the teacher asks the learner to state the possible problem and describe the appropriate actions to take. 3. Teacher may need to prompt learner to solve the problem i.e. “What is happening here”. If the learner is having difficulties identifying the problem then go back and review associated concepts.

4. Process feedback. 4. Continue feedback. 4. Continue presenting scenarios until learner is developing correct solutions and taking correct actions.

PROBLEM DESCRIPTION: Constipation and related inadequate drain.

LIST OF PRINCIPLES USED TO SOLVE THE PROBLEM:

If you have constipation, then you may have an inadequate drain.

Problem Scenario Problem Solution

1. Present the scenario that the learner has not had a bowel movement in one week. Put an apron on the patient with an Ultra Bag with the drain bag only with a small amount of fluid in it. 1. Learner should take the following actions: Change position to encourage additional flow. If the drain bag is smaller than the fill bag check the catheter, transfer set, and drain line for kinks, closed clamp, intact frangible. Open any clamps, unkink the tubing, or bend the frangible at the break point back and forth 3-4 times to create additional space. If drain does not resume then clamp the drain line and weigh the bag. If drain volume is >¾ of the fill volume complete the exchange. If the drain volume is <¾ then continue as per facility guidelines. Learner will state: Take an enema as prescribed by facility. Learner will state: Adjust stool softeners, fluid intake, and activity as prescribed by facility. Learner will state: If constipation and inadequate drain volume happens on two consecutive exchanges call the facility.

2. Present the scenario that the learner's bowel movements consist of hard dry stools. Hang 2500 ml UltraBag along with the drain bag attached hanging from a spring scale with the markers measuring 1400 ml.2. Learner should take the following actions: Change position to encourage additional flow. If the drain bag is smaller than the fill bag check the catheter, transfer set, and drain line for kinks, closed clamp, intact frangible. Open any clamps, unkink the tubing, or bend the frangible at the break point back and forth 3-4 times to create additional space. If drain does not resume then clamp the drain line and weigh the bag. If drain volume is >¾ of the fill volume complete the exchange. If the drain volume is <3/4 then continue as per facility guidelines. Learner will state: Take an enema as prescribed by facility. Learner will state: Adjust stool softeners, fluid intake, and activity as prescribed by facility. Learner will state: If constipation and inadequate drain volume happens on two consecutive exchanges call the facility.

3. Present the scenario that the learner's bowel movements consist of hard dry stools. Show Picture of an UltraBag with fill bag showing a volume of 2500 ml along with a drain bag attached hanging from a spring scale with markers measuring 2800 ml(TS 16). 2. Learner will identify that this is not a problem of inadequate drain. Learner will state: Take an enema as prescribed by facility. Learner will state: Adjust stool softeners, fluid intake, and activity as prescribed by facility.

Fibrin—concept formation

UNIT: Troubleshooting

OBJECTIVE: The learner will be able to recognize the presence of fibrin in a drained bag.

MEDIA: Pictures of examples and non examples(TS 1, 3, 11-13; FIGS. 9A, 9B, 9F and 9G), simulation.

REQUISITE KNOWLEDGE: UltraBag/Home Choice Procedure, Peritonitis.

HOW WILL I EVALUATE WHETHER LEARNING HAS OCCURRED? When given a description of fibrin and after viewing a picture of a drained bag, the learner will tell the teacher if fibrin is present.

GETTING THE LEARNER READY: “At the end of this lesson you will tell whether a drained bag has fibrin present. I will tell you what fibrin looks like. I will show you pictures of various ways fibrin can look, then I will ask you to guess if there is fibrin. I will tell you if you are right or wrong and why. It is OK if you make mistakes because that is how you learn. We will keep doing this until you are guessing them all correctly and then we will know that you got it.”

LEARNER ACTIVITY TEACHER ACTIVITY NOTES

1. Pay attention to definition. 1. Formulate definition of fibrin 1. Use simple terms that are non-medical

2. Guess if it is example or non-example. 2. Present examples and non-examples of items to illustrate what fibrin is. Give learner feedback about accuracy of guesses.2. Usually start with example/non-example pairs, then as learner is guessing correctly, present single examples and non-examples. Final examples and non-examples should be very close so learner must make fine discriminations.

3. Continue guessing as examples and non-examples are presented. 3. Continue to present examples and non-examples until learner is guessing correctly all of the time.

4. Help teacher formulate definition of fibrin. 4. Have learner formulate definition of fibrin with you. 4. If definition has been presented at start of lesson, have learner use own words to formulate definition.

Definition(Critical Characteristics)

1. White particle in drained fluid.2. White/clear strand in drained fluid.3. White/clear cloud-like formation in drained fluid.4. Raw egg white in appearance.

Suggested Example/Non-Example Pairs(Verbal Descriptions, Suggested Pictures/Video-clips, Scenarios)

1. Picture of a clear drained bag/drained bag with large white particle of fibrin (TS 1/11).2. Picture of a clear drained bag/drained bag with a large white/clear cloud of fibrin present(TS 1/12).3. Picture of a clear dark amber drained bag(TS 13).4. Picture of a clear light yellow drained bag(TS 1).5. Picture of a cloudy drained bag/picture of a clear drained bag with a large particle of fibrin present(TS 3/11).6. Simulate the appearance of fibrin by soaking a cotton ball in a glass of water.7. Simulate the appearance of fibrin by opening a raw egg and pointing out the albumin portion.(optional)8. Simulate the appearance of fibrin by injecting milk into a new solution bag and let stand for several days.

Fibrin—principle

OBJECTIVE: Learner will be able to identify if fibrin is present and conditions warrant intervention.

MEDIA: Pictures (TS 1, 4, 12, 14; FIGS. 9A, 9B, 9F and 9G). Verbal scenarios. Simulations as specified in Fibrin Concept Analysis.

REQUISITE KNOWLEDGE: UltraBag Exchange, Fibrin Concept, Peritonitis, UltraBag Judgment/Decision Memory Lesson.

HOW WILL I EVALUATE WHETHER LEARNING HAS OCCURRED? Learner will state the principles,

1. If fibrin is present, flow may be slowed.

2. If fibrin persists, the catheter may become blocked.

3. If heparin is added, fibrin will decrease.

4. If flow does not resume after heparin is added, the clinic should be notified.

5. If fibrin is present and the drain bag is cloudy, peritonitis is present.

GETTING THE LEARNER READY: “You have learned what fibrin is and what it looks like. Now we will talk about what happens when you have fibrin in your drain line and bag.

LEARNER ACTIVITY TEACHER ACTIVITY NOTES

1. Pay attention to concepts. 1. Review concepts and state principles.

2. Guess. 2. Teacher presents scenarios and asks learner to guess. Give feedback re: accuracy of description.

3. Continue guessing as scenarios that are examples and non-examples are presented. 3. Continue to present examples and non-examples until learner is guessing correctly most of the time.

4. Restate the principles linking the concepts. 4. Have learners restate the principle in their own words.

List of Concepts Linked to Form Principle

1. If fibrin is present, flow may be slowed.2. If fibrin persists, the catheter may become blocked.3. If heparin is added, fibrin will decrease.4. If flow does not resume after heparin is added, the clinic should be notified.5. If fibrin is present in a cloudy bag, peritonitis is present.

Suggested Scenarios

1. Picture of drain bag with small particle of fibrin(TS 4), drain time 15 minutes.

2. Picture of drain bag with fibrin cloud (TS 12), drain time 30 minutes.

3. Verbal description of fibrin particle on light blue frangible, drain bag (TS 14) at 20 minutes.

4. Simulation of fibrin visible in transfer set with cotton ball in water, drain bag (TS 1) time 40 minutes.

5. Simulation of fibrin in cloudy bag with milk.

Fibrin—judgment/decision

OBJECTIVE: The learner will be able to recognize fibrin and state the appropriate action to take.

MEDIA: Pictures of bags with fibrin (TS 1, 4, 12, 14; FIGS. 9A, 9B, 9F and 9G), verbal scenarios, drain bag with milk in dialysate, cotton ball in water, transfer set.

REQUISITE KNOWLEDGE: Fibrin Principle Lesson

HOW WILL I EVALUATE WHETHER LEARNING HAS OCCURRED? When presented with a picture and scenarios of fibrin, the learner will state the appropriate action.

GETTING THE LEARNER READY: “Now that you understand how fibrin can affect your dialysis, it is time to learn what you can do if you see fibrin at home. I will present situations to you and suggest some actions for you take if these happen to you. You just pay attention and try to memorize the correct actions. We will know that you have learned what to do when you can repeat to me what you should do if you have fibrin.”

LEARNER ACTIVITY TEACHER ACTIVITY NOTES

1. Pay attention and recall the concepts. 1. Review associated concepts.

2. Pay attention. 2. State the principles.

3. Pay attention. 3. Present what the learner should be looking for and possible action steps that should be taken. 3. The purpose of this lesson is to get the learner to memorize where/when judgments should be made and the correct actions that should be taken.

4. Repeat the judgment and decision. 4. Ask the learner to repeat the action steps.

5. Process feedback. 5. Provide feedback. 5. Continue until the learner has memorized.

List of Principles used to Make the Judgement/Decision:

1. If fibrin is present, flow may be slowed.

2. If fibrin persists, the catheter may become blocked.

3. If heparin is added, fibrin will decrease.

4. If flow does not resume after heparin is added, the clinic should be notified.

5. If fibrin is present and the drain bag is cloudy, peritonitis is present.

What the Learner should be looking for?(Judgments) What choice(s)/possible action steps should be taken? (Decisions) (some judgments will have several action steps)

1. Picture of small particle of fibrin (TS 4); verbal description drain time 15 minutes.

1. Watch future exchanges for increasing fibrin, prolonged drain time.

2. Picture of drain bag with fibrin cloud (TS 12), verbal description of drain time 30 minutes. 1. Add heparin to fill bag as prescribed; watch future exchanges for fibrin, drain time.

3. Verbal description of fibrin particle on light blue frangible; drain bag (TS 14) at 20 minutes. 1. Bend frangible back and forth to dislodge fibrin, if successful and drain resumes, add heparin to fill bag as prescribed, if unsuccessful and drain does not resume, notify clinic.

4. Simulation of fibrin visible in transfer set with cotton ball in water, drain bag (TS 1) time 40 minutes. 1. Squeeze tubing to dislodge fibrin. Add heparin to fill bag as prescribed. Watch exchanges for fibrin, drain time.

5. Simulation of fibrin in cloudy bag—add milk to drain bag, allow to sit until clabbered. 1. Notify clinic as soon as possible.

Fibrin—problem solving

UNIT: Troubleshooting

OBJECTIVE: Learner will be able to identify fibrin and take the appropriate action steps.

MEDIA: See Fibrin Principle Lesson; plus TS 15, 17; FIGS. 9H and 9I.

REQUISITE KNOWLEDGE: Fibrin Decision/Decision Lesson

HOW WILL I EVALUATE WHETHER LEARNING HAS OCCURRED? Learner will identify fibrin and demonstrate the appropriate actions to take.

GETTING THE LEARNER READY: “You've learned about fibrin and what to do if you see it in your drain bag. Now I will give you problem examples, ask you to tell me what you see, what you know about the situation and what you would do if this happened to you. I will help you along in working through the situation, so don't be afraid. When you can take the correct action, then we will know you can solve this problem at home.”

LEARNER ACTIVITY TEACHER ACTIVITY NOTES

1. Pay attention and recall the concepts. 1. Review associated concepts.

2. Pay attention. 2. State the principles.

3. Solve problems and take correct actions. 3. Present scenario(s) and ask learner to identify the and solve the problem. After each scenario, the teacher asks the learner to state the possible problem and describe the appropriate actions to take. 3. Teacher may need to prompt learner to solve the problem i.e. “What is happening here?”, “What do you know about this?”, and “What do you think you should do?”. If the learner is having difficulty identifying the problem then go back and review associated concepts.

** Problem Solutions to Include Unit Specific Standing Orders.

4. Process feedback. 4. Continue feedback. 4. Continue presenting scenarios until learner is developing correct solutions and taking correct actions.

PROBLEM DESCRIPTION: Fibrin

List of Principles used to Solve the Problem:

1. If fibrin is present, flow may be slowed.

2. If fibrin persists, the catheter may become blocked.

3. If heparin is added, fibrin will decrease.

4. If flow does not resume after heparin is added, the clinic should be notified.

5. If fibrin is present and the drain bag is cloudy, peritonitis is present.

Problem Scenario Problem Solution

1. At the end of an actual drain tell the learner that their effluent “looks like this” and show them a picture of fibrin (TS 12). 1. Learner notes time required to complete drain, add heparin to fill bag, watch future exchanges for increasing fibrin and drain time.

2. At the end of drain, tell learner effluent “looks like this” and show them a picture of fibrin (TS 4). 1. Learner will note time required to complete drain, watch future exchanges for increasing fibrin and drain time.

3. Fifteen minutes into a drain, simulate fibrin particle in transfer set, tell learner effluent “looks like this” and show them decreased drain volume bag (TS 14). 1. Learner demonstrates squeezing transfer set to dislodge fibrin; drain volume does not increase; calls clinic.

4. Twenty minutes elapsed in drain, simulate fibrin hung on light blue frangible, tell learner effluent “looks like this” show picture of decreased drain volume bag being weighed (TS 15). Learner takes correct action—tell learner “now your drain bag looks like this” show picture of drain bag weighing at 2400 ml (TS 17). 1. Learner demonstrates bending frangible to dislodge fibrin. Learner demonstrates adding heparin to fill bag as prescribed. Learner demonstrates watching future exchanges for fibrin and drain time.

5. At the end of an actual drain, tell learner, “now your bag looks like this”, show learner a drained bag with milk injected and allowed to clabber. 1. Learner states he has peritonitis, demonstrates saving bag, calling clinic as soon as possible.

Fluid Overload—principle

UNIT: Troubleshooting

OBJECTIVE: Learner will be able to recognize situations that may lead to fluid overload.

MEDIA: Pictures(FB 10, 12, 14, 15, 16, 25; FIGS. 6E-6H and 6N) See below and Verbal Scenarios. Mock CAPD/CCPD Flow Sheets.

REQUISITE KNOWLEDGE: Fluid Overload Concept Lesson, Intake, Output

HOW WILL I EVALUATE WHETHER LEARNING HAS OCCURRED? Learner will state the principles:

1. If fluid intake exceeds fluid output, then fluid weight will increase.

2. If fluid weight increases, fluid overload may occur.

3. If fluid overload is present, edema may be present.

4. If fluid overload is present, blood pressure may be elevated.

5. If fluid overload is present, it may be difficult to breathe, especially lying down.

GETTING THE LEARNER READY: “You have learned what fluid overload is. Let's talk now about how fluid overload happens and how to recognize it. I will present situations to you and ask you to guess whether or not you think fluid overload may be present. Don't be afraid to guess wrong, that is how you learn. When you are guessing correctly I will ask you why and if you answer correctly, then we will know you understand how to recognize fluid overload.”

LEARNER ACTIVITY TEACHER ACTIVITY NOTES

1. Pay attention to concepts. 1. Review concepts and state principles. 1. Review Fluid Overload concept. State principles.

2. Guess. 2. Teacher presents scenarios and asks learner to guess. Give feedback re: accuracy of description. 2. After verbalizing scenarios or demonstrating scenarios ask the learner to guess if this would cause be a reason to check for fluid overload Get learner to state what to do in each situation.

3. Continue guessing as scenarios that are examples and non-examples are presented. 3. Continue to present examples and non-examples until learner is guessing correctly most of the time.

4. Restate the principles linking the concepts. 4. Have learner restate the principle in their own words.

List of Concepts Linked to Form Principle

1. If fluid intake exceeds fluid output, then fluid weight will increase.2. If fluid weight increases, fluid overload may occur.3. If fluid overload is present, edema may be present.4. If fluid overload is present, blood pressure may be elevated.5. If fluid overload is present, it may be difficult to breathe, especially lying down.

Suggested Scenarios

1. Show picture of glass of water, 250 cc, urinal 100 cc (FB 25) “If you continued to drink more fluid than you produced in urine, would that represent fluid overload?”

2. Mock CAPD/CCPD flow sheet of increasing weights over several days. “If your weight continued to increase 1 lb each day for seven days, would that represent fluid overload?”

3. Show pictures of edema(FB 10 top, FB 12) “If you noticed your eyes looked like this or your looked like this, would that represent fluid overload?”

4. Show mock CAPD/CCPD flow sheet with increased blood pressure, and/or picture of blood pressure monitor with increased blood pressure (FB 14) “If your blood pressure reading was this, would that represent fluid overload?”

5. Show pictures (FB 15, 16) of person sleeping on several pillow and in chair. “If you had to prop up on pillows at night or sleep in a chair to catch your breath, would that represent fluid overload?”

6. Show picture of person exercising on treadmill. “You are exercising vigorously and breathing hard. Is this representative of fluid overload?”

7. Ask learner, “After eating heavily during the holidays, you note your weight has climbed five pounds over the last month. Does this represent fluid overload?”

Fluid Overload—judgment/decision

OBJECTIVE: The learner will be able to identify fluid overload and state the appropriate action.

MEDIA: Verbal scenarios.

REQUISITE KNOWLEDGE: Fluid Overload Principle Lesson.

HOW WILL I EVALUATE WHETHER LEARNING HAS OCCURRED? When presented with a variety of scenarios that could represent fluid overload, the learner will tell the teacher the appropriate action.

GETTING THE LEARNER READY: “Now that you understand what causes fluid overload, it is time to learn what you can do if you become fluid overloaded. I will present situations to you and suggest some actions for you take. You just pay attention and try to memorize the correct actions. We will know that you have learned what to do when you can repeat to me what you should do if become fluid overloaded.”

LEARNER ACTIVITY TEACHER ACTIVITY NOTES

1. Pay attention and recall the concepts. 1. Review associated concepts.

2. Pay attention. 2. State the principles.

3. Pay attention. 3. Present what the learner should be looking for and possible action steps that should be taken. 3. The purpose of this lesson is to get the learner to memorize where/when judgments should be made and the correct actions that should be taken.

4. Repeat the judgment and decision. 4. Ask the learner to repeat the action steps.

5. Process feedback. 5. Provide feedback. 5. Continue until the learner has memorized.

List of Principles used to Make the Judgement/Decision:

1. If fluid intake exceeds fluid output, then fluid weight will increase.

2. If fluid weight increases, fluid overload may occur.

3. If fluid overload is present, edema may be present.

4. If fluid overload is present, blood pressure may be elevated.

5. If fluid overload is present, it may be difficult to breathe, especially lying down.

What the Learner should be looking for?(Judgments) What choice(s)/possible action steps should be taken? (Decisions) (some judgments will have several action steps)

1. Increased weight of several pounds over three days. 1. Check blood pressure.2. Check for edema. If blood pressure is increased and/or edema is present,. decrease fluid and salt intake. use 4.25% and 2.5% dialysate.. call clinic if breathing difficult, or problem not resolved.

2. Edema. 1. Check blood pressure. If increased. decrease salt and fluid intake.. use 4.25% and 2.5% dialysate.. call clinic if breathing difficult, or problem not resolved.

3. Weight above target weight 1. If it has happened over a few days, A. Check blood pressure B. Check for edema. If increased blood pressure,. decrease salt and fluid intake.. use 4.25% and 2.5% dialysate. if breathing difficult, or if no improvement, call the clinic. B. If it has happened over a several weeks or months with increasing appetite, report at next clinic visit.

4. Shortness of breath 1. Check blood pressure. 2. Check for edema.3. Check weight.. If blood pressure elevated, edema present, weight elevated decrease fluid and salt intake. use 4.25% and 2.5% dialysate.. call clinic if or problem not resolved after 4.25% exchange.

5. Shortness of breath with chest pain 1. Call 911.

Fluid Overload—problem solving

OBJECTIVE: The learner will be able to identify fluid overload and take the appropriate action.

MEDIA: See Fluid Overload Principle Lesson

REQUISITE KNOWLEDGE: Fluid Overload Decision/Decision Lesson

HOW WILL I EVALUATE WHETHER LEARNING HAS OCCURRED? The learner will identify episodes of fluid overload and take appropriate actions.

GETTING THE LEARNER READY: “You've learned about fluid overload and what to do if you do become fluid overloaded. Now I will give you problem examples, ask you to tell me what you see, what you know about the situation and what you would do if this happened to you. I will help you along in working through the situation, so don't be afraid. When you can take the correct action, then we will know you can solve this problem at home.”

LEARNER ACTIVITY TEACHER ACTIVITY NOTES

1. Pay attention and recall the concepts. 1. Review associated concepts. 1.

2. Pay attention. 2. State the principles. 1. If fluid intake exceeds fluid output, then fluid weight will increase.2. If fluid weight increases, fluid overload may occur.3. If fluid overload is present, edema may be present.4. If fluid overload is present, blood pressure may be elevated.5. If fluid overload is present, it may be difficult to breathe, especially lying down.

3. Solve problems and take correct actions. 3. Present scenario(s) and ask learner to identify the and solve the problem. 3. Teacher may need to prompt learner to solve the problem i.e. “What is happening here”, “What do you know about this?”, and “What do you think you should do?”. If the learner is having difficulty identifying the problem then go back and review associated concepts. ** Problem solutions to include unit specific standing orders.

4. Process feedback. 4. Continue feedback. 4. Continue presenting scenarios until learner is developing correct solutions and taking correct actions.

PROBLEM DESCRIPTION: Fluid overload

List of Principles used to Solve the Problem:

1. If fluid intake exceeds fluid output, then fluid weight will increase.

2. If fluid weight increases, fluid overload may occur.

3. If fluid overload is present, edema may be present.

4. If fluid overload is present, blood pressure may be elevated.

5. If fluid overload is present, it may be difficult to breathe, especially lying down.

Problem Scenario Problem Solution

1. After going to a picnic and eating salty food, you are so thirsty that you drink a 2 liter drink! 1. Check weight and blood pressure, and check for edema.. If weight is up, blood pressure is up, and edema is present, fluid overload is present.. decrease salt and fluid intake. use 4.25% and 2.5% dialysate until weight and blood pressure are within normal range.. check blood pressure every hour until within normal range.. if problem persists, call clinic.

2. Your weight has crept up six pounds over your target weight over the last several days. Your urine output was really down this week. 1. Check blood pressure and check for edema.. If blood pressure is elevated and/or edema is present. decrease salt and fluid intake. use 4.25% and 2.5% dialysate until weight and blood pressure are within normal range.. check blood pressure every hour until within normal range.. if problem persists, call clinic.

3. You have begun stopping at donut shop on the way to work each morning for the last month. The donuts are so delicious, you are eating three or four! While looking at your flow sheets, you notice your weight has increased three pounds this month! Your blood pressures are okay. 1. Decrease intake of donuts.

4. While lying down to sleep, you notice a sudden shortness of breath. An extra pillow helps a little, but you end up sleeping in the recliner to catch your breath! 1. Check blood pressure and check for edema. If blood pressure is elevated and/or edema is present. decrease salt and fluid intake. use 4.25% and 2.5% dialysate until weight and blood pressure are within normal range.. check blood pressure every hour until within normal range.. if problem persists, call clinic. if chest pain present, call 911

5. Your favorite shoes are too tight, and your ankles are a bit puffy. 1. Check blood pressure and weight.. If blood pressure and/or weight are elevated. decrease salt and fluid intake. use 4.25% and 2.5% dialysate until weight and blood pressure are within normal range.. check blood pressure every hour until within normal range.. if problem persists, call clinic

Dehydration—principle

UNIT: Troubleshooting

OBJECTIVE: Learner will be able to identify if dehydration is present and conditions warrant intervention.

MEDIA: Pictures (UP 17, FB 20, 24; FIGS. 1E, 6K and 6N) Verbal scenarios. Mock CAPD/CCPD Flow Sheets indicating dehydration and euvolemia.

REQUISITE KNOWLEDGE: Dehydration Concept.

HOW WILL I EVALUATE WHETHER LEARNING HAS OCCURRED? Learner will state the principles,

1. If fluid output exceeds fluid intake, fluid weight will decrease.

2. If fluid weight decreases below target weight, dehydration may be present.

3. If dehydration is present, blood pressure will decrease and pulse will increase.

4. If dehydration is present, dizziness may be present.

5. If dehydration is present, fatigue may be present.

GETTING THE LEARNER READY: “You have learned what dehydration is and how to know if you have it. Let's talk now about some causes of dehydration and what you should know if you have it. I will present situations to you and ask you to guess whether or not they may cause dehydration. I will also ask you if you think this is normal. Don't be afraid to guess wrong, that is how you learn. When you are guessing correctly I will ask you why and if you answer correctly, then we will know you understand what causes this condition and if it is normal.”

LEARNER ACTIVITY TEACHER ACTIVITY NOTES

1. Pay attention to concepts. 1. Review concepts and state principles.

2. Guess. 2. Teacher presents scenarios and asks learner to guess. Give feedback re: accuracy of description.

3. Continue guessing as scenarios that are examples and non-examples are presented. 3. Continue to present examples and non-examples until learner is guessing correctly most of the time.

4. Restate the principles linking the concepts. 4. Have learners restate the principle in their own words.

List of Concepts Linked to Form Dehydration Principle

1. If fluid output exceeds fluid intake, fluid weight will decrease.2. If fluid weight decreases below target weight, dehydration may be present.3. If dehydration is present, blood pressure will decrease and pulse will increase.4. If dehydration is present, dizziness may be present.5. If dehydration is present, fatigue may be present.

Suggested Scenarios

1. Verbal description of flu, nausea, vomiting, diarrhea; unable to keep down liquids.

2. Verbal description of use of all 4.25% dextrose dialysate, weight 5 lbs below target weight.

3. Verbal description of use of all 1.5% dextrose dialysate, intake of 3 liters per day, weight 7 lbs above target weight.

4. Picture of decreased blood pressure, increased pulse (FB22) (FIG. 6L).

5. Picture of dizzy character (FB 20) (FIG. 6K).

6. Picture of fatigued character (UP 17) (FIG. 6I).

7. Picture of person exercising, perspiring (FB 18) (FIG. 6J).

Dehydration-judgment/decision

OBJECTIVE: The learner will be able to identify dehydration and state the appropriate action.

MEDIA: Verbal scenarios.

REQUISITE KNOWLEDGE: Dehydration Principle Lesson.

HOW WILL I EVALUATE WHETHER LEARNING HAS OCCURRED? When presented with a variety of scenarios that could represent dehydration, the learner will tell the teacher the appropriate action.

GETTING THE LEARNER READY: “Now that you understand what causes dehydration, it is time to learn what you can do if you become dehydrated. I will present situations to you and suggest some actions for you take. You just pay attention and try to memorize the correct actions. We will know that you have learned what to do when you can repeat to me what you should do if become dehydrated.”

LEARNER ACTIVITY TEACHER ACTIVITY NOTES

1. Pay attention and recall the concepts. 1. Review associated concepts.

2. Pay attention. 2. State the principles.

3. Pay attention. 3. Present what the learner should be looking for and possible action steps that should be taken. 3. The purpose of this lesson is to get the learner to memorize where/when judgments should be made and the correct actions that should be taken.

4. Repeat the judgment and decision. 4. Ask the learner to repeat the action steps.

5. Process feedback. 5. Provide feedback. 5. Continue until the learner has memorized.

List of Principles used to Make the Judgement/Decision:

What the Learner should be looking for?(Judgments) What choice(s)/possible action steps should be taken? (Decisions) (some judgments will have several action steps)

1. Dizziness 1. Lay down until dizziness is gone with your feet higher than your heart.2. Take your blood pressure and pulse.3. If blood pressure is down and pulse is up increase salt and fluid intake—drink salty broth, or eat saltine crackers and drink fluids.. use all 1.5% dialysate.. if you are on blood pressure medication, call the clinic before taking any doses.. recheck your blood pressure and pulse every hour until normal.. reevaluate dialysate dextrose concentration.. call the clinic if no improvement.

2. Decreased blood pressure and increased pulse 1. Increase salt and fluid intake —drink salty broth or eat saltine crackers and drink fluids.. use all 1.5% dialysate.. if you are on blood pressure medication, call clinic before taking doses.. if you are dizzy, lay down with feet elevated above level of heart until all dizziness gone.. recheck your blood pressure and pulse every hour until normal.. reevaluate dialysate dextrose concentration.. call the clinic if no improvement.

3. Weight below dry weight 2. If it has happened over a few days, A. Check blood pressure and pulse. If decreased blood pressure, increased pulse:. increase salt and fluid intake-drink salty broth or eat saltine crackers and drink fluids.. use all 1.5% dialysate. if you are on blood pressure medication, call clinic before taking doses.. recheck your blood pressure and pulse every hour until normal.. if no improvement, call the clinic.2. If it has happened over a several weeks or months with decreasing appetite, call the clinic.

4. Fatigue. 1. Check blood pressure and pulse.2. Check weight. If decreased blood pressure, increased pulse, decreased weight below target weight:. increase salt and fluid intake—drink salty broth or eat saltine crackers and drink fluids.. use all 1.5% dialysate. if you are on blood pressure medication, call clinic before taking doses.. recheck your blood pressure and pulse every hour until normal.. if no improvement, call the clinic.3. If blood pressure and pulse within normal limits, consider other causes (anemia, inadequate dialysis, low potassium).

Dehydration—problem solving

OBJECTIVE: Learner will be able to identify dehydration and take the appropriate action steps.

MEDIA: See Dehydration Principle Lesson

REQUISITE KNOWLEDGE: Dehydration Decision/Decision Lesson

HOW WILL I EVALUATE WHETHER LEARNING HAS OCCURRED? Learner will identify dehydration and demonstrate the appropriate actions to take.

GETTING THE LEARNER READY: “You've learned about dehydration and what to do if you become dehydrated. Now I will give you problem examples, ask you to tell me what you see, what you know about the situation and what you would do if this happened to you. I will help you along in working through the situation, so don't be afraid. When you can take the correct action, then we will know you can solve this problem at home.”

LEARNER ACTIVITY TEACHER ACTIVITY NOTES

1. Pay attention and recall the concepts. 1. Review associated concepts.

2. Pay attention. 2. State the principles.

3. Solve problems and take correct actions. 3. Present scenario(s) and ask learner to identify the and solve the problem. After each scenario, the teacher asks the learner to state the possible problem and describe the appropriate actions to take. 3. Teacher may need to prompt learner to solve the problem i.e. “What is happening here?”, “What do you know about this?”, and “What do you think you should do?”. If the learner is having difficulty identifying the problem then go back and review associated concepts.

** Problem Solutions to Include Unit Specific Standing Orders.

4. Process feedback. 4. Continue feedback. 4. Continue presenting scenarios until learner is developing correct solutions and taking correct actions.

PROBLEM DESCRIPTION: Dehydration

List of Principles used to Solve the Problem:

1. If fluid output exceeds fluid intake, fluid weight will decrease.

2. If fluid weight decreases below target weight, dehydration may be present.

3. If dehydration is present, blood pressure will decrease and pulse will increase.

4. If dehydration is present, dizziness may be present.

5. If dehydration is present, fatigue may be present.

Problem Scenario Problem Solution

1. Tell the learner, “On a routine check of blood pressure and pulse you obtain these readings.” Show picture (FB 22) 1. Learner will lie down if dizzy, increase salt and fluid intake, use all 1.5% dialysate, recheck blood pressure and pulse every hour until normal, call clinic if no improvement; reevaluate dialysate dextrose concentration.

2. Tell the learner, “Due to a case of food poisoning, you have had nausea and vomiting for 24 hours. Upon standing, you are dizzy. What should you do?” (Give the learner a mock CAPD/CCPD flow sheet with decreased blood pressure and increased pulse.” 1. Learner will lie down with feet elevated above level of heart, check blood pressure and pulse; if decreased blood pressure and increased pulse, will increase salt and fluid intake, use all 1.5% dialysate, recheck blood pressure and pulse every hour until normal, call clinic if no improvement, reevaluate dialysate dextrose concentration.

3. Tell the learner, “After working in the yard in the summer heat for two days, you weigh and your weight is (six lbs below the patient's actual target weight). What do you do?” 1. Learner will lie down if dizzy, check blood pressure and pulse; if blood pressure is decreased and pulse is increased, increase salt and fluid intake, use all 1.5% dialysate, recheck blood pressure and pulse every hour until normal, call clinic if no improvement; reevaluate dialysate dextrose concentration.

4. Tell the learner, “You feel very tired today. You have had plenty of sleep. What should you do?” 1. Learner will lie down if dizzy, check blood pressure and pulse; if blood pressure is decreased and pulse is increased, increase salt and fluid intake, use all 1.5% dialysate, recheck blood pressure and pulse every hour until normal, call clinic if no improvement; reevaluate dialysate dextrose concentration.

5. Tell the learner “Over the last month, you have been watching your calories. You note today your weight is down four pounds below target. You feel okay. What should you do?” (Show the learner a mocked up CAPD/CCPD flow sheet with normal blood pressure and pulse, or show FB 13) 1. Learner will check blood pressure and pulse. States readings within normal limits. Pats yourself on back.

The optional but preferred Follow-Up chapter/module is directed to helping the learner organize their care after the initial training period, from scheduling clinic visits to traveling. This chapter would preferably be one of the last ones taught anticipating completion of CAPD/CCPD training. It would also be during this chapter that the learner learns his/her initial PD prescription and to keep CAPD/CCPD flow sheets handy. The trainer should also be prepared to give the learner the on-call procedure and travel guidelines for the clinic the patient is regularly going to visit. Other clinic media may include calendars, telephones and a mock inventory location. The following is a proposed chapter outline of sub-sections based on subject and requisite knowledge:

Clinic Visits (memory)

On-Call Procedure (memory)

PD Prescription (memory)

Ordering and Managing Supplies (memory)

Travel (memory)

A memory learning plan for the Clinic Visits sub-section will give the patient/learner the ability to state the frequency of clinic visits and what the patient/learner should bring to the clinic. The patient/learner will be able to identify situations that would require additional visits or calls to the clinic. Preferred illustration media may include a calendar, completed CAPD/CCPD flow sheets from training days, clinic telephone number, telephone. As an initial point, the trainer will present the information, telling the patient the frequency based on unit protocol; routine (monthly and for adequacy studies) vs. Other (ongoing exit site infection, post-hospitalization, post-training, post-peritonitis, change of modality or prescription). The trainer should use the calendar to emphasize the frequency of visits and normal days for lab draws (Much of this is clinic specific). The trainer will then show the learner the completed flow sheet as an example of what they should be bringing to the clinic. The trainer will also tell the learner that all medications currently being taken should be brought at each routine visit. Also, the patient/learner will be told that the CAPD/CCPD flow sheets are a permanent part of the chart per local/state/federal regulations. The patient/learner should repeat information several times until memorized. Lastly, the trainer will ask the learner to make an appointment and verbalize what they will bring to the clinic, asking also the learner what other instances would result in a clinic visit or call (the appointment may be made prior to the patient leaving on the last training day or later that day once they have returned home). The patient/learner will then make their first clinic appointment. Preferably, the patient/learner will also list the situations that would result in an additional visit or call. Ultimately, the learner will be able to state the frequency of clinic visits and what they should bring to the clinic, and the learner will identify situations when additional visits or calls to the clinic are necessary. A list of information to be memorized may include: Frequency and duration of visits (note, this will likely be unit specific); Call for appointment; Bring all medications; Bring all CAPD/CCPD flow sheets; Frequency of lab draws; Situations that may require additional visits or calls.

A memory learning plan for the On-Call Procedure sub-section will give the patient/learner the ability to state the after hours on-call procedure. Preferred media may include a written on-call procedure for the unit, and a telephone. A trainer may prepare the learner using introductory phrases such as: “At the end of this lesson you will know how to get help when you are at home and having a problem with your dialysis treatment. First I will give you a copy of the after hours procedure and discuss it with you. Then I will help you make a call to the after hours number. When you think you know how to get help for dialysis-related problems, I will ask you to make a call to the after hours number on your own.”

The trainer may then present information to the patient/learner, such as “When you are at home and having a problem, there are specific numbers to call. Then, the trainer can give a written on-call procedure (if not already completed then an on-call procedure should be developed) to the patient, who should repeat the information several times. Use written information to make an after hours call with the help of the teacher. Help learner call the after hours on-call number. Use a speaker telephone system to ensure that learner hears all potential sounds associated with accessing a beeper. Ask the learner to make a call to the after hours on-call number. Make a call to the after hours number.

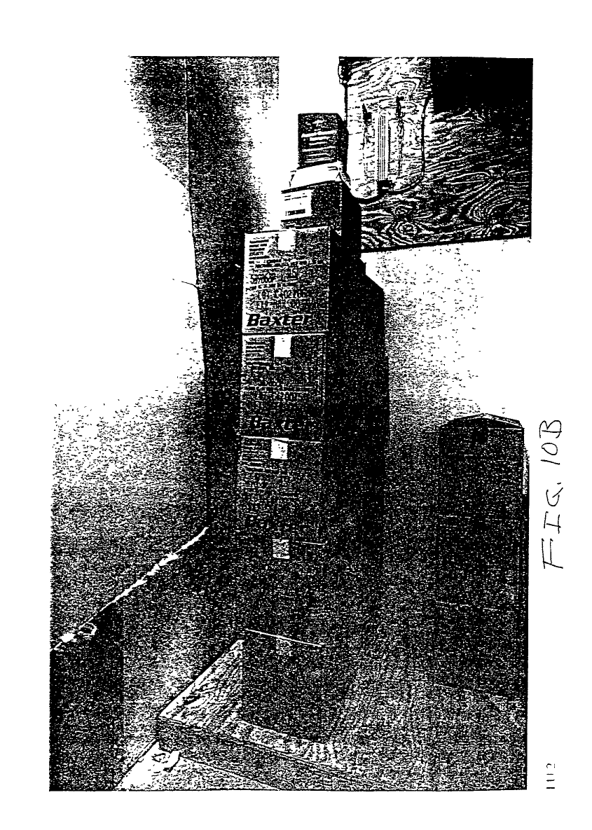

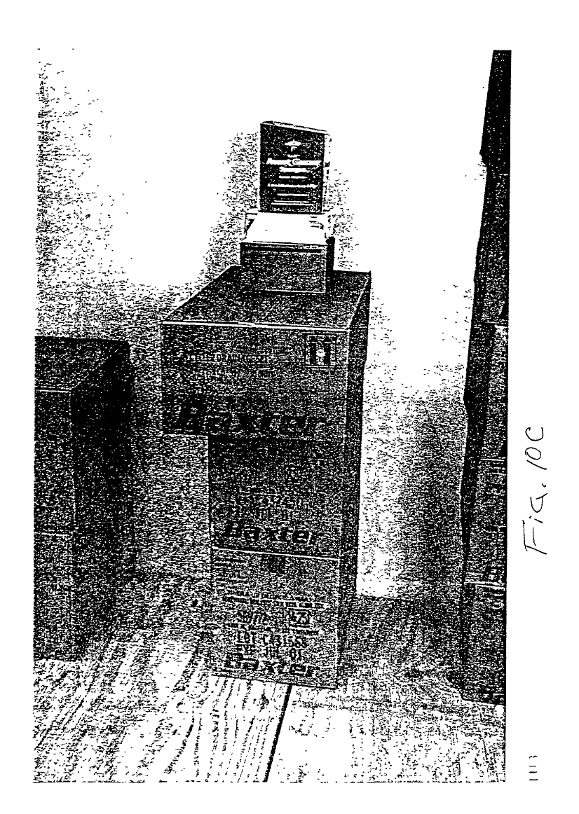

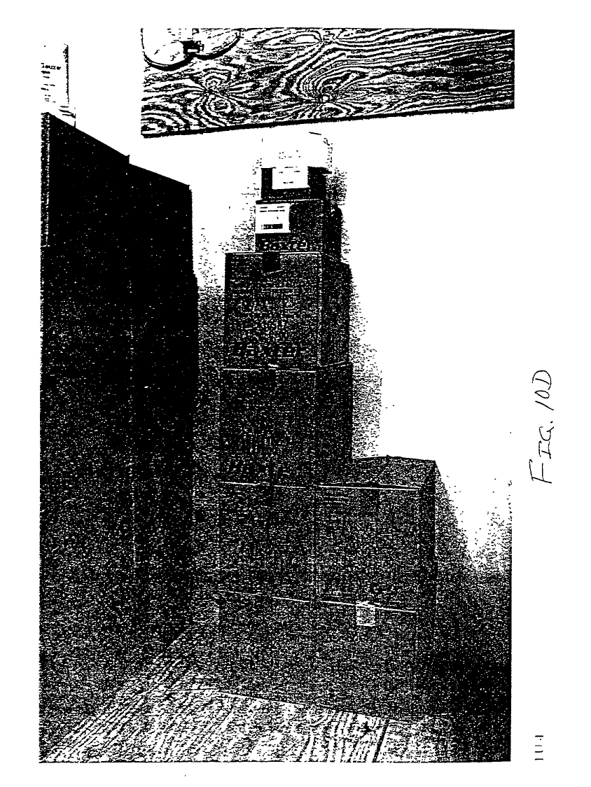

A memory learning plan for the Ordering and Managing Supplies sub-section will give the patient/learner the ability to identify what is necessary to maintain an appropriate inventory of supplies. Preferred MEDIA may include: Pictures of mock inventory appropriate for type of PD (FU 1-4; FIGS. 10A-10D), inventory board, telephone, photocopy of the business card of the supply representative. Ultimately, The learner will successfully place an order for the correct amount of PD supplies. Preparing the learner: “You will be responsible for ordering your PD supplies. At the end of this lesson you will know how to place an order for the correct amount of supplies. I will tell you how to count and record your inventory and how to place an order. I will also explain how to select an appropriate storage site. You will pay attention to what I am saying. At the end of this lesson I will ask you to count and record a sample inventory and place a call to your supply representative.” ACTIVITIES may include: Presentation of information using the picture of the sample inventory. Use the picture of the sample inventory to illustrate what the inventory might look like. Use CAPD or CCPD inventory as appropriate to the modality. Explain appropriate storage conditions, i.e. cool, dry, clean, indoor space large enough to contain most supplies. Also, Presentation of the inventory board as the place to record numbers of supplies. Show the learner the 1-800 # on the board for placing orders and give the learner the extension and name of their supply representative. Tell the learner that they will be given an order and delivery date. Inventory should be counted and ordered on the same date. Tell learner that supplies should be rotated so supplies with earliest expiration dates are used first. It is the responsibility of the delivery person to rotate supplies, but the learner should check this when they count inventory. Give the learner another picture of sample inventory and ask them to count the inventory, record and make a call to the supply representative. The second picture of sample inventory should have some supplies with later expiration dates at the front of the supplies. Learner Counts and records inventory and place a call to the supply representative. The learner should be able to identify that these supplies belong toward the back. If clinic inventory is used, place several boxes with later expiration dates at the front so learner identifies this as being incorrect. This lesson will need to be repeated if the learner changes PD modality.

List of Information to be Memorized

1. Order and delivery date.

2. How to fill out inventory board.

3. Phone number and name of supply representative.

4. Current peritoneal dialysis prescription.

5. Determine trend from CAPD/CCPD flow sheets.

6. Rotating stock.

7. Selection of appropriate storage site.

A memory learning plan for the PD Prescription sub-section will give the patient/learner the ability to state their PD prescription. MEDIA may include: CAPD/CCPD flow sheets. REQUISITE KNOWLEDGE: PD at Home, Dextrose Concentration. Preparing the learner: “At the end of this lesson you will know your initial peritoneal dialysis prescription. I will tell you what your initial prescription is. I will write the prescription down for you on the CAPD/CCPD flow sheet and give you copies to take home. You will pay attention to what I am saying. When you think you know what your prescription is, I will ask you to fill it in on a CAPD/CCPD flow sheet.” Activities may include: Presentation of information using the CAPD/CCPD flow sheets. (May want to write in the learner's name, social security number along with the initial prescription.) Have learner study the CAPD/CCPD flow sheet. Give the learner a CAPD/CCPD flow sheet with their name and social security number on it and ask them to fill in the prescription. If necessary, ask them to study the first CAPD/CCPD flow sheet and then have them fill in the prescription on another CAPD/CCPD flow sheet. . Learner Fills in the prescription on a CAPD/CCPD flow sheet. When the learner correctly fills in the prescription, make 10-15 copies to be taken home. Remind the learner that completed CAPD/CCPD flow sheets need to be brought to clinic visits.

List of Information to be Memorized

1. CAPD: # of exchanges Fill volume Dextrose concentration

2. CCPD: Cycler prescription hours Total therapy volume Fill volume # of cycles Last fill Day fill volume

3. Hi-Dose CCPD: Cycler prescription hours Total therapy volume Fill volume # of cycles Hi-Dose Day fill

A memory learning plan for the Travel sub-section will give the patient/learner the ability to know and use the proper procedure for traveling while on peritoneal dialysis. Preferred MEDIA may include: A List of items needed when traveling (as identified in Gambro PD Policy and Procedure Manual). Ultimately, the learner will state that communication of travel plans is mandatory to start the process of traveling. Preparing the learner may occur as follows: “At the end of this lesson you will know what is required to travel. First I will tell you what is needed to travel and give you a memory trick to help you. I will indicate which of these should come first. I want you to pay attention to what I say and use the memory trick to help you. When you think you know the requirements for travel, I will ask you to tell me them from memory.” Activities may include: Present information to be memorized. Learner Repeats information several times. Tell the learner to ask questions or “say after me.” May be helpful to have the social worker sit in on this lesson to discuss payment of supplies, insurance issues on length of stay, and to identify the back-up facility. Present mnemonics—may ask patient questions to form own associations. See mnemonic as follows. Practice/Test. Question and provide feedback.

List of Information to be Memorized Including Mnemonic(s) or Other Helpful Memory Aids or Memorization Strategies:

1. Communicate travel plans in advance (2 weeks for travel within continental US, 1 month for travel outside the continental US). Car Communicate

2. There is information related to treatment that must be taken along when traveling. Train Transfer information

3. A back-up facility must be identified. Foot Facility

4. May be responsible for transporting all supplies other than solution. Ship Supplies

5. If traveling with the Cycler, will need a note from the physician that it is life-sustaining medical equipment. Cycler is not recommended as checked baggage. Camel Cycler

6. Medications requiring refrigeration should be transported at the appropriate temperature. Motorhome Medication

Thus, this invention provides training systems and methods particularly suited for use in medical self-care situations and in particular in situations where persons being trained have difficulty maintaining safe medical practices or where the individuals being trained have had less success with education curricula. Because of the steps employed and in the manner in which the steps are preferably taught, reinforcement of the training experience is achieved. While specific embodiments have been shown and described, it will be understood by those skilled in the art that changes and modifications may be made thereto without departing from the teachings of the invention herein.

This disclosure also describes the impact of a new patient training curriculum on selected patient outcomes in pilot facilities over a six month period. The curriculum breaks down the tasks needed to perform peritoneal dialysis into the different types of learning required. Each type of learning is learned differently, thus it is taught separately. Lesson plans and media were developed to provide stimulation for all types of learners—auditory, visual, kinesthetic.

The study design was quasi-experimental, using a non-probability convenience sample. Inclusion criteria were all patients new to peritoneal dialysis; exclusion criteria were patients who were non-English speaking; legally blind without a sighted care-giver, prior training on peritoneal dialysis and those residing in nursing homes. Eighteen peritoneal dialysis clinics served as pilot facilities, while fourteen others served as controls. Clinics were chosen based on their interest in participating. Pilot patients were trained using the new curriculum described herein. Control patients were trained using that particular clinic's existing training curriculum. Data collected for all patients included training sessions, both length and number; patient outcomes, including peritonitis and exit site infections, and drop out. Compliance and fluid balance were scored on a 0-4 point scale. A total of 212 patients were trained; 99 patients in the pilot group and 113 in the control group. Peritonitis and exit site infection rates were half in the pilot group versus the control group. These results are shown in Table A.

TABLE A

| | TRAINING | FLUID | | | EXIT SITE |
|---|---|---|---|---|---|
| | TIME | BALANCE | COMPLIANCE | PERITONITIS | INFECTION |
| GROUP | (HRS) | SCORE | SCORE | RATE | RATE |
| PILOT (N = 99) | 27.7 | 3.4 | 3.6 | 1:50.58 | 1:25.25 |
| CONTROL (N = 113) | 21.0 | 3.2 | 3.6 | 1:26.59 | 1:13.30 |

This learning theory-based curriculum for peritoneal dialysis training has thus been demonstrated to promote better patient outcomes during the limited duration of this study. Further study is ongoing to demonstrate long term benefits of this training methodology.

In establishing this peritoneal dialysis patient training methodology, several objectives were first considered; namely, appreciating what were the goals for the Patient Training Pilot and Study; exploring principles of adult learning as related to patients' existing understanding of peritoneal dialysis and their learning styles and modes; outlining teaching methodologies for each type of learning; and demonstrating the teaching of a lesson plan for each type of learning.

To develop the Patient Training System, it was first necessary to develop the goals and decide which outcomes it was desired to have an impact on. Priorities then also had to be established. First was asepsis, then learning to use the UltraBag™ system and then also learning to use the Home Choice system. The primary goal was determined to be improving clinical outcomes by standardizing patient education, thus improving learning efficiency, while maintaining/encouraging the flexibility needed to successfully meet individual patient needs. Finally, analyses and lesson plans were developed and associated media were developed. The system was then tested in a pilot program, as introduced above. The conclusion of the program was that standardized patient training organizes the process and (facilitates) makes patient learning easier and more effective.

What is claimed is:

1. A system for training a patient/learner about a self-care medical procedure, the training system comprising:
one or more training modules,
each training module containing a concept or operation to be learned,
each operation containing one or more steps for performing the operation,
at least one such training module containing an illustration of at least a part of a concept or an operation;
whereby the illustration from the at least one such training module is adapted to be presented to the patient/learner,
whereby the illustration is adapted to provide a demonstration of at least a part of a concept or an operation to the patient/learner;
whereby the at least one such training module is adapted to provide for presenting to the patient/learner the concept or operation associated with the illustration; and
whereby the at least one such training module is adapted to provide for having the patient/learner demonstrate the concept or operation in response to the presentation of the illustration and the concept or operation to the patient/learner.

2. A system according to claim 1 wherein the at least one such training module is further adapted to provide for having the patient/learner demonstrate the concept or operation while referring to the illustration.

3. A system according to claim 1 wherein the at least one such training module includes a verbal presentation associated with the illustration of the concept or operation to be learned.

4. A system according to claim 1 wherein the illustration is a visual presentation.

5. A system according to claim 1 wherein the illustration is a non-visual presentation.

6. A system according to claim 1 wherein the illustration includes what should be avoided relative to the concept or in performing the operation.

7. A system as in claim 1 wherein the at least one such training module is directed to memory training.

8. A system as in claim 1 wherein the at least one such training module is directed to a higher cognitive ability than memory training.

9. A system as in claim 8 wherein the cognitive ability is concept formation.

10. A system as in claim 8 wherein the cognitive ability is principle formation.

11. A system as in claim 8 wherein the cognitive ability is judgment or decision-making.

12. A system as in claim 8 wherein the cognitive ability is problem-solving.

13. A system as in claim 8 wherein the cognitive ability involves motor skill formation.

14. A system as in claim 8 wherein the cognitive ability involves habit formation.

15. A system as in claim 1 wherein the at least one such training module is adapted to provide for a trainer to present feedback to the patient/learner.

16. A system as in claim 1 wherein the training system comprises steps for performing a dialysis operation.

17. A system as in claim 1 wherein the training system comprises steps for performing a peritoneal dialysis operation.

18. A system as in claim 1 wherein the module is an understanding of peritoneal dialysis module.

19. A system as in claim 1 wherein the module is a maintaining asepsis module.

20. A system as in claim 1 wherein the module is a vital signs module.

21. A system as in claim 1 wherein the module is an exit site care module.

22. A system as in claim 1 wherein the module is a tubing set module.

23. A system as in claim 1 wherein the module is a fluid balance module.

24. A system as in claim 1 wherein the module is a diet module.

25. A system as in claim 1 wherein the module is a managing medications module.

26. A system as in claim 1 wherein the module is a subcutaneous medication module.

27. A system as in claim 1 wherein the module is an intra-peritoneal module.

28. A system as in claim 1 wherein the module is a trouble-shooting module.

29. A system as in claim 1 wherein the module is a follow-up procedures module.

30. A system as in claim 1 wherein the module is a module directed to training a patient/learner on a particular peritoneal dialysis system.

31. A method for training a patient/learner, the method comprising:
(a) providing one or more training modules for use in training a patient/learner about a self-care medical operation, each training module involving a concept or operation to be learned, each operation containing one or more steps for performing the operation, at least one such training module containing an illustration of at least a part of a concept or an operation;
(b) presenting to the patient/learner the illustration from the training module, the illustration providing a demonstration of at least a part of a concept or an operation;
(c) presenting to the patient/learner the concept or operation associated with the illustration; and
(d) having the patient/learner demonstrate the concept or operation in response to the presenting steps.

32. A method according to claim 31 wherein the step of having the patient/learner demonstrate the concept or operation includes having the patient/learner demonstrate thus while referring to the illustration.

33. A method according to claim 31 wherein the training module includes a verbal presentation associated with the illustration of the concept or operation to be learned.

34. A method according to claim 31 wherein the illustration is a visual presentation.

35. A method according to claim 31 wherein the illustration is a non-visual presentation.

36. A method according to claim 31 wherein the illustration includes what should be avoided relative to the concept or the performance of the operation.

37. A method as in claim 31 wherein a training module is directed to memory training.

38. A method as in claim 31 wherein a training module is directed to a higher cognitive ability than memory training.

39. A method as in claim 38 wherein the cognitive ability is concept formation.

40. A method as in claim 38 wherein the cognitive ability is principle formation.

41. A method as in claim 38 wherein the cognitive ability is judgment or decision-making.

42. A method as in claim 38 wherein the cognitive ability is problem-solving.

43. A method as in claim 38 wherein the cognitive ability involves motor skill formation.

44. A method as in claim 38 wherein the cognitive ability involves habit formation.

45. A method as in claim 31 wherein a trainer is used for providing feedback to the patient/learner during or after the step of having the patient/learner demonstrate the concept or operation.

46. A method as in claim 31 wherein a training module comprises steps for performing a dialysis operation.

47. A method as in claim 31 wherein a training module comprises steps for performing a peritoneal dialysis operation.

48. A method as in claim 31 wherein a module is an understanding of peritoneal dialysis module.

49. A method as in claim 31 wherein a module is a maintaining asepsis module.

50. A method as in claim 31 wherein a module is a vital signs module.

51. A method as in claim 31 wherein a module is an exit site care module.

52. A method as in claim 31 wherein a module is a tubing set module.

53. A method as in claim 31 wherein a module is a fluid balance module.

54. A method as in claim 31 wherein a module is a diet module.

55. A method as in claim 31 wherein a module is a managing medications module.

56. A method as in claim 31 wherein a module is a subcutaneous medication module.

57. A method as in claim 31 wherein a module is an intra-peritoneal module.

58. A method as in claim 31 wherein a module is a trouble-shooting module.

59. A method as in claim 31 wherein a module is a follow-up procedures module.

60. A method as in claim 31 wherein a module is directed to training a patient/learner on a particular peritoneal dialysis system.

61. A method for training a patient/learner, the method comprising:
(a) providing a training system for use in training a patient/learner about a self-care medical operations, the training system comprising one or more training modules each training module containing a concept or operation to be learned, each operation containing one or more steps for performing the operation, at least one such training module containing an illustration of at least a part of a concept or an operation;
(b) presenting to the patient/learner the illustration from the training module, the illustration providing a demonstration of at least a part of a concept or an operation;
(c) presenting to the patient/learner the concept or operation associated with the illustration; and
(d) having the patient/learner demonstrate the concept or operation in response to the presenting steps.

62. A method according to claim 61 wherein the step of having the patient/learner demonstrate the concept or operation includes having the patient/learner demonstrate thus while referring to the illustration.

63. A method according to claim 61 wherein the training module includes a verbal presentation associated with the illustration of the concept or operation to be learned.

64. A method according to claim 61 wherein the illustration includes what should be avoided relative to the concept or the performance of the operation.
